(19) United States
(12) Patent Application Publication
(10) Pub. No.: US 2022/0161815 A1
(43) Pub. Date: May 26, 2022

(54) AUTONOMOUS VEHICLE SYSTEM

(71) Applicant: Intel Corporation, Santa Clara, CA (US)

(72) Inventors: Petrus J. Van Beek, Fremont, CA (US); Darshana D. Salvi, Foster City, CA (US); Mehrnaz Khodam Hazrati, San Jose, CA (US); Pragya Agrawal, San Jose, CA (US); Darshan Iyer, Santa Clara, CA (US); Suhel Jaber, San Jose, CA (US); Soila P. Kavulya, Hillsboro, OR (US); Hassnaa Moustafa, Portland, OR (US); Patricia Ann Robb, Prairie Grove, IL (US); Naveen Aerrabotu, Fremont, CA (US); Jeffrey M. Ota, Morgan Hill, CA (US); Iman Saleh Moustafa, Mountain View, CA (US); Monica Lucia Martinez-Canales, Los Altos, CA (US); Mohamed Eltabakh, Nuremberg (DE); Cynthia E. Kaschub, San Francisco, CA (US); Rita H. Wouhaybi, Portland, OR (US); Fatema S. Adenwala, Hillsboro, OR (US); Jithin Sankar Sankaran Kutty, Fremont, CA (US); Li Chen, Hillsboro, OR (US); David J. Zage, Livermore, CA (US)

(73) Assignee: Intel Corporation, Santa Clara, CA (US)

(21) Appl. No.: 17/434,721

(22) PCT Filed: Mar. 27, 2020
(86) PCT No.: PCT/US2020/025520

§ 371 Date: Aug. 27, 2021

Related U.S. Application Data
(60) Provisional application No. 62/826,955, filed on Mar. 29, 2019.

(51) Int. Cl. B60W 60/00; B60W 50/00; G06T 9/00

(52) U.S. Cl. CPC B60W 60/001; B60W 50/00; G06T 9/00; B60W 2420/52; B60W 2556/35; B60W 2420/42; B60W 2050/0052

(57) ABSTRACT

According to one embodiment, an apparatus includes an interface to receive sensor data from a plurality of sensors of an autonomous vehicle. The apparatus also includes processing circuitry to apply a sensor abstraction process to the sensor data to produce abstracted scene data, and to use the abstracted scene data in a perception phase of a control process for the autonomous vehicle. The sensor abstraction process may include one or more of: applying a Sensor data response normalization process to the sensor data, applying a warp process to the sensor data, and applying a filtering process to the sensor data.

### CROSS-REFERENCE TO RELATED APPLICATIONS

This application claims the benefit of and priority from U.S. Provisional Patent Application No. 62/826,955 entitled “Autonomous Vehicle System” and filed Mar. 29, 2019, the entire disclosure of which is incorporated herein by reference.

### TECHNICAL FIELD

This disclosure relates in general to the field of computer systems and, more particularly, to computing systems enabling autonomous vehicles.

### BACKGROUND

Some vehicles are configured to operate in an autonomous mode in which the vehicle navigates through an environment with little or no input from a driver. Such a vehicle typically includes one or more sensors that are configured to sense information about the environment, internal and external of the vehicle. The vehicle may use the sensed information to navigate through the environment or determine passenger status. For example, if the sensors sense that the vehicle is approaching an obstacle, the vehicle may navigate around the obstacle. As another example, if the sensors sense that a driver gets drowsy, the vehicle may sound alarms or slow down or come to a stop.

### BRIEF DESCRIPTION OF THE DRAWINGS

FIG. 1 is a simplified illustration showing an example autonomous driving environment.

FIG. 2 is a simplified block diagram illustrating an example implementation of a vehicle (and corresponding in-vehicle computing system) equipped with autonomous driving functionality.

FIG. 3 illustrates an example portion of a neural network in accordance with certain embodiments.

FIG. 4 is a simplified block diagram illustrating example levels of autonomous driving, which may be supported in various vehicles (e.g., by their corresponding in-vehicle computing systems.

FIG. 5 is a simplified block diagram illustrating an example autonomous driving flow which may be implemented in some autonomous driving systems.

FIG. 6 is a simplified diagram showing an example process of rating and validating crowdsourced autonomous vehicle sensor data in accordance with at least one embodiment.

FIG. 7 is a flow diagram of an example process of rating sensor data of an autonomous vehicle in accordance with at least one embodiment.

FIG. 8 is a flow diagram of an example process of rating sensor data of an autonomous vehicle in accordance with at least one embodiment.

FIG. 9 is a simplified diagram of an example environment for autonomous vehicle data collection in accordance with at least one embodiment.

FIG. 10 is a simplified block diagram of an example crowdsourced data collection environment for autonomous vehicles in accordance with at least one embodiment.

FIG. 11 is a simplified diagram of an example heatmap for use in computing a sensor data goodness score in accordance with at least one embodiment.

FIG. 12 is a flow diagram of an example process of computing a goodness score for autonomous vehicle sensor data in accordance with at least one embodiment.

FIG. 13 depicts a flow of data categorization, scoring, and handling according to certain embodiments.

FIG. 14 depicts an example flow for handling data based on categorization in accordance with certain embodiments.

FIG. 15 depicts a system to intelligently generate synthetic data in accordance with certain embodiments.

FIG. 16 depicts a flow for generating synthetic data in accordance with certain embodiments.

FIG. 17 depicts a flow for generating adversarial samples and training a machine learning model based on the adversarial samples.

FIG. 18 depicts a flow for generating a simulated attack data set and training a classification model using the simulated attack data set in accordance with certain embodiments.

FIG. 19 illustrates operation of a non-linear classifier in accordance with certain embodiments.

FIG. 20 illustrates operation of a linear classifier in accordance with certain embodiments.

FIG. 21 depicts a flow for triggering an action based on an accuracy of a linear classifier.

FIG. 22 is a diagram illustrating example Gated Recurrent Unit (GRU) and Long Short Term Memory (LSTM) architectures.

FIG. 23 depicts a system for anomaly detection in accordance with certain embodiments.

FIG. 24 depicts a flow for detecting anomalies in accordance with certain embodiments.

FIG. 25 illustrates an example of a method of restricting the autonomy level of a vehicle on a portion of a road, according to one embodiment.

FIG. 26 illustrates an example of a map wherein each area of the roadways listed shows a road safety score for that portion of the road.

FIG. 27 illustrates communication system for preserving privacy in computer vision systems of vehicles according to at least one embodiment described herein.

FIGS. 28A-28B illustrate example for a discriminator.

FIG. 29 illustrates additional possible component and operational details of GAN configuration system according to at least one embodiment.

FIG. 30 shows example disguised images generated by using a StarGAN based model to modify different facial attributes of an input image.

FIG. 31 shows example disguised images generated by a StarGAN based model from an input image of a real face and results of a face recognition engine that evaluates the real and disguised images.

FIG. 32A shows example disguised images generated by a StarGAN based model from an input image of a real face and results of an emotion detection engine that evaluates the real and the disguised images.

FIG. 32B a listing of input parameters and output results that correspond to the example processing of the emotion detection engine for input image and disguised images illustrated in FIG. 32A.

FIG. 33 shows an example transformation of an input image of a real face to a disguised image as performed by an IcGAN based model.

FIG. 34 illustrates additional possible operational details of a configured GAN model implemented in a vehicle.

FIG. 35 illustrates an example operation of configured GAN model in vehicle to generate a disguised image and the use of the disguised image in machine learning tasks according to at least one embodiment.

FIG. 36 is a simplified flowchart that illustrates a high level of a possible flow of operations associated with configuring a Generative Adversarial Network (GAN) that is trained to perform attribute transfers on images of faces.

FIG. 37 is a simplified flowchart that illustrates a high level of a possible flow of operations associated with operations of a privacy-preserving computer vision system of a vehicle when a configured GAN model is implemented in the system.

FIG. 38 is a simplified flowchart that illustrates a high level of a possible flow of operations associated with operations that may occur when a configured GAN model is applied to an input image.

FIG. 39 illustrates an on-demand privacy compliance system for autonomous vehicles.

FIG. 40 illustrates a representation of data collected by a vehicle and objects defined to ensure privacy compliance for the data.

FIG. 41 shows an example policy template for on-demand privacy compliance system according to at least one embodiment.

FIG. 42 is a simplified block diagram illustrating possible components and a general flow of operations of a vehicle data system.

FIG. 43 illustrates features and activities of an edge or cloud vehicle data system, from a perspective of various possible human actors and hardware and/or software actors.

FIG. 44 is an example portal screen display of an on-demand privacy compliance system for creating policies for data collected by autonomous vehicles.

FIG. 45 shows an example image collected from a vehicle before and after applying a license plate blurring policy to the image.

FIG. 46 shows an example image collected from a vehicle before and after applying a face blurring policy to the image.

FIG. 47 is a simplified flowchart that illustrates a high-level possible flow of operations associated with tagging data collected at a vehicle in an on-demand privacy compliance system.

FIG. 48 is a simplified flowchart that illustrates a high-level possible flow of operations associated with policy enforcement in an on-demand privacy compliance system.

FIG. 49 is a simplified flowchart that illustrates a high-level possible flow of operations associated with policy enforcement in an on-demand privacy compliance system.

FIG. 50 is a simplified diagram of a control loop for automation of an autonomous vehicle in accordance with at least one embodiment.

FIG. 51 is a simplified diagram of a Generalized Data Input (GDI) for automation of an autonomous vehicle in accordance with at least one embodiment.

FIG. 52 is a diagram of an example GDI sharing environment in accordance with at least one embodiment.

FIG. 53 is a diagram of an example blockchain topology in accordance with at least one embodiment.

FIG. 54 is a diagram of an example “chainless” block using a directed acyclic graph (DAG) topology in accordance with at least one embodiment.

FIG. 55 is a simplified block diagram of an example secure intra-vehicle communication protocol for an autonomous vehicle in accordance with at least one embodiment.

FIG. 56 is a simplified block diagram of an example secure inter-vehicle communication protocol for an autonomous vehicle in accordance with at least one embodiment.

FIG. 57 is a simplified block diagram of an example secure intra-vehicle communication protocol for an autonomous vehicle in accordance with at least one embodiment.

FIG. 58A depicts a system for determining sampling rates for a plurality of sensors in accordance with certain embodiments.

FIG. 58B depicts a machine learning algorithm to generate a context model in accordance with certain embodiments.

FIG. 59 depicts a fusion algorithm to generate a fusion-context dictionary in accordance with certain embodiments.

FIG. 60 depicts an inference phase for determining selective sampling and fused sensor weights in accordance with certain embodiments.

FIG. 61 illustrates differential weights of the sensors for various contexts.

FIG. 62A illustrates an approach for learning weights for sensors under different contexts in accordance with certain embodiments.

FIG. 62B illustrates a more detailed approach for learning weights for sensors under different contexts in accordance with certain embodiments.

FIG. 63 depicts a flow for determining a sampling policy in accordance with certain embodiments.

FIG. 64 is a simplified diagram of example VLC or Li-Fi communications between autonomous vehicles in accordance with at least one embodiment.

FIGS. 65A-65B are simplified diagrams of example VLC or Li-Fi sensor locations on an autonomous vehicle in accordance with at least one embodiment.

FIG. 66 is a simplified diagram of example VLC or Li-Fi communication between a subject vehicle and a traffic vehicle in accordance with at least one embodiment.

FIG. 67 is a simplified diagram of example process of using VLC or Li-Fi information in a sensor fusion process of an autonomous vehicle in accordance with at least one embodiment.

FIG. 68A illustrates a processing pipeline for a single stream of sensor data coming from a single sensor.

FIG. 68B illustrates an example image obtained directly from LIDAR data.

FIG. 69 shows example parallel processing pipelines for processing multiple streams of sensor data.

FIG. 70 shows a processing pipeline where data from multiple sensors is being combined by the filtering action.

FIG. 71 shows a processing pipeline where data from multiple sensors is being combined by a fusion action after all actions of sensor abstraction outlined above.

FIG. 72 depicts a flow for generating training data including high-resolution and corresponding low-resolution images in accordance with certain embodiments.

FIG. 73 depicts a training phase for a model to generate high-resolution images from low-resolutions images in accordance with certain embodiments.

FIG. 74 depicts an inference phase for a model to generate high-resolution images from low-resolution images in accordance with certain embodiments.

FIG. 75 depicts a training phase for training a student model using knowledge distillation in accordance with certain embodiments.

FIG. 76 depicts an inference phase for a student model trained using knowledge distillation in accordance with certain embodiments.

FIG. 77 depicts a flow for increasing resolution of captured images for use in object detection in accordance with certain embodiments.

FIG. 78 depicts a flow for training a machine learning model based on an ensemble of methods in accordance with certain embodiments.

FIG. 79 illustrates an example of a situation in which an autonomous vehicle has occluded sensors, thereby making a driving situation potentially dangerous.

FIG. 80 illustrates an example high-level architecture diagram of a system that uses vehicle cooperation.

FIG. 81 illustrates an example of a situation in which multiple actions are contemplated by multiple vehicles.

FIG. 82 depicts a vehicle having dynamically adjustable image sensors and calibration markers.

FIG. 83 depicts the vehicle of FIG. 82 with a rotated image sensor.

FIG. 84 depicts a flow for adjusting an image sensor of a vehicle in accordance with certain embodiments.

FIG. 85 is an example illustration of a processor according to an embodiment.

FIG. 86 illustrates a computing system that is arranged in a point-to-point (PtP) configuration according to an embodiment.

### DESCRIPTION OF EXAMPLE EMBODIMENTS

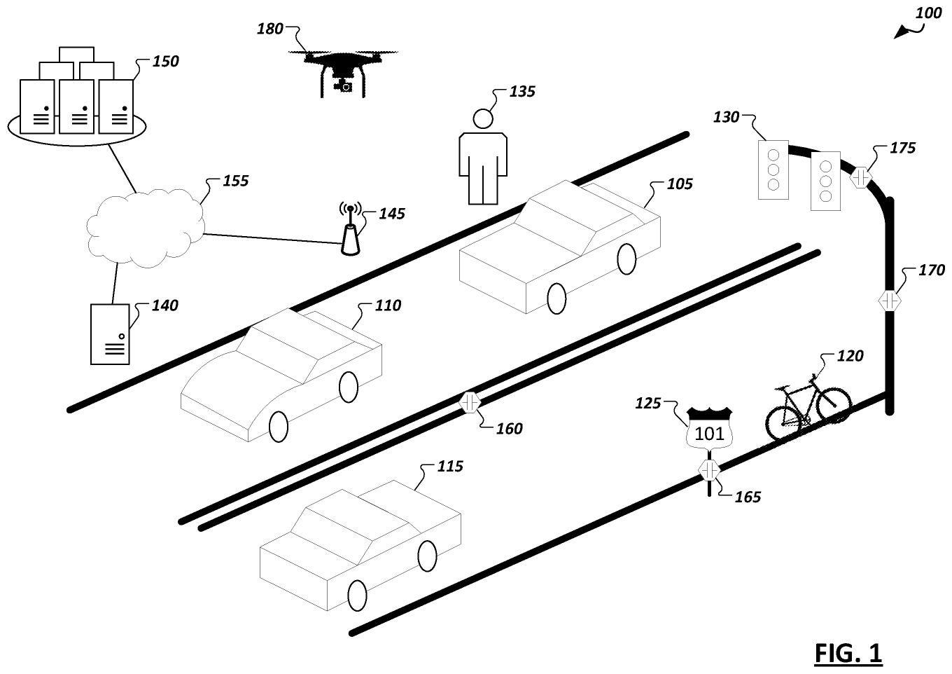

FIG. 1 is a simplified illustration 100 showing an example autonomous driving environment. Vehicles (e.g., 105, 110, 115, etc.) may be provided with varying levels of autonomous driving capabilities facilitated through in-vehicle computing systems with logic implemented in hardware, firmware, and/or software to enable respective autonomous driving stacks. Such autonomous driving stacks may allow vehicles to self-control or provide driver assistance to detect roadways, navigate from one point to another, detect other vehicles and road actors (e.g., pedestrians (e.g., 135), bicyclists, etc.), detect obstacles and hazards (e.g., 120), and road conditions (e.g., traffic, road conditions, weather conditions, etc.), and adjust control and guidance of the vehicle accordingly. Within the present disclosure, a “vehicle” may be a manned vehicle designed to carry one or more human passengers (e.g., cars, trucks, vans, buses, motorcycles, trains, aerial transport vehicles, ambulance, etc.), an unmanned vehicle to drive with or without human passengers (e.g., freight vehicles (e.g., trucks, rail-based vehicles, etc.), vehicles for transporting non-human passengers (e.g., livestock transports, etc.), and/or drones (e.g., land-based or aerial drones or robots, which are to move within a driving environment (e.g., to collect information concerning the driving environment, provide assistance with the automation of other vehicles, perform road maintenance tasks, provide industrial tasks, provide public safety and emergency response tasks, etc.). In some implementations, a vehicle may be a system configured to operate alternatively in multiple different modes (e.g., passenger vehicle, unmanned vehicle, or drone vehicle), among other examples. A vehicle may “drive” within an environment to move the vehicle along the ground (e.g., paved or unpaved road, path, or landscape), through water, or through the air. In this sense, a “road” or “roadway”, depending on the implementation, may embody an outdoor or indoor ground-based path, a water channel, or a defined aerial boundary. Accordingly, it should be appreciated that the following disclosure and related embodiments may apply equally to various contexts and vehicle implementation examples

In some implementations, vehicles (e.g., 105, 110, 115) within the environment may be “connected” in that the in-vehicle computing systems include communication modules to support wireless communication using one or more technologies (e.g., IEEE 802.11 communications (e.g., WiFi), cellular data networks (e.g., 3rd Generation Partnership Project (3GPP) networks (4G, 5G, 6G, etc.), Global System for Mobile Communication (GSM), general packet radio service, code division multiple access (CDMA), etc.), Bluetooth, millimeter wave (mmWave), ZigBee, Z-Wave, etc.), allowing the in-vehicle computing systems to connect to and communicate with other computing systems, such as the in-vehicle computing systems of other vehicles, roadside units, cloud-based computing systems, or other supporting infrastructure. For instance, in some implementations, vehicles (e.g., 105, 110, 115) may communicate with computing systems providing sensors, data, and services in support of the vehicles' own autonomous driving capabilities. For instance, as shown in the illustrative example of FIG. 1, supporting drones 180 (e.g., ground-based and/or aerial), roadside computing devices (e.g., 140), various external (to the vehicle, or “extraneous”) sensor devices (e.g., 160, 165, 170, 175, etc.), and other devices may be provided as autonomous driving infrastructure separate from the computing systems, sensors, and logic implemented on the vehicles (e.g., 105, 110, 115) to support and improve autonomous driving results provided through the vehicles, among other examples. Vehicles may also communicate with other connected vehicles over wireless communication channels to share data and coordinate movement within an autonomous driving environment, among other example communications.

As illustrated in the example of FIG. 1, autonomous driving infrastructure may incorporate a variety of different systems. Such systems may vary depending on the location, with more developed roadways (e.g., roadways controlled by specific municipalities or toll authorities, roadways in urban areas, sections of roadways known to be problematic for autonomous vehicles, etc.) having a greater number or more advanced supporting infrastructure devices than other sections of roadway, etc. For instance, supplemental sensor devices (e.g., 160, 165, 170, 175) may be provided, which include sensors for observing portions of roadways and vehicles moving within the environment and generating corresponding data describing or embodying the observations of the sensors. As examples, sensor devices may be embedded within the roadway itself (e.g., sensor 160), on roadside or overhead signage (e.g., sensor 165 on sign 125), sensors (e.g., 170, 175) attached to electronic roadside equipment or fixtures (e.g., traffic lights (e.g., 130), electronic road signs, electronic billboards, etc.), dedicated road side units (e.g., 140), among other examples. Sensor devices may also include communication capabilities to communicate their collected sensor data directly to nearby connected vehicles or to fog- or cloud-based computing systems (e.g., 140, 150). Vehicles may obtain sensor data collected by external sensor devices (e.g., 160, 165, 170, 175, 180), or data embodying observations or recommendations generated by other systems (e.g., 140, 150) based on sensor data from these sensor devices (e.g., 160, 165, 170, 175, 180), and use this data in sensor fusion, inference, path planning, and other tasks performed by the in-vehicle autonomous driving system. In some cases, such extraneous sensors and sensor data may, in actuality, be within the vehicle, such as in the form of an after-market sensor attached to the vehicle, a personal computing device (e.g., smartphone, wearable, etc.) carried or worn by passengers of the vehicle, etc. Other road actors, including pedestrians, bicycles, drones, unmanned aerial vehicles, robots, electronic scooters, etc., may also be provided with or carry sensors to generate sensor data describing an autonomous driving environment, which may be used and consumed by autonomous vehicles, cloud- or fog-based support systems (e.g., 140, 150), other sensor devices (e.g., 160, 165, 170, 175, 180), among other examples.

As autonomous vehicle systems may possess varying levels of functionality and sophistication, support infrastructure may be called upon to supplement not only the sensing capabilities of some vehicles, but also the computer and machine learning functionality enabling autonomous driving functionality of some vehicles. For instance, compute resources and autonomous driving logic used to facilitate machine learning model training and use of such machine learning models may be provided on the in-vehicle computing systems entirely or partially on both the in-vehicle systems and some external systems (e.g., 140, 150). For instance, a connected vehicle may communicate with road-side units, edge systems, or cloud-based devices (e.g., 140) local to a particular segment of roadway, with such devices (e.g., 140) capable of providing data (e.g., sensor data aggregated from local sensors (e.g., 160, 165, 170, 175, 180) or data reported from sensors of other vehicles), performing computations (as a service) on data provided by a vehicle to supplement the capabilities native to the vehicle, and/or push information to passing or approaching vehicles (e.g., based on sensor data collected at the device 140 or from nearby sensor devices, etc.). A connected vehicle (e.g., 105, 110, 115) may also or instead communicate with cloud-based computing systems (e.g., 150), which may provide similar memory, sensing, and computational resources to enhance those available at the vehicle. For instance, a cloud-based system (e.g., 150) may collect sensor data from a variety of devices in one or more locations and utilize this data to build and/or train machine-learning models which may be used at the cloud-based system (to provide results to various vehicles (e.g., 105, 110, 115) in communication with the cloud-based system 150, or to push to vehicles for use by their in-vehicle systems, among other example implementations. Access points (e.g., 145), such as cell-phone towers, road-side units, network access points mounted to various roadway infrastructure, access points provided by neighboring vehicles or buildings, and other access points, may be provided within an environment and used to facilitate communication over one or more local or wide area networks (e.g., 155) between cloud-based systems (e.g., 150) and various vehicles (e.g., 105, 110, 115). Through such infrastructure and computing systems, it should be appreciated that the examples, features, and solutions discussed herein may be performed entirely by one or more of such in-vehicle computing systems, fog-based or edge computing devices, or cloud-based computing systems, or by combinations of the foregoing through communication and cooperation between the systems.

In general, “servers,” “clients,” “computing devices,” “network elements,” “hosts,” “platforms”, “sensor devices,” “edge device,” “autonomous driving systems”, “autonomous vehicles”, “fog-based system”, “cloud-based system”, and “systems” generally, etc. discussed herein can include electronic computing devices operable to receive, transmit, process, store, or manage data and information associated with an autonomous driving environment. As used in this document, the term “computer,” “processor,” “processor device,” or “processing device” is intended to encompass any suitable processing apparatus, including central processing units (CPUs), graphical processing units (GPUs), application specific integrated circuits (ASICs), field programmable gate arrays (FPGAs), digital signal processors (DSPs), tensor processors and other matrix arithmetic processors, among other examples. For example, elements shown as single devices within the environment may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

Any of the flows, methods, processes (or portions thereof) or functionality of any of the various components described below or illustrated in the figures may be performed by any suitable computing logic, such as one or more modules, engines, blocks, units, models, systems, or other suitable computing logic. Reference herein to a “module”, “engine”, “block”, “unit”, “model”, “system” or “logic” may refer to hardware, firmware, software and/or combinations of each to perform one or more functions. As an example, a module, engine, block, unit, model, system, or logic may include one or more hardware components, such as a micro-controller or processor, associated with a non-transitory medium to store code adapted to be executed by the micro-controller or processor. Therefore, reference to a module, engine, block, unit, model, system, or logic, in one embodiment, may refers to hardware, which is specifically configured to recognize and/or execute the code to be held on a non-transitory medium. Furthermore, in another embodiment, use of module, engine, block, unit, model, system, or logic refers to the non-transitory medium including the code, which is specifically adapted to be executed by the microcontroller or processor to perform predetermined operations. And as can be inferred, in yet another embodiment, a module, engine, block, unit, model, system, or logic may refer to the combination of the hardware and the non-transitory medium. In various embodiments, a module, engine, block, unit, model, system, or logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. A module, engine, block, unit, model, system, or logic may include one or more gates or other circuit components, which may be implemented by, e.g., transistors. In some embodiments, a module, engine, block, unit, model, system, or logic may be fully embodied as software. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. Furthermore, logic boundaries that are illustrated as separate commonly vary and potentially overlap. For example, a first and second module (or multiple engines, blocks, units, models, systems, or logics) may share hardware, software, firmware, or a combination thereof, while potentially retaining some independent hardware, software, or firmware.

The flows, methods, and processes described below and in the accompanying figures are merely representative of functions that may be performed in particular embodiments. In other embodiments, additional functions may be performed in the flows, methods, and processes. Various embodiments of the present disclosure contemplate any suitable signaling mechanisms for accomplishing the functions described herein. Some of the functions illustrated herein may be repeated, combined, modified, or deleted within the flows, methods, and processes where appropriate. Additionally, functions may be performed in any suitable order within the flows, methods, and processes without departing from the scope of particular embodiments.

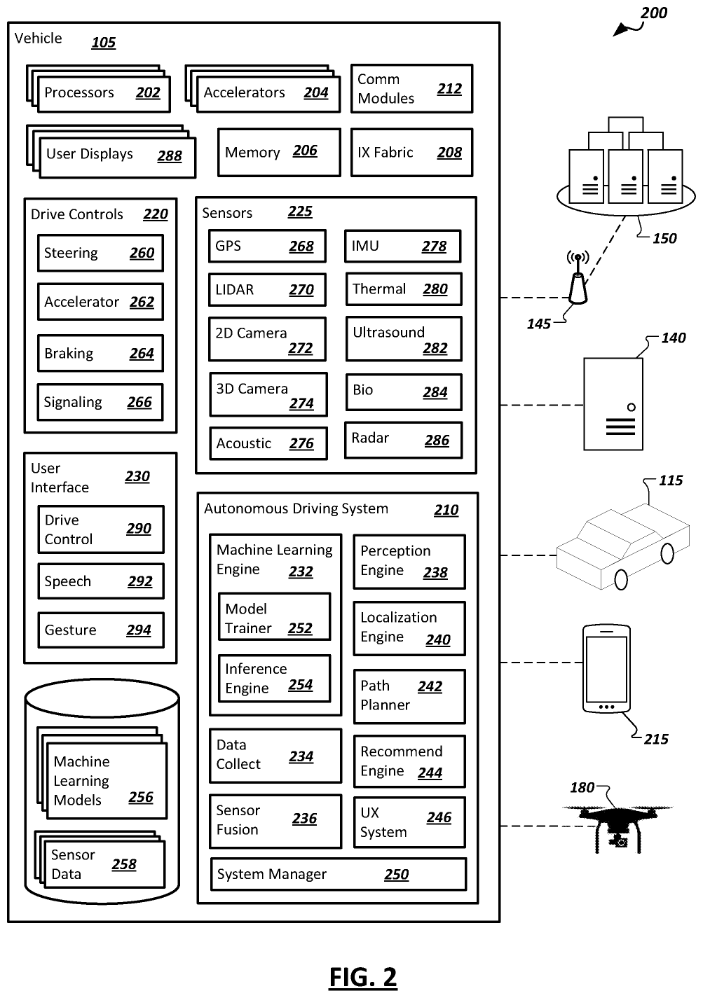

With reference now to FIG. 2, a simplified block diagram 200 is shown illustrating an example implementation of a vehicle (and corresponding in-vehicle computing system) 105 equipped with autonomous driving functionality. In one example, a vehicle 105 may be equipped with one or more processors 202, such as central processing units (CPUs), graphical processing units (GPUs), application specific integrated circuits (ASICs), field programmable gate arrays (FPGAs), digital signal processors (DSPs), tensor processors and other matrix arithmetic processors, among other examples. Such processors 202 may be coupled to or have integrated hardware accelerator devices (e.g., 204), which may be provided with hardware to accelerate certain processing and memory access functions, such as functions relating to machine learning inference or training (including any of the machine learning inference or training described below), processing of particular sensor data (e.g., camera image data, LIDAR point clouds, etc.), performing certain arithmetic functions pertaining to autonomous driving (e.g., matrix arithmetic, convolutional arithmetic, etc.), among other examples. One or more memory elements (e.g., 206) may be provided to store machine-executable instructions implementing all or a portion of any one of the modules or sub-modules of an autonomous driving stack implemented on the vehicle, as well as storing machine learning models (e.g., 256), sensor data (e.g., 258), and other data received, generated, or used in connection with autonomous driving functionality to be performed by the vehicle (or used in connection with the examples and solutions discussed herein). Various communication modules (e.g., 212) may also be provided, implemented in hardware circuitry and/or software to implement communication capabilities used by the vehicle's system to communicate with other extraneous computing systems over one or more network channels employing one or more network communication technologies. These various processors 202, accelerators 204, memory devices 206, and network communication modules 212, may be interconnected on the vehicle system through one or more interconnect fabrics or links (e.g., 208), such as fabrics utilizing technologies such as a Peripheral Component Interconnect Express (PCIe), Ethernet, OpenCAPI™, Gen-Z™, UPI, Universal Serial Bus, (USB), Cache Coherent Interconnect for Accelerators (CCIX™), Advanced Micro Device™'s (AMD™) Infinity™, Common Communication Interface (CCI), or Qualcomm™s Centrig™ interconnect, among others.

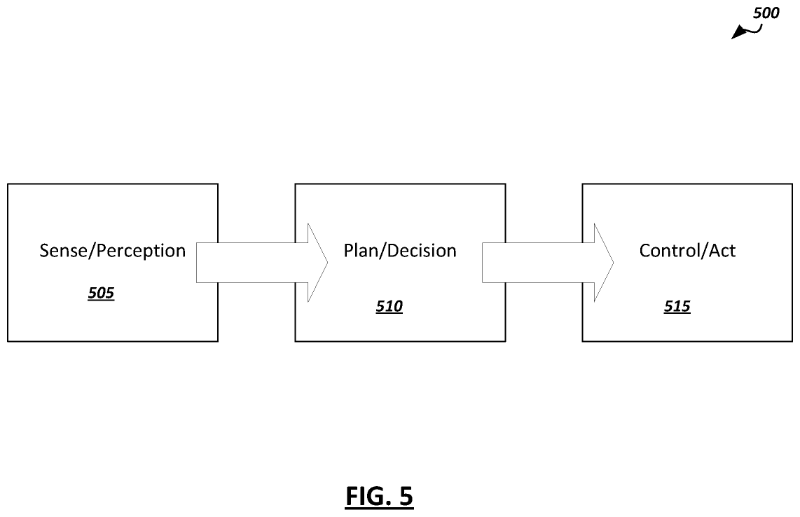

Continuing with the example of FIG. 2, an example vehicle (and corresponding in-vehicle computing system) 105 may include an in-vehicle processing system 210, driving controls (e.g., 220), sensors (e.g., 225), and user/passenger interface(s) (e.g., 230), among other example modules implemented functionality of the autonomous vehicle in hardware and/or software. For instance, an in-vehicle processing system 210, in some implementations, may implement all or a portion of an autonomous driving stack and process flow (e.g., as shown and discussed in the example of FIG. 5). The autonomous driving stack may be implemented in hardware, firmware or software. A machine learning engine 232 may be provided to utilize various machine learning models (e.g., 256) provided at the vehicle 105 in connection with one or more autonomous functions and features provided and implemented at or for the vehicle, such as discussed in the examples herein. Such machine learning models 256 may include artificial neural network models, convolutional neural networks, decision tree-based models, support vector machines (SVMs), Bayesian models, deep learning models, and other example models. In some implementations, an example machine learning engine 232 may include one or more model trainer engines 252 to participate in training (e.g., initial training, continuous training, etc.) of one or more of the machine learning models 256. One or more inference engines 254 may also be provided to utilize the trained machine learning models 256 to derive various inferences, predictions, classifications, and other results. In some embodiments, the machine learning model training or inference described herein may be performed off-vehicle, such as by computing system 140 or 150.

The machine learning engine(s) 232 provided at the vehicle may be utilized to support and provide results for use by other logical components and modules of the in-vehicle processing system 210 implementing an autonomous driving stack and other autonomous-driving-related features. For instance, a data collection module 234 may be provided with logic to determine sources from which data is to be collected (e.g., for inputs in the training or use of various machine learning models 256 used by the vehicle). For instance, the particular source (e.g., internal sensors (e.g., 225) or extraneous sources (e.g., 115, 140, 150, 180, 215, etc.)) may be selected, as well as the frequency and fidelity at which the data may be sampled is selected. In some cases, such selections and configurations may be made at least partially autonomously by the data collection module 234 using one or more corresponding machine learning models (e.g., to collect data as appropriate given a particular detected scenario).

A sensor fusion module 236 may also be used to govern the use and processing of the various sensor inputs utilized by the machine learning engine 232 and other modules (e.g., 238, 240, 242, 244, 246, etc.) of the in-vehicle processing system. One or more sensor fusion modules (e.g., 236) may be provided, which may derive an output from multiple sensor data sources (e.g., on the vehicle or extraneous to the vehicle). The sources may be homogenous or heterogeneous types of sources (e.g., multiple inputs from multiple instances of a common type of sensor, or from instances of multiple different types of sensors). An example sensor fusion module 236 may apply direct fusion, indirect fusion, among other example sensor fusion techniques. The output of the sensor fusion may, in some cases by fed as an input (along with potentially additional inputs) to another module of the in-vehicle processing system and/or one or more machine learning models in connection with providing autonomous driving functionality or other functionality, such as described in the example solutions discussed herein.

A perception engine 238 may be provided in some examples, which may take as inputs various sensor data (e.g., 258) including data, in some instances, from extraneous sources and/or sensor fusion module 236 to perform object recognition and/or tracking of detected objects, among other example functions corresponding to autonomous perception of the environment encountered (or to be encountered) by the vehicle 105. Perception engine 238 may perform object recognition from sensor data inputs using deep learning, such as through one or more convolutional neural networks and other machine learning models 256. Object tracking may also be performed to autonomously estimate, from sensor data inputs, whether an object is moving and, if so, along what trajectory. For instance, after a given object is recognized, a perception engine 238 may detect how the given object moves in relation to the vehicle. Such functionality may be used, for instance, to detect objects such as other vehicles, pedestrians, wildlife, cyclists, etc. moving within an environment, which may affect the path of the vehicle on a roadway, among other example uses.

A localization engine 240 may also be included within an in-vehicle processing system 210 in some implementation. In some cases, localization engine 240 may be implemented as a sub-component of a perception engine 238. The localization engine 240 may also make use of one or more machine learning models 256 and sensor fusion (e.g., of LIDAR and GPS data, etc.) to determine a high confidence location of the vehicle and the space it occupies within a given physical space (or “environment”).

A vehicle 105 may further include a path planner 242, which may make use of the results of various other modules, such as data collection 234, sensor fusion 236, perception engine 238, and localization engine (e.g., 240) among others (e.g., recommendation engine 244) to determine a path plan and/or action plan for the vehicle, which may be used by drive controls (e.g., 220) to control the driving of the vehicle 105 within an environment. For instance, a path planner 242 may utilize these inputs and one or more machine learning models to determine probabilities of various events within a driving environment to determine effective real-time plans to act within the environment.

In some implementations, the vehicle 105 may include one or more recommendation engines 244 to generate various recommendations from sensor data generated by the vehicle's 105 own sensors (e.g., 225) as well as sensor data from extraneous sensors (e.g., on sensor devices 115, 180, 215, etc.). Some recommendations may be determined by the recommendation engine 244, which may be provided as inputs to other components of the vehicle's autonomous driving stack to influence determinations that are made by these components. For instance, a recommendation may be determined, which, when considered by a path planner 242, causes the path planner 242 to deviate from decisions or plans it would ordinarily otherwise determine, but for the recommendation. Recommendations may also be generated by recommendation engines (e.g., 244) based on considerations of passenger comfort and experience. In some cases, interior features within the vehicle may be manipulated predictively and autonomously based on these recommendations (which are determined from sensor data (e.g., 258) captured by the vehicle's sensors and/or extraneous sensors, etc.

As introduced above, some vehicle implementations may include user/passenger experience engines (e.g., 246), which may utilize sensor data and outputs of other modules within the vehicle's autonomous driving stack to cause driving maneuvers and changes to the vehicle's cabin environment to enhance the experience of passengers within the vehicle based on the observations captured by the sensor data (e.g., 258). In some instances, aspects of user interfaces (e.g., 230) provided on the vehicle to enable users to interact with the vehicle and its autonomous driving system may be enhanced. In some cases, informational presentations may be generated and provided through user displays (e.g., audio, visual, and/or tactile presentations) to help affect and improve passenger experiences within a vehicle (e.g., 105) among other example uses.

In some cases, a system manager 250 may also be provided, which monitors information collected by various sensors on the vehicle to detect issues relating to the performance of a vehicle's autonomous driving system. For instance, computational errors, sensor outages and issues, availability and quality of communication channels (e.g., provided through communication modules 212), vehicle system checks (e.g., issues relating to the motor, transmission, battery, cooling system, electrical system, tires, etc.), or other operational events may be detected by the system manager 250. Such issues may be identified in system report data generated by the system manager 250, which may be utilized, in some cases as inputs to machine learning models 256 and related autonomous driving modules (e.g., 232, 234, 236, 238, 240, 242, 244, 246, etc.) to enable vehicle system health and issues to also be considered along with other information collected in sensor data 258 in the autonomous driving functionality of the vehicle 105.

In some implementations, an autonomous driving stack of a vehicle 105 may be coupled with drive controls 220 to affect how the vehicle is driven, including steering controls (e.g., 260), accelerator/throttle controls (e.g., 262), braking controls (e.g., 264), signaling controls (e.g., 266), among other examples. In some cases, a vehicle may also be controlled wholly or partially based on user inputs. For instance, user interfaces (e.g., 230), may include driving controls (e.g., a physical or virtual steering wheel, accelerator, brakes, clutch, etc.) to allow a human driver to take control from the autonomous driving system (e.g., in a handover or following a driver assist action). Other sensors may be utilized to accept user/passenger inputs, such as speech detection 292, gesture detection cameras 294, and other examples. User interfaces (e.g., 230) may capture the desires and intentions of the passenger-users and the autonomous driving stack of the vehicle 105 may consider these as additional inputs in controlling the driving of the vehicle (e.g., drive controls 220). In some implementations, drive controls may be governed by external computing systems, such as in cases where a passenger utilizes an external device (e.g., a smartphone or tablet) to provide driving direction or control, or in cases of a remote valet service, where an external driver or system takes over control of the vehicle (e.g., based on an emergency event), among other example implementations.

As discussed above, the autonomous driving stack of a vehicle may utilize a variety of sensor data (e.g., 258) generated by various sensors provided on and external to the vehicle. As an example, a vehicle 105 may possess an array of sensors 225 to collect various information relating to the exterior of the vehicle and the surrounding environment, vehicle system status, conditions within the vehicle, and other information usable by the modules of the vehicle's processing system 210. For instance, such sensors 225 may include global positioning (GPS) sensors 268, light detection and ranging (LIDAR) sensors 270, two-dimensional (2D) cameras 272, three-dimensional (3D) or stereo cameras 274, acoustic sensors 276, inertial measurement unit (IMU) sensors 278, thermal sensors 280, ultrasound sensors 282, bio sensors 284 (e.g., facial recognition, voice recognition, heart rate sensors, body temperature sensors, emotion detection sensors, etc.), radar sensors 286, weather sensors (not shown), among other example sensors. Such sensors may be utilized in combination to determine various attributes and conditions of the environment in which the vehicle operates (e.g., weather, obstacles, traffic, road conditions, etc.), the passengers within the vehicle (e.g., passenger or driver awareness or alertness, passenger comfort or mood, passenger health or physiological conditions, etc.), other contents of the vehicle (e.g., packages, livestock, freight, luggage, etc.), subsystems of the vehicle, among other examples. Sensor data 258 may also (or instead) be generated by sensors that are not integrally coupled to the vehicle, including sensors on other vehicles (e.g., 115) (which may be communicated to the vehicle 105 through vehicle-to-vehicle communications or other techniques), sensors on ground-based or aerial drones 180, sensors of user devices 215 (e.g., a smartphone or wearable) carried by human users inside or outside the vehicle 105, and sensors mounted or provided with other roadside elements, such as a roadside unit (e.g., 140), road sign, traffic light, streetlight, etc. Sensor data from such extraneous sensor devices may be provided directly from the sensor devices to the vehicle or may be provided through data aggregation devices or as results generated based on these sensors by other computing systems (e.g., 140, 150), among other example implementations.

In some implementations, an autonomous vehicle system 105 may interface with and leverage information and services provided by other computing systems to enhance, enable, or otherwise support the autonomous driving functionality of the device 105. In some instances, some autonomous driving features (including some of the example solutions discussed herein) may be enabled through services, computing logic, machine learning models, data, or other resources of computing systems external to a vehicle. When such external systems are unavailable to a vehicle, it may be that these features are at least temporarily disabled. For instance, external computing systems may be provided and leveraged, which are hosted in road-side units or fog-based edge devices (e.g., 140), other (e.g., higher-level) vehicles (e.g., 115), and cloud-based systems 150 (e.g., accessible through various network access points (e.g., 145)). A roadside unit 140 or cloud-based system 150 (or other cooperating system, with which a vehicle (e.g., 105) interacts may include all or a portion of the logic illustrated as belonging to an example in-vehicle processing system (e.g., 210), along with potentially additional functionality and logic. For instance, a cloud-based computing system, road side unit 140, or other computing system may include a machine learning engine supporting either or both model training and inference engine logic. For instance, such external systems may possess higher-end computing resources and more developed or up-to-date machine learning models, allowing these services to provide superior results to what would be generated natively on a vehicle's processing system 210. For instance, an in-vehicle processing system 210 may rely on the machine learning training, machine learning inference, and/or machine learning models provided through a cloud-based service for certain tasks and handling certain scenarios. Indeed, it should be appreciated that one or more of the modules discussed and illustrated as belonging to vehicle 105 may, in some implementations, be alternatively or redundantly provided within a cloud-based, fog-based, or other computing system supporting an autonomous driving environment.

Various embodiments herein may utilize one or more machine learning models to perform functions of the autonomous vehicle stack (or other functions described herein). A machine learning model may be executed by a computing system to progressively improve performance of a specific task. In some embodiments, parameters of a machine learning model may be adjusted during a training phase based on training data. A trained machine learning model may then be used during an inference phase to make predictions or decisions based on input data.

The machine learning models described herein may take any suitable form or utilize any suitable techniques. For example, any of the machine learning models may utilize supervised learning, semi-supervised learning, unsupervised learning, or reinforcement learning techniques.

In supervised learning, the model may be built using a training set of data that contains both the inputs and corresponding desired outputs. Each training instance may include one or more inputs and a desired output. Training may include iterating through training instances and using an objective function to teach the model to predict the output for new inputs. In semi-supervised learning, a portion of the inputs in the training set may be missing the desired outputs.

In unsupervised learning, the model may be built from a set of data which contains only inputs and no desired outputs. The unsupervised model may be used to find structure in the data (e.g., grouping or clustering of data points) by discovering patterns in the data. Techniques that may be implemented in an unsupervised learning model include, e.g., self-organizing maps, nearest-neighbor mapping, k-means clustering, and singular value decomposition.

Reinforcement learning models may be given positive or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

Various embodiments described herein may utilize one or more classification models. In a classification model, the outputs may be restricted to a limited set of values. The classification model may output a class for an input set of one or more input values. References herein to classification models may contemplate a model that implements, e.g., any one or more of the following techniques: linear classifiers (e.g., logistic regression or naïve Bayes classifier), support vector machines, decision trees, boosted trees, random forest, neural networks, or nearest neighbor.

Various embodiments described herein may utilize one or more regression models. A regression model may output a numerical value from a continuous range based on an input set of one or more values. References herein to regression models may contemplate a model that implements, e.g., any one or more of the following techniques (or other suitable techniques): linear regression, decision trees, random forest, or neural networks.

In various embodiments, any of the machine learning models discussed herein may utilize one or more neural networks. A neural network may include a group of neural units loosely modeled after the structure of a biological brain which includes large clusters of neurons connected by synapses. In a neural network, neural units are connected to other neural units via links which may be excitatory or inhibitory in their effect on the activation state of connected neural units. A neural unit may perform a function utilizing the values of its inputs to update a membrane potential of the neural unit. A neural unit may propagate a spike signal to connected neural units when a threshold associated with the neural unit is surpassed. A neural network may be trained or otherwise adapted to perform various data processing tasks (including tasks performed by the autonomous vehicle stack), such as computer vision tasks, speech recognition tasks, or other suitable computing tasks.

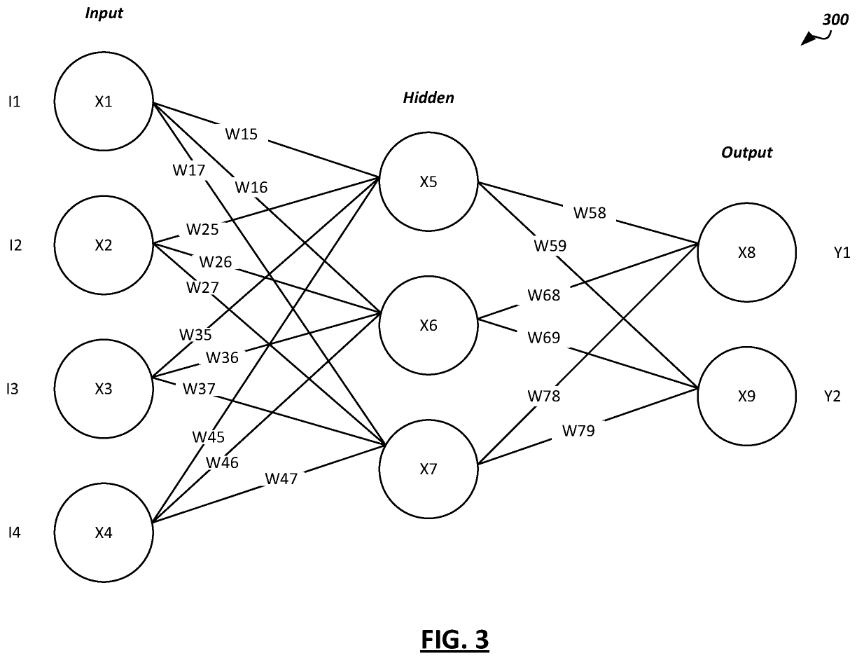

FIG. 3 illustrates an example portion of a neural network 300 in accordance with certain embodiments. The neural network 300 includes neural units X1-X9. Neural units X1-X4 are input neural units that respectively receive primary inputs I1-I4 (which may be held constant while the neural network 300 processes an output). Any suitable primary inputs may be used. As one example, when neural network 300 performs image processing, a primary input value may be the value of a pixel from an image (and the value of the primary input may stay constant while the image is processed). As another example, when neural network 300 performs speech processing the primary input value applied to a particular input neural unit may change over time based on changes to the input speech.

While a specific topology and connectivity scheme is shown in FIG. 3, the teachings of the present disclosure may be used in neural networks having any suitable topology and/or connectivity. For example, a neural network may be a feedforward neural network, a recurrent network, or other neural network with any suitable connectivity between neural units. As another example, although the neural network is depicted as having an input layer, a hidden layer, and an output layer, a neural network may have any suitable layers arranged in any suitable fashion In the embodiment depicted, each link between two neural units has a synapse weight indicating the strength of the relationship between the two neural units. The synapse weights are depicted as WXY, where X indicates the pre-synaptic neural unit and Y indicates the post-synaptic neural unit. Links between the neural units may be excitatory or inhibitory in their effect on the activation state of connected neural units. For example, a spike that propagates from X1 to X5 may increase or decrease the membrane potential of X5 depending on the value of W15. In various embodiments, the connections may be directed or undirected.

In various embodiments, during each time-step of a neural network, a neural unit may receive any suitable inputs, such as a bias value or one or more input spikes from one or more of the neural units that are connected via respective synapses to the neural unit (this set of neural units are referred to as fan-in neural units of the neural unit). The bias value applied to a neural unit may be a function of a primary input applied to an input neural unit and/or some other value applied to a neural unit (e.g., a constant value that may be adjusted during training or other operation of the neural network). In various embodiments, each neural unit may be associated with its own bias value or a bias value could be applied to multiple neural units.

The neural unit may perform a function utilizing the values of its inputs and its current membrane potential. For example, the inputs may be added to the current membrane potential of the neural unit to generate an updated membrane potential. As another example, a non-linear function, such as a sigmoid transfer function, may be applied to the inputs and the current membrane potential. Any other suitable function may be used. The neural unit then updates its membrane potential based on the output of the function.

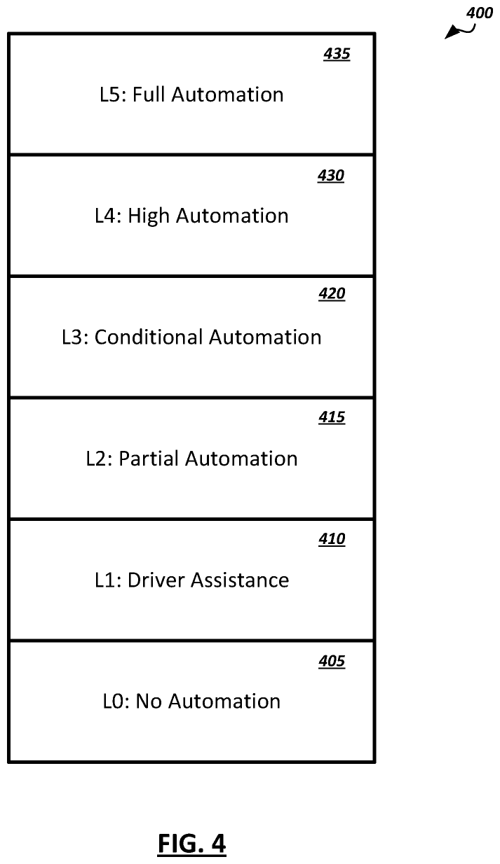

Turning to FIG. 4, a simplified block diagram 400 is shown illustrating example levels of autonomous driving, which may be supported in various vehicles (e.g., by their corresponding in-vehicle computing systems. For instance, a range of levels may be defined (e.g., L0-L5 (405-435)), with level 5 (L5) corresponding to vehicles with the highest level of autonomous driving functionality (e.g., full automation), and level 0 (L0) corresponding the lowest level of autonomous driving functionality (e.g., no automation). For instance, an L5 vehicle (e.g., 435) may possess a fully-autonomous computing system capable of providing autonomous driving performance in every driving scenario equal to or better than would be provided by a human driver, including in extreme road conditions and weather. An L4 vehicle (e.g., 430) may also be considered fully-autonomous and capable of autonomously performing safety-critical driving functions and effectively monitoring roadway conditions throughout an entire trip from a starting location to a destination. L4 vehicles may differ from L5 vehicles, in that an L4's autonomous capabilities are defined within the limits of the vehicle's “operational design domain,” which may not include all driving scenarios. L3 vehicles (e.g., 420) provide autonomous driving functionality to completely shift safety-critical functions to the vehicle in a set of specific traffic and environment conditions, but which still expect the engagement and availability of human drivers to handle driving in all other scenarios. Accordingly, L3 vehicles may provide handover protocols to orchestrate the transfer of control from a human driver to the autonomous driving stack and back. L2 vehicles (e.g., 415) provide driver assistance functionality, which allow the driver to occasionally disengage from physically operating the vehicle, such that both the hands and feet of the driver may disengage periodically from the physical controls of the vehicle. L1 vehicles (e.g., 410) provide driver assistance of one or more specific functions (e.g., steering, braking, etc.), but still require constant driver control of most functions of the vehicle. L0 vehicles may be considered not autonomous—the human driver controls all of the driving functionality of the vehicle (although such vehicles may nonetheless participate passively within autonomous driving environments, such as by providing sensor data to higher level vehicles, using sensor data to enhance GPS and infotainment services within the vehicle, etc.). In some implementations, a single vehicle may support operation at multiple autonomous driving levels. For instance, a driver may control and select which supported level of autonomy is used during a given trip (e.g., L4 or a lower level). In other cases, a vehicle may autonomously toggle between levels, for instance, based on conditions affecting the roadway or the vehicle's autonomous driving system. For example, in response to detecting that one or more sensors have been compromised, an L5 or L4 vehicle may shift to a lower mode (e.g., L2 or lower) to involve a human passenger in light of the sensor issue, among other examples.

FIG. 5 is a simplified block diagram 500 illustrating an example autonomous driving flow which may be implemented in some autonomous driving systems. For instance, an autonomous driving flow implemented in an autonomous (or semi-autonomous) vehicle may include a sensing and perception stage 505, a planning and decision stage 510, and a control and action phase 515. During a sensing and perception stage 505 data is generated by various sensors and collected for use by the autonomous driving system. Data collection, in some instances, may include data filtering and receiving sensor from external sources. This stage may also include sensor fusion operations and object recognition and other perception tasks, such as localization, performed using one or more machine learning models. A planning and decision stage 510 may utilize the sensor data and results of various perception operations to make probabilistic predictions of the roadway(s) ahead and determine a real time path plan based on these predictions. A planning and decision stage 510 may additionally include making decisions relating to the path plan in reaction to the detection of obstacles and other events to decide on whether and what action to take to safely navigate the determined path in light of these events. Based on the path plan and decisions of the planning and decision stage 510, a control and action stage 515 may convert these determinations into actions, through actuators to manipulate driving controls including steering, acceleration, and braking, as well as secondary controls, such as turn signals, sensor cleaners, windshield wipers, headlights, etc.

As noted herein, high-definition maps may be utilized in various autonomous driving applications, including by the in-vehicle system itself, as well as external systems providing driving assistance to an autonomous vehicle (e.g., cloud- or road-side-based systems, remote valet systems, etc.). Accordingly, accuracy of the HD map used in autonomous driving/autonomous vehicle control is essential. To generate the HD map and to maintain it, it is important to get dynamic and up-to-date data. If there is any change in the environment (for example, there is a road work, accident, etc.) the HD map should be updated to reflect the change. In some implementations, data from a number of autonomous vehicles may be crowdsourced and used to update the HD map. However, in some cases, trust or confidence in the data received may be questionable. One challenge may include understanding and codifying the trustworthiness of the data received from each of the cars. For instance, the data coming from an autonomous vehicle may be of lower fidelity (e.g., coming from less capable sensors), unintentionally corrupted (e.g., random bit flip), or maliciously modified. Such low- (or no-) quality data in turn could corrupt the HD maps present in the servers.

Accordingly, in certain embodiments, the data collected by the various sensors of an autonomous vehicle may be compared with data present in a relevant tile of the HD map downloaded to the autonomous vehicle. If there is a difference between the collected data and the HD map data, the delta (difference of the HD map tile and the newly collected data) may be transferred to the server hosting the HD map so that the HD map tile at that particular location may be updated. Before transferring to the server, the data may be rated locally at each autonomous vehicle and again verified at the server before updating the HD map. Although described herein as the server validating autonomous vehicle sensor data before updating an HD map, in some cases, the delta information may also be sent to other autonomous vehicles near the autonomous vehicle that collected the data in order to update their HD maps quickly. The other autonomous vehicles may analyze the data in the same way the server does before updating their HD map.

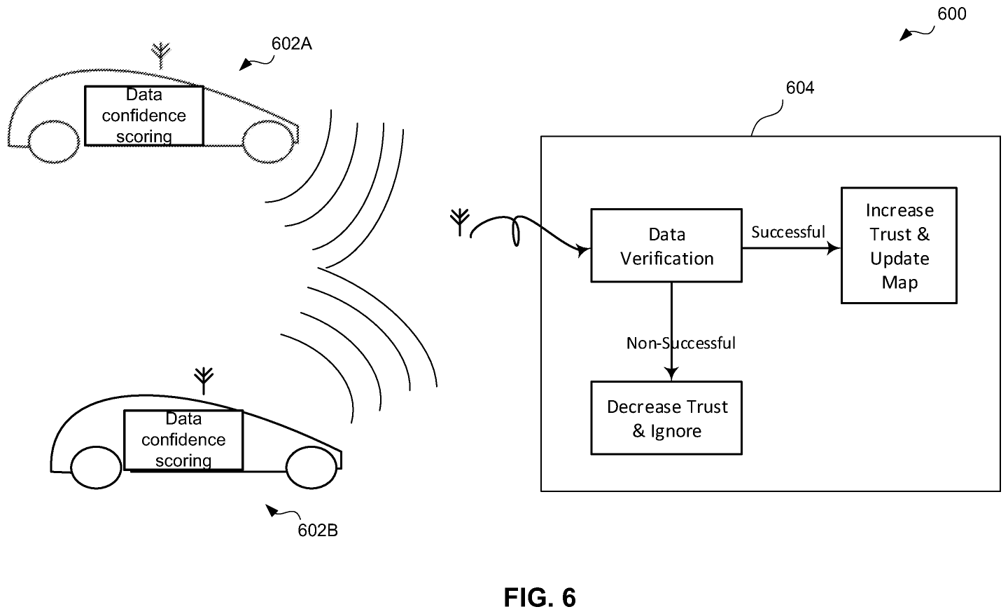

FIG. 6 is a simplified diagram showing an example process of rating and validating crowdsourced autonomous vehicle sensor data in accordance with at least one embodiment. In the example shown, each autonomous vehicle 602 collects data from one or more sensors coupled thereto (e.g., camera(s), LIDAR, radar, etc.). The autonomous vehicles 602 may use the sensor data to control one or more aspects of the autonomous vehicle. As each autonomous vehicle collects data from its one or more sensors, the autonomous vehicle may determine an amount of confidence placed in datum collected. For example, the confidence score may be based on information related to the collection of the sensor data, such as, for example, weather data at the time of data collection (e.g., camera information on a sunny day may get a larger confidence score than cameras on a foggy day), sensor device configuration information (e.g., a bitrate or resolution of the camera stream), sensor device operation information (e.g., bit error rate for a camera stream), sensor device authentication status information (e.g., whether the sensor device has been previously authenticated by the autonomous vehicle, as described further below), or local sensor corroboration information (e.g., information indicating that each of two or more cameras of the autonomous vehicle detected an object in the same video frame or at the same time).

The autonomous vehicle may calculate a confidence score, which may be maintained in metadata associated with the data. The confidence score may be a continuous scale between zero and one in some implementations (rather than a binary decision of trusting everything or trusting nothing), or between zero and another number (e.g., 10). Additionally, in cases where the collection device is capable of authentication or attestation (e.g., where the device is authenticated by the autonomous vehicle before the autonomous vehicle accepts the data from the device), the device's authentication/attestation status may be indicated in the metadata of the data collected by the sensor device (e.g., as a flag, a digital signature, or other type of information indicating the authentication status of the sensor device), allowing the server 604 or other autonomous vehicle to more fully verify/validate/trust the data before using the data to update the HD map. In some cases, the autonomous vehicle itself may be authenticated (e.g., using digital signature techniques) by the server. In such cases, the data collected from different sensors of the autonomous vehicle may be aggregated, and in some cases authenticated, by the main processor or processing unit within the autonomous vehicle before being transferred or otherwise communicated to the server or to nearby autonomous vehicles.

The values for how to score different devices may be defined by a policy for collecting and aggregating the data. The policy may also indicate when the autonomous vehicle is to upload the newly collected data, e.g., to update the HD map. For example, the policy may state that the delta from the HD map tile and the newly collected data must be above a certain threshold to send the data back to the server for updating the HD map. For instance, construction site materials (barrels, equipment, etc.) may cause a large delta between the HD map data and collected data, while a pebble/rock in the road may cause a smaller delta, so the construction site-related data may be passed to the cloud while the pebble data might not. The policy may also indicate that the confidence score associated with the data must be above a certain threshold before uploading the data. As an example, the confidence score may be required to be above 0.8 (for example) for all data to be sent back/published to the server.

Once received from the autonomous vehicle, the server may perform additional verification actions before applying an update to the HD map with the delta information. For example, the server may verify the confidence score/metrics that were shared with the data (e.g., in its metadata). As long as the confidence score value(s) satisfy a server policy (e.g., all delta data used to update the map must have a confidence score greater than a threshold value, such as 0.9), then the server may consider the data for updating of the HD map. In some cases, the server may maintain a list of recently seen autonomous vehicles and may track a trust score/value for each of the autonomous vehicles along with the confidence score of the data for updating the map. In some embodiments, the trust score may be used as an additional filter for whether the server uses the data to update the HD map. In some cases, the trust score may be based on the confidence score of the data received. As an example, if the confidence score is above a first threshold, the trust score for the autonomous vehicle may be increased (e.g., incremented (+1)), and if the confidence score is below a second threshold (that is lower that the first threshold) then the trust score for the autonomous vehicle may be decreased (e.g., decremented (−1)). If the confidence score is between the first and second thresholds, then the trust score for the autonomous vehicle may remain the same. An IoT-based reputation system (e.g., EigenTrust or PeerTrust) can be utilized for this tracking, in some implementations. In some cases, the sensor data may be correlated with sensor data from other autonomous vehicles in the area to determine whether the sensor data is to be trusted.

In some embodiments, as each car publishes the data to the server, the autonomous vehicle may sign the data with pseudo-anonymous certificates. The autonomous vehicle may use one of the schemes designed for V2X communications, for example. In some cases, when the signed data is received at the server, as long as the data is not from a blacklisted autonomous vehicle, it may be passed to the HD map module for updating of the HD map. In other cases, whether the data is signed or not may be used in the determination of the trust score for the autonomous vehicle.

If the authentication and/or trust verification are not successful at the server, the trust score for the autonomous vehicle from which the data was received may be ranked low or decreased and the data may be ignored/not used to update the HD map. In some cases, the autonomous vehicle may be blacklisted if its trust score drops below a specified threshold value. If the authentication and/or trust verification is successful at the server, then the trust score for the autonomous vehicle may be increased and the data received from the autonomous vehicle may be used to update the HD map. Mechanisms as described herein can also enable transitivity of trust, allowing autonomous vehicles to use data from sources (e.g., other autonomous vehicles) that are more distant, and can be used for ranking any crowdsourced data required for any other purpose (e.g., training of machine learning models).

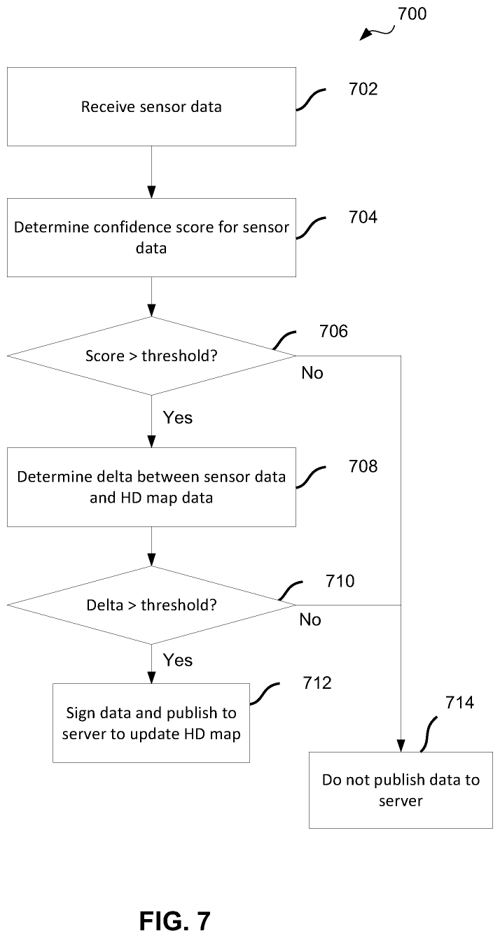

FIG. 7 is a flow diagram of an example process of rating sensor data of an autonomous vehicle in accordance with at least one embodiment. Operations in the example processes shown in FIG. 7 may be performed by various aspects or components of an autonomous vehicle. The example processes may include additional or different operations, and the operations may be performed in the order shown or in another order. In some cases, one or more of the operations shown in FIGS. 7 are implemented as processes that include multiple operations, sub-processes, or other types of routines. In some cases, operations can be combined, performed in another order, performed in parallel, iterated, or otherwise repeated or performed another manner.

At 702, sensor data is received from a sensor of an autonomous vehicle. The sensor data may include data from a camera device, a LIDAR sensor device, a radar device, or another type of autonomous vehicle sensor device.

At 704, a confidence score for the sensor data is determined. The confidence score may be based on information obtained or gleaned from the sensor data received at 702 or other sensor data (e.g., weather or other environmental information), sensors device authentication status information (e.g., whether the sensor device was authenticated by the autonomous vehicle before accepting its data), local sensor corroboration data, or other information that may be useful for determining whether to trust the sensor data obtained (e.g., device sensor capabilities or settings (e.g., camera video bitrate), bit error rate for sensor data received, etc.) or a level of the trust of the sensor data.

At 706, it is determined whether the confidence score is above a threshold value. If so, a delta value between the sensor data received at 702 and the HD map data is determined at 708, and if the delta value is determined to be above a threshold at 710, the autonomous vehicle signs the data and publishes the data to the server for updating of the HD map at 712. If the confidence score is below its corresponding threshold value or the delta value is below its corresponding threshold value, then the data is not published to the server for updating of the HD map.

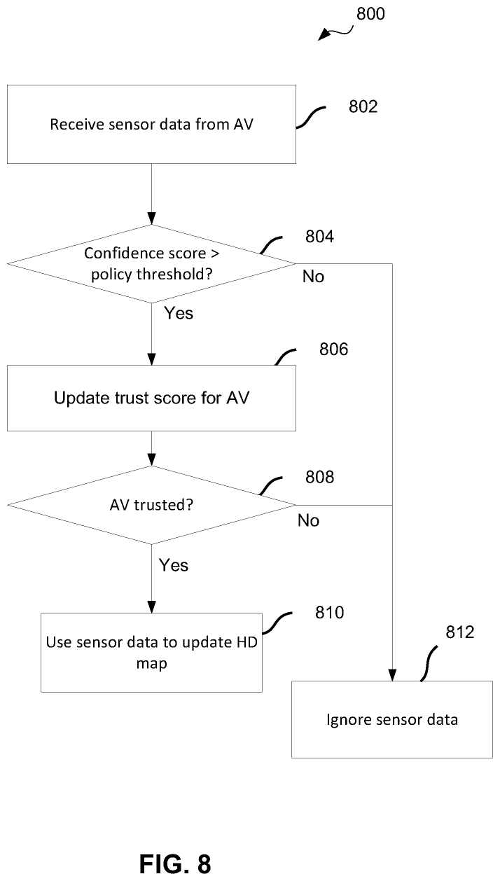

FIG. 8 is a flow diagram of an example process of rating sensor data of an autonomous vehicle in accordance with at least one embodiment. Operations in the example processes shown in FIG. 8 may be performed by various aspects or components of a server device, such as a server that maintains an HD map for autonomous vehicles, or by one or more components of an autonomous vehicle. The example processes may include additional or different operations, and the operations may be performed in the order shown or in another order. In some cases, one or more of the operations shown in FIGS. 8 are implemented as processes that include multiple operations, sub-processes, or other types of routines. In some cases, operations can be combined, performed in another order, performed in parallel, iterated, or otherwise repeated or performed another manner.

At 802, sensor data is received from an autonomous vehicle. The sensor data may include a confidence score associated with the sensor data that indicates a level of confidence in the datum collected by the sensor device. The confidence score may be computed according to the process 700 described above. The confidence score may be included in metadata, in some cases.

At 804, the confidence score is compared with a policy threshold. The confidence score is greater than the threshold, then a trust score for the autonomous vehicle is updated based on the confidence score at 806. If not, then the sensor data is ignored at 812.

At 808, it is determined whether the autonomous vehicle is trusted based at least in part on the trust score. In some cases, determining whether the autonomous vehicle is trusted may be based on whether the autonomous vehicle has been blacklisted (e.g., as described above). In some cases, determining whether the autonomous vehicle is trusted may be based on a correlation of the sensor data of the autonomous vehicle with sensor data from other autonomous vehicles nearby (e.g., to verify that the sensor data is accurate). If the autonomous vehicle is trusted, then the sensor data may be used to update the HD map at 810. If not, then the sensor data is ignored at 812. Alternatively, the level of trust based on the trust score may be used to determine the level of trust the autonomous vehicle has on the sensor data and hence update the HD map based on a range or scale accordingly.

As discussed herein, crowdsourcing data collections may consist of building data sets with the help of a large group of autonomous vehicles. There are source and data suppliers who are willing to enrich the data with relevant, missing, or new information.

Obtaining data from a large group of autonomous vehicles can make data collection quick, in turn leading to faster model generation for autonomous vehicles. When crowdsourcing data, some of the data may be incomplete or inaccurate, and even when the data may be complete and accurate, it can still be difficult to manage such a large amount of data. Moreover, the crowdsourced data presents its own real-world challenges of not having balanced positive and negative categories along with the difference in noise levels induced by the diverse sensors used by different autonomous vehicles. Hence, it may be beneficial to score and rank the data collected by crowdsourcing in a way that helps identify its goodness.

Accordingly, in some aspects, crowdsourced data may be scored and ranked based on geolocation information for the autonomous vehicle. In some aspects, the crowdsourced data may be scored and ranked by considering location metadata in addition to vehicular metadata. By using geolocation information to score and rank data, location specific models may be generated as opposed to vehicle specific ones.

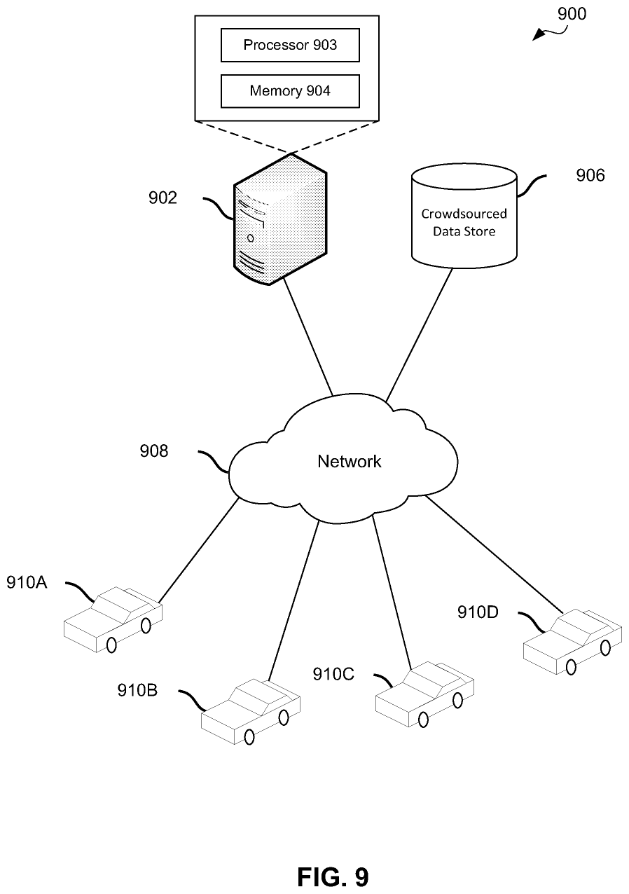

FIG. 9 is a simplified diagram of an example environment 900 for autonomous vehicle data collection in accordance with at least one embodiment. The example environment 900 includes an autonomous vehicle data scoring server 902, a crowdsourced data store 906, and multiple autonomous vehicles 910, each connected to one another via the network 908. Although not shown, each of the autonomous vehicles 910 includes one or more sensors that are used by the autonomous vehicle to control the autonomous vehicle and negotiate trips by the autonomous vehicle between locations. As described further, the example environment 900 may be used to crowdsource data collection from each of the autonomous vehicles 910. In particular, as each of the autonomous vehicles 910 drives, the autonomous vehicle will gather sensor data from each of a plurality of sensors coupled to the autonomous vehicle, such as camera data, LIDAR data, geolocation data, temperature or other weather data. The autonomous vehicle may, in some cases, transmit its sensor data to the autonomous vehicle data scoring server 902 via the network 908. The autonomous vehicle data scoring server 902 may in turn score or rank the data as described herein, and determine based on the scoring/ranking whether to store the data in the crowdsourced data store 906.

In some cases, the data sent by the autonomous vehicles comprises Image Data and Sensor Data and may also have some associated metadata. Both of the data sources can be used in conjunction or in isolation to extract and generate metadata/tags related to location. The cumulative location specific metadata can be information like geographic coordinates for example: “45° 31′ 22.4256″ N and 122° 59′ 23.3880″ W”. It can also be additional environment information indicating environmental contexts such as terrain information (e.g., “hilly” or “flat”), elevation information (e.g., “59.1 m”), temperature information (e.g., “20° C.”), or weather information associated with that geolocation (e.g., “sunny”, “foggy”, or “snow”). All of the location specific and related metadata (such as weather) may be used to score the data sent by the autonomous vehicle in order to determine whether to store the data in a crowdsourced data store. In some cases, the data scoring algorithm may achieve saturation for the geography with regards to data collection by using a cascade of location context-based heatmaps or density maps for scoring the data, as described further below.

For example, where there are a number of location metadata categories, like geographic coordinates, elevation, weather, etc. an overall goodness score for the autonomous vehicle's sensor data may be determined using a location score. The location score may be a weighted summation across all the categories, and may be described by:

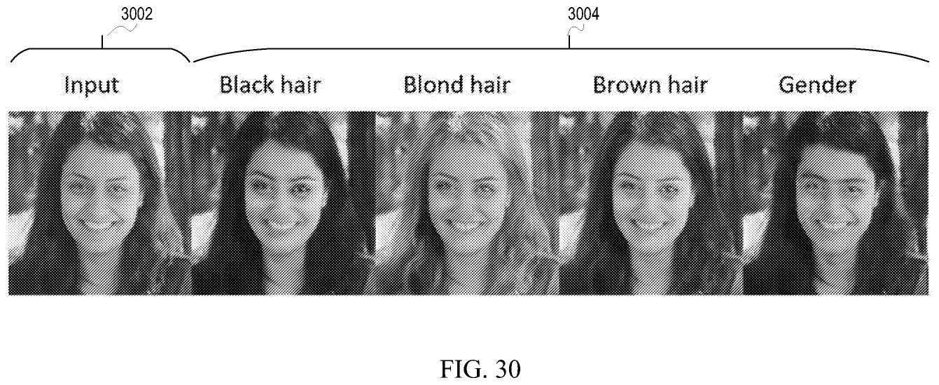

Score_{Location}=Σ(α.GeoCoordinates+β.Elevation+γ.Weather+ . . . )

where each of the variables GeoCoordinates, Elevation, and Weather are values determined from a heatmap, any type of density-plot, or any type of density distribution map (e.g., the heatmap 3000 of FIGS. 30) and α,β,γ are weights (which may each be computed based on a separate density plot) associated with each location metadata category. In some cases, each of the variables of the location score are between 0-1, and the location score is also between 0-1.

After the location score computation, additional qualities associated with the sensor data (e.g., such as the noise level, objects of interest in image data, etc.) may be used to determine an overall goodness score for the sensor data. In some cases, the overall goodness score for the sensor data is a cumulative weighted sum of all the data qualities, and may be described by:

Score_{Goodness}=Σ(a.Score_{Location}+b.Score_{Noise}+c.Score_{objectDiversity}+ . . . )

where a, b, c are the weights associated with data quality categories. In some cases, each of the variables of the overall goodness score are between 0-1, and the overall goodness score is also between 0-1. The overall goodness score output by the autonomous vehicle data scoring algorithm (e.g., as performed by an external data repository system, or other computing system implementing a data scoring system) may be associated with the autonomous vehicle's sensor data and may be used to determine whether to pass the autonomous vehicle data to the crowdsourced data store.

In some implementations, an example autonomous vehicle data scoring server 902 includes a processor 903 and memory 904. The example processor 903 executes instructions, for example, to perform one or more of the functions described herein. The instructions can include programs, codes, scripts, or other types of data stored in memory. Additionally, or alternatively, the instructions can be encoded as pre-programmed or re-programmable logic circuits, logic gates, or other types of hardware or firmware components. The processor 903 may be or include a general-purpose microprocessor, as a specialized co-processor or another type of data processing apparatus. In some cases, the processor 903 may be configured to execute or interpret software, scripts, programs, functions, executables, or other instructions stored in the memory 904. In some instances, the processor 903 includes multiple processors or data processing apparatuses. The example memory 904 includes one or more computer-readable media. For example, the memory 904 may include a volatile memory device, a non-volatile memory device, or a combination thereof. The memory 904 can include one or more read-only memory devices, random-access memory devices, buffer memory devices, or a combination of these and other types of memory devices. The memory 904 may store instructions (e.g., programs, codes, scripts, or other types of executable instructions) that are executable by the processor 903. Although not shown, each of the autonomous vehicles 910 may include a processor and memory similar to the processor 903 and memory 904.

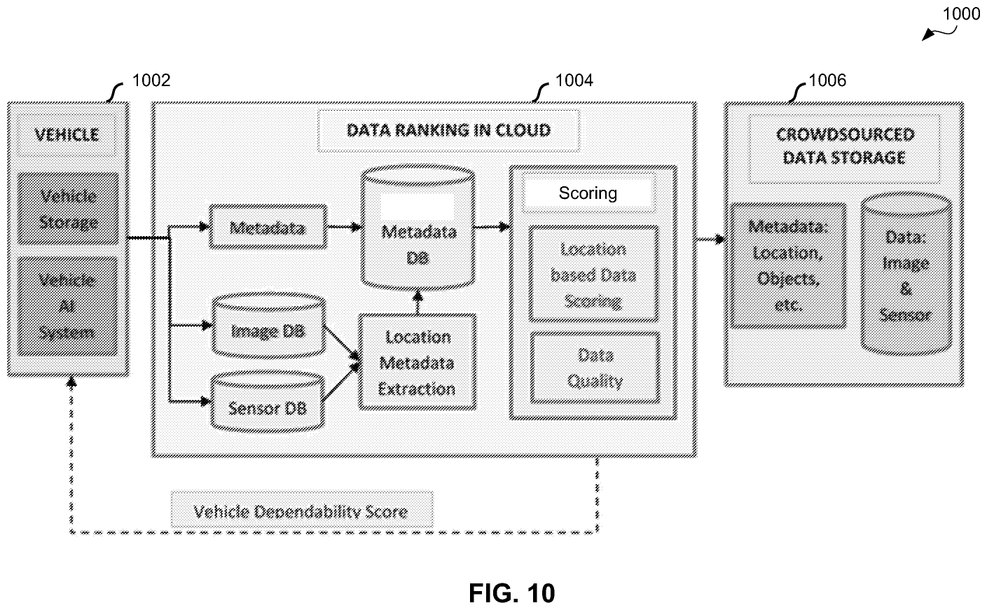

FIG. 10 is a simplified block diagram of an example crowdsourced data collection environment 1000 for autonomous vehicles in accordance with at least one embodiment. The example environment 1000 includes an autonomous vehicle 1002, an autonomous vehicle data scoring/ranking server 1004 in the cloud, and a crowdsourced data storage 1006. In the example shown, the autonomous vehicle includes its own storage for its sensor data and an AI system used to navigate the autonomous vehicle based on the sensor data. The autonomous vehicle sends all or some of its sensor data to the autonomous vehicle data scoring/ranking server, which extracts metadata included with the data and stores the metadata. The server also analyzes the image and sensor data from the autonomous vehicle to extract additional information/metadata and stores the information. The stored metadata is then used by a scoring module of the server to compute a location-based score (e.g., the location score described above) and a data quality score (e.g., the overall goodness score described above). Based on those scores, the server determines whether to pass the autonomous vehicle sensor data to the crowdsourced data storage.

In some cases, the server may also compute a Vehicle Dependability Score that is to be associated with the autonomous vehicle. This score may be based on historical location scores, goodness scores, or other information, and may be a metric used by the crowdsource governance system as some context for providing identity of the autonomous vehicle for future data scoring/ranking. The Vehicle Dependability Score may also be used for incentivizing the autonomous vehicle's participation in providing its data in the future.

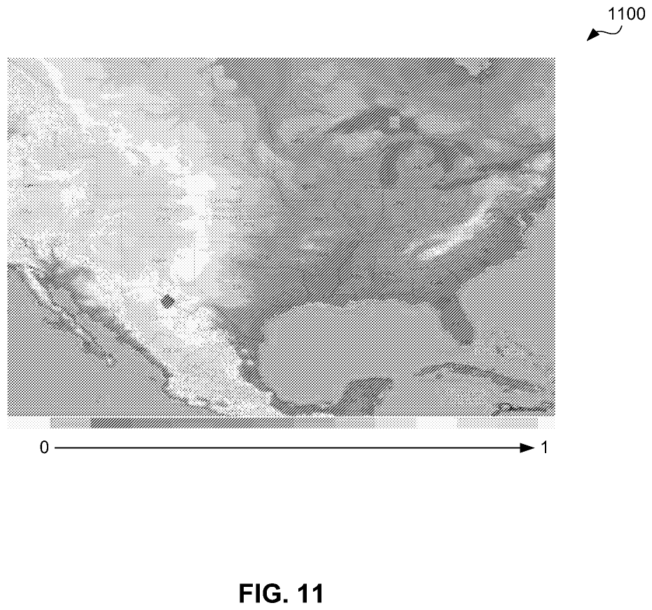

FIG. 11 is a simplified diagram of an example heatmap 1100 for use in computing a sensor data goodness score in accordance with at least one embodiment. In the example shown, the heatmap signifies the crowdsourced data availability according to geographic co-ordinates metadata. Each location in the heatmap indicates a value associated with the data availability. In the example shown, the values range from 0-1. The lighter areas on the map would indicate least amount of data available from those locations where as the darker areas indicate an area of dense collected data. The reason for the variation in the collected data density, could be one or multiple of the following factors: population density, industrial development, geographic conditions etc. Thus, the goal of the data scoring algorithm may be to score the data such that enough data is collected in the geographic co-ordinates of the lighter areas of the heatmap. Since the collected data is scarce in the lighter regions, it will be scored leniently. On the other hand, if data is collected from the darker region of the map, which has dense data, factors such as noise in the data will have more influence on data score.

Each variable/factor of the location score may have a separate heatmap associated with it. For example, referring to the location score above, the GeoCoordinates variable would have a first heatmap associated therewith, the Elevation variable would have a second heatmap associated therewith, and the Weather variable would have a third heatmap associated therewith. Each of the heatmaps may include different values, as the amount of data collected for each of the variables may vary depending on the location. The values of the different heatmaps may be used in computing the location score, e.g., through a weighted summation as described above.

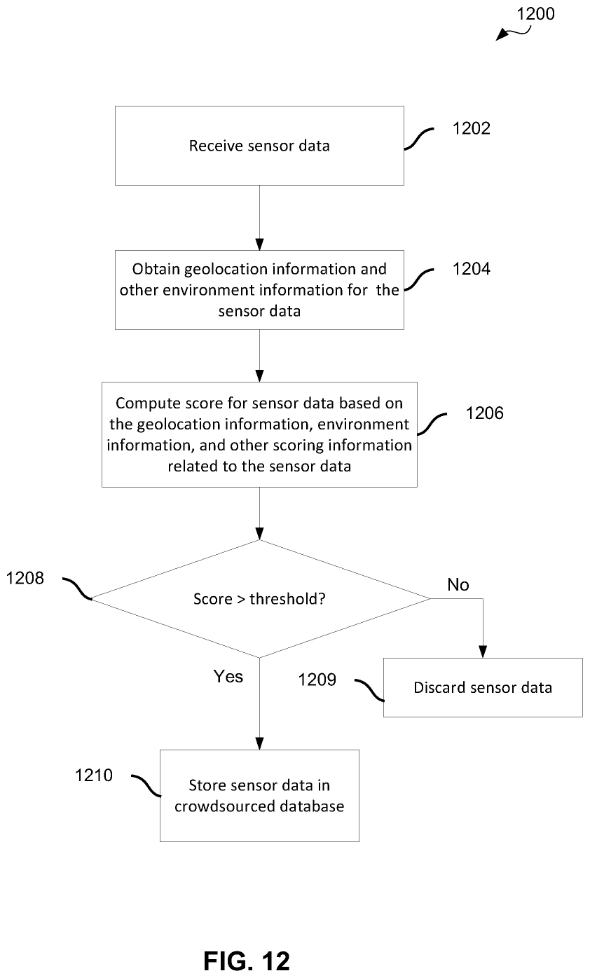

FIG. 12 is a flow diagram of an example process 1200 of computing a goodness score for autonomous vehicle sensor data in accordance with at least one embodiment. Operations in the example process 1200 may be performed by components of, or connected to, an autonomous vehicle data scoring server 902 (e.g., server of FIG. 9). The example process 1200 may include additional or different operations, and the operations may be performed in the order shown or in another order. In some cases, one or more of the operations shown in FIG. 1200 are implemented as processes that include multiple operations, sub-processes, or other types of routines. In some cases, operations can be combined, performed in another order, performed in parallel, iterated, or otherwise repeated or performed another manner.

At 1202, sensor data is received from one or more autonomous vehicles. The sensor data may include one or more of video or image data (e.g., from cameras) and point data values (e.g., temperature, barometric pressure, etc.).

At 1204, geolocation and other environmental information is obtained from the sensor data.

At 1206, a score is computed for the sensor data that indicates its overall goodness or quality. The score is based on the geolocation and environmental information obtained at 1204. For example, the score may be based on a location score computed from the geolocation and environmental information as described above. In some cases, the score may also be based on additional scoring information associated with the sensor data. For example, the score may be based a noise score, object diversity score, or other scores computed for the sensor data.

At 1208, it is determined whether the score computed at 1206 is above a threshold value, or within a range of values. If so, the sensor data is stored at 1210 in a database used for collecting crowdsourced autonomous vehicle sensor data. When stored, the sensor data may be associated with the calculated goodness score. If the score is below the threshold value, or outside a range of values, the sensor data is discarded or otherwise not stored at 1209.

An approach involving continuous collection of data to help train AI algorithms for an autonomous vehicle may encounter issues with scalability (due to the large volume of required data and miles to drive to obtain this data) and exact availability (chances of having data sufficient number of data sets needed to cover all possible road scenarios that an autonomous vehicle may encounter). Accordingly, autonomous vehicles may benefit from more efficient and rich data sets for training AI systems for autonomous vehicles. In various embodiments of the present disclosure, data sets may be improved by categorizing a data set to guide the collection process for each category. In some embodiments, each data set may be scored based on its category and the score of the data set may be used to determine processing techniques for the collected data.

In a particular embodiment, data collected by autonomous vehicles undergoes novel processing including categorization, scoring, and handling based on the categorization or scoring. In various embodiments, this novel processing (or one or more sub-portions thereof) may be performed offline by a computing system (e.g., remote processing system 1304) networked to the autonomous vehicle (e.g., in the cloud) and/or online by a computing system of the autonomous vehicle (e.g., autonomous vehicle computing system 1302).

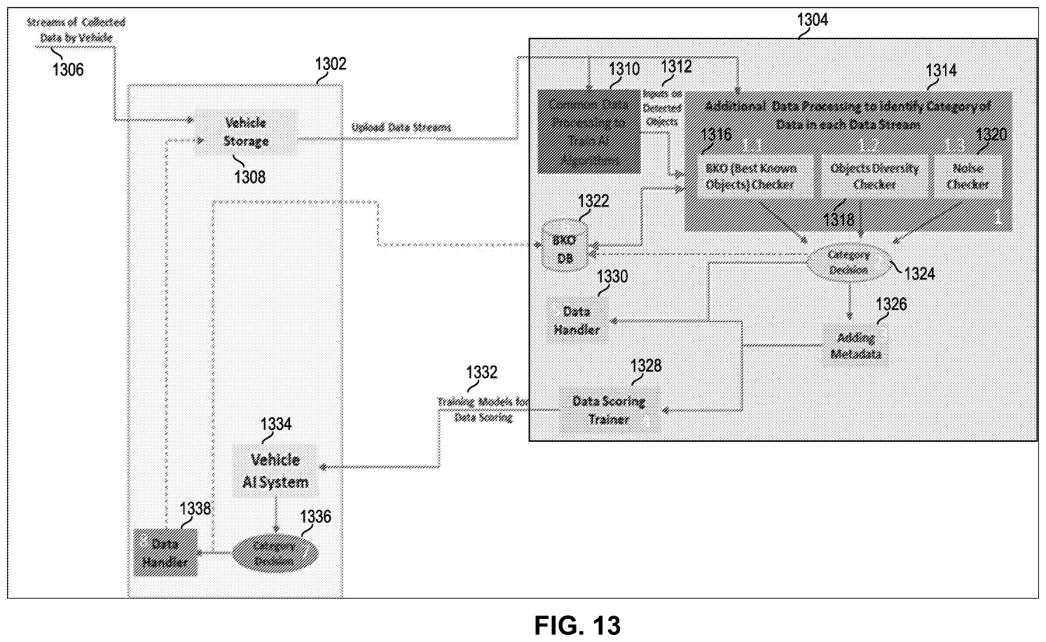

FIG. 13 depicts a flow of data categorization, scoring, and handling according to certain embodiments. FIG. 13 depicts an autonomous vehicle computing system 1302 coupled to a remote processing system 1304. Each of the various modules in systems 1302 and 1304 may be implemented using any suitable computing logic. The autonomous vehicle computing system 1302 may be coupled to remote processing system 1304 via any suitable interconnect, including point-to-point links, networks, fabrics, etc., to transfer data from the vehicle to the remote processing system (e.g., a special device that copies data from the car then re-copies the data to a Cloud cluster). In other embodiments, data from system 1302 may be made available to system 1304 (or vice versa) via a suitable communication channel (e.g., by removing storage containing such data from one of the systems and coupling it to the other). The autonomous vehicle computing system 1302 may be integrated within an autonomous vehicle, which may have any suitable components or characteristics of other vehicles described herein and remote processing system 1304 may have any suitable components or characteristics of other remote (e.g., cloud) processing systems described herein. For example, remote processing system 1304 may have any suitable characteristics of systems 140 or 150 and computing system 1302 may have any suitable characteristics of the computing system of vehicle 105.

In the flow, various streams of data 1306 are collected by vehicle 1302. Each stream of data 1306 may be collected from a sensor of the vehicle, such as any one or more of the sensors described herein or other suitable sensors. The streams 1306 may be stored in a storage device 1308 of the vehicle and may also be uploaded to remote processing system 1304.

The data streams may be provided to an artificial intelligence (AI) object detector 1310. Detector 1310 may perform operations associated with object detection. In a particular embodiment, detector 1310 may include a training module and an inference module. The training module may be used to train the inference module. For example, over time, the training module may analyze multiple uploaded data sets to determine parameters to be used by the inference module. An uploaded data stream may be fed as an input to the inference module and the inference module may output information associated with one or more detected objects 1312.

The format of the output of the inference module of the object detector 1310 may vary based on the application. As one example, detected objects information 1312 may include one or more images including one or more detected objects. For example, detected objects information 1312 may include a region of interest of a larger image, wherein the region of interest includes one or more detected objects. In some embodiments, each instance of detected objects information 1312 includes an image of an object of interest. In some instances, the object of interest may include multiple detected objects. For example, a detected vehicle may include multiple detected objects, such as wheels, a frame, windows, etc. In various embodiments, detected objects information 1312 may also include metadata associated with the detected object(s). For example, for each object detected in an instance of detected objects information 1312, the metadata may include one or more classifiers describing the type of an object (e.g., vehicle, tree, pedestrian, etc.), a position (e.g., coordinates) of the object, depth of the object, context associated with the object (e.g., any of the contexts described herein, such as the time of the day, type of road, or geographical location associated with the capture of the data used to detect the object), or other suitable information.

The detected objects information 1312 may be provided to object checker 1314 for further processing. Object checker 1314 may include any suitable number of checkers that provide outputs used to assign a category to the instance of detected objects information 1312. In the embodiment depicted, object checker 1314 includes a best-known object (BKO) checker 1316, an objects diversity checker 1318, and a noise checker 1320, although any suitable checker or combination of checkers is contemplated by this disclosure. In various embodiments, the checkers of an object checker 1314 may perform their operations in parallel with each other or sequentially.

In addition to detected objects information 1312, object checker 1314 may also receive the uploaded data streams. In various embodiments, any one or more of BKO checker 1316, objects diversity checker 1318, and noise checker 1320 may utilize the raw data streams.

In response to receiving an instance of detected objects information 1312, BKO checker 1316 consults the BKO database (DB) 1322 to determine the level of commonness of one or more detected objects of the instance of the detected objects information 1312. BKO DB 1322 is a database which stores indications of best known (e.g., most commonly detected) objects. In some embodiments BKO DB 1322 may include a list of best-known objects and objects that are not on this list may be considered to not be best known objects, thus the level of commonness of a particular object may be expressed using a binary value (best known or not best known). In other embodiments, BKO DB 1322 may include a more granular level of commonness for each of a plurality of objects. For example, BKO DB 1322 may include a score selected from a range (e.g., from 0 to 10) for each object. In particular embodiments, multiple levels of commonness may be stored for each object, where each level indicates the level of commonness for the object for a particular context. For example, a bicycle may have a high level of commonness on city streets, but a low level of commonness on highways. As another example, an animal such as a donkey or horse pulling a cart may have a low level of commonness in all but a few contexts and regions in the world. A combination level of commonness may also be determined, for example, one or more mopeds traveling in the lane are common in Southeast Asian countries even on highways than Western countries. Commonness score can be defined according to the specific rule set that applies for a specific environment.

BKO DB 1322 may be updated dynamically as data is collected. For example, logic of BKO DB 1322 may receive information identifying a detected object from BKO checker 1316 (e.g., such information may be included in a request for the level of commonness of the object) or from another entity (e.g., object detector 1310). In various embodiments, the information may also include context associated with the detected object. The logic may update information in the BKO DB 1322 indicating how many times and/or the frequency of detection for the particular object. In some embodiments, the logic may also determine whether the level of the commonness of the object has changed (e.g., if the frequency at which the object has been detected has crossed a threshold, the level of commonness of the object may rise).

In response to a request from BKO checker 1316, the BKO DB 1322 may return a level of commonness of the object. The BKO checker 1316 then provides this level to the category assigner 1324.

Objects diversity checker 1318 scores an instance of detected objects information 1312 based on diversity (e.g., whether the stream including objects is diverse or not which may be based on the number of objects per stream and the commonness of each object). The diversity score of an instance of detected objects information 1312 may be higher when the instance includes a large number of detected objects, and higher yet when the detected objects are heterogenous. For example, a detected car or bicycle may include a plurality of detected objects (e.g., wheels, frame, etc.) and may receive a relatively high diversity score. However, homogenous objects may result in relatively lower diversity scores. However, multiple objects that are rarely seen together may receive a relatively high diversity score. For example, multiple bicycles in a race or multiple runners on roads (e.g., in a marathon) may be considered diverse relative to a scene of one person running. Objects diversity checker 1318 may determine diversity based on any suitable information, such as the raw sensor data, indications of detected objects from BKO checker 1316, and the number of detected objects from BKO checker 1316.

Noise checker 1320 analyzes the uploaded data streams associated with an instance of detected objects information 1312 and determines a noise score associated with the instance. For example, an instance may have a higher score when the underlying data streams have low signal to noise ratios. If one or more of the underlying data streams appears to be corrupted, the noise score will be lower.

Category assigner 1324 receives the outputs of the various checkers of object checker 1314 and selects one or more categories for the instance of detected objects information 1312 based on the outputs of the checkers. This disclosure contemplates any suitable categories that may be used to influence data handling policy. Some example categories are Common Data, Minority Class Data, Data Rich of Diverse Objects, and Noisy Data. Any one or more of these categories may be applied to the instance based on the outputs received from object checker 1314.

The Common Data category may be applied to objects that are frequently encountered and thus the system may already have robust data sets for such objects. The Minority Class Data category may be applied to instances that include first time or relatively infrequent objects. In various embodiments, both the Common Data category and the Minority Class Data may be based on an absolute frequency of detection of the object and/or a context-specific frequency of detection of the object. The Data Rich of Diverse Objects category may be applied to instances including multiple, diverse objects. The Noisy Data category may be applied to instances having data with relatively high noise. In other embodiments, any suitable categories may be used. As examples, the categories may include “Very Rare”, “Moderately Rare”, “Moderately Common”, and “Very Common” categories or “Very Noisy”, “Somewhat Noisy”, and “Not Noisy” categories.

In some embodiments, after one or more categories are selected (or no categories are selected) for an instance of detected objects information 1312, additional metadata based on the category selection may be associated with the instance by metadata module 1326. In a particular embodiment, such metadata may include a score for the instance of detected objects information 1312 based on the category selection. In a particular embodiment, the score may indicate the importance of the data. The score may be determined in any suitable manner. As one example, an instance categorized as Common Data (or otherwise assigned a category indicative of a high frequency of occurrence) may receive a relatively low score, as such data may not improve the functionality of the system due to a high likelihood that similar data has already been used to train the system. As another example, an instance categorized as Minority Class Data may receive a relatively high score, as such data is not likely to have already been used to train the system. As another example, an instance categorized as Data Rich of Diverse Objects may receive a higher score than a similar instance not categorized as Data Rich of Diverse Objects, as an instance with diverse objects may be deemed more useful for training purposes. As another example, an instance categorized as Noisy Data may receive a lower score than a similar instance not categorized as Noisy Data, as an instance having higher noise may be deemed less useful for training purposes.

In some embodiments, in addition (or as an alternative) to the score, any suitable metadata may be associated with the instance of detected objects information 1312. For example, any of the context associated with the underlying data streams may be included within the metadata and the context can impact the score (e.g., a common data in a first context may be minority data in a second context).

The instance of data, categorization decision, score based on the categorization, and/or additional metadata may be provided to data handler 1330. Data handler 1330 may perform one or more actions with respect to the instance of data. Any suitable actions are contemplated by this disclosure. For example, data handler 1330 may purge instances with lower scores or of a certain category or combination of categories. As another example, data handler 1330 may store instances with higher scores or of a certain category or combination of categories. As another example, data handler 1330 may generate a request for generation of synthetic data associated with the instance (e.g., the data handler 1330 may request the generation of synthetic data associated with an object classified as Minority Class Data). As another example, data handler 1330 may generate a request for collection of more data related to the object of the instance by the sensors of one or more autonomous vehicles. As yet another example, data handler 1330 may determine that the instance (and/or underlying data streams) should be included in a set of data that may be used for training (e.g., by object detector 1310).

The instance of data, categorization decision, score based on the categorization, and/or additional metadata may also be provided to data scoring trainer 1328. Data scoring trainer 1328 trains models on categories and/or scores. In various embodiments, the instances of the detected objects and their associated scores and/or categories may be used as ground truth by the data scoring trainer 1328. Trainer 1328 outputs training models 1332. The training models are provided to vehicle AI system 1334 and may be used by the vehicle to categorize and/or score objects detected by vehicle AI system 1334. In various embodiments, the instances of data that are used to train the models is filtered based on categories and/or scores. For example, instances including commonly encountered objects may be omitted from the training set.

Vehicle AI system 1334 may include circuitry and other logic to perform any suitable autonomous driving operations, such as one or more of the operations of an autonomous vehicle stack. In a particular embodiment, vehicle AI system 1334 may receive data streams 1306 and process the data streams 1306 to detect objects.

An in-vehicle category assigner 1336 may have any one or more characteristics of category assigner 1324. Information about an instance of the detected objects (e.g., the detected objects as well as the context) may be provided to category assigner 1336 which selects one or more categories for the instance (such as one or more of the categories described above or other suitable categories). In some embodiments, category assigner 1336 or other logic of computing system 1302 may also (or alternatively) assign a score to the instance of detected object(s). In some embodiments, the score may be based on the categorization by category assigner 1336. of the detected objects. In other embodiments, a score may be determined by the autonomous vehicle without any explicit determination of categories by the autonomous vehicle. In various embodiments, the categories and/or scores assigned to the detected objects are determined using one or more machine learning inference modules that utilize parameters generated by data scoring trainer 1328.

The output of the category assigner 1336 may be provided to an in-vehicle data handler 1338, which may have any one or more characteristics of data handler 1330. In various embodiments, the output of the category assigner 1336 may also be provided to the BKO DB 1322 to facilitate updating of the BKO data based on the online learning and scoring

Data handler 1338 may have any one or more characteristics of data handler 1330. Data handler 1338 may make decisions as to how to handle data streams captured by the vehicle based on the outputs of the in-vehicle category assigner 1336. For example, the data handler 1338 may take any of the actions described above or perform other suitable actions associated with the data based on the output of the category assigner 1336. As just one example, the data handler 1338 may determine whether data associated with a detected object is to be stored in the vehicle or purged based on the data scoring.

In various embodiments, a location-based model used to score the data may synthesize urgency and importance of data as well as provide useful guidance for better decision making by an autonomous vehicle. The location of captured data may be used by the autonomous vehicle computing system 1302 or the remote computing system 1304 to obtain other contextual data associated with capture of the data, such as the weather, traffic, pedestrian flow, and so on (e.g., from a database or other service by using the location as input). Such captured data may be collected at a particular granularity so as to form a time series of information. The same location may be associated with each data stream captured within a radius of the location and may allow the vehicle to improve its perception and decision capabilities within this region. The location may be taken into account by any of the modules described above. As just one example, BKO DB 1322 may store location specific data (e.g., a series of commonness levels of various objects for a first location, a separate list of commonness levels of various objects for a second location, and so on).

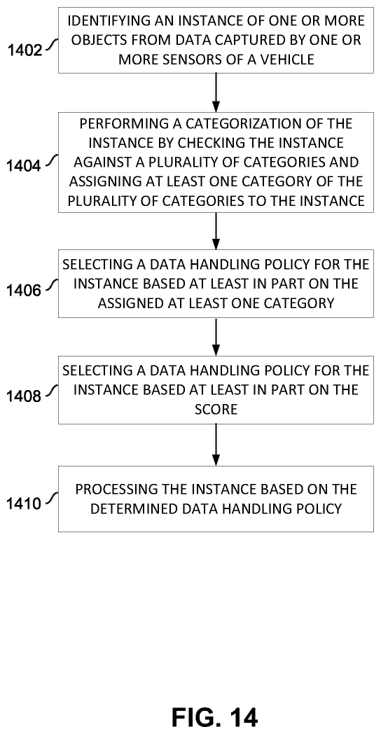

FIG. 14 depicts an example flow for handling data based on categorization in accordance with certain embodiments. At 1402, an instance of one or more objects from data captured by one or more sensors of a vehicle is identified. At 1404, a categorization of the instance is performed by checking the instance against a plurality of categories and assigning at least one category of the plurality of categories to the instance. At 1406, a score is determined based on the categorization of the instance. At 1408, a data handling policy for the instance is selected based at least in part on the score. At 1410, the instance is processed based on the determined data handling policy.

Creating quality machine learning models includes using robust data sets during training for model creation. In general, a model is only as good as the data set it uses for training. In many applications, such as training on images for object or person identification, data set collection is fairly simple. However, in other cases, data set collection for less common contexts or combinations thereof can be extremely difficult. This presents a difficult challenge for model development as the model may be tasked with identifying or classifying a context based on inadequate data. In ideal situations, data sets used to train object detection models have an equal or similar amount of data for each category. However, data sets collected from vehicle sensors are generally unbalanced, as vehicles encounter far more positive data than negative data.

In various embodiments of the present disclosure, a system may create synthetic data in order to bolster data sets lacking real data for one or more contexts. In some embodiments, a generative adversarial network (GAN) image generator creates the synthetic data. GAN is a type of generative model that uses machine learning, more specifically deep learning, to generate images (e.g., still images or video clips) based on a list of keywords presented as input to the GAN. The GAN uses these keywords used to create an image. Various embodiments also employ logic to determine which keywords are supplied to the GAN for image generation. Merely feeding random data to the GAN would result in a host of unusable data. Certain context combinations may not match up with occurrences in the real world. For example, a clown in the middle of a highway road in a snowstorm in Saudi Arabia is an event so unlikely as to be virtually impossible. As another example, it is unlikely (though far more likely than the previous scenario) to encounter bicycles on a snowy highway road. Accordingly, a system may generate images for this scenario (e.g., by using the keywords “bicycle”, “snow”, and “highway”), but not the previous scenario. By intelligently controlling the synthetic data creation, the system may create images (for training) that would otherwise require a very long time for a vehicle to encounter in real life.

Various embodiments may be valuable in democratizing data availability and model creation. For example, the success of an entity in a space such as autonomous driving as a service may depend heavily on the amount and diversity of data sets accessible to the entity. Accordingly, in a few years when the market is reaching maturity, existing players who started their data collection early on may have an unfair advantage, potentially crowding out innovation by newcomers. Such data disparity may also hinder research in academia unless an institution has access to large amounts of data through their relationships to other entities that have amassed large data sets. Various embodiments may ameliorate such pressures by increasing the availability of data available to train models.

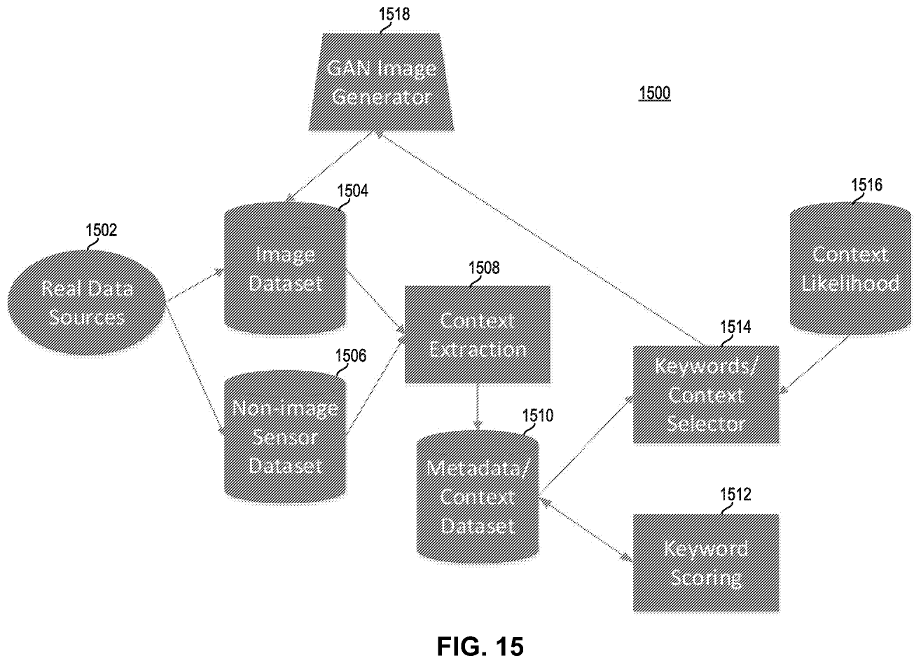

FIG. 15 depicts a system 1500 to intelligently generate synthetic data in accordance with certain embodiments. System 1500 represents any suitable computing system comprising any suitable components such as memory to store information and one or more processors to perform any of the functions of system 1500. In the embodiment depicted, system 1500 accesses real data sources 1502 and stores the real data sources in image dataset 1504 and non-image sensor dataset 1506. The real data sources 1502 may represent data collected from live vehicles or simulated driving environments. Such real data may include image data, such as video data streaming from one or more cameras, point clouds from one or more LIDARs, or similar imaging data obtained from one or more vehicles or supporting infrastructure (e.g., roadside cameras). The collected image data may be stored in image dataset 1504 using any suitable storage medium. The real data sources may also include non-image sensor data, such as data from any of numerous sensors that may be associated with a vehicle. The non-image sensor data may also be referred to as time-series data. This data may take any suitable form, such as a timestamp and an associated value. The non-image sensor data may include, for example, measurements from motion sensors, GPS, temperature sensors, or any process used in the vehicle that generate data at any given rate. The collected non-image sensor data may be stored in non-image dataset 1506 using any suitable storage medium.

Context extraction module 1508 may access instances of the image data and non-image sensor data and may determine a context associated with the data. The two types of data may be used jointly or separately to generate a context (which may represent a single condition or a combination of conditions), such as any of the contexts described herein. For example, imaging data alone may be used to generate the context “snow”. As another example, imaging data and temperature data may be used to generate the context “foggy and humid”. In yet another example, the sensor data alone may be used to generate a context of “over speed limit”. The determined context(s) is often expressed as metadata associated with the raw data.

The context extraction module 1508 may take any suitable form. In a particular embodiment, module 1508 implements a classification algorithm (e.g., a machine learning algorithm) that can receive one or more streams of data as input and generate a context therefrom. The determined context is stored in metadata/context dataset 1510 with the associated timestamp which can be used to map the context back to the raw data stream (e.g., the image data and/or the non-image sensor dataset). These stored metadata streams may tell a narrative of driving environment conditions over a period of time. For model development, the image data and non-sensor image data is often collected in the cloud and data scientist and machine learning experts are given access to enable them to generate models that can be used in different parts of the autonomous vehicle.

Keyword scoring module 1512 will examine instances of the context data (where a context may include one or more pieces of metadata) and, for each examined instance, identify a level of commonness indicating a frequency of occurrence of each context instance. This level of commonness may be indicative of how often the system has encountered the particular context (whether through contexts applied to real data sources or through contexts applied to synthetically generated images). The level of commonness for a particular context may represent how much data with that particular context is available to the system (e.g., to be used in model training). The level of commonness may be saved in association with the context (e.g., in the metadata/context dataset 1510 or other suitable storage location).

The keyword scoring module 1512 may determine the level of commonness in any suitable manner. For example, each time a context instance in encountered, a counter specific to that context may be incremented. In other examples, the metadata/context dataset 1510 may be searched to determine how many instances of that context are stored in the database 1510. In one example, once a context has been encountered a threshold number of times, the context may be labeled as “commonly known” or the like, so as to not be selected as a candidate for synthetic image generation. In some embodiments, metadata/context dataset 1510 may store a table of contexts with each context's associated level of commonness.

The keywords/context selector module 1514 may access the metadata/context dataset (or other storage) and analyze various contexts and their associated levels of commonness to identify candidates for synthetic image generation. In a particular embodiment, module 1514 looks for contexts that are less common (as the system may already have sufficient data for contexts that are very common). The module 1514 may search for such contexts in a batched manner by analyzing a plurality of contexts in one session (e.g., periodically or upon a trigger) or may analyze a context in response to a change in its level of commonness. Module 1514 may select one or more contexts that each include one or more key words describing the context. For example, referring to an example above, a selected context may include the key words “bicycle”, “snow”, and “highway”.

After selecting a context as a candidate for synthetic image generation, module 1514 may consult context likelihood database 1516 to determine whether the selected context occurs in the real world. Context likelihood database 1516 may be generated using data (e.g., text, pictures, and videos) compiled from books, articles, internet websites, or other suitable sources. The data of the context likelihood database 1516 may be enriched as more data becomes available online. The data may be harvested from online sources in any suitable manner, e.g., by crawling websites and extracting data from such websites, utilizing application programming interfaces of a data source, or other suitable methods. Image data (including pictures and video) may be processed using machine learning or other classification algorithms to determine key words associated with objects and context present in the images. The collected data may be indexed to facilitate searching for keywords in the database as searching for the proximity of keywords to other keywords. The gathered data may form a library of contexts that allow deduction of whether particular contexts occur in the real world.

After selecting a context as a candidate for synthetic image generation, module q14 may consult context likelihood database 1516 to determine how often the key words of the context appear together in the collected data sources within the context likelihood database 1516. If the key words never appear together, module 1514 may determine that the context does not appear in the real world and may determine not to generate synthetic images for the context. In some embodiments, if the key words do appear together (or appear together more than a threshold number of times), a decision is made that the context does occur in the real world and the keywords of the context are passed to GAN image generator 1518.

In a particular embodiment, an indication of whether the context occurs in real life and/or whether synthetic images have been generated for the context may be stored in association with the context in metadata/context dataset 1510 (or other suitable storage) such that module 1514 may avoid performing unnecessary lookups of context likelihood database 1516 for the particular context. Additionally, if a particular context is determined to not occur in the real world, module 1514 may determine that child contexts for that particular context do not occur in the real world either (where a child context inherits all of the keywords of the parent context and includes at least one additional key word). In some embodiments, a context may be analyzed again for occurrence in the real world under certain conditions (e.g., upon a major update to the context likelihood database 1516) even if it is determined not to occur in the real world in a first analysis.

Upon a determination that a context selected as a candidate for synthetic image generation does occur in the real world according to the information within context likelihood database 1516, the context is provided to GAN image generator 1518. Image generator 1518 may include suitable logic to generate image data (e.g., one or more pictures or video clips) representing the context. For example, to continue the example from above, if a context has keywords “bicycle”, “snow”, and “highway,” the image generator 1518 may generate one or more instances of image data each depicting a bicycle on a highway in the snow. In various embodiments, the GAN image generator 1518 may be tuned to provide image data useful for model training. As an example, the generator 1518 may generate images having various types of bicycles (optionally in different positions within the images) on various types of highways in the snow.

The image data generated by the image generator 1518 may be placed into the image dataset and stored in association with the context used to generate the images. Such images may be used to train one or more models (e.g., machine learning models) to be used by an autonomous vehicle to detect objects. Accordingly, system 1500 may identify unlikely contexts, determine whether such contexts are likely to exist in the real world, and then generate synthetic images of such contexts in order to enrich the data set to improve classification and object identification performance.

In various embodiments, system 100 may also include modules to receive input from human or other actors (e.g., computing entities) to guide any of the functions described herein. For example, explicit input may be received regarding whether a certain context is possible. In some embodiments, a subset of the queries to context likelihood database 1516 may be used to query a human operator as to whether a context is realistic. For example, if a search of the database 1516 returns very few instances of the keywords of the context together, a human operator may be queried as to whether the context is realistic before passing the context on to the image generator 1518. As another example, a human operator or computing entity may inject keywords directly to GAN image generator 1518 for generation of images for desired contexts. Such images may then be stored into the image dataset 1504 along with their associated contexts. In some embodiments, the human input may be provided via a developer of a computing model to be used by an autonomous vehicle or by a crowdsourcing platform, such as Amazon Mechanical Turk.

In some embodiments, the system may be biased towards a specific set of contexts and associated keywords. For example, if a model developer knows that the model is less accurate during fog or at night, the model developer could trigger the generation of additional synthetic image datasets using these keywords in order to train the model for improved performance. In various embodiments, the synthetic image data generated could also be used for model testing to determine the accuracy of the model. In some embodiments, synthetic data images may be used to test a model before they are added to the image dataset. For example, if a current model has a hard time accurately classifying the synthetic images, such images may be considered useful for training to improve model performance and may then be added to the image dataset 1504.

In various embodiments, all or a portion of system 1500 may be separate from an onboard computing system of a vehicle (e.g., system 1500 or components thereof may be located in a cloud computing environment). In other embodiments, all or a portion of system 1500 may be integrated with an onboard, in-vehicle computing system of a vehicle, such as discussed herein.

In a particular embodiment, an on-board context detection algorithm may be performed by a vehicle in response to data capture by the vehicle. The vehicle may store and use a snapshot of the context likelihood database 1516 (e.g., as a parallel method to the GAN). Upon upload of data associated with a rare event, the image generator 1518 may use data from a context detection algorithm performed by the vehicle as input to generate more instances of these rare contexts.

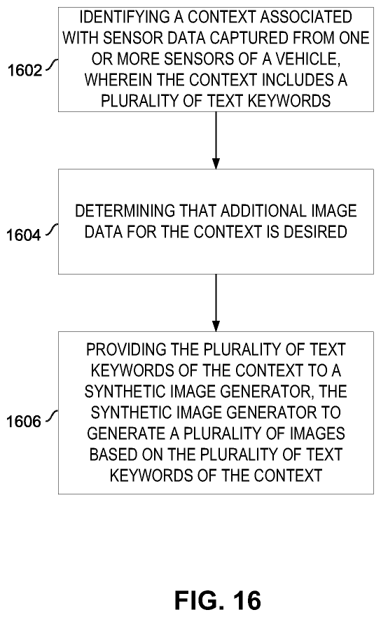

FIG. 16 depicts a flow for generating synthetic data in accordance with certain embodiments. At 1602, context associated with sensor data captured from one or more sensors of a vehicle is identified, wherein the context includes a plurality of text keywords. At 1604, it is determined that additional image data for the context is desired. At 1606, the plurality of text keywords of the context are provided to a synthetic image generator, the synthetic image generator to generate a plurality of images based on the plurality of text keywords of the context.

During the operation of autonomous vehicles, extensive amounts of vision classification and audio recognition algorithms are performed. Due to their state-of-the-art performance, deep learning algorithms may be used for such applications. However, such algorithms, despite their highly effective classification performance, may be vulnerable to attack. With respect to computer vision, adversarial attackers may manipulate the images through very small perturbations, which may be unnoticeable to the human eyes, but may distort an image enough to cause a deep learning algorithm to misclassify the image. Such an attack may be untargeted, such that the attacker may be indifferent to the resulting classification of the image so long as the image is misclassified, or an attack may be targeted, such that the image is distorted so as to be classified with a targeted classifier. Similarly, in the audio space, an attacker can inject noise which does not affect human hearing of the actual sentences, but the speech-to-text algorithm will misunderstand the speech completely. Recent results also show that the vulnerability to adversarial perturbations is not limited to deep learning algorithms but may also affect classical machine learning methods.

In order to improve security of machine learning algorithms, various embodiments of the present disclosure include a system to create synthetic data specifically mimicking the attacks that an adversary may create. To synthesize attack data for images, multiple adversaries are contemplated, and adversarial images are generated from images for which the classifiers are already known and then used in a training set along with underlying benign images (at least some of which were used as the underlying images for the adversarial images) to train a machine learning model to be used for object detection by a vehicle.

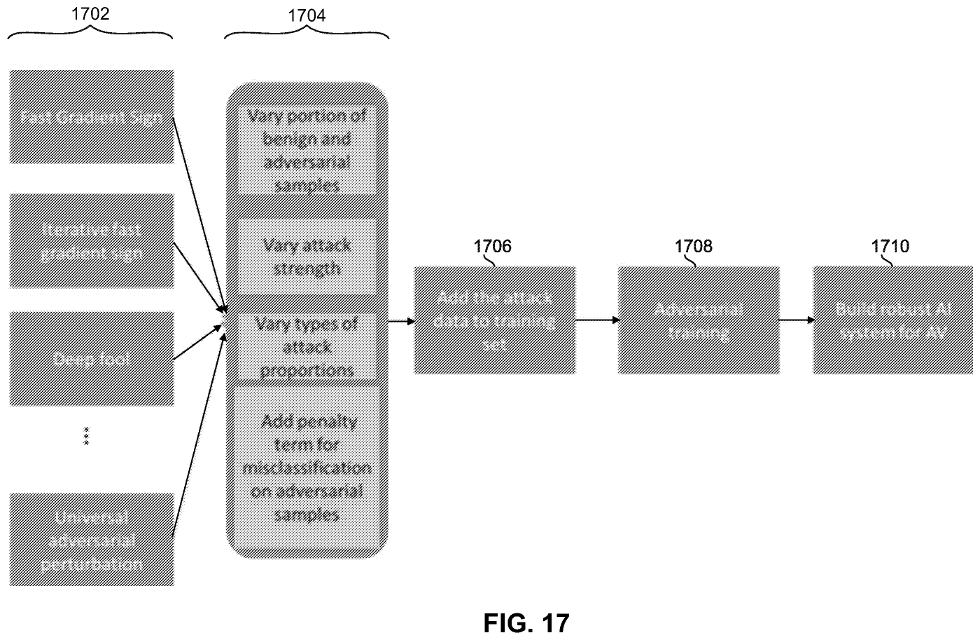

FIG. 17 depicts a flow for generating adversarial samples and training a machine learning model based on the adversarial samples. The flow may include using a plurality of different attack methods 1702 to generate adversarial samples. One or more parameters 1704 may be determined to build the training data set. The parameters may include, e.g., on or more of a ratio of benign to adversarial samples, various attack strengths to be used (and ratios of the particular attack strengths for each of the attack methods), proportions of attack types (e.g., how many attacks will utilize a first attack method, how many will utilize a second attack method, and so on), and a penalty term for misclassification of adversarial samples. The adversarial samples may be generated by any suitable computing, such as discussed herein.

After the adversarial samples are generated according to the parameters, the adversarial samples may be added to benign samples of a training set at 1706. The training set may then be used to train a classification model at 1708 by a computing system. The output of the training may be used to build a robust Al classification system for a vehicle at 1710 (e.g., an ML model that may be executed by, e.g., inference engine 254). The various portions of the flow are described in more detail below.

Any number of expected attack methods may be used to generate the synthetic images. For example, one or more of a fast gradient sign method, an iterative fast gradient sign method, a deep fool, a universal adversarial perturbation, or other suitable attack method may be utilized to generate the synthetic images.

Generating an adversarial image via a fast gradient sign method may include evaluating a gradient of a loss function of a neural network according to an underlying image, taking the sign of the gradient, and then multiplying it by a step size (e.g., a strength of the attack). The result is then added to the original image to create an adversarial image. Generating an adversarial image via an iterative fast gradient sign method may include an iterative attack of a step size over a number of gradient steps, rather than a single attack (as is the case in the fast gradient sign method), where each iteration is added to the image. Generating an adversarial image via a deep fool method may include linearizing the loss function at an input point and applying the minimal perturbation that would be necessary to switch classes if the linear approximation is correct. This may be performed iteratively until the network's chosen class switches. Generating an adversarial image via a universal adversarial perturbation method may include calculating a perturbation on an entire training set and then adding it to all of the images (whereas some of the other attack methods attack images individually).

In some embodiments, multiple adversarial images may be generated from a single image with a known classifier using different attack strengths. For example, for a particular attack method, a first adversarial image may be generated from a benign image using a first attack strength and a second adversarial image may be generated from the same benign image using a second attack strength.

In some embodiments, multiple attack methods may be applied to generate multiple adversarial images from a single benign image. For example, a first attack method may be used with one or more attack strengths to generate one or more adversarial images from a benign image and a second attack method may be used with one or more attack strengths to generate one or more additional adversarial images from the same benign image.

Any suitable number of attack methods and any suitable number of attack strengths may be used to generate adversarial images for the synthetic data set. Moreover, in some embodiments, the attack methods and attack strengths may be distributed across benign images (e.g., not all methods and/or strengths are applied to each benign image). For example, one or more attack methods and/or one or more attack strengths may be applied to a first benign image to generate one or more adversarial images, a different one or more attack methods and/or one or more attack strengths may be applied to a second benign image to generate one or more additional adversarial images, and so on. In some embodiments, the attack strength may be varied for attacks on images from each class to be trained.

In various embodiments, the proportions of each type of attack may be varied based on an estimate of real-world conditions (e.g., to match the ratio of the types of expected attacks). For example, 50% of the adversarial images in the synthetic data set may be generated using a first attack method, 30% of the adversarial images may be generated using a second attack method, and 20% of the adversarial images may be generated using a third attack method.

In various embodiments, the proportion of benign images to adversarial images may also be varied from one synthetic data set to another synthetic data set. For example, multiple synthetic data sets having different ratios of benign images to adversarial images may be tested to determine the optimal ratio (e.g., based on object detection accuracy).

Each adversarial image is stored with an association to the correct ground truth label (e.g., the class of the underlying benign image). In some embodiments, the adversarial images may each be stored with a respective attack label (e.g., the label that the adversarial image would normally receive if the classifier wasn't trained on the adversarial data which may be the attacker's desired label in a targeted attack). A collection of such adversarial images and associated classifiers may form a simulated attack data set.

A simulated attack data set may be mixed with a set of benign images (and associated known classifiers) and used to train a supervised machine learning classification model, such as a neural network, decision tree, support vector machine, logistic regression, k-nearest neighbors algorithm, or other suitable classification model. Thus, the synthetic attack data may be used as augmentation to boost the resiliency against the attacks on deep learning algorithms or classical ML algorithms. During training, the adversarial images with their correct labels are incorporated as part of the training set to refine the learning model. Furthermore, in some embodiments, the loss function of the learning model may incur a penalty if the learning algorithm tends to classify the adversarial images into the attacker's desired labels during training. As a result, the learning algorithm will develop resiliency against adversarial attacks on the images.

Any of the approaches described above may be adapted to similar attacks on audio data. Any suitable attack methods for audio data may be used to generate the adversarial audio samples. For example, methods based on perturbing an input sample based on gradient descent may be used. These attack methods may be one-time attacks or iterative attacks. As with the image attacks, multiple different attack methods may be used, the audio attacks may vary in attack strength, the ratio of adversarial samples generated from the attack methods may vary, and the ratio of adversarial samples to benign samples may vary as well. The adversarial audio samples may be used to train any suitable text-to-speech (e.g., WaveNet, DeepVoice, Tacotron, etc.) or speech recognition (e.g., deep models with Hidden Markov Models, Connectionist Temporal Classification models, attention-based models, etc.) machine learning model.

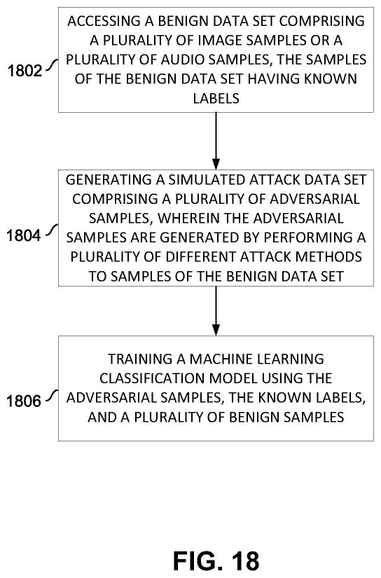

FIG. 18 depicts a flow for generating a simulated attack data set and training a classification model using the simulated attack data set in accordance with certain embodiments. At 1802, a benign data set comprising a plurality of image samples or a plurality of audio samples are accessed. The samples of the benign data set have known labels. At 1804, a simulated attack data set comprising a plurality of adversarial samples is generated, wherein the adversarial samples are generated by performing a plurality of different attack methods to samples of the benign data set. At 1806, a machine learning classification model is trained using the adversarial samples, the known labels, and a plurality of benign samples.

Semi-autonomous and autonomous vehicle systems are heavily dependent on Machine Learning (ML) techniques for object identification. As time elapses, the models that are used for classifying must be updated (including retraining) so they continue to accurately reflect the changing environments that are experienced during use, both in terms of novel events (e.g., a change in a snow storm) and changing patterns (e.g., increases in traffic density). While updates to a ML model may be performed in a periodic manner, such updates may result in excess resource usage when a valid model is unnecessarily replaced or may result in a greater number of misclassifications when updates are not frequent enough.

In various embodiments of the present disclosure, multiple classifiers, each having different properties, are used during object detection and the behavior of one classifier may be used to determine when the other classifier(s) should be updated (e.g., retrained using recently detected objects). For example, the behavior of a simple classifier (e.g., a linear classifier) may be used to determine when a more robust or complicated classifier (e.g., a non-linear classifier) is to be updated. The simple classifier may act as an early detection system (like a “canary in the coal mine”) for needed updates to the more robust classifier. While the simple classifier may not provide as robust or accurate object detection as the other classifier, the simple classifier may be more susceptible to changes in environment and thus may enable easier detection of changes in environment relative to a non-linear classifier. In a particular embodiment, a classifier that is relatively more susceptible to accuracy deterioration in a changing environment is monitored and when the accuracy of this classifier drops by a particular amount, retraining of the classifiers is triggered.

Although this disclosure focuses on embodiments using a linear classifier as the simple classifier and a non-linear classifier as the more robust classifier, other embodiments may utilize any suitable classifiers as the simple and robust classifiers. For example, in a particular embodiment, the robust classifier may be a complex non-linear classifier and the simple classifier may be a less sophisticated non-linear classifier. The simple classifier (e.g., linear classifier) and robust classifier (e.g., non-linear classifier) may be implemented by any suitable computing systems.

Although the class boundaries of the linear and non-linear classifiers in the examples below are depicted as classifying samples along two dimensions (x and y dimensions) to simplify the explanation, in various embodiments the linear classifier or the non-linear classifier may classify samples along any suitable number of dimensions (e.g., the input vector to the classifier may have any number of feature values). For example, instead of a line as a class boundary for a linear classifier, a hyperplane may be used to split an n-dimensional input space where all samples on one side of the hyperplane are classified with one label while the samples on the other side of the hyperplane are classified with another label.

A linear classifier may make a classification decision based on the value of a linear combination of multiple characteristics (also referred to as feature values) of an input sample. This disclosure contemplates using any suitable linear classifiers as the simple classifier. For example, a classifier based on regularized least squares, a logistic regression, a support vector machine, Naïve Bayes, linear discriminant classifier, perceptron, or other suitable linear classification technology may be used.

A non-linear classifier generally determines class boundaries that cannot be approximated well with linear hyperplanes and thus the class boundaries are non-linear. This disclosure contemplates using any suitable non-linear classifiers as the robust classifier. For example, a classifier based on quadratic discriminant classifier, multi-layer perceptron, decision trees, random forest, K-nearest neighbor, ensembles, or other suitable non-linear classification technology may be used.

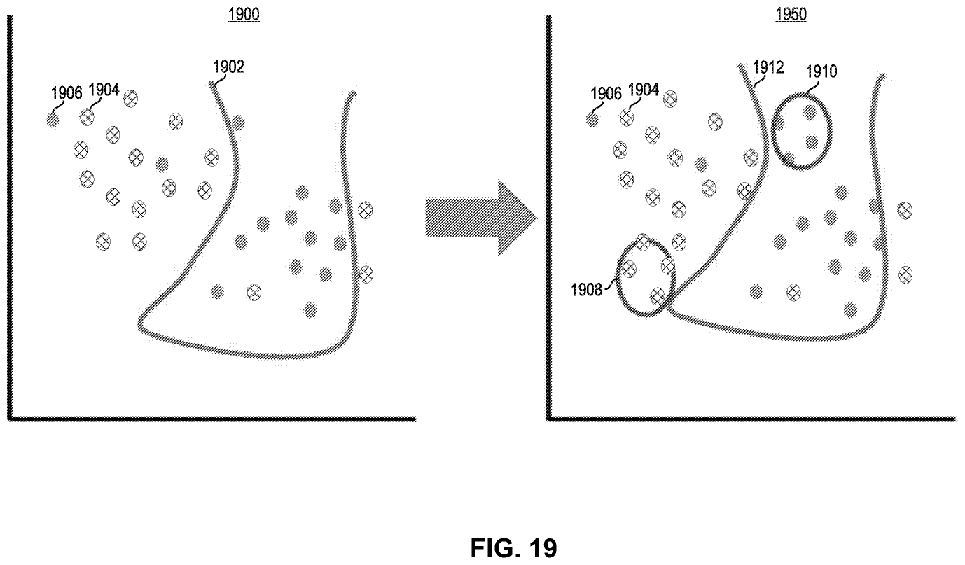

FIG. 19 illustrates operation of a non-linear classifier in accordance with certain embodiments. The non-linear classifier may be used to classify any suitable input samples (e.g., events) having one or more feature values. FIG. 19 depicts a first dataset 1900 with a plurality of samples 1904 of a first-class and a plurality of samples 1906 of a second-class. The non-linear classifier is configured to distinguish whether a sample is of the first-class or the second-class based on the feature values of the sample and a class boundary defined by the non-linear classifier.

Data set 1900 may represent samples used to train the non-linear classifier while data set 1950 represents the same samples as well as additional samples 1908 of the first type and additional samples 1910 of the second type. Class boundary 1912 represents the class boundary for the non-linear classifier after the non-linear classifier is retrained based on a training set including the new samples 1908 and 1910. While the new class boundary 1912 may still enable the non-linear classifier to correctly label the new samples, the shifting data patterns may not be readily apparent because the class boundaries 1902 and 1912 have generally similar properties.

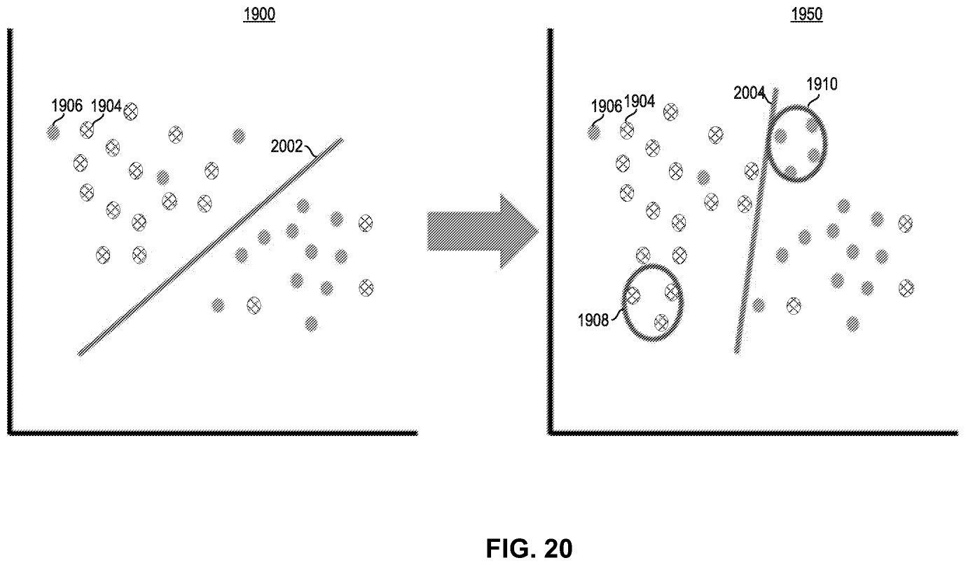

FIG. 20 illustrates operation of a linear classifier in accordance with certain embodiments. FIG. 20 depicts the same data sets 1900 and 1950 as FIG. 19. Class boundary 2002 represents a class boundary of the linear classifier after training on data set 1900, while class boundary 2004 represents a class boundary of the linear classifier after the linear classifier is retrained based on a training set including the new samples 1908 and 1910. The new data patterns (exemplified by the new samples 1908 and 1910) may be apparent since the new samples would be incorrectly categorized without retraining of the linear classifier.

Thus, the linear classifier may provide an early warning that data is changing, leading to the ability to monitor the changing dataset and proactively train new models. In particular embodiments, a system may monitor the accuracy of the linear classifier, and when the accuracy drops below a threshold amount, retraining of both the linear and non-linear classifiers may be triggered. The retraining may be performed using training sets including the more recent data.

As the combination of classifiers is designed to provide early change detection while preserving robust classification, various embodiments, in addition to detecting shifts in the environment, may be used to detect attacks. Attack data will generally be different than the training data, which is assumed to be gathered in a clean manner (e.g., from sensors of one or more autonomous vehicles) or using synthetic generation techniques (such as those discussed herein or other suitable data generation techniques). Accordingly, a loss in the accuracy of the linear classifier will provide an early indication of attack (e.g., the accuracy of the linear classifier will degrade at a faster pace than the accuracy of the non-linear classifier). Additionally, as the classifiers function differently, it may be more difficult for an attacker to bypass both systems at the same time.

In particular embodiments, changes in the linear classifier over time may allow a system to determine which data is new or interesting to maintain for further training. For example, when a change in the accuracy of the linear classifier is detected, the recently acquired data (and/or the incorrectly classified data) may be analyzed to determine data of interest, and this data of interest may be used to synthetically generate related data sets (using any of the techniques described herein or other suitable synthetic data generation techniques) to be used to train the linear and non-linear classifiers.

As the classifier will change due to data that is dissimilar from the training data, the new sample instances may be analyzed and maintained for further training. For example, in FIG. 20, samples 1908 and 1910 caused the class boundary of the linear classifier to shift. A subset of these new samples may be sampled and maintained for future training sets. In a particular embodiment, these new samples may be randomly sampled to avoid introducing data bias into the training set. In other embodiments, a disproportionate amount of a certain class may be maintained for a future training set (e.g., if the number of samples of that class is significantly less than the number of samples of the other class).

Although the example describes a two-class classifier, various embodiments may also provide multiclass classification according to the concepts described herein (e.g., utilizing simple and robust classifiers). For example, a series of hyperplanes may be used, where each class i (for 1−n) is compared against the other classes as a whole (e.g., one versus all). As another example, a series of hyperplanes may be used, where each class i (for 1−n) is compared against the other classes j (for 1−n) individually (e.g., one versus one).

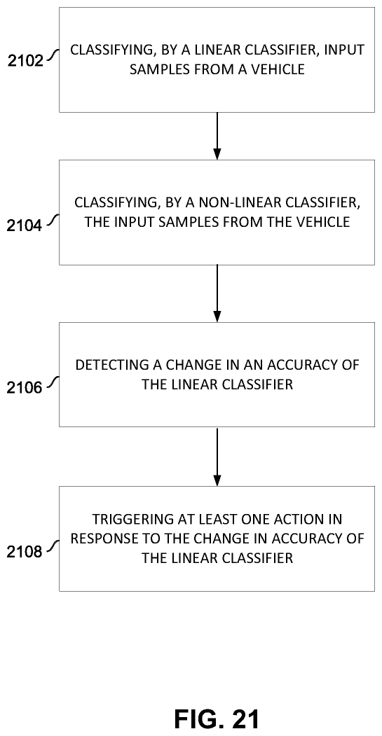

FIG. 21 depicts a flow for triggering an action based on an accuracy of a linear classifier. At 2102, a linear classifier classifies input samples from a vehicle. At 2104, a non-linear classifier classifies the same input samples from the vehicle. In particular embodiments, such classification may be performed in parallel. At 2106, a change in an accuracy of the linear classifier is detected. At 2108, at least one action is triggered in response to the change in accuracy of the linear classifier.

An autonomous vehicle may be equipped with several sensors that produce a large amount of data, even over a relatively small period of time (e.g., milliseconds). Under the assumption of real-time data processing fashion, which is vital for such systems, the data collected at time T should be processed before the next data generated is recorded at time T+1 (where the unit 1 here is the maximum resolution of the particular sensor). For a Camera (which generally operates at 30 frames per second) and a LIDAR (which generally operates at 20 sweeps per second), 33 ms resolution and 50 ms respectively may be considered acceptable resolutions. Thus, high speed decisions are desirable. An event or situation is formed by a series of recordings over a period of time, so various decisions may be made based on a time-series problem based on the current data point as well as previous data points. In practice, a predefined processing windows is considered, as it may not be feasible to process all recorded data and the effect of recorded data over time tends to diminish.

The process of detecting patterns that do not match with the expected behaviors of sensor data is called anomaly detection. Determining the reason for an anomaly is termed anomaly recognition. Anomaly recognition is a difficult task for machine learning algorithms for various reasons. First, machine learning algorithms rely on the seen data (training phase) to estimate the parameters of the prediction model for detecting and recognizing an object. However, this is contrary to the characteristics of anomalies, which are rare events without predefined characteristics (and thus are unlikely to be included in traditional training data). Second, the concept of an anomaly is not necessarily constant and thus may not be considered as a single class in traditional classification problems. Third, the number of classes in traditional machine learning algorithms is predefined and when input data that is not relevant is received, the ML algorithm may find the most probable class and label the data accordingly, thus the anomaly may go undetected.

In various embodiments of the present disclosure, a machine learning architecture for anomaly detection and recognition is provided. In a particular embodiment, a new class (e.g., “Not known”) is added to a Recurrent Neural Network to enhance the model to enable both time-based anomaly detection and also to increase an anomaly detection rate by removing incorrect positive cases. Various embodiments may be suitable in various applications, including in object detection for an autonomous vehicle. Accordingly, in one embodiment, at least a part of the architecture may be implemented by perception engine 238.

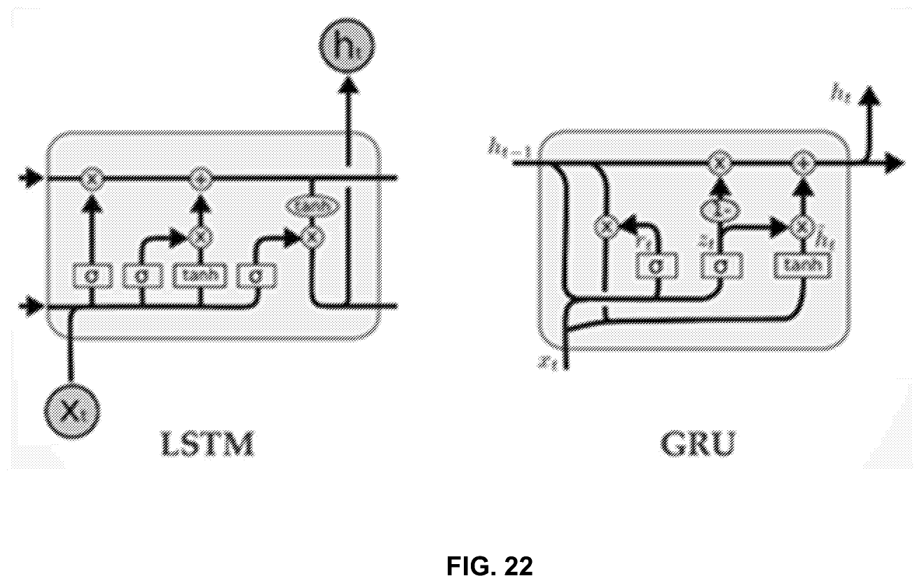

In particular embodiments, the architecture may include one or more ML models including or based on a Gated Recurrent Unit (GRU) or a Long Short Term Memory networks (LSTM) neural network. FIG. 22 represents example GRU and LSTM architectures. Such networks are popularly used for natural language processing (NLP). GRU was introduced in 2014 and has a simpler architecture than LSTM and has been used in an increasing number of applications in recent years. In the GRU architecture, both forget and input gates are merged together to form “update gates”. Also, the cell state and hidden state get combined.

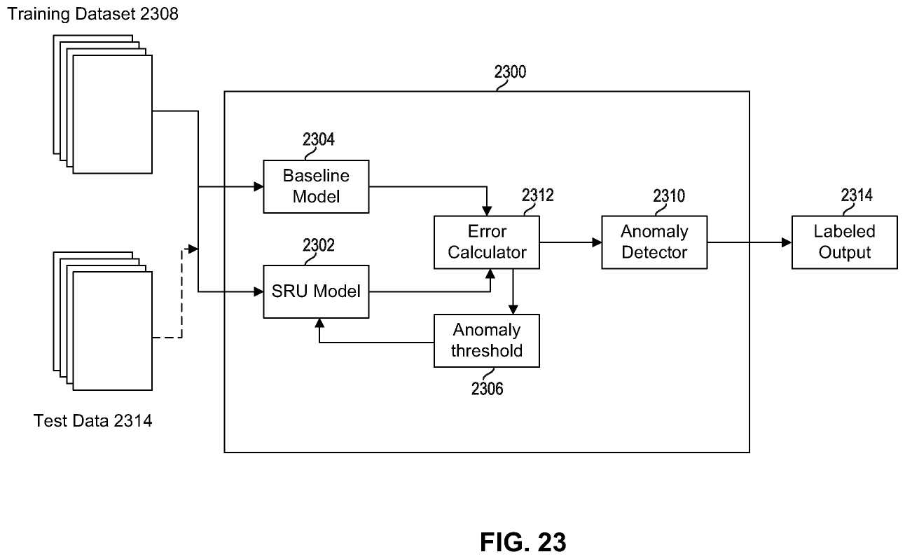

FIG. 23 depicts a system 2300 for anomaly detection in accordance with certain embodiments. The addition of an anomaly detector may enhance the intelligence of a system to enable reporting of unknown situations (e.g., time-based events) that would not have been detected previously. A new ML model based on an LSTM or GRU architecture (termed Smart Recurrent Unit (SRU) model 2302 herein) may be provided and used in conjunction with a standard LSTM or GRU model (“baseline model” 2304). In various embodiments, the architecture of the SRU model 2302 may be similar to the architecture of the baseline predictor, but may be specially tuned to detect anomalies. In various embodiments, the system 2300 is able to both encode a newly arriving sequence of anomaly data (e.g., encode the sequence as an unknown class) as well as decode a given data representation to an anomaly tag (e.g., over time, identify new anomaly classes and apply labels accordingly). Any suitable data sequence may be recognized as an anomaly by the system 2300. For example, an anomaly may be an unknown detected object or an unknown detected event sequence. In various embodiments, the addition of the SRU model may enhance the system's intelligence to report unknown situations (time-based events) that were not been seen by the system previously (either at training or test phases). The system may be able to encode a new sequence of anomaly data and assign a label to it to create a new class. When the label is generated, any given data representation to this type of anomaly may be decoded.

System 2300 demonstrates an approach to extract anomaly events on the training and inference phases. Anomaly threshold 2306 is calculated during the training phase, where the network calculates the borderline between learned, unlearned, and anomaly events. In a particular embodiment, the anomaly threshold 2306 is based on a sigmoid function used by one or both of the baseline model 2304 and the SRU model 2302. The anomaly threshold 2306 may be used to adjust parameters of the SRU model 2302 during training.

By enriching the training data set 2308 to encompass the expected normal cases, the whole network may converge to a state that only considers unknown situations as anomalies (thus anomaly samples do not need to be included in the training data set). This is the detection point when the anomaly detector 2310 will recognize that the situation cannot be handled correctly with the learned data. The training data set 2308 may include or be based on any suitable information, such as images from cameras, point clouds from LIDARs, features extracted from images or point clouds, or other suitable input data.

During training, the training dataset 2308 is provided to both the baseline model 2304 and the SRU model 2302. Each model may output, e.g., a predicted class as well as a prediction confidence (e.g., representing the assessed probability that the classification is correct). In some embodiments, the outputs may include multiple classes each with an associated prediction confidence. In some embodiments, e.g., based on GRU models, the outputs may be a time series indicative of how the output is changing based on the input. The SRU model 2302 may be more sensitive to unknown classes than the baseline model (e.g., 2304). The error calculator 2312 may determine an error based on the difference between the output of the baseline model 2304 and the output of the SRU model 2302.

During inference, test data 2314 (which in some embodiments may include information gathered or derived from one or more sensors of an autonomous vehicle) is provided to the baseline model 2304 and the SRU model 2302. If the error representing the difference between the outputs of the models is relatively high as calculated by error calculator 2312, then the system 2300 determines a class for the object was not included in the training data and an anomaly is detected. For example, during inference, the system may use anomaly detector 2310 to determine whether the error for the test data is greater than the anomaly threshold 2306. In one example, if the error is greater than the anomaly threshold 2306, an anomaly class may be assigned to the object.

In various embodiments, the anomaly detector 2310 may assign a catchall label of unknown classes to the object. In another embodiment, the anomaly detector 2310 may assign a specific anomaly class to the object. In various embodiments, the anomaly detector may assign various anomaly classes to various objects. For example, a first anomaly class may be assigned to each of a first plurality of objects having similar characteristics, a second anomaly class may be assigned to each of a second plurality of objects having similar characteristics, and so on. In some embodiments, a set of objects may be classified as a catchall (e.g., default) anomaly class, but once the system 2300 recognizes similar objects as having similar characteristics, a new anomaly class may be created for such objects.

The labeled output 2314 indicates the predicted class (which may be one of the classes of the training dataset or an anomaly class). In various embodiments, the labeled output may also include a prediction confidence for the predicted class (which in some cases may be a prediction confidence for an anomaly class).

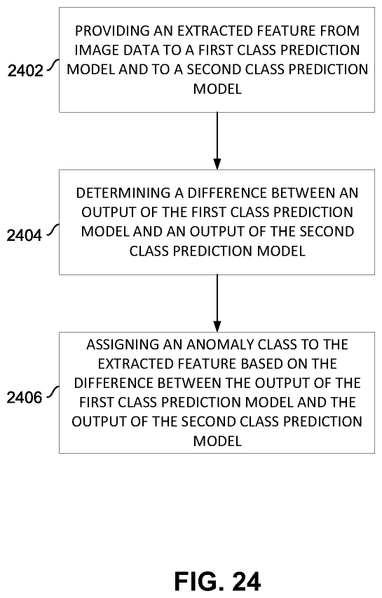

FIG. 24 depicts a flow for detecting anomalies in accordance with certain embodiments. At 2402, an extracted feature from image data is provided to a first-class prediction model and to a second-class prediction model. At 2404, a difference between an output of the first-class prediction model and an output of the second-class prediction model is determined. At 2406, an anomaly class is assigned to the extracted feature based on the difference between the output of the first-class prediction model and the output of the second-class prediction model.

Autonomous vehicles vary greatly in their characteristics. For example, the level of autonomy of vehicles can range from L1 to L5. As a further example, vehicles can have a wide variety of sensors. Examples of such sensors include LIDAR, cameras, GPS, ultrasound, radar, hyperspectral sensors, inertial measurement units, and other sensors described herein. In addition, vehicles can vary as to the number of each type of sensor with which they are equipped. For example, a particular vehicle may have two cameras, while another vehicle has twelve cameras.

In addition, vehicles have different physical dynamics and are equipped with different control systems. One manufacturer may have a different in-vehicle processing system with a different control scheme than another manufacturer. Similarly, different models from the same manufacturer, or even different trim levels of the same model vehicle, could have different in-vehicle processing and control systems. Furthermore, different types of vehicles may implement different computer vision or other computing algorithms, therefore, the vehicles may respond differently from one another in similar situations.

Given the possible differences between the autonomous vehicles (e.g., autonomy level, sensors, algorithms, processing systems, etc.,) there will be differences between the relative safety levels of the different vehicles. These differences may also be dependent on the portion of the road upon which each vehicle is traveling. In addition, different vehicles may be better at handling certain situations than others, such as, for example, inclement weather.

Since current autonomous vehicles are not capable of handling every situation that they may encounter, especially in every type of condition that they may encounter, it may be valuable to determine whether an autonomous vehicle has the capability of handling a portion of a road in the current conditions.

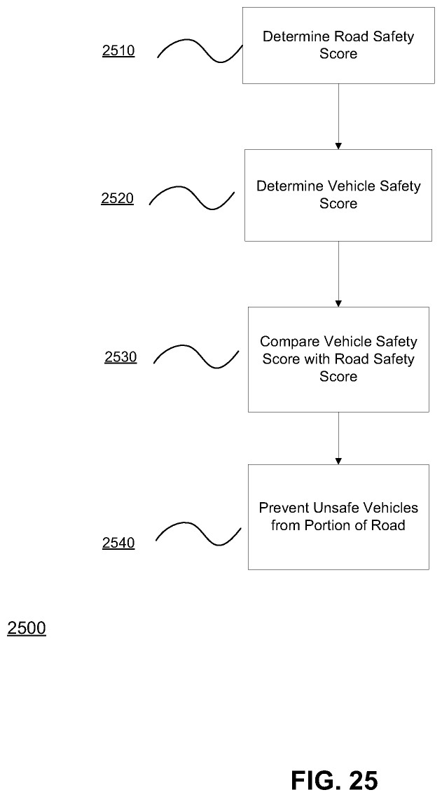

FIG. 25 illustrates an example of a method 2500 of restricting the autonomy level of a vehicle on a portion of a road, according to one embodiment. Method 2500 can be considered a method of dynamic geo-fencing using an autonomous driving safety score.

Method 2500 includes determining a road safety score for a portion of a road at 2510. This may comprise determining an autonomous driving safety score limit for a portion of a road. This road safety score can be a single score calculated by weighting and scoring driving parameters critical to the safety of autonomous vehicles. This score can represent the current safety level for an area of the road. This score can be a standardized value, which means that this value is the same for every individual autonomous vehicle on the road. In some embodiments, this safety score can be dynamic, changing constantly depending on the current conditions of a specific area of the road. Examples of criteria that can be used in the calculation of the score can include, but are not limited to: the weather conditions, time of day, the condition of the driving surface, the number of other vehicles on the road, the percentage of autonomous vehicles on the road, the number of pedestrians in the area, and whether there is construction. Any one or more of these conditions or other conditions that can affect the safety of an autonomously driven vehicle on that portion of the road can be considered in determining the road score. In some examples, the score criteria can be determined by a group of experts and/or regulators. The criteria can be weighted to allow certain conditions to affect the safety score more than others. In one example, the safety score can range from 0 to 100, although any set of numbers can be used or the safety score may be expressed in any other suitable manner.

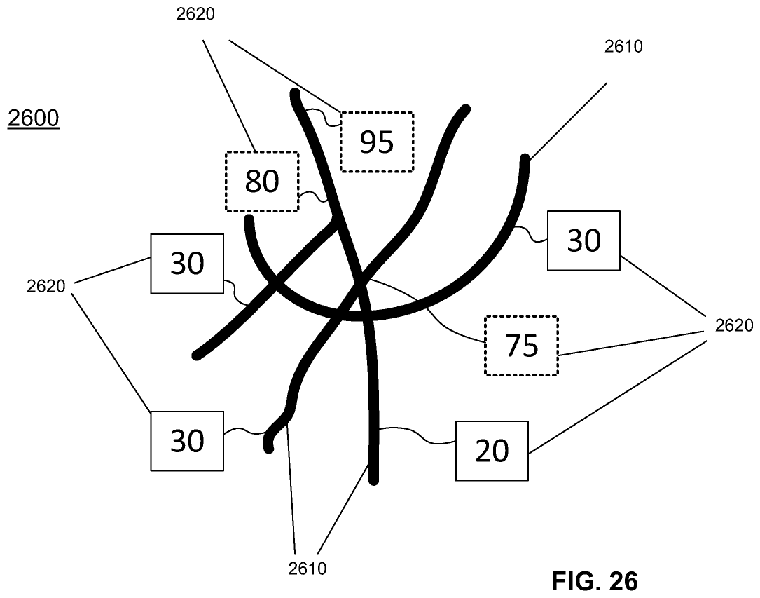

FIG. 26 illustrates an example of a map 2600 wherein each area of the roadways 2610 listed shows a road safety score 2620 for that portion of the road. This map can be displayed by a vehicle in a similar fashion to current GPS maps, wherein traffic and speed limit are displayed on the maps. In some examples, the mapping system (e.g., path planner module 242) can calculate the safety score based on inputs from sensors or other data in the geographic region of the road. In other examples, the score may be calculated externally to the vehicle (e.g., by 140 or 150) and the score is transmitted to the vehicle.

Method 2500 further includes determining a safety score for a vehicle at 2520. This safety score can be considered an autonomous vehicle safety score. The safety score can be used to represent the relative safety of an autonomous vehicle and may be used to determine the score limit of the roads that a car can drive on autonomously. Similar to the road safety score, the vehicle safety score may be a single score calculated by weighting important safety elements of the vehicle. Examples of criteria to be considered for the vehicle safety score can include: the type of sensors on the vehicle (e.g., LIDAR, cameras, GPS, ultrasound, radar, hyperspectral sensors, and inertial measurement units), the number of each sensor, the quality of the sensors, the quality of the driving algorithms implemented by the vehicle, the amount of road mapping data available, etc. Testing of each type of vehicle can be conducted by experts/regulators to determine each vehicle's safety score (or a portion thereof). In one example, a vehicle with advanced algorithms and a very diverse set of sensors can have a higher score, such as 80 out of 100. Another vehicle with less advanced algorithms and a fewer number and types of sensors will have a lower score, such as 40 out of 100.

Next, method 2500 includes comparing the vehicle safety score with the road safety score at 2530. the comparison may include a determination of whether an autonomous vehicle is safe enough to be autonomously driven on a given portion of a road. For example, if the road has a safety score of 95 and the car has a score of 50, the car is not considered safe enough to be driven autonomously on that stretch of the road. However, once the safety score of the road lowers to 50 or below, the car can once again be driven autonomously. If the car is not safe enough to be driven autonomously, the driver should take over the driving duties and therefor the vehicle may alert the driver of a handoff. In some examples, there can be a tiered approach to determining whether a car is safe enough to be driven autonomously. For example, the road can have multiple scores: an L5 score, an L4 score, and L3 score, etc. In such examples, the car safety score can be used to determine what level of autonomy an individual vehicle may use for a given portion of the road. If the car has a score of 50, and that score is within a range of scores suitable for L4 operation, the vehicle may be driven with an L4 level of autonomy.

Finally, method 2500 concludes with preventing autonomous vehicles from unsafe portions of a road at 2540. This may include alerting a vehicle that it is not capable of being driven autonomously on a particular stretch of road. Additionally or alternatively, this may include alerting the driver that the driver needs to take over the driving duties and handing over the drive duties to the driver once the driver is engaged. If the road has a tiered scoring level, as mentioned above, the proper autonomy level of the vehicle may be determined and an alert that the autonomous level is going to be dropped and the driver must engage or be prepared to engage may be provided, depending on the level of autonomy that is allowed for that vehicle on a particular portion of the road.

Image and video data may be collected by a variety of actors within a driving environments, such as by mobile vehicles (e.g., cars, buses, trains, drones, subways, etc.) and other transportation vehicles, roadside sensors, pedestrians, and other sources. Such image and video data is likely to sometimes contain images of people. Such images may be obtained, for example, by an outward or inward facing image capturing device mounted on a vehicle, or by data transmission of images from other electronic devices or networks to a computing system integrated with the vehicle. This data could be used to identify people and their locations at certain points in time, causing both safety and privacy concerns. This is particularly problematic when the images depict children or other vulnerable persons.

In some implementations, an example autonomous driving system (including in-vehicle autonomous driving systems and support systems implemented in the cloud or the fog) may utilize machine learning models to disguise faces depicted in images captured by a camera or other image capturing device integrated in or attached to vehicles. In an example embodiment, a trained Generative Adversarial Network (GAN) may be used to perform image-to-image translations for multiple domains (e.g., facial attributes) using a single model. The trained GAN model may be tested to select a facial attribute or combination of facial attributes that, when transferred to a known face depicted in an image to modify (or disguise) the known face, cause a face detection model to fail to identify the known face in the modified (or disguised) face. The trained GAN model can be configured with the selected facial attribute or combination of facial attributes. The configured GAN model can be provisioned in a vehicle to receive images captured by an image capturing device associated with the vehicle or other images received by a computing system in the vehicle from other electronic devices or networks. The configured GAN model can be applied to a captured or received image that depicts a face in order to disguise the face while retaining particular attributes (or features) that reveal information about the person associated with the face. Such information could include, for example, the gaze and/or emotion of the person when the image was captured.

As smart driving systems implemented in mobile vehicles have become more sophisticated, and even partially or fully autonomous, the amount and quality of image and video data collected by these mobile vehicles have increased significantly. Image and video data may be collected by any type of mobile vehicle including, but not necessarily limited to cars, buses, trains, drones, boats, subways, planes, and other transportation vehicles. The increased quality and quantity of image and video data obtained by image capturing devices mounted on mobile vehicles, can enable identification of persons captured in the image and video data and can reveal information related to the locations of such persons at particular points in time. Such information raises both safety and privacy concerns, which can be particularly troubling when the captured data includes children or other vulnerable individuals.

In the case of autonomous vehicles, image and video data collected by vehicles (e.g., up to 5 TB/hour) can be used to train autonomous driving machine learning (ML) models. These models aim at understanding the scene around the vehicle, detecting objects and pedestrians as well as predicting their trajectory.

In some geographies (e.g., the European Union, some states within the United States of America, etc.) identifying information is protected and stiff financial penalties may be levied on any entity retaining that protected information. Moreover, knowing that transportation vehicles are continuously collecting this data may affect the public trust and the adoption of autonomous vehicles, and may even negatively affect public sentiment towards service vehicles. Consequently, if left unaddressed, these user privacy issues could potentially hinder the adoption of at least some autonomous vehicle technology.

One approach to preserving privacy of image and video data is to blur or pixelate faces in the data. While blurring and pixilation can work in cases where basic computer vision algorithms are employed with the goal of detecting a person holistically, these approaches do not work with modern algorithms that aim at understanding a person's gaze and intent. Such information may be particularly useful and even necessary for example, when an autonomous car encounters a pedestrian and determines a reaction (e.g., slow down, stop, honk the horn, continue normally, etc.) based on predicting what the pedestrian is going to do (e.g., step into cross-walk, wait for the light to change, etc.). The gaze and intent of pedestrians are being increasingly researched to increase the “intelligence” built into vehicles. By detecting gaze and intent from a pedestrian's face, intelligence algorithms aim to predict the pedestrian trajectory and hence avoid accidents. For example, a pedestrian looking at his phone is more likely to miss a passing vehicle than another pedestrian looking directly at the vehicle. Machine learning algorithms need to extract some landmarks from the face to predict gaze. Blurring or pixelating a face renders this task impractical.

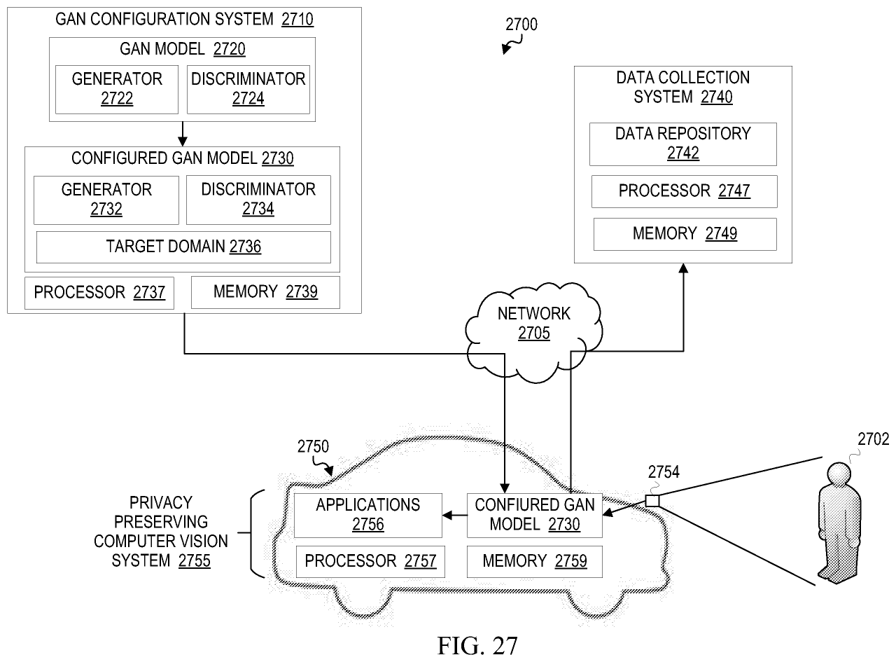

A communication system 2700, as shown in FIG. 27, resolves many of the aforementioned issues (and more). In at least one embodiment, a privacy-preserving computer vision system employs a Generative Adversarial Network (GAN) to preserve privacy in computer vision applications while maintaining the utility of the data and minimally affecting computer vision capabilities. GANs are usually comprised of two neural networks, which may be referred to herein as a “generator” (or “generative model”) and a “discriminator” (or “discriminative model”). The generator learns from one (true) dataset and then tries to generate new data that resembles the training dataset. The discriminator tries to discriminate between the new data (produced by the generator) and the true data. The generator's goal is to increase the error rate of the discriminative network (e.g., “fool” the discriminator network) by producing novel synthesized instances that appear to have come from the true data distribution.

At least one embodiment may use a pre-trained GAN model that specializes in facial attributes transfer. In communication system 2700, the pre-trained GAN model can be used to replace facial attributes in images of real people with a variation of those attributes while maintaining facial attributes that are needed by other machine learning capabilities that may be part of a vehicle's computer vision capabilities. Generally, the GAN model is pre-trained to process an input image depicting a face (e.g., a digital image of a real person's face) to produce a new image depicting the face with modifications or variations of attributes. This new image is referred to herein as a ‘disguised’ face or ‘fake’ face. Communication system 2700 may configure the pre-trained GAN model with one or more selected domain attributes (e.g., age, gender) to control which attributes or features are used to modify the input images.

The configured GAN model can be provisioned in a vehicle having one or more image capturing devices for capturing images of pedestrians, other vehicle operators, passengers, or any other individuals who come within a certain range of the vehicle. When an image of a person is captured by one of the vehicle's image capturing devices, the image may be prepared for processing by the configured GAN model. Processing may include, for example, resizing the image, detecting a face depicted in the image, and aligning the face. The processed image may be provided to the pre-configured GAN model, which modifies the face depicted in the image based on the pre-configured domain attributes (e.g., age, gender). The generator of the GAN model produces the new image depicting a modified or disguised face and provides it to other vehicle computer vision applications and/or to data collection repositories (e.g., in the cloud) for information gathering or other purposes, without revealing identifying information of the person whose face has been disguised. The new image produced by the GAN model is referred to herein as ‘disguised image’ and ‘fake image’.

Communication system 2700 may provide several example potential advantages. The continued growth expected for autonomous vehicle technology is likely to produce massive amounts of identifiable images in everyday use. Embodiments described herein address privacy concerns of photographing individuals while maintaining the utility of the data and minimally affecting computer vision capabilities. In particular, embodiments herein can render an image of a person's face unrecognizable while preserving the facial attributes needed in other computer vision capabilities implemented in the vehicle. User privacy can have both societal and legal implications. For example, without addressing the user privacy issues inherent in images that are captured in real time, the adoption of the computer vision capabilities may be hindered. Because embodiments herein mitigate user privacy issues of autonomous vehicles (and other vehicles with image capturing devices), embodiments can help increase trust in autonomous vehicles and facilitate the adoption of the technology as well as helping vehicle manufacturers, vehicle owners, and wireless service providers to comply with the increasing number of federal, state, and/or local privacy regulations.

Turning to FIG. 27, FIG. 27 illustrates communication system 2700 for preserving privacy in computer vision systems of vehicles according to at least one embodiment described herein. Communication system 2700 includes a Generative Adversarial Network (GAN) configuration system 2710, a data collection system 2740, and a vehicle 2750. One or more networks, such as network 2705, can facilitate communication between vehicle 2750 and GAN configuration system 2710 and between vehicle 2750 and data collection system 2740.

GAN configuration system 2710 includes a GAN model 2720 with a generator 2722 and a discriminator 2724. GAN model 2720 can be configured with a selected target domain, resulting in a configured GAN model 2730 with a generator 2732, a discriminator 2734, and a target domain 2736. GAN model 2720 also contains appropriate hardware components including, but not necessarily limited to a processor 2737 and a memory 2739, which may be realized in numerous different embodiments.

The configured GAN model can be provisioned in vehicles, such as vehicle 2750. In at least one embodiment, the configured GAN model can be provisioned as part of a privacy-preserving computer vision system 2755 of the vehicle. Vehicle 2750 can also include one or more image capturing devices, such as image capturing device 2754 for capturing images (e.g., digital photographs) of pedestrians, such as pedestrian 2702, other drivers, passengers, and any other persons proximate the vehicle. Computer vision system 2755 can also include applications 2756 for processing a disguised image from configured GAN model 2730 to perform evaluations of the image and to take any appropriate actions based on particular implementations (e.g., driving reactions for autonomous vehicles, sending alerts to driver, etc.). Appropriate hardware components are also provisioned in vehicle 2750 including, but not necessarily limited to a processor 2757 and a memory 2759, which may be realized in numerous different embodiments.

Data collection system 2740 may include a data repository 2742 for storing disguised images produced by configured GAN model 2730 when provisioned in a vehicle. The disguised images may be stored in conjunction with information related to image evaluations and/or actions taken by computer vision system 2752. In one example implementation, data collection system 2740 may be a cloud processing system for receiving vehicle data such as disguised images and potentially other data generated by autonomous vehicles. Data collection system 2740 also contains appropriate hardware components including, but not necessarily limited to a processor 2747 and a memory 2749, which may be realized in numerous different embodiments.

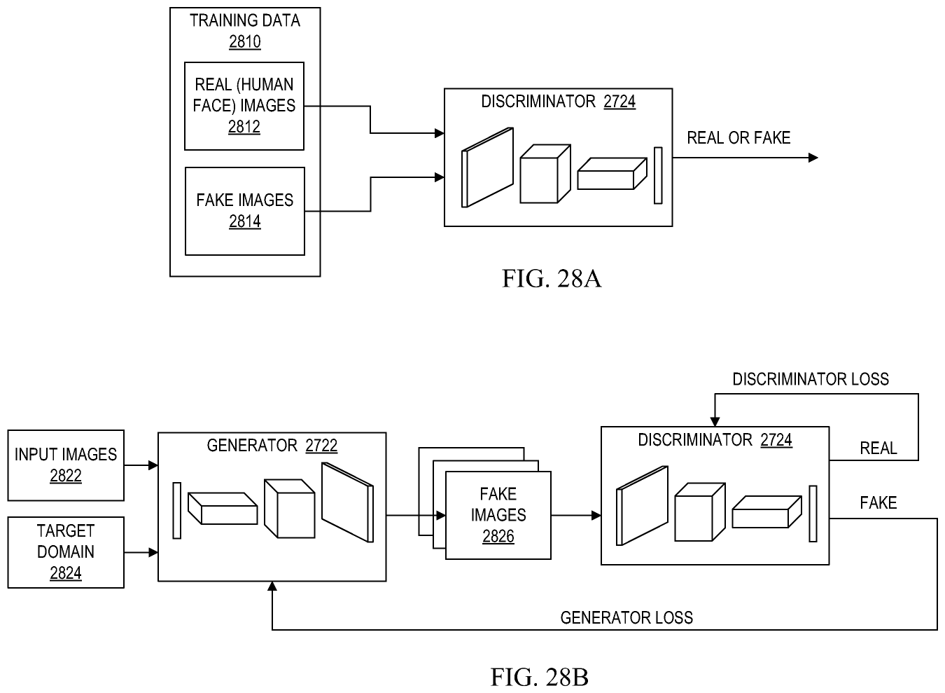

FIGS. 28A and 28B illustrate example machine learning phases for a Generative Adversarial Network (GAN) to produce a GAN model (e.g., 2720), which may be used in embodiments described herein to effect facial attribute transfers to a face depicted in a digital image. Extension models from GANs that are trained to transfer facial attributes are currently available including, but not necessarily limited to, StarGAN, IcGAN, DIAT, and CycleGAN.

In FIG. 28A, an initial training phase is shown for discriminator 2724. In one example, discriminator 2724 may be a standard convolutional neural network (CNN) that processes images and learns to classify those images as real or fake. Training data 2810 may include real images 2812 and fake images 2814. The real images 2812 depict human faces, and the fake images 2814 depict things other than human faces. The training data is fed to discriminator 2724 to apply deep learning (e.g., via a convolutional neural network) to learn to classify images as real faces or fake faces.

Once the discriminator is trained to classify images of human faces as real or fake, the GAN may be trained as shown in FIG. 28B. In one example, generator 2722 may be a deconvolutional (or inverse convolutional) neural network. Generator 2722 takes an input image from input images 2822 and transforms it into a disguised (or fake) image by performing facial attribute transfers based on a target domain 2824. In at least one embodiment, the domain attribute is spatially replicated and concatenated with the input image. Generator 2722 attempts to generate fake images 2826 that cannot be distinguished from real images by the discriminator.

Discriminator 2724, which was trained to recognize real or fake human faces as shown in FIG. 28A, receives the fake images 2826 and applies convolutional operations to the fake image to classify it as “real” or “fake”. Initially, the generator may produce fake images with a high loss value. Backpropagation of the generator loss can be used to update the generator's weights and biases to produce more realistic images as training continues. When a fake image “tricks” the discriminator into classifying it as “real”, then backpropagation is used to update the discriminator's weights and biases to more accurately distinguish a “real” human face from a “fake” (e.g., produced by the generator) human face. Training may continue as shown in FIG. 28B until a threshold percentage of fake images have been classified as real by the discriminator.

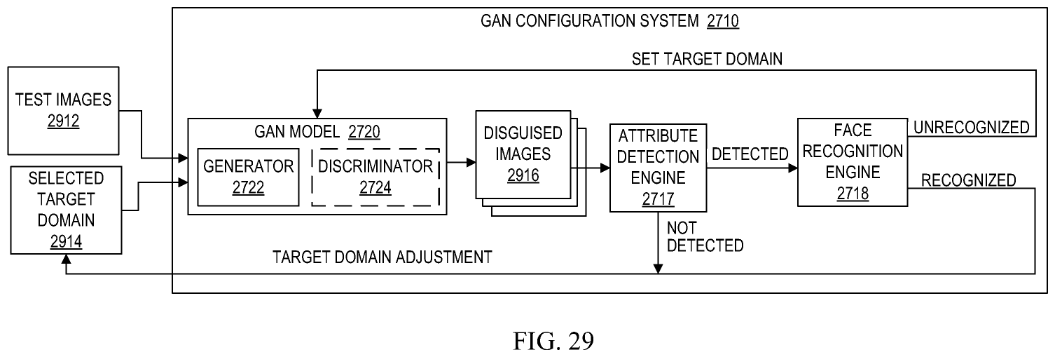

FIG. 29 illustrates additional possible component and operational details of GAN configuration system 2710 according to at least one embodiment. In GAN configuration system 2710, a target domain can be identified and used to configure GAN model 2720. A target domain indicates one or more attributes to be used by the GAN model to modify a face depicted in an input image. Certain other attributes that are not in the target domain are not modified, and therefore, are preserved in the disguised image produced by generator 2722 of the GAN model. For example, in vehicle technology, attributes that may be desirable to preserve include a gaze attribute, which can indicate the intent of the person represented by the face. A trajectory of the person can be determined based on the person's gaze and deduced intent. Another attribute that may be useful in vehicle technology is emotion. Emotion indicated by a face in a captured image can indicate whether the person represented by the face is experiencing a particular emotion at a particular time (e.g., is the passenger of a ride-sharing service pleased or not, is a driver of another vehicle showing signs of road rage, is a pedestrian afraid or agitated, etc.). Although any facial attributes may be preserved, for ease of illustration, the GAN configuration system 2710 shown in FIG. 29 will be described with reference to configuring GAN model 2720 with an optimal target domain that leaves the gaze and emotion attributes in a face unchanged, without requiring retention of other identifying features of the face.

In at least one embodiment, a target domain used for image transformation can be selected to achieve a maximum identity disguise while maintaining the gaze and/or emotion of the face. For example, an optimal target domain may indicate one or more attributes that minimizes the probability of recognizing a person while maintaining their gaze and emotional expression as in the original image or substantially like the original image. FIG. 29 illustrates one possible embodiment to determine an optimal target domain.

GAN configuration system 2710 includes GAN model 2720, an attribute detection engine 2717 (e.g., an emotion detection module and/or a gaze detection module), and a face recognition engine 2718. GAN model 2720 is pre-trained to modify a face depicted in an image to produce a new disguised image (e.g., disguised images 2916) by transferring one or more facial attributes to the face. The particular facial attributes to be transferred are based on a selected target domain 2914 provided to the generator of the GAN model. Any number of suitable GAN models may be used, including for example, StarGAN, IcGAN, DIAT, or CycleGAN.

In order to configure GAN model 2720 with an optimal target domain for anonymizing a face while simultaneously preserving desired facial attributes (e.g., gaze and intent, emotion), test images 2912 along with selected target domain 2914 can be fed into generator 2722 of GAN model 2720. For a given test image, generator 2722 can produce a disguised image (e.g., disguised images 2916), in which the attributes in the test image that correspond to the selected target domain 2914 are modified. For example, if the selected target domain includes attribute identifiers for “aged” and “gender”, then the face depicted in the disguised image is modified from the test image to appear older and of the opposite gender. Other attributes in the face such as gaze and emotion, however, remain unchanged or at least minimally changed.

In at least one embodiment, attribute detection engine 2717 may be provided to evaluate whether the desired attributes are still detectable in the disguised images 2916. For example, an emotion detector module may evaluate a disguised image to determine whether the emotion detected in the modified face depicted the disguised image is the same (or substantially the same) as the emotion detected in its corresponding real face depicted in the test image (e.g., 2912). In another example, a gaze detector module may evaluate a disguised image to determine whether the gaze detected in the modified face depicted in the disguised image is the same (or substantially the same) as the gaze detected in its corresponding real image depicted in the test image. Accordingly, in at least some embodiments, test images 2912, or labels specifying the attributes indicated in the test images (e.g., happy, angry, distracted, direction of gaze, etc.), may also be provided to attribute detection engine 2717 to make the comparison. Other desired attributes may also be evaluated to determine whether they are detectable in the disguised images. If the desired one or more attributes (e.g., emotion, gaze) are not detected, then a new target domain indicating a new attribute or a set of new attributes may be selected for input to generator 2722. If the desired one or more attributes are detected, however, then the disguised image may be fed to face recognition engine 2718 to determine whether the disguised face is recognizable.

Face recognition engine 2718 may be any suitable face recognition software that is configured or trained to recognize a select group of people (e.g., a group of celebrities). For example, Celebrity Endpoint is a face recognition engine that can detect more than ten thousand celebrities and may be used in one or more testing scenarios described herein, where the test images 2912 are images of celebrities that are recognizable by Celebrity Endpoint. In at least one scenario, prior to GAN model 2720 processing test images 2912, these test images can be processed by face recognition engine 2718 to ensure that they are recognizable by the face recognition engine. In another scenario, certain images that are recognizable by face recognition engine 2718 may be accessible to GAN configuration system 2710 for use as test images 2912.

Once a disguised image is generated (and the desired attributes are still detectable in the disguised image), the disguised image can be fed to face recognition engine 2718 to determine whether a person can be identified from the disguised image. If the face recognition engine recognizes the person from the disguised image, then the generator did not sufficiently anonymize the face. Thus, a new target domain indicating a new attribute or a set of new attributes may be selected for input to generator 2722. If the face recognition engine does not recognize the person from the disguised image, however, then the selected target domain that was used to generate the disguised image is determined to have successfully anonymized the face, while retaining desired attributes. In at least one embodiment, once a threshold number (or percentage) of images have been successfully anonymized with desired attributes being preserved, the selected target domain that successfully anonymized the image may be used to configure the GAN model 2720. In one example, the selected target domain may be set as the target domain of GAN model 2720 to use in a real-time operation of an autonomous vehicle.

It should be apparent that some of the activities in GAN configuration system 2710 may performed by user action or may be automated. For example, new target domains may be selected for input to the GAN model 2720 by a user tasked with configuring the GAN model with an optimal target domain. In other scenarios, a target domain may be automatically selected. Also, although visual comparisons may be made of the disguised images and the test images, such manual efforts can significantly reduce the efficiency and accuracy of determining whether the identity of a person depicted in an image is sufficiently disguised and whether the desired attributes are sufficiently preserved such that the disguised image will be useful in computer vision applications.

FIG. 30 shows example disguised images 3004 generated by using a StarGAN based model to modify different facial attributes of an input image 3002. The attributes used to modify input image 3002 include hair color (e.g., black hair, blond hair, brown hair) and gender (e.g., male, female). A StarGAN based model could also be used to generate images with other modified attributes such as age (e.g., looking older) and skin color (e.g., pale, brown, olive, etc.). In addition, combinations of these attributes could also be used to modify an image including H+G (e.g., hair color and gender), H+A (e.g., hair color and age), G+A (e.g., gender and age), and H+G+A (e.g., hair color, gender, and age). Other existing GAN models can offer attribute modifications such as reconstruction (e.g., change in face structure), baldness, bangs, eye glasses, heavy makeup, and a smile. One or more of these attribute transformations can be applied to test images, and the transformed (or disguised images) can be evaluated to determine the optimal target domain to be used to configure a GAN model for use in a vehicle, as previously described herein.

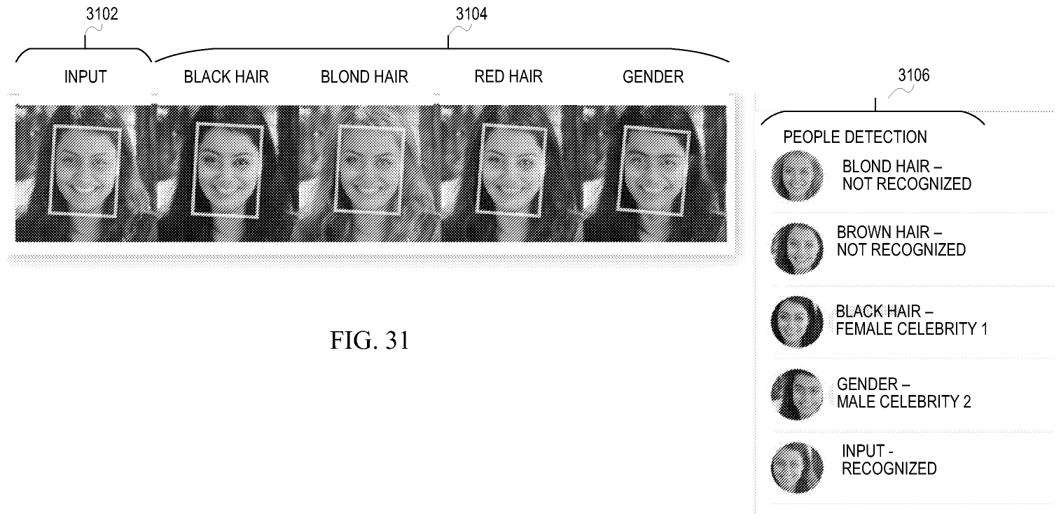

FIG. 31 shows example disguised images 3104 generated by a StarGAN based model from an input image 3102 of a real face and results of a face recognition engine (e.g., 2718) that evaluates the real and disguised images. Disguised images 3104 are generated by changing different facial attributes of input image 3102. The attributes used to modify the input image 3102 in this example include black hair, blond hair, brown hair, and gender (e.g., male). The use of the face recognition engine illustrates how the images generated from a GAN model can anonymize a face. The example face recognition engine, offered by Sightengine of Paris, France, recognizes celebrities. Accordingly, when a non-celebrity input image is processed by Sightengine, the results may indicate that the input image is not recognized or potentially may mis-identify the non-celebrity input image. Results 3106 of Sightengine, shown in FIG. 31, indicate that the person represented by input image 3102 is not a celebrity that Sightengine has been trained to recognized. However, the face recognition engine mis-identifies some of the disguised images 3104. For example, results 3106 indicate that the disguised image with black hair is recognized as female celebrity 1 and the disguised image with a gender flip is recognized as male celebrity 2. Furthermore, it is notable that when gender is changed, the face recognition engine recognizes the disguised image as depicting a person from the opposite gender, which increases protection of the real person's privacy.

In other testing scenarios, input images may include celebrities that are recognizable by the face recognition engine. These input images of celebrities may be fed through the GAN model and disguised based on selected target domains. An optimal target domain may be identified based on the face recognition engine not recognizing a threshold number of the disguised images and/or incorrectly recognizing a threshold number of the disguised images, as previously described herein.

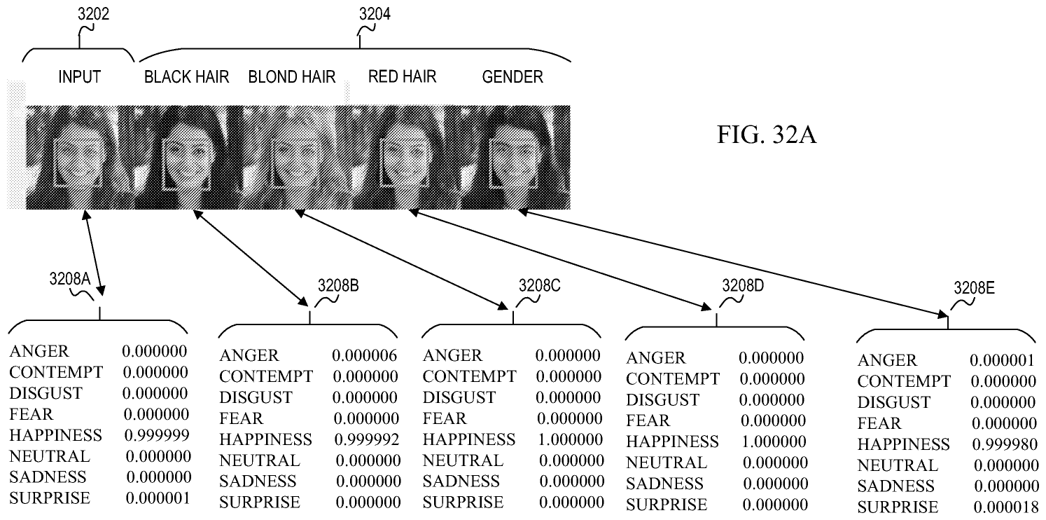

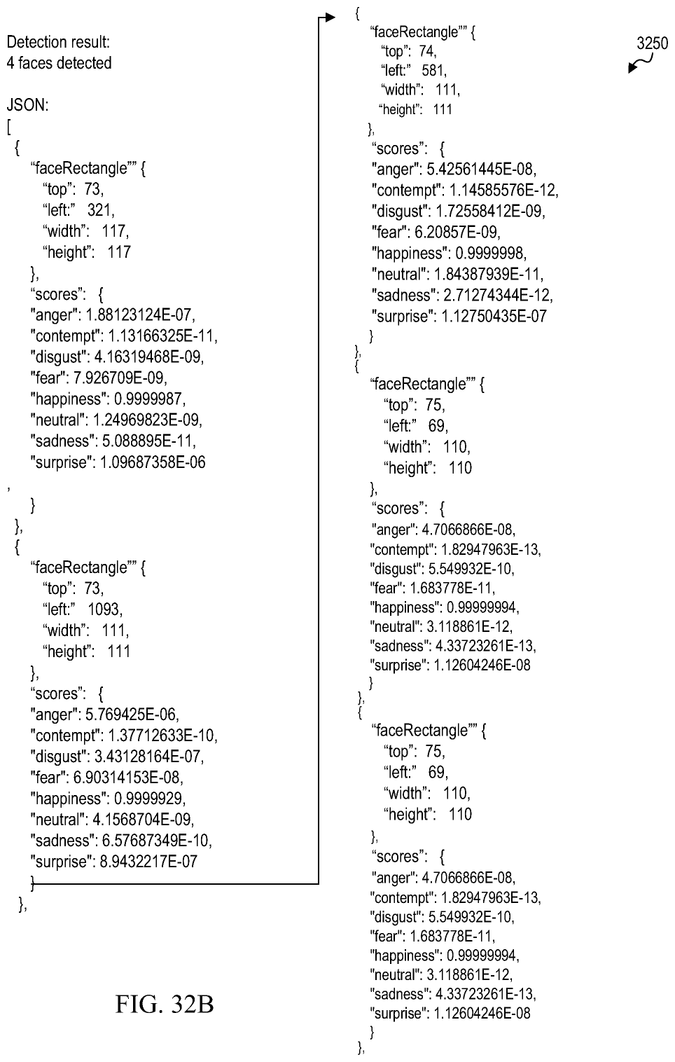

FIG. 32A shows example disguised images 3204 generated by a StarGAN based model from an input image 3202 of a real face and results of an emotion detection engine that evaluates the real and the disguised images. Disguised images 3204 are generated by changing different facial attributes of input image 3202. The attributes used to modify the input image 3202 include black hair, blond hair, brown hair, and gender (e.g., male). FIG. 32A also shows example results 3208A-3208E of an emotion detection engine, which may take a facial expression in an image as input and detect emotions in the facial expression. As shown in results 3208A-3208E, the emotions of anger, contempt, disgust, fear, neutral, sadness, and surprise are largely undetected by the emotion detection engine, with the exception of minimal detections of anger in results 3208B for the disguised image with black hair, and minimal detections of anger and surprise in results 3208E for the disguised image with a gender flip. Instead, the engine strongly detects happiness in the input image and in every disguised image. FIG. 32A shows that, despite failing to recognize a person, the GAN model's disguise approach preserved the emotion from input image 3202 in each of the disguised images 3204.

FIG. 32B a listing 3250 of input parameters and output results that correspond to the example processing of the emotion detection engine for input image 3202 and disguised images 3204 illustrated in FIG. 32A.

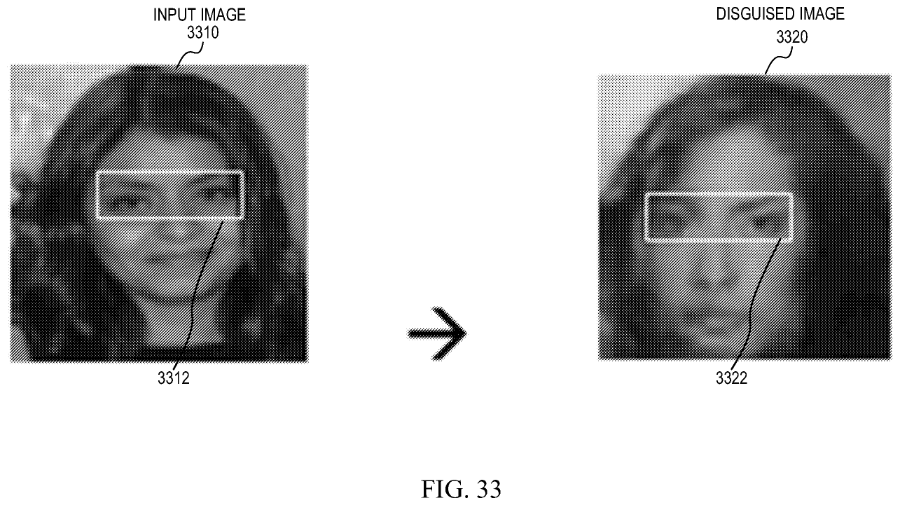

FIG. 33 shows an example transformation of an input image 3310 of a real face to a disguised image 3320 as performed by an IcGAN based model. In FIG. 33, the gaze of the person in the input image, highlighted by frame 3312, is the same or substantially the same in the disguised image, highlighted by frame 3322. Although the face may not be recognizable as the same person because certain identifying features have been are modified, other features of the face such as the gaze, are preserved. In an autonomous vehicle scenario, preserving the gaze in an image of a face enables the vehicle's on-board intelligence to predict and project the trajectory of a walking person based on their gaze, and to potentially glean other valuable information from the preserved features, without sacrificing the privacy of the individual.

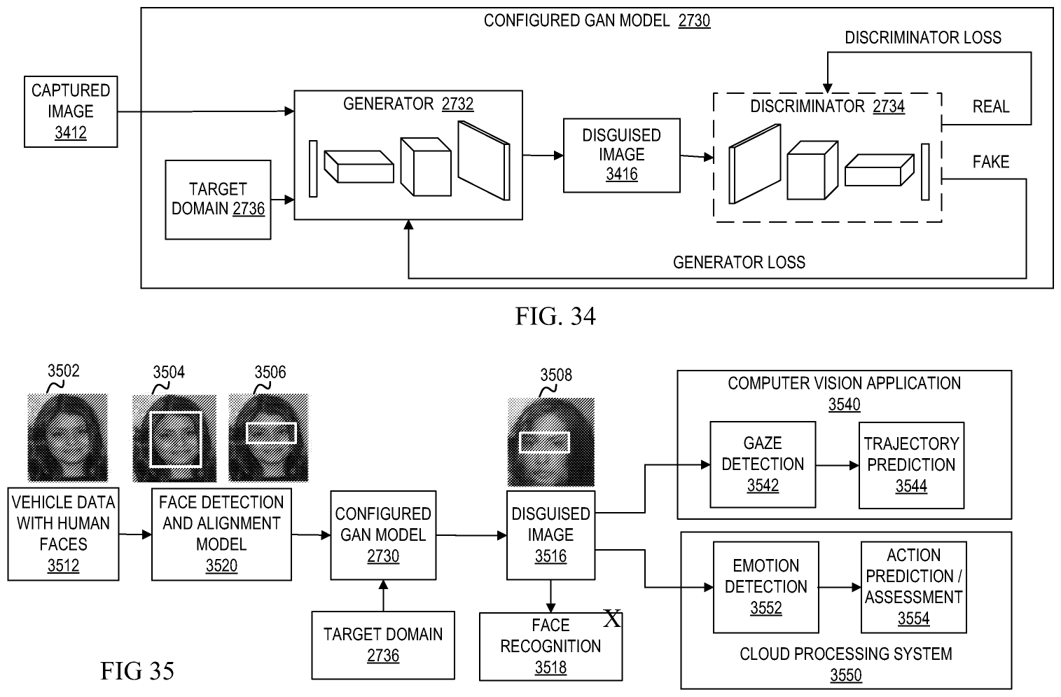

FIG. 34 illustrates additional possible operational details of a configured GAN model (e.g., 2730) implemented in a vehicle (e.g., 2750). Configured GAN model 2730 is configured with target domain 2736, which indicates one or more attributes to be applied to captured images. In at least one embodiment, target domain 2736 can include one or more attribute identifiers representing attributes such as gender, hair color, age, skin color, etc. In one example, generator 2732 can transfer attributes indicated by target domain 2736 to a face depicted in a captured image 3412. The result of this attribute transfer is a disguised image 3416 produced by the generator 2732. In one nonlimiting example, target domain 2736 includes gender and age attribute identifiers.

Captured image 3412 may be obtained by a camera or other image capturing device mounted on the vehicle. Examples of possible types of captured images include, but are not necessarily limited to, pedestrians, bikers, joggers, drivers of other vehicles, and passengers within the vehicle. Each of these types of captured images may offer relevant information for a computer vision system of the vehicle to make intelligent predictions about real-time events involving persons and other vehicles in close proximity to the vehicle.

Disguised image 3416 can be provided to any suitable systems, applications, clouds, etc. authorized to receive the data. For example, disguised image 3416 may be provided to applications (e.g., 2756) of a computer vision system (e.g., 2755) in the vehicle or in a cloud, and/or to a data collection system (e.g., 2740).

In at least some embodiments, configured GAN model 2730 may continue to be trained in real-time. In these embodiments, configured GAN model 2730 executes discriminator 2734, which receives disguised images, such as disguised image 3416, produced by the generator. Discriminator determines whether a disguised image is real or fake. If the discriminator classifies the disguised image as real, then a discriminator loss value may be backpropagated to the discriminator to learn how to better predict whether an image is real or fake. If the discriminator classifies the disguised image as fake, then a generator loss value may be backpropagated to the generator to continue to train the generator to produce disguised images that are more likely to trick the discriminator into classifying them as real. It should be apparent, however, that continuous real-time training may not be implemented in at least some embodiments. Instead, the generator 2732 of the configured GAN model 2730 may be implemented without the corresponding discriminator 2734, or with the discriminator 2734 being inactive or selectively active.

FIG. 35 illustrates an example operation of configured GAN model 2730 in vehicle 2750 to generate a disguised image 3516 and the use of the disguised image in machine learning tasks according to at least one embodiment. At 3512, vehicle data with human faces is collected by one or more image capturing devices mounted on the vehicle. To visually illustrate the operations shown in FIG. 35, an example input image 3502 depicting a real face and an example disguised image 3508 depicting a modified face is shown. These example images were previously shown and described with reference to FIG. 33. It should be noted that image 3502 is provided for illustrative purposes and that a face may be a small portion of an image typically captured by an image capturing device associated with a vehicle. In addition, in some scenarios, vehicle data with human faces 3512 may contain captured images received from image capturing devices associated with the vehicle and/or captured images received from image capturing devices separate from the vehicle (e.g., other vehicles, drones, traffic lights, etc.).

A face detection and alignment model 3520 can detect and align faces in images from the vehicle data. In at least one embodiment, a supervised learned model such as multi-task cascaded convolutional networks (MTCNN) can be used for both detection and alignment. Face alignment is a computer vision technology that involves estimating the locations of certain components of the face (e.g., eyes, nose, mouth). In FIG. 35, face detection is shown in an example image 3504, and alignment of the eyes is shown in an example image 3506.

The detected face is fed into configured GAN model 2730 along with target domain 2736. In one example, a combination of gender and age transformations to the detected face may lower the face recognition probability while maintaining the desired features of the face, such as emotion and gaze information. The generator of configured GAN model 2730 generates disguised image 3516, as illustrated in image 3508, based on the target domain 2736 and the input image from face detection and alignment model 3520.

Note that while face recognition 3518 fails in this example (e.g., the face of disguised image 3508 is not recognizable as the same person shown in the original image 3502), certain features of the face such as gaze are preserved. In an autonomous vehicle scenario, the vehicle's on-board intelligence (e.g., computer vision system 2755) can still predict and project the trajectory of a moving person (e.g., walking, running, riding a bike, driving a car, etc.) based on their gaze. Because some of the identifying features of people in image data are discarded (e.g., by being transformed or modified) at the time that the image is processed, attempts by malicious or prying actors (e.g., hackers or surveillance entities), to recover the identities of people in the data will fail, without compromising the ability of computer vision applications to obtain valuable information from the disguised images.

The disguised image can be provided to any systems, applications, or clouds based on particular implementations and needs. In this example, disguised image 3516 is provided to a computer vision application 3540 on the vehicle to help predict the actions of the person represented by the face. For example, gaze detection 3542 may determine where a person (e.g., pedestrian, another driver, etc.) is looking and trajectory prediction 3544 may predict a trajectory or path the person is likely to take. For example, if a pedestrian is looking at their phone or shows other signs of being distracted, and if the predicted trajectory indicates the person is likely to enter the path of the vehicle, then the appropriate commands may be issued to take one or more actions such as alerting the driver, honking the horn, reducing speed, stopping, or any other appropriate action or combination of actions.

In another example, disguised image 3516 can be used to determine the emotions of the person represented by the face. This may be useful, for example, for a service provider, such as a transportation service provider, to determine whether its passenger is satisfied or dissatisfied with the service. In at least some scenarios, such evaluations may be done remote from the vehicle for example, by a cloud processing system 3550 of the service provider. Thus, photos of individuals (e.g., passengers in a taxi) captured by image capturing devices on the vehicle may be shared with other systems, applications, devices, etc. For example, emotion detection 3552 may detect a particular emotion of a person depicted in the disguised image. Action prediction/assessment 3554 may predict a particular action a person depicted in the disguised image is likely to take. For example, extreme anger or distress may be used to send an alert to the driver. Embodiments herein protect user privacy by disguising the face to prevent face recognition while preserving certain attributes that enable successful gaze and emotion detection.

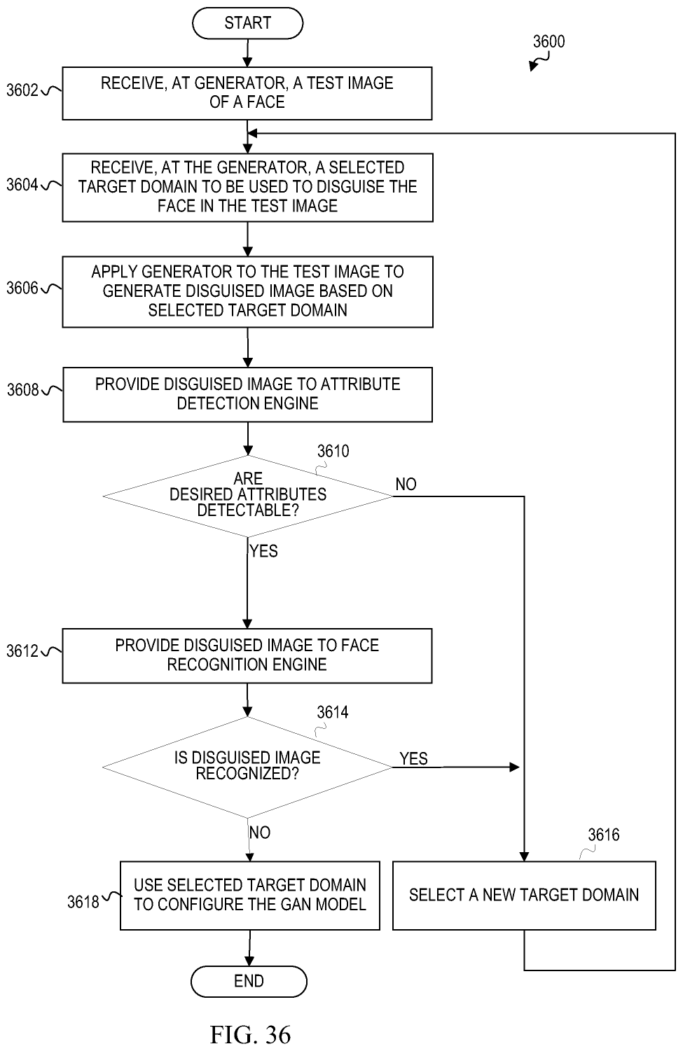

Turning to FIG. 36, FIG. 36 is a simplified flowchart that illustrates a high level of a possible flow 3600 of operations associated with configuring a Generative Adversarial Network (GAN) that is trained to perform attribute transfers on images of faces. In at least one embodiment, a set of operations corresponds to activities of FIG. 36. GAN configuration system 2710 may utilize at least a portion of the set of operations. GAN configuration system 2710 may include one or more data processors 2737, for performing the operations. In at least one embodiment, generator 2722 of GAN model 2720, attribute detection engine 2717, and face recognition engine 2718 may each perform one or more of the operations. In some embodiments, at least some of the operations of flow 3600 may be performed with user interaction. For example, in some scenarios, a user may select attributes for a new target domain to be tested. In other embodiments, attributes for a new target domain may be automatically selected at random or based on an algorithm, for example.

At 3602, the generator of the GAN model receives a test image of a face. In at least one embodiment, test images processed in flow 3600 may be evaluated a priori by face recognition engine 2718 to ensure that they are recognizable by the engine. At 3604, the generator obtains a target domain indicating one or more attributes to be used to disguise the face in the test image.

At 3606, the generator is applied to the test image to generate a disguised image based on the selected target domain (e.g., gender, age, hair color, etc.). The disguised image depicts the face from the test image as modified based on the one or more attributes.

At 3608, the disguised image is provided to an attribute detection engine to determine whether desired attributes are detectable in the disguised image. For example, a gaze attribute may be desirable to retain so that a computer vision system application can detect the gaze and predict the intent and/or trajectory of the person associated with the gaze. In another example, emotion may be a desirable attribute to retain so that a third party can assess the emotion of a person who is a customer and determine what type of experience the customer is having (e.g., satisfied, annoyed, etc.). Any other desirable attributes may be evaluated based on particular implementations and needs, and/or the types of machine learning systems that consume the disguised images.

At 3610, a determination is made as to whether the desirable attributes are detectable. If one or more of the desirable attributes are not detectable, then at 3616, a new target domain may be selected for testing. The new target domain may indicate a single attribute or a combination of attributes and may be manually selected by a user or automatically selected. Flow passes back to 3604, where the newly selected target domain is received at the generator and another test is performed using the newly selected target domain.

If at 3610, it is determined that the desired attributes are detectable in the disguised image, then at 3612, the disguised image is provided to face recognition engine to determine whether the disguised image is recognizable. At 3614, a determination is made as to whether the disguised image is recognized by the face detection engine. If the disguised image is recognized, then at 3616, a new target domain may be selected for testing. The new target domain may indicate a single attribute or a combination of attributes and may be manually selected by a user or automatically selected. Flow passes back to 3604, where the newly selected target domain is received at the generator and another test is performed using the newly selected target domain.

At 3614, if it is determined that the disguised image is not recognized by the face detection engine, then at 3618, the GAN model may be configured by setting its target domain as the target domain that was used by the generator to produce the disguised image. In at least one embodiment, the selected target domain used by the generator may not be used to configure the generator until a certain threshold number of disguised images, which were disguised based on the same selected target domain, have not been recognized by the face detection engine.

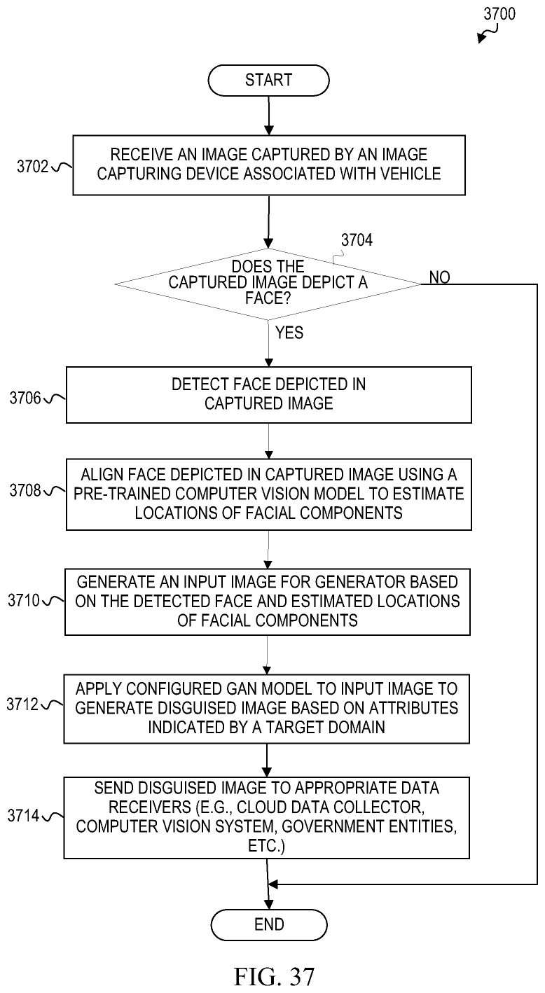

FIG. 37 is a simplified flowchart that illustrates a high level of a possible flow 3700 of operations associated with operations of a privacy-preserving computer vision system (e.g., 2755) of a vehicle (e.g., 2750) when a configured GAN model (e.g., 2730) is implemented in the system. In at least one embodiment, a set of operations corresponds to activities of FIG. 37. Configured GAN model 2730 and face detection and alignment model 3520 may each utilize at least a portion of the set of operations. Configured GAN model 2730 and face detection and alignment model 3520 may include one more data processors 2757, for performing the operations.

At 3702, a privacy-preserving computer vision system receives an image captured by an image capturing device associated with a vehicle. In other scenarios, the computer vision system may receive an image from another device in close proximity to the vehicle. For example, the image could be obtained by another vehicle passing the vehicle receiving the image.

At 3704, a determination is made as to whether the captured image depicts a face. If a determination is made that the captured image does not depict a face, then flow 3700 may end and the configured GAN model does not process the captured image.

If a determination is made at 3704 that the captured image does depict a face, then at 3706, the face is detected in the captured image. For example, a set of pixels corresponding to the face may be detected in the captured image. At 3708 the detected face is aligned to estimate locations of facial components (e.g., corners of eyes, corners of mouth, corners of nose, etc.). At 3710, an input image for the generator may be generated based on the detected face and the estimated locations of facial components. In at least one example, a supervised learned model such as multi-task cascaded convolutional networks (MTCNN) can be used for both detection and alignment.

At 3712, the generator of the configured GAN model is applied to the input image to generate a disguised image based on a target domain set in the generator. Attributes indicated by the target domain may include age and/or gender in at least one embodiment. In other embodiments, other combinations of attributes (e.g., hair color, eye color, skin color, makeup, etc.) or a single attribute may be indicated by the target domain if such attribute(s) result in a disguised image that is not recognizable but retains the desired attributes.

At 3714, the disguised image is sent to appropriate data receivers including, but not necessarily limited to, one or more of a cloud data collection system, applications in the computer vision system, and government entities (e.g., regulatory entities such as a state department of transportation, etc.).

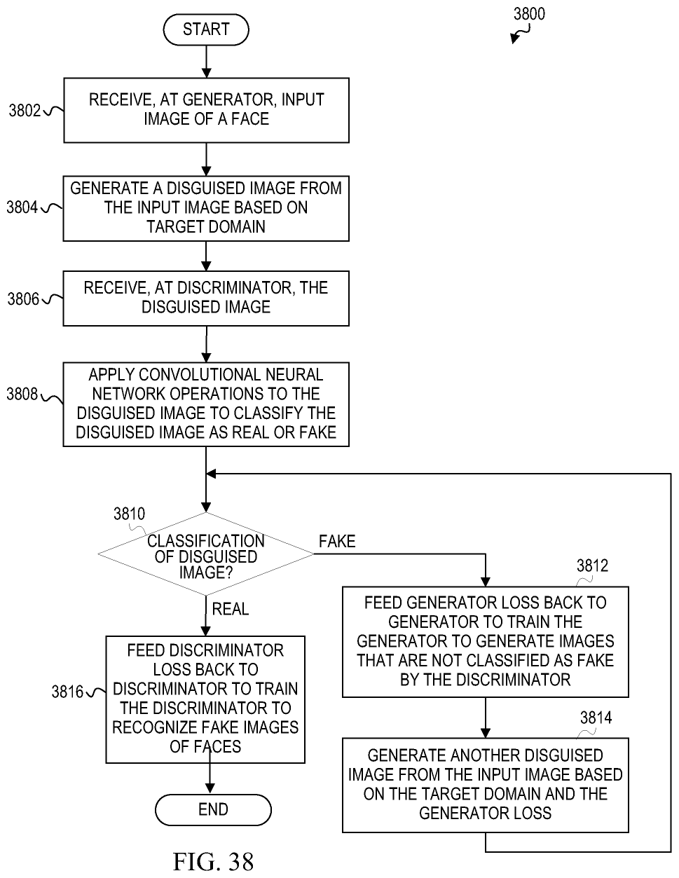

FIG. 38 is a simplified flowchart that illustrates a high level of a possible flow 3800 of operations associated with operations that may occur when a configured GAN model (e.g., 2730) is applied to an input image. In at least one embodiment, a set of operations corresponds to activities of FIG. 38. Configured GAN model 2730, including generator 2732 and discriminator 2734 may each utilize at least a portion of the set of operations. Configured GAN model 2730 may include one or more data processors 2757, for performing the operations. In at least one embodiment, the operations of flow 3800 may correspond to the operation indicated at 3712.

At 3802, the generator of a configured GAN model in a vehicle receives an input image. An input image may be generated, for example, by detecting and aligning a face depicted in an image captured by a vehicle. At 3804, the generator generates a disguised image from the input image based on the generator's preconfigured target domain (e.g., gender and age).

At 3806, a discriminator of the configured GAN model receives the disguised image from the generator. At 3808, the discriminator performs convolutional neural network operations on the disguised image to classify the disguised image as real or fake.

At 3810, a determination is made as to the classification of the disguised image. If the discriminator classifies the disguised image as fake, then at 3812, a generator loss is propagated back to the generator to continue training the generator to generate disguised images that are classified as “real” by the discriminator (e.g., disguised images that trick the discriminator). At 3814, the generator can generate another disguised image from the input image based on the target domain and the generator loss. Flow may then pass to 3810 to determine how the discriminator classified the new disguised image.

If the discriminator classifies a disguised image as real at 3810, then at 3816, a discriminator loss may be propagated back to the discriminator to continue training the discriminator to more accurately recognize fake images.

Flow 3800 illustrates an example flow in which the configured GAN model continues training its generator and discriminator in real-time when implemented in a vehicle. In some scenarios, the training may be paused during selected periods of time until additional training is desired, for example, to update the configured GAN model. In these scenarios, during at least some periods of time, only the generator may perform neural network operations when a captured image is processed. The discriminator may not execute until additional training is initiated.

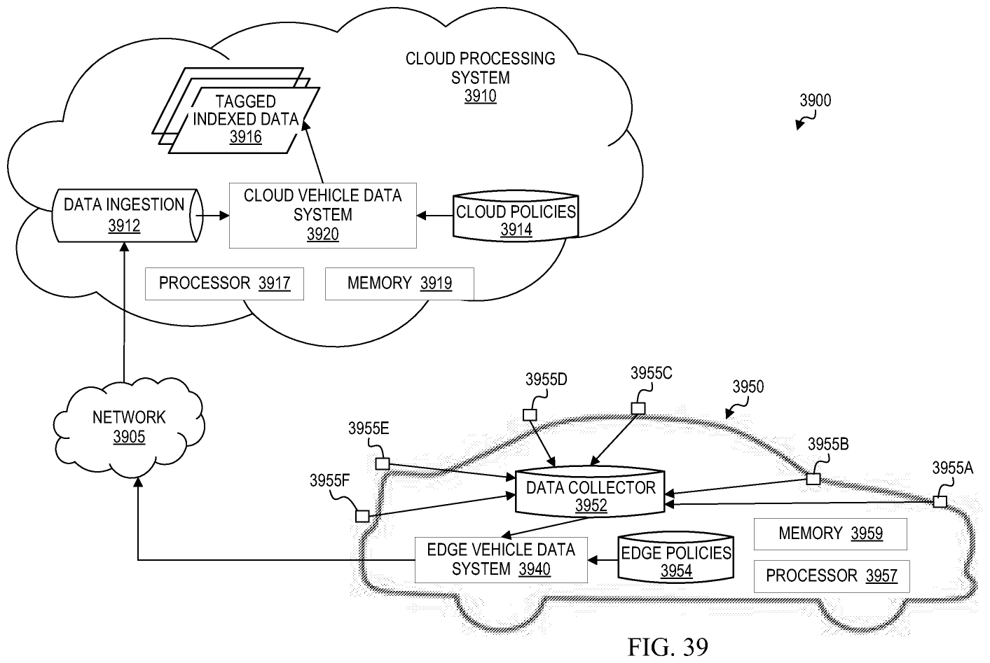

Additional (or alternative) functionality may be provided in some implementations to provide privacy protection associated with image data collected in connection with autonomous driving systems. For instance, an on-demand privacy compliance system may be provided for autonomous vehicles. In an embodiment, descriptive tags are used in conjunction with a “lazy” on-demand approach to delay the application of privacy measures to collected vehicle data until the privacy measures are needed. Descriptive tags are used to specify different attributes of the data. As used with reference to FIGS. 39 through 49, the term “attribute” is intended to mean a feature, characteristic, or trait of data. Attributes can be used to subjectively define privacy provisions for compliance with privacy regulations and requirements. Tags applied to datasets from a particular vehicle are evaluated in a cloud or in the vehicle to determine whether a “lazy” policy is to be applied to the dataset. If a lazy policy is applied, then processing to privatize or anonymize certain aspects of the dataset is delayed until the dataset is to be used in a manner that could potentially compromise privacy.

New technologies such as autonomous vehicles are characterized by (i) collections of huge amounts of sensor data, and (ii) strict laws and regulations that are in-place, in-the-making, and frequently changing that regulate the use and handling of the collected data. In some edge devices, such as L4/L5 autonomous vehicles, camera and video data may be generated at a rate of 5 TB/hour. This data may contain personal identifying information that may raise privacy and safety concerns, and that may be subject to various governmental regulations. This personal identifying information may include, but is not necessarily limited to, images of people including children, addresses or images of private properties, exact coordinates of a location of a vehicle, and/or images of vehicle license plates. In some geographies (e.g., European Union), personal identifying information is legally protected and stiff financial penalties may be levied to any entity in possession of that protected information.

In a traditional data center, data management techniques are typically implemented over an entire dataset, usually just once, using one compliance policy that can become abruptly obsolete as a result of new or modified government legislation. Further, the amount of data generated by some edge devices (e.g., 5 TB/hour) renders the application of efficient compliance policies not scalable.

Generally, current compliance policies, such as data privacy, are applied by processing all data files to ensure compliance. These policies typically employ a set of predefined search criterion to detect potential privacy violations. This approach is inefficient for data-rich environments such as autonomous vehicles and are not scalable. Currently, an autonomous vehicle can collect as much as 5 TB/hour of data across its array of sensors. When combined with other mobile edge devices, the rate at which sensor data is being generated can potentially flood standard processing channels as well as additional data management analytics that enforce compliance.

Additionally, current compliance solutions are rigid, one-time implementations that cannot adapt quickly to the continuous change and evolution of privacy regulations, as well as the disperse nature of these regulations with respect to locale, context, and industry. For example, an autonomous ambulance in the United States may collect data that is subject to both department of transportation regulations as well as the Health Insurance Portability and Accountability Act (HIPAA). Moreover, privacy regulations may be different by state and by country. An autonomous vehicle crossing state lines or country borders needs to adjust its processing, in real time, to comply with regulations in the new locale. A rigid one-time implementation can potentially create compliance liability exposure in these scenarios and others.

Modern data compliance techniques can also hinder application development and cause deployment problems. Typically, these techniques either silo data or delete unprocessed data altogether. Such actions can be a significant encumbrance to a company's capability development pipeline that is based on data processing.

An on-demand privacy compliance system 3900 for autonomous vehicles, as shown in FIG. 39, resolves many of the aforementioned issues (and more). Embodiments herein enrich data that is captured or otherwise obtained by a vehicle by attaching descriptive tags to the data. Tags specify different attributes that can be used to subjectively define the privacy provisions needed for compliance. In at least one embodiment, tags are flat and easy to assign and understand by humans. They can be used to describe different aspects of the data including for example location, quality, time-of-day, and/or usage. At least some embodiments described herein also include automatic tag assignment using machine learning based on the actual content of the data, such as objects in a picture, current location, and/or time-of-day.

Embodiments also apply a ‘lazy’ on-demand approach for addressing privacy compliance. In a lazy on-demand approach, processing data to apply privacy policies is deferred as much as possible until the data is actually used in a situation that may compromise privacy. Data collected in autonomous vehicles is often used for machine learning (ML). Machine learning typically applies sampling on data to generate training and testing datasets. Given the large quantity of data that is collected by just a single autonomous vehicle, processing these sample datasets to apply privacy policies on-demand ensures better use of computing resources. Moreover, based on tags, data can be selected for indexing and/or storage, which also optimizes resource usage.

On-demand privacy compliance system 3900 offers several advantages. The system comprises a compute-efficient and contextually-driven compliance policy engine that can be executed either within the vehicle (the mobile edge device) or in a datacenter/cloud infrastructure. The utility of vehicle data collection is enriched using tags that, unlike structured metadata, are flat and easy to assign and understand by humans, both technical and non-technical. The use of tags in embodiments herein ensures that the correct privacy compliance processes are executed on the correct datasets without the need to examine every frame or file in a dataset. Accordingly, significant data center resources can be saved. These tags ensure that the vehicle data is free from regulatory privacy violations. Thus, entities (e.g., corporations, service providers, vehicle manufacturers, etc.) that use, store, or process vehicle data remain compliant to relevant compliance and regulatory statutes. This can prevent such entities from being subjected to significant fines. Furthermore, as regulations change, embodiments herein can accommodate those changes without requiring significant code changes or re-implementation of the system. Regulations may change, for example, when regulatory bodies add or update privacy regulations, when a vehicle leaves an area subject to one regulatory body and enters an area subject to another regulatory body (e.g., driving across state lines, driving across country borders, etc.). Also, by addressing regulatory compliance, embodiments described herein can increase the trust of the data collected by vehicles (and other edge devices) and its management lifecycle. In addition to data privacy assurances, embodiments enable traceability for auditing and reporting purposes. Moreover, the modular extensible framework described herein can encompass new, innovative processes.

Turning to FIG. 39, on-demand privacy compliance system 3900 includes a cloud processing system 3910, a vehicle 3950, and a network 3905 that facilitates communication between vehicle 3950 and cloud processing system 3910. Cloud processing system 3910 includes a cloud vehicle data system 3920, a data ingestion component 3912 for receiving vehicle data, cloud policies 3914, and tagged indexed data 3916. Vehicle 3950 includes an edge vehicle data system 3940, edge policies 3954, a data collector 3952, and numerous sensors 3955A-3955F. Elements of FIG. 39 also contain appropriate hardware components including, but not necessarily limited to processors (e.g., 3917, 3957) and memory (e.g., 3919, 3959), which may be realized in numerous different embodiments.

In vehicle 3950, data collector 3952 may receive near-continuous data feeds from sensors 3955A-3955F. Sensors may include any type of sensor described herein, including image capturing devices for capturing still images (e.g., pictures) and moving images (e.g., video). Collected data may be stored at least temporarily in data collector 3952 and provided to edge vehicle data system 3940 to apply tags and edge policies 3954 to datasets formed from the collected data. A tag can be any user-generated word that helps organize web content, label it in an easy human-understandable way, and index it for searching. Edge policies 3954 may be applied to a dataset based on the tags. A policy associates one or more tags associated with a dataset to one or more processes. Processes are defined as first-class entities in the system design that perform some sort of modification to the dataset to prevent access to any personally identifying information.

In at least some scenarios, datasets of vehicle data collected by the vehicle are provided to cloud vehicle data system 3920 in cloud processing system 3910, to apply cloud policies 3914 to the datasets based on their tags. In this scenario, data collected from the vehicle may be formed into datasets, tagged, and provided to data ingestion component 3912, which then provides the datasets to cloud vehicle data system 3920 for cloud policies 3914 to be applied to the datasets based on their tags. In at least one embodiment, cloud policies 3914 applied to datasets from a particular vehicle (e.g., 3950) may be the same policies that would be applied to the datasets by edge vehicle data system 3940 if the datasets stayed with the vehicle. In at least some scenarios, cloud vehicle data system 3920 may also apply tags to the data (or additional tags to supplement tags already applied by edge vehicle data system 3940). In at least some embodiments, tagging may be performed wherever it can be most efficiently accomplished. For example, although techniques exist to enable geographic (geo) tagging in the cloud, it is often performed by a vehicle because image capturing devices may contain global positioning systems and provide real-time information related to the location of subjects.

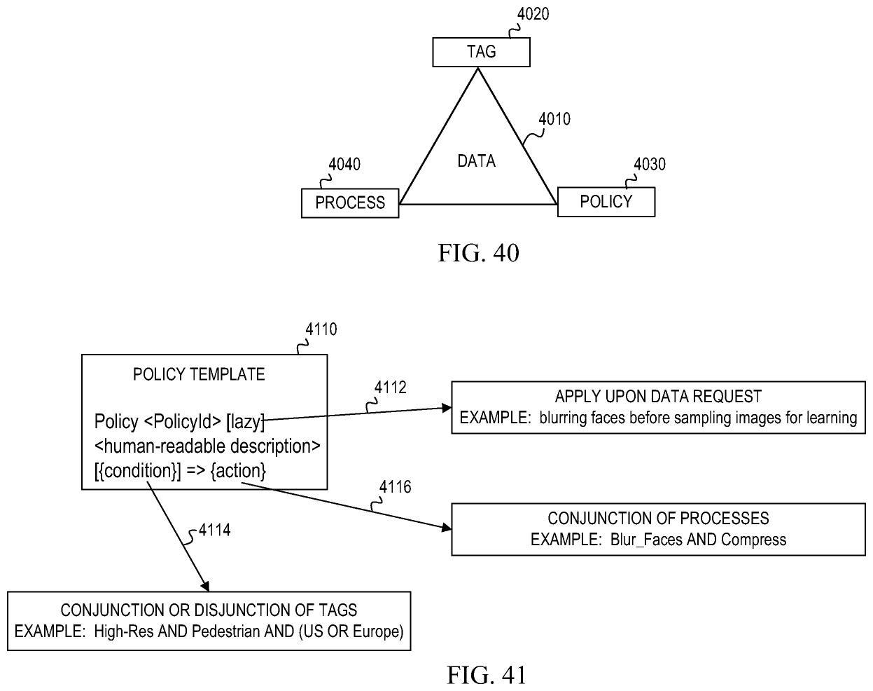

Turning to FIG. 40, FIG. 40 illustrates a representation of data 4010 collected by a vehicle and objects defined to ensure privacy compliance for the data. Objects include one or more tags 4020, one or more policies 4030, and one or more processes 4040. In at least one embodiment, data 4010 may be a dataset that includes one or more files, images, video frames, records, or any object that contains information in an electronic format. Generally, a dataset is a collection of related sets of information formed from separate elements (e.g., files, images, video frames, etc.).

A tag, such as tag 4020, may be a characterization metadata for data. A tag can specify a data format (e.g., video, etc.), quality (e.g., low-resolution, etc.), locale (e.g., U.S.A, European Union, etc.), area (e.g., highway, rural, suburban, city, etc.), traffic load (e.g., light, medium, heavy, etc.), presence of humans (e.g., pedestrian, bikers, drivers, etc.) and any other information relevant to the data. A tag can be any user-generated word that helps organize web content, label it in an easy human-understandable way, and index it for searching. In some embodiments, one or more tags may be assigned manually. At least some tags can be assigned automatically using machine learning. For example, a neural network may be trained to identify various characteristics of the collected data and to classify each dataset accordingly. For example, a convolutional neural network (CNN) or a support vector machine (SVM) algorithm can be used to identify pictures or video frames in a dataset that were taken on a highway versus a suburban neighborhood. The latter has higher probability of containing pictures of pedestrians and private properties and would potentially be subject to privacy regulations. The dataset may be classified as ‘suburban’ and an appropriate tag may be attached to or otherwise associated with the dataset.

A process, such as process 4040, may be an actuation action that is defined as a REST Application Programming Interface (API) that takes as input a dataset and applies some processing to the dataset that results in a new dataset. Examples of processes include, but are not necessarily limited to, applying a data anonymization script to personally identifying information (e.g., GPS location, etc.), blurring personally identifying information or images (e.g., faces, license plates, private or sensitive property addresses, etc.), pixelating sensitive data, and redacting sensitive data.

Processes are defined as first-class entities in the system design. In at least one embodiment, processes may be typical anonymization, alteration, rectification, compression, storage, etc. This enables a modular pipeline design to be used in which processes are easily pluggable, replaceable and traceable. Accordingly, changes to data can be tracked and compliance requirements can be audited. In addition, this modular pipeline design facilitates the introduction of new privacy processes as new regulations are enacted or existing regulations are updated.

A policy, such as policy 4030, associates one or more tags to one or more processes. For example, a dataset that is tagged with ‘suburban’ as previously described could be subject to a policy that associates the ‘suburban’ tag with a privacy process to anonymize (e.g., blur, redact, pixelate, etc.) faces of people and private property information. The tag in that case enables the right processes to be matched to the right dataset based on the nature of that dataset and the potential privacy implications that it contains.

FIG. 41 shows an example policy template 4110 for on-demand privacy compliance system 3900 according to at least one embodiment. Policy template 4110 includes a ‘lazy’ attribute 4112, which defines the policy to be an on-demand policy, the application of which is deferred and subsequently applied upon request. More specifically, the policy is not applied until the dataset is to be used in a situation that could potentially compromise privacy. Upon a determination that the policy is designated as a lazy policy, the dataset is marked for later processing. For example, before a marked dataset (e.g., of images) is sampled for machine learning, the policy may be applied to blur faces in images in the dataset.

Policy template 4110 also includes a condition 4114, which is indicated by the conjunction or disjunction of tags. Thus, one or more tags may be used in condition 4114 with desired conjunctions and/or disjunctions. Examples of tags may include, but are not necessarily limited to, pedestrian, night, day, highway, rural, suburban, city, USA, EU, Asia, low-resolution, high-resolution, geographic (geo) location, and date and time.

Policy template 4110 further includes an action 4116, which indicates a single process or the conjunction of processes that are to be performed on a dataset if the condition is satisfied from the tags on the dataset. As shown in FIG. 41, an example condition could be: High-Res AND Pedestrian AND (US OR Europe), and an example conjunction of processes is to blur faces and compress the data. Thus, this example policy is applicable to dataset that contains, according to its tags, high-resolution data and pedestrians and that is collected in either the US or Europe. If the dataset satisfies this combination of tags, then one or more processes are applied to blur the faces of pedestrians in the images and to compress the data.

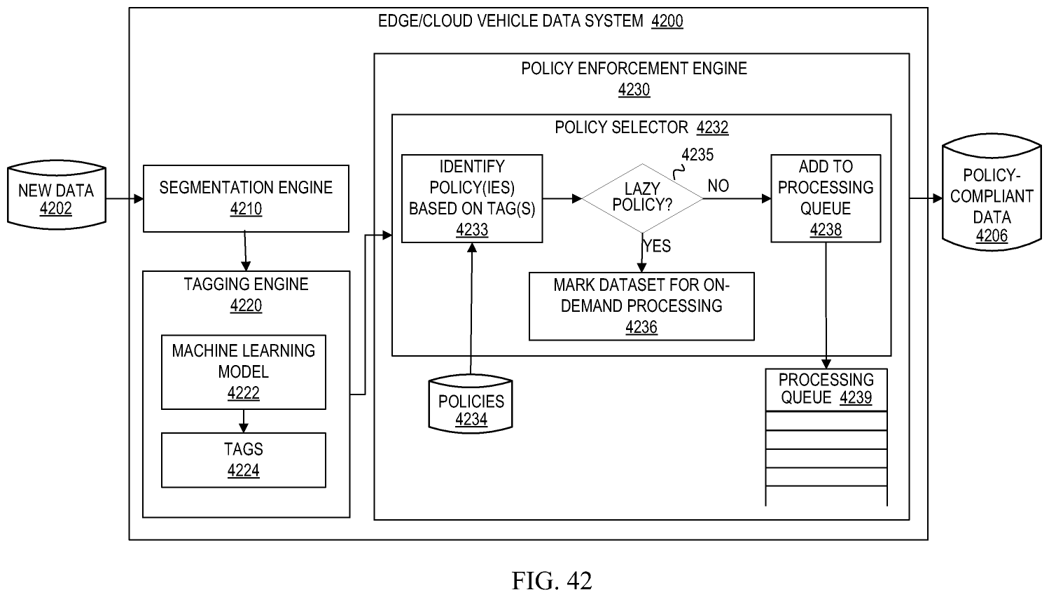

FIG. 42 is a simplified block diagram illustrating possible components and a general flow of operations of a vehicle data system 4200. Vehicle data system 4200 can be representative of a cloud vehicle data system (e.g., 3920) and/or an edge vehicle data system (e.g., 3940). Vehicle data system 4200 includes a segmentation engine 4210, a tagging engine 4220, and a policy enforcement engine 4230. Vehicle data system 4200 ensures privacy compliance for data collected from sensors (e.g., 3955A-3955F) attached to an autonomous vehicle (e.g., 3950) by tagging datasets from the vehicle and applying policies to the datasets based on the tags attached to the datasets.

Segmentation engine 4210 can receive new data 4202, which is data collected by a data collector (e.g., 3952) of a vehicle (e.g., 3950). Segmentation engine 4210 can perform a segmentation process on new data 4202 to form datasets from the new data. For example, the new data may be segmented into datasets that each contain a collection of related sets of information. For example, a dataset may contain data associated with a particular day, geographic location, etc. Also, segmentation may be specific to an application. In at least one embodiment, tags can be applied per dataset.

Tagging engine 4220 may include a machine learning model 4222 that outputs tags 4224 for datasets. Machine learning model 4222 can be trained to identify appropriate tags based on given data input. For example, given images or video frames of a highway, a suburban street, a city street, or a rural road, model 4222 can identify appropriate tags such as ‘highway’, ‘suburban’, ‘city’, or ‘rural’. Examples of suitable machine learning techniques that may be used include, but are not necessarily limited to, a convolutional neural network (CNN) or a support vector machine (SVM) algorithm. In some examples, a single machine learning model 4222 may generate one or more tags for each dataset. In other embodiments, one or more machine learning models may be used in the tagging engine to identify various tags that may be applicable to a dataset.

Policy enforcement engine 4230 may include a policy selector 4232, policies 4234, and a processing queue 4239. Policy selector 4232 can receive tagged datasets from tagging engine 4220. Policies 4234 represent edge policies (e.g., 3954) if vehicle data system 4200 is implemented in an edge device (e.g., vehicle 3950), or cloud policies (e.g., 3913) if vehicle data system 4200 is implemented in a cloud processing system (e.g., 3910). Policy selector 4232 detects the one or more tags on a dataset, and at 4233, identifies one or more policies based on the detected tags. A policy defines which process is applicable in which case. For example, a policy can say, for all images tagged as USA, blur the license plates.

As shown at 4235, policy selector 4232 determines whether the identified one or more policies are designated as lazy policies. If a policy that is identified for a dataset based on the tags of the dataset is designated as lazy, then the dataset is marked for on-demand processing, as shown at 4236. Accordingly, the lazy policy is not immediately applied to the dataset. Rather, the dataset is stored with the policy until the dataset is queried, read, copied, or accessed in any other way that could compromise the privacy of contents of the dataset. For example, if an identified policy indicates a process to blur faces in images and is designated as a lazy policy, then any images in the dataset are not processed immediately to blur faces, but rather, the dataset is marked for on-demand processing and stored. When the dataset is subsequently accessed, the dataset may be added to processing queue 4239 to apply the identified policy to blur faces in the images of the dataset. Once the policy is applied, an access request for the dataset can be satisfied.

If a policy that is identified for a dataset based on the tags of the dataset is not designated as lazy, then the dataset is added to a processing queue 4239 as indicated at 4238. The identified policy is then applied to the dataset. For example, if an identified policy for a dataset indicates a process to encrypt data in a file and is not designated as a lazy policy, then the dataset is added to processing queue 4239 to encrypt the dataset. If there are no policies associated with the dataset and designated as lazy, then once all of the policies have been applied to the dataset (e.g., encrypted), the policy is added to policy-compliant data 4206 where it can be accessed without further privacy policy processing.

Some of the capabilities of vehicle data system 4200 can be implemented in an edge device (e.g., vehicle 3950) to optimize data flow. For example, privacy filters can be applied at the edge to prevent sensitive data from being saved on a cloud (e.g., 3910) and hence ensuring compliance with data minimization rules, as enforced by recent regulations such as the European Union General Data Protection Regulation (GDPR). For example, a privacy policy can be defined to anonymize location data by replacing GPS coordinates with less precise location data such as the city. This policy can be defined as a non-lazy policy to be applied on all location data in the vehicle (edge) to prevent precise locations from being sent to the cloud.

In at least one embodiment, contextual policies may be used to affect in-vehicle processing based on real-time events or other information that adds additional context to tagged datasets. By way of illustration, but not of limitation, two examples will now be described. In a first example, many countries employ a system in which an alert (e.g., AMBER alert in the U.S.) is triggered when a child is endangered. This child-safety contextual policy can be communicated to a micro-targeted geographic region, such as a dynamic search radius around the incident, to vehicles whose owners have opted into that AMBER-alert-type system. For data tagged with ‘highway’, under an AMBER-alert-type condition, lazy policy is set to ‘No’, and the data is sent to the vehicle machine learning engine for real-time processing of license plates with optical character recognition (OCR), vehicle color if it is given, and vehicle description if it is given. In this scenario, to maintain privacy of the ‘crowd vehicles’, only GPS information obtained within ‘begin hits and end hits’ is sent to the law enforcement who can triangulate the pings or hits from the ‘crowd of vehicles’ around the actor-vehicle subject of the AMBER alert.

In a second nonlimiting example of applying contextual policies, micro-targeted geographic regions may be selected for contextual policies. For example, in some cities, large homeless populations tend to cluster around public parks and in the side or underside or highway ramp structures, which creates unique micro-targeted geographic regions. For these localized micro-regions, a contextual policy or function could be ‘likelihood of humans is high’. Even though a dataset may be tagged as ‘highway’ or ‘expressway ramp’, and the relevant policy for these tags may be designated as a lazy policy, a contextual policy could override lazy processing and direct the data to the in-vehicle vehicle data system (e.g., 4200) for processing for humans/pedestrians. While the humans/pedestrians may not be detected as being on the road itself, clusters of humans around highways may have higher instances of individuals darting across the road with very little warning. The identification of humans/pedestrians could signal the decision processing engine in the vehicle to actuate a slower-speed, to give the vehicle time to react, than would otherwise be warranted.

Vehicle data system 4200 may be used in both research and design systems, where large amounts of data are collected from vehicles to build machine learning models, and in operational systems where data is collected from vehicles to continuously update high definition maps, track traffic gridlocks, or re-train models when new use cases emerge. In a research and design system, machine learning model 4214 may be continuously trained with test data to learn how to classify datasets with appropriate tags. The test data may include real data from test vehicles.

Tagging, policy, and processing in vehicle data system 4200, are used to create a highly efficient enforcement workflow that is easily integrated into the compute resource utilization framework of the vehicle. In vehicles with over 150 Electronic Control Units, 1-2 ADAS/AV Engines, and a central-server controller, it is possible to route processing to different compute units based on compute availability and policy.

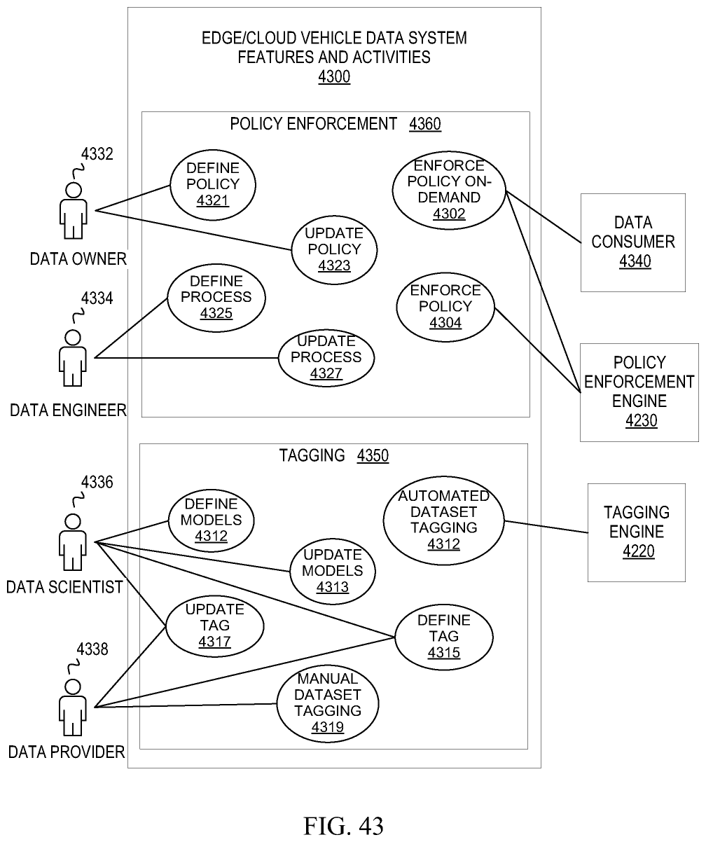

Turning to FIG. 43, FIG. 43 illustrates features and activities 4300 of an edge or cloud vehicle data system 4200, from a perspective of various possible human actors and hardware and/or software actors. In at least one example, tagging 4350 refers to applying appropriate tags (e.g., pedestrian, highway, rural, suburban, city, GPS location, etc.) to datasets. In at least one embodiment, automated dataset tagging 4212 can be performed by tagging engine 4220. As previously described, a machine learning model of tagging engine 4220 (e.g., CNN, SVM) can be trained to recognize images and other information in data collected from vehicles and to output tags that apply to the input data. Manual tagging may also (or alternatively) be used in a vehicle data system. For example, a data provider 4338 may define tags 4315, update tags 4317, and perform manual dataset tagging 4319.

A data scientist 4336 may define tags 4315 and update tags 4317, and in addition, may define models 4312 and update models 4313. Machine learning models, like CNN or SVM, may be trained to distinguish between contents of datasets to select appropriate tags. For example, a model may be trained to distinguish between images from highways and rural roads and images from suburban roads and city streets. Images from suburban roads and city streets are likely to have more pedestrians where privacy policies to blur faces, for example, should be applied. Accordingly, in one example, a trained CNN or SVM model to be used by tagging engine 4220 to classify a dataset of images as ‘highway’, ‘rural’, ‘city’, or ‘suburban’. Tagging engine 4220 can automatically attach the tags to the dataset.

For policy enforcement 4360, a data engineer 4334 may define processes 4325 and update processes 4327. For example, a first process may be defined to blur faces of an image, a second process may be defined to blur license plates of cars, a third process may be defined to replace GPS coordinates with less precise location information, a fourth process may be defined to encrypt data. A data owner 4332 may define policies 4321 and update policies 4323. For example, a policy may be defined by selecting a particular condition (e.g., conjunction or disjunction of tags) and assigning an action (e.g., conjunction of processes) to the condition. The policy can be associated with datasets that satisfy the condition. The action defined by the policy is to be performed on the tagged datasets either immediately or on-demand if the policy is designated as a ‘lazy’ policy as further described herein.

Policy enforcement engine 4230 can enforce a policy 4304 in real-time if the policy is not designated as lazy and can enforce a policy on-demand 4302 if the policy is designated as lazy. A data consumer 4340 that consumes a dataset (e.g., requests access to a dataset) may trigger the policy enforcement engine 4230 to enforce a policy associated with the dataset. This can occur when the dataset is marked for on-demand processing due to a policy that is associated with the dataset being designated as a lazy policy.

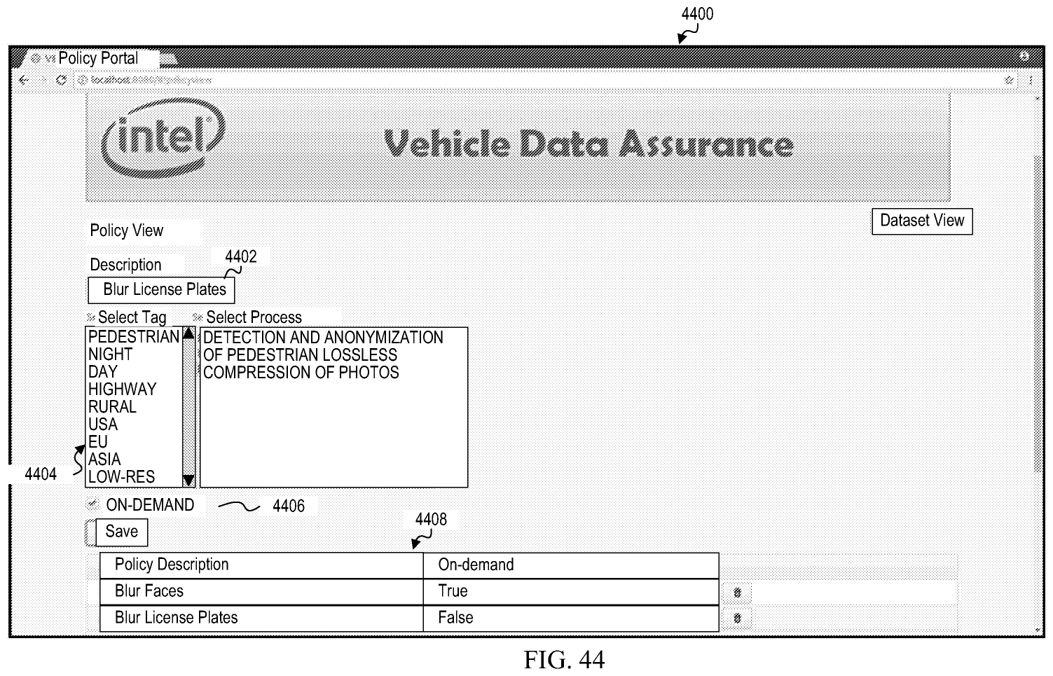

FIG. 44 is an example portal screen display 4400 of an on-demand privacy compliance system for creating policies for data collected by autonomous vehicles. Portal screen display 4400 allows policies to be created and optionally designated as ‘lazy’. A description 4402 field allows a user to provide a description of a policy, such as ‘Blur License Plates’. A tag selection box 4404 allows a user to select tags to be used as a condition for the policy. An on-demand box 4406 may be selected by a user to designate the policy as ‘lazy’. If the box is not selected, then the policy is not designated as ‘lazy’. A policy description table 4408 provides a view of which policies are designated as ‘lazy’ and which policies are not designated as ‘lazy’. For example, in the example of FIG. 44, a policy to blur faces is designated as lazy and, therefore, is to be applied to datasets on-demand. In another example, the blur license plates policy is not designated as ‘lazy’ and, therefore, is applied to datasets immediately to blur license plates in images in the dataset.

FIG. 45 shows an example image collected from a vehicle before and after applying a license plate blurring policy to the image. Image 4500A is an image with an unobscured and decipherable license place 4504A. A policy to blur the license plate is applied at 4510 and results in image 4500B, which has an obscured and undecipherable license plate 4504B due to a blurring technique applied to pixels representing the license plate in the image.

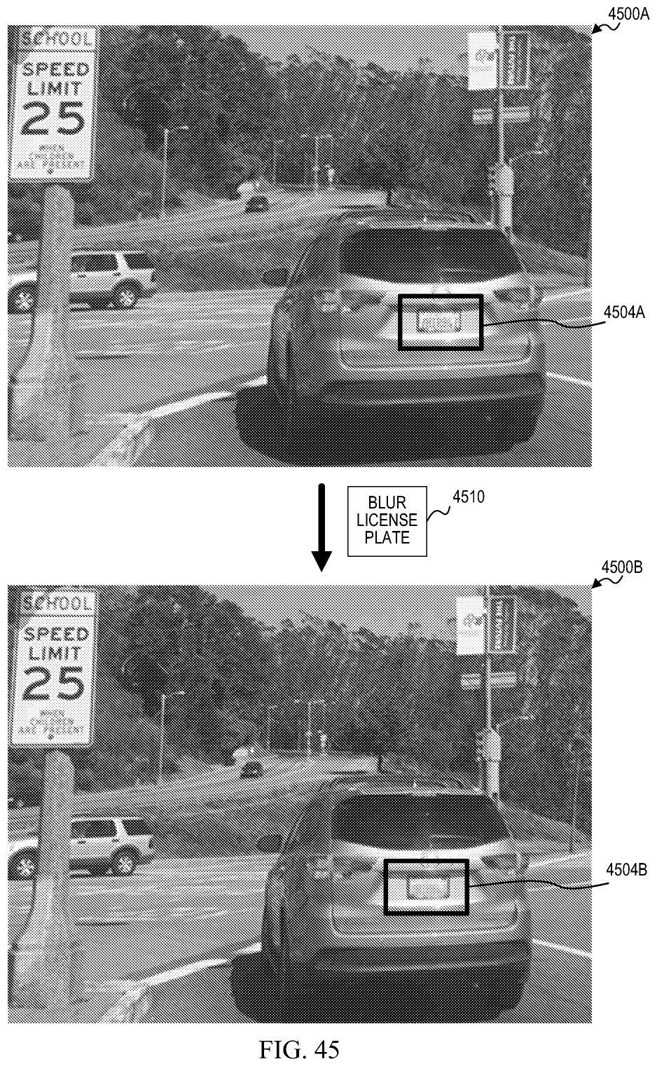

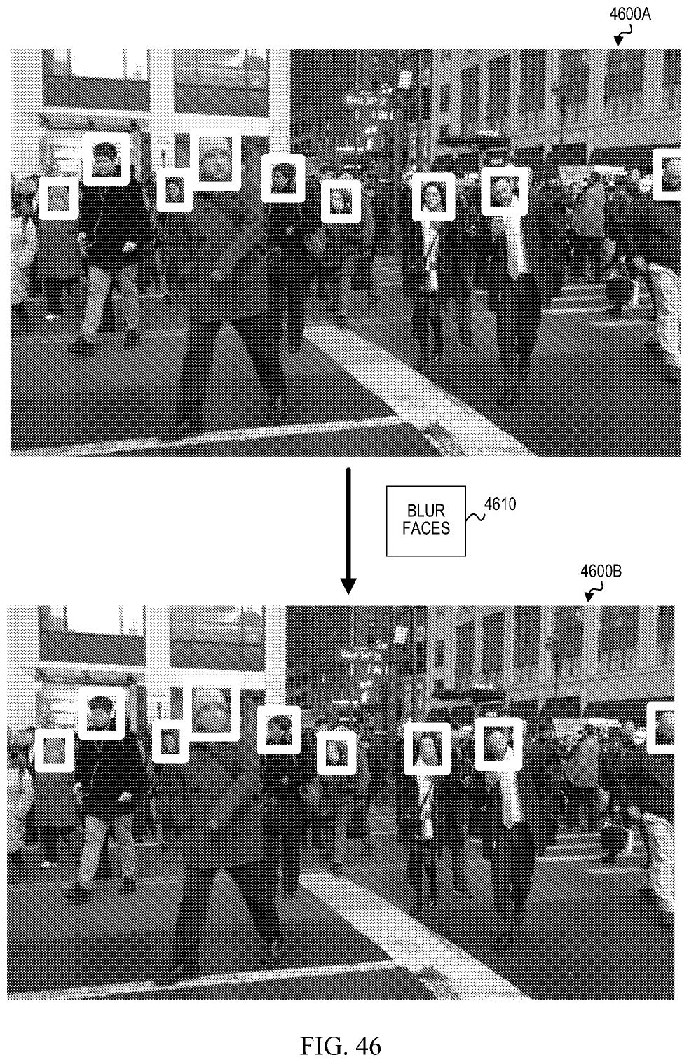

FIG. 46 shows an example image collected from a vehicle before and after applying a face blurring policy to the image. Image 4600A is an image with some unobscured and recognizable human faces (highlighted by white frames). A policy to blur faces is applied at 4610 and results in image 4600B, which has obscured and unrecognizable faces (highlighted by white frames) due to a blurring technique applied to pixels representing the faces in the image.

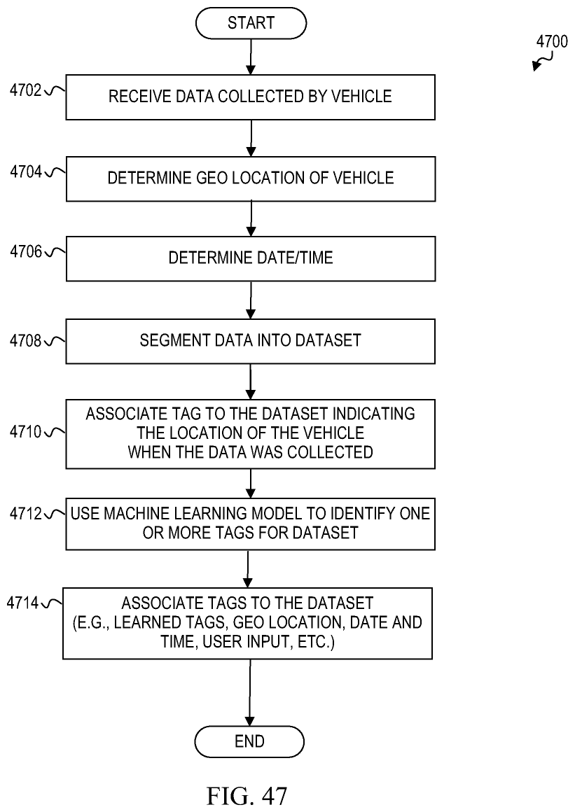

Turning to FIG. 47, FIG. 47 is a simplified flowchart that illustrates a high-level possible flow 4700 of operations associated with tagging data collected at a vehicle in an on-demand privacy compliance system, such as system 3900. In at least one embodiment, a set of operations corresponds to activities of FIG. 47. Vehicle data system 4200 may utilize at least a portion of the set of operations. Vehicle data system 4200 may comprise one or more data processors (e.g., 3927 for a cloud vehicle data system, 3957 for an edge vehicle data system), for performing the operations. In at least one embodiment, segmentation engine 4210 and tagging engine 4220 each perform one or more of the operations. For ease of discussion, flow 4700 will be described with reference to edge vehicle data system 3940 in vehicle 3950.

At 4702, data collected by vehicle 3950 is received by edge vehicle data system 3940. Data may be collected from a multitude of sensors, including image capturing devices, by data collector 3952 in the vehicle.

At 4704, a geo location of the vehicle is determined and at 4706 a date and time can be determined. In some implementations, it may be desirable for geo tagging and/or date and time tagging to be performed at the edge where the real-time information is readily available even if the collected data is subsequently sent to a corresponding cloud vehicle data system for additional tagging and policy enforcement. Accordingly, at 4708, the data may be segmented into a dataset.

At 4710, one or more tags are attached to the data indicating the location of the vehicle and/or the date and time associated with the collection of the data. In this scenario, segmentation is performed before the tag is applied and the geo location tag and/or date and time tag may be applied to the dataset. In other scenarios, a geo location tag and/or a date and time tag may be applied to individual instances of data that are subsequently segmented into datasets and tagged with appropriate geo location tag and/or date and time tag.

At 4712, a machine learning model (e.g., CNN, SVM) is applied to the dataset to identify one or more tags to be associated with the dataset. At 4714, the identified one or more tags are associated with the dataset. A policy may be ‘attached’ to a dataset by being stored with, appended to, mapped to, linked to or otherwise associated with the dataset.

In at least some scenarios, a user (e.g., vehicle owner, data provider) may manually attach a tag to the dataset. For example, if a driver sees an obstacle or accident on the road, that driver could manually enter information into the vehicle data system. The tagging engine could use the information to create a new tag for one or more relevant datasets. Thus, additional contextual information can be manually added to the data in real-time.

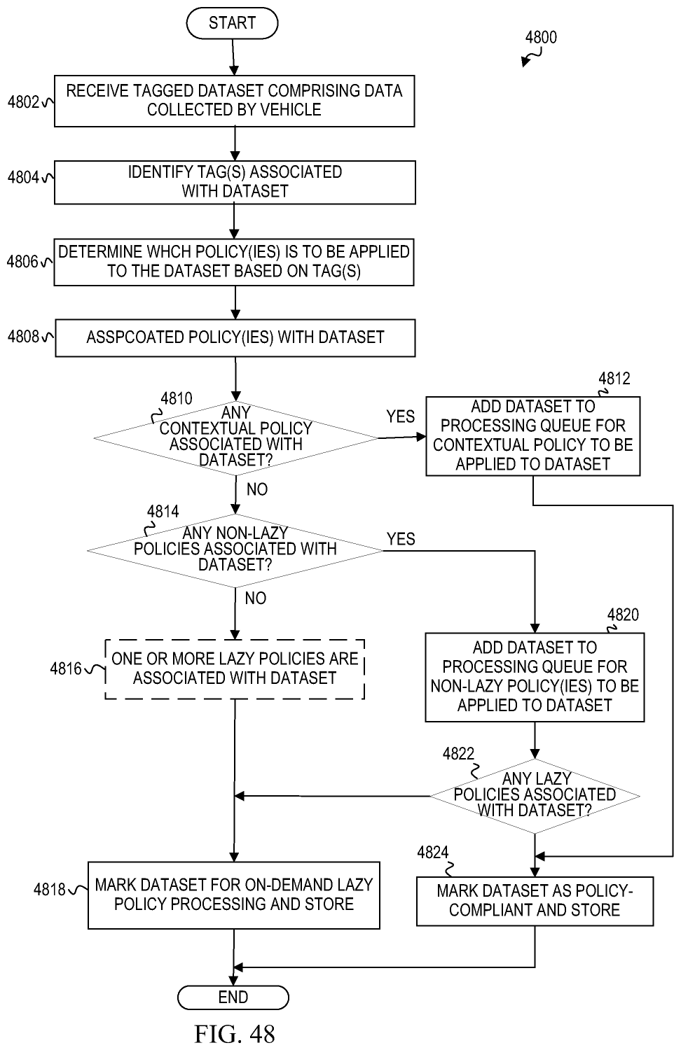

FIG. 48 is a simplified flowchart that illustrates a high-level possible flow 4800 of operations associated with policy enforcement in an on-demand privacy compliance system, such as system 3900. In at least one embodiment, a set of operations corresponds to activities of FIG. 48. A vehicle data system, such as vehicle data system 4200, may utilize at least a portion of the set of operations. Vehicle data system 4200 may include one or more data processors (e.g., 3927 for a cloud vehicle data system, 3957 for an edge vehicle data system), for performing the operations. In at least one embodiment, policy enforcement engine 4230 performs one or more of the operations. For ease of discussion, flow 4800 will be described with reference to edge vehicle data system 3940 in vehicle 3950.

At 4802, a policy enforcement engine in edge vehicle data system 3940 of vehicle 3950 receives a tagged dataset comprising data collected by the vehicle. The dataset may be received subsequent to activities described with reference to FIG. 47. For example, once data collected from the vehicle is segmented into a dataset, and tagged by a tagging engine, then the tagged dataset is received by the policy enforcement engine.

At 4804, one or more tags associated with the data are identified. At 4806 a determination is made as to which policy is to be applied to the dataset. For example, if the tags associated with the dataset satisfy a condition of a particular policy, then that policy is to be applied to the dataset. At 4808, the determined policy is associated with the dataset. A policy may be ‘associated’ with a dataset by being stored with, attached to, appended to, mapped to, linked to or otherwise associated in any suitable manner with the dataset.

At 4810, a determination is made as to whether any contextual policy is associated with the dataset. A contextual policy can override a lazy policy and/or a non-lazy policy. For example, if a vehicle receives an AMBER-type-child alert, a lazy policy for blurring license plates in datasets tagged as ‘highway’ might be set to ‘NO’. However, instead of immediately blurring license places in dataset, OCR may be used to obtain license plate information in the dataset. Accordingly, if a contextual policy is applicable, then at 4812, the dataset is added to the processing queue for the contextual policy to be applied to the dataset. Flow then may pass to 4824 where the dataset is marked as policy compliant and stored for subsequent use (e.g., sending to law enforcement, etc.). In some cases, the use may be temporary until the contextual policy is no longer valid (e.g., AMBER-type-child alert is cancelled). In this scenario, policy enforcement engine may process the dataset again to apply any non-lazy policies and to mark the dataset for processing on-demand if any lazy policies are associated with the dataset and not already applied to the dataset.

If it is determined at 4810 that a contextual policy is not associated with the dataset, then at 4814 a determination may be made as to whether any non-lazy policies are associated with the dataset. If non-lazy policies are not associated with the dataset, then this means that one or more lazy policies are associated with the dataset, as shown at 4816. That is, if one or more policies are associated with the dataset at 4808, and if the one or more policies are not contextual (determined at 4810) and not non-lazy (determined at 4814), then the policies are lazy. Therefore, at 4818, the dataset is marked for on-demand lazy policy processing and is stored.

If it is determined at 4814 that one or more non-lazy policies are associated with the dataset, then at 4820, the dataset is added to the processing queue for non-lazy policy(ies) to be applied to the dataset. At 4822, a determination is made as to whether any lazy policies are associated with the dataset. If one or more lazy policies are associated with the dataset, then at 4818, the dataset is marked for on-demand lazy policy processing and is stored. If one or more lazy policies are not associated with the dataset, then at 4824, the dataset is marked as being policy-compliant and is stored for subsequent access and/or use.

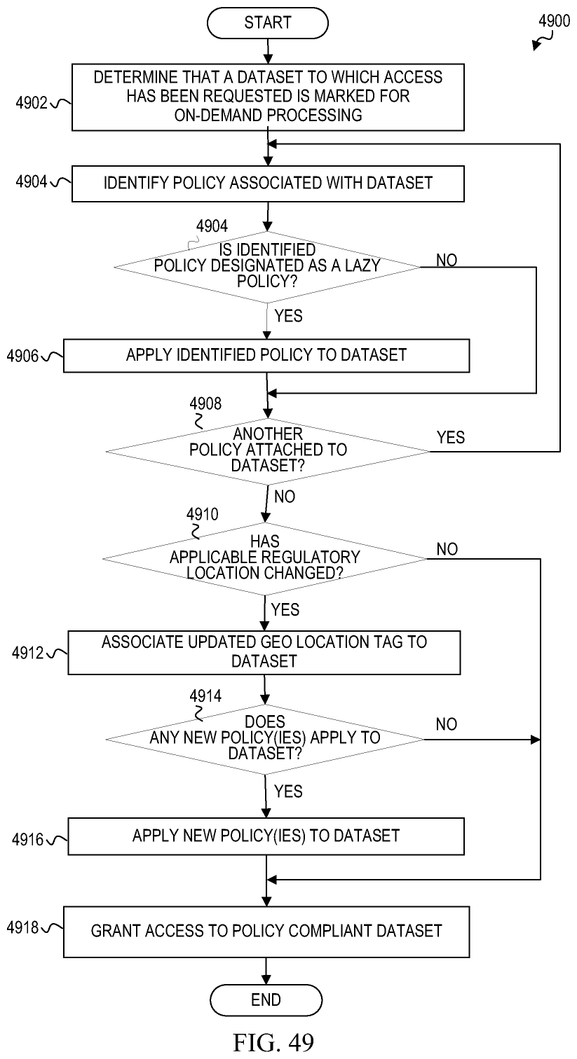

FIG. 49 is a simplified flowchart that illustrates a high-level possible flow 4900 of operations associated with policy enforcement in an on-demand privacy compliance system, such as system 3900. In at least one embodiment, a set of operations corresponds to activities of FIG. 49. A vehicle data system, such as vehicle data system 4200, may utilize at least a portion of the set of operations. Vehicle data system 4200 may include one or more data processors (e.g., 3927 for a cloud vehicle data system, 3957 for an edge vehicle data system), for performing the operations. In at least one embodiment, policy enforcement engine 4230 performs one or more of the operations. Generally, flow 4900 may be applied to a dataset that has been marked for on-demand processing.

It should be noted that, in at least one embodiment, when a request for access to a dataset is received, a determination may be made as to whether the dataset is marked for on-demand processing. If the dataset is marked for on-demand processing, then at 4902, a determination is made that the dataset to which access has been requested is marked for on-demand processing. Because the dataset has been marked for on-demand processing, at least one policy associated with the dataset is designated as a lazy policy. A request for access to the dataset may be a request from any device or application, for example, to read, share, receive, sample, or access the dataset in any other suitable manner.

At 4904, a policy associated with the dataset is identified. At 4904, a determination is made as to whether the identified policy is designated as lazy. If it is determined that the identified policy is designated as lazy, then the identified policy is applied to the dataset at 4906. If the identified policy is not designated as lazy, or once the identified policy is applied to the dataset, at 4908, a determination is made as to whether another policy is associated with the dataset. If another policy is associated with the dataset, the flow passes back to 4904 to identify another policy associated with the dataset and continue processing as previously described. Flow may continue looping until all policies associated with the dataset and designated as lazy have been applied to the dataset.

If it is determined at 4908 that another policy is not associated with the dataset, then at 4910, a determination is made as to whether the applicable regulatory location has changed. For example, if a vehicle stores a dataset locally (e.g., in the vehicle) with at least one policy designated as lazy, and if the vehicle then moves into another regulatory area, then an evaluation may be performed to determine whether the new regulatory area requires additional privacy-compliance actions. Thus, if the applicable regulatory location has not changed, then flow may pass to 4918 to grant access to the policy compliant dataset.

If the applicable regulatory location has changed, then at 4912, an updated geo location tag is associated to the dataset. At 4914, a determination is made as to whether any new one or more policies apply to the dataset. If no new policies apply to the dataset (based at least in part on the new geo location tag), then flow may pass to 4918 to grant access to the policy compliant dataset.

If at least one new policy does apply to the dataset, then at 4916, the new policy (or multiple new policies) are applied to the dataset. Then, at 4918, access can be granted to the policy compliant dataset.

It should be noted that if a dataset is not marked for on-demand processing and a request for access to the dataset is received, then in at least one embodiment, a determination is made that the dataset is policy-compliant and flow may proceed at 4910. Thus, a policy-compliant dataset may still be evaluated to determine whether a new regulatory location of the vehicle affects the policies to be applied to the dataset.

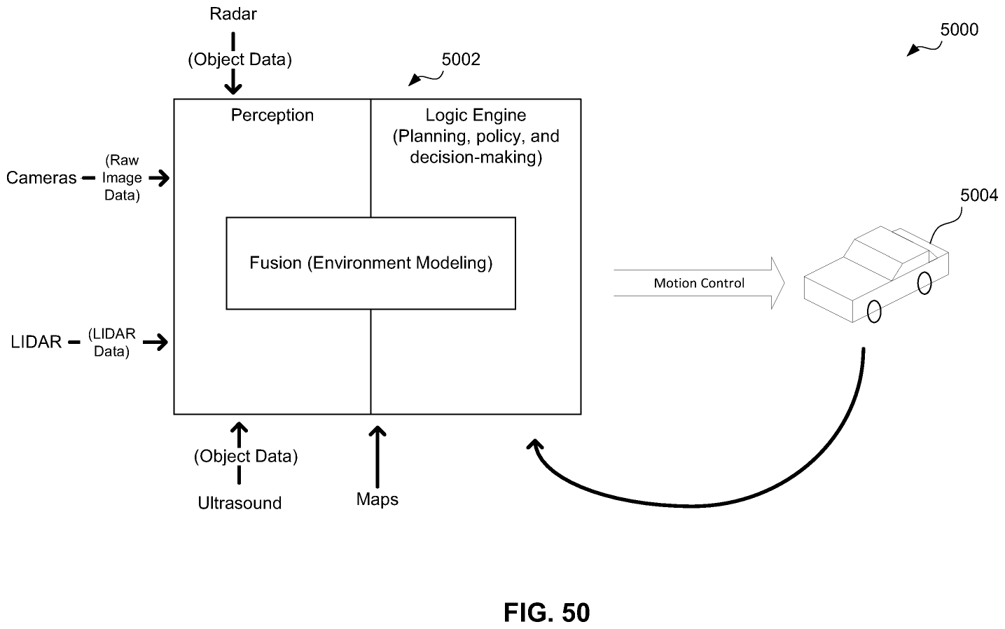

FIG. 50 is a simplified diagram of a control loop for automation of an autonomous vehicle 5010 in accordance with at least one embodiment. As shown in FIG. 50, automated driving may rely on a very fast feedback loop using a logic engine 5002 (which includes perception, fusion planning, driver policy, and decision-making aspects), and Distributed Actuation of the AV 5004 based on the output of such engines. Each of these meta-modules may be dependent on input or processing that is assumed to be trustworthy.

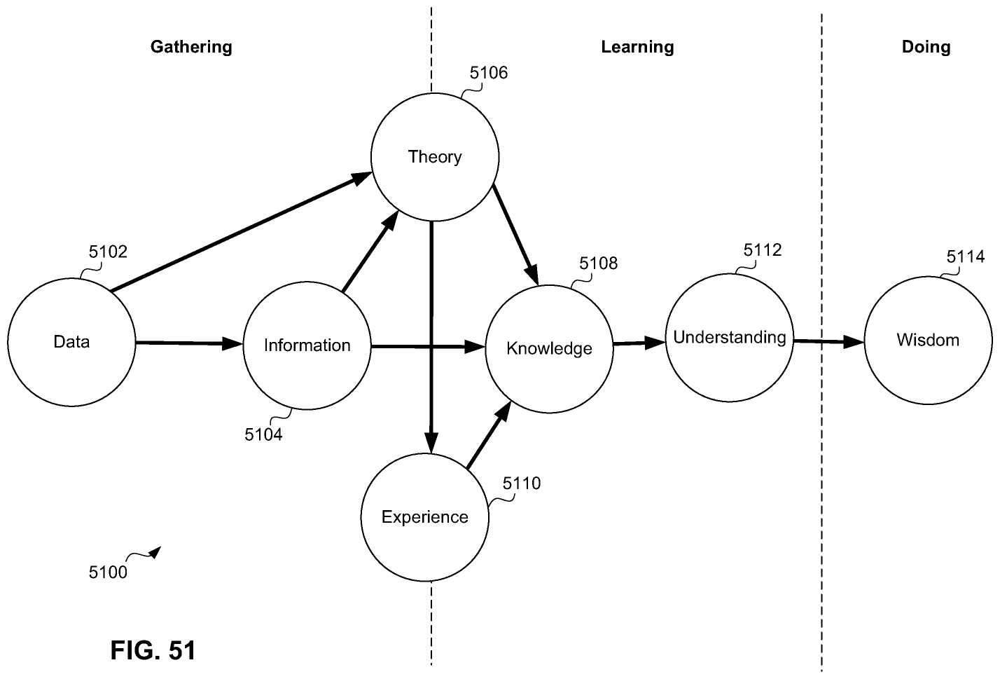

FIG. 51 is a simplified diagram of a Generalized Data Input (GDI) for automation of an autonomous vehicle in accordance with at least one embodiment. In the context of automated driving and transportation in smart cities and smart infrastructure, input can take the form of raw data 5102 (e.g., numbers, symbols, facts), information 5104 (e.g., data processed and organized to model), knowledge 5108 (e.g., collected information, which may be structured or contextual), experiences 5110 (e.g., knowledge gained through past action), theory frameworks 5106 (e.g., for explaining behaviors), or understanding 5112 (e.g., assigning meaning, explaining why a behavior occurred, or applying analysis). Each of these different types of inputs may be referred to as Generalized Data Input (GDI). As shown in FIG. 51, the GDI may be used to provide wisdom (e.g., judgment, evaluated understanding, proper/good/correct/right actions). The data displayed may be stored by any suitable type of memory and/or processed by one or more processors of an in-vehicle computing system of an autonomous vehicle.

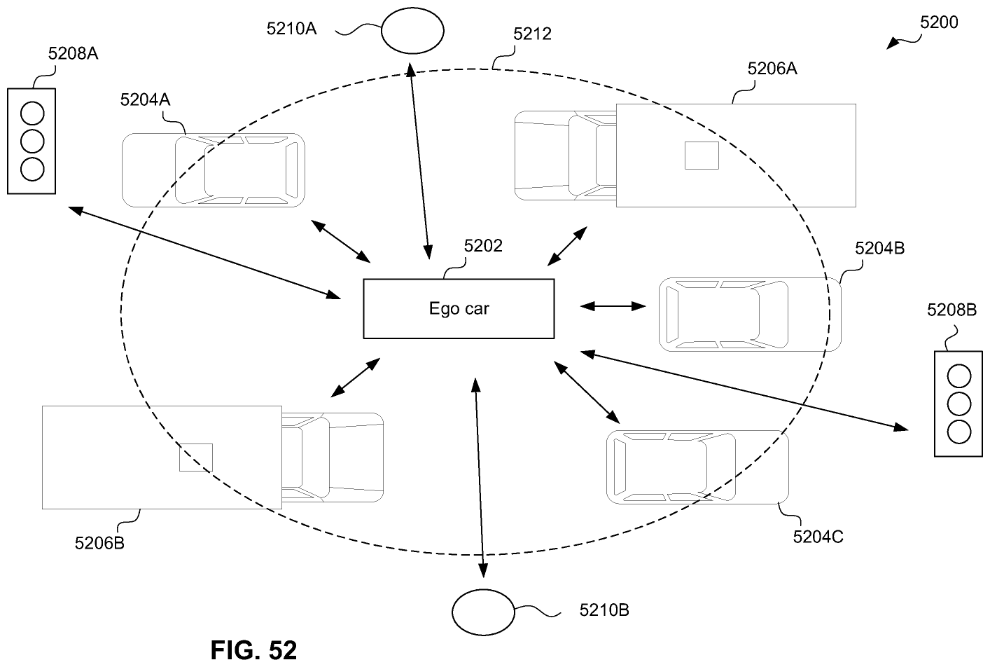

FIG. 52 is a diagram of an example GDI sharing environment 5200 in accordance with at least one embodiment. In the example shown, there is an ego vehicle (e.g., a subject autonomous vehicle) 5202 surrounded by other vehicle actors 5204, and fleet vehicle actors 5206 in a neighborhood 5212 around the ego vehicle 5202. In addition, there are infrastructure sensors around the ego vehicle 5202, including traffic light sensors 5208 and street lamp sensors 5210.

As shown, the ego vehicle 5202 may be in communication with one or more of the other actors or sensors in the environment 5200. GDI may be shared among the actors shown. The communication between the ego vehicle 5202 and the other actors may be implemented in one or more of the following scenarios: (1) self-to-self, (2) broadcast to other autonomous vehicles (1:1 or 1:many), (3) broadcast out to other types of actors/sensors (1:1 or 1:many), (4) receive from other autonomous vehicles (1:1 or 1:many), or (5) receive from other types of actors/sensors (1:1 or 1:many).

In some embodiments, the ego vehicle 5202 may process GDI generated by its own sensors, and in some cases, may share the GDI with other vehicles in the neighborhood 5200 so that the other vehicles may use the GDI to make decisions (e.g., using their respective logic engines for planning and decision-making). The GDI (which may be assumed to be trusted) can come from the ego autonomous vehicle's own heterogeneous sensors (which may include information from one or more of the following electronic control units: adaptive cruise control, electronic brake system, sensor cluster, gateway data transmitter, force feedback accelerator pedal, door control unit, sunroof control unit, seatbelt pretensioner, seat control unit, brake actuators, closing velocity sensor, side satellites, upfront sensor, airbag control unit, or other suitable controller or control unit) or from other GDI actor vehicles (e.g., nearby cars, fleet actor vehicles, such as buses, or other types of vehicles), Smart City infrastructure elements (e.g., infrastructure sensors, such as sensors/computers in overhead light posts or stoplights, etc.), third-party apps such as a Map service or a Software-update provider, the vehicles' OEMs, government entities, etc. Further, in some embodiments, the ego vehicle 5202 may receive GDI from one or more of the other vehicles in the neighborhood and/or the infrastructure sensors. Any malicious attack on any one of these GDI sources can result in the injury or death of one or more individuals. When malicious attacks are applied to vehicles in a fleet, a city, or an infrastructure, vehicles could propagate erroneous actions at scale with horrific consequences, creating chaos and eroding the public's trust of technologies.

In some instances, sharing data with potentially untrusted sources may be done via blockchain techniques. Sharing GDI may include one or more of the following elements implemented by one or more computing systems associated with a vehicle:

A Structure for packaging the GDI.

The Topology that describes how the GDI is related to other GDI

Permission Policies (e.g., similar to chmod in Linux/Unix systems), for instance:

Read-Access Policy to determine who can read the GDI

A Write-Control Policy to determine who can write the GDI

An Execute-Control Policy to determine who can actually execute executable GDI components (for instance, running a model, updating software, etc.).

A State policy to determine valid state of the Topology

Ownership Policies applied to the GDI (similar to chgrp/chown in Linux/Unix systems). For instance, Self, Group, All.

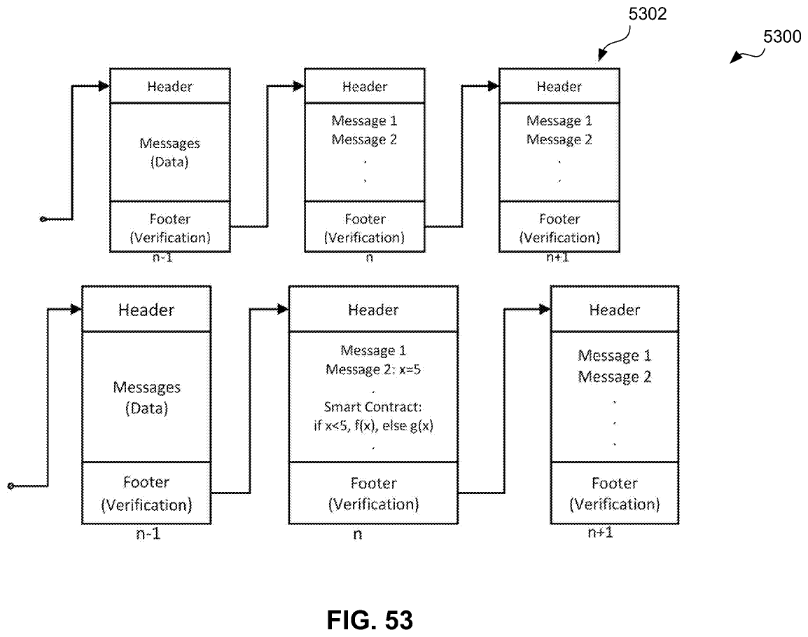

FIG. 53 is a diagram of an example blockchain topology 5300 in accordance with at least one embodiment. As shown, the structure of the GDI may include a “block” 5302 that includes a header, a body (that includes the GDI details), and a footer. The topology includes a linked-list of blocks (or, a linear network), with a cryptographic-based header and footer (see, e.g., FIG. 53). The header of a block, n, in a chain contains information that establishes it as the successor to the precursor block, n−1, in the linked-list. In some instances, computing system(s) implementing the blockchain (e.g., by storing blocks and verifying new blocks) may enforce one or more of the following elements:

Permission Policies, which may include, for instance:

1. A Read-Access Policy to indicate who can read the block information is based on public-private key pair matches generated from cryptographic hashes such Elliptic Curve Digital Signal Algorithm.

2. A Write-Control Policy to indicate who can append the blocks, and thus, who can ‘write’ the header information into the appending block is based on ability to verify the previous block with the time-to-verify being the crucial constraint.

3. An Execute-Control Policy embedded in the block information as a smart contract.

A State Policy based on distributed consensus to determine which state of the blockchain is valid when conflicting state information is presented. The reward for establishing the ‘valid state’ is write-control permission. Examples of this include Proof of Work (the first miner that solves a cryptographic puzzle, within a targeted elapsed time and whose difficulty is dynamically throttled by a central platform, is deemed to have established the ‘valid state’ and is thus awarded the write-control permission at that particular time), Proof of Stake (assigns the cryptographic puzzle to the miner with the highest stake/wealth/interest and awards the write-control permission to that miner once the puzzle is solved), Proof of Burn (awards the write-control permission in exchange for burning down their owned currency), etc.

Ownership information, which may be captured within the Message details.

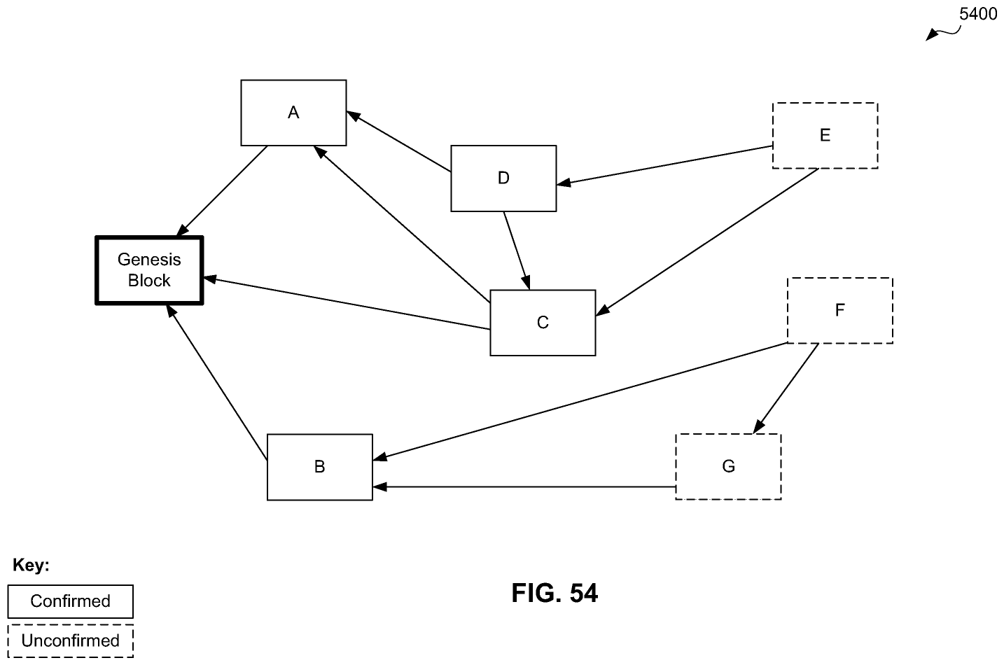

FIG. 54 is a diagram of an example “chainless” block using a directed acyclic graph (DAG) topology 5400 in accordance with at least one embodiment. In some instances, to address scalability, new platforms using DAGs, such as the IOTA platform, have been developed. In DAGs, the State policy (and thus the write-control permission) may be based on Proof of work, which may be used to confirm previous blocks to any currently unconfirmed blocks.

However, in some cases, block-like technologies such as these may present challenges, through one or more of the permission policy, the state policy, or the scalability of the given platform. For example, inherent in the permission and state policies may be the utilization of Elliptic curve cryptography (ECC) which has been sufficient to date, but these cryptography technologies may be insufficient going forward. For instance, ECC-based signatures (which are based on elliptic curve discrete log problems) may be one of the riskiest components of the technology when subjected to efficient quantum algorithms, with the most insecure components being: (1) a static address associated with the public key, and (2) unprocessed blocks (blocks not yet appended to the blockchain or to the Block-DAG). Further, such technologies may be susceptible to supply chain intercepts by bad actors (e.g., for fleet vehicle actors).

Example issues with such block-like technologies, and systems, include issues with permission policies. If the static address is stolen, all of its associated data and transactions and monetary value may become the property of the hacker-thief. This is because the hacker-thief may gain read, write, and/or execute permissions up through full ownership. Other issues may pertain to state policies. For instance, in the case of unprocessed blocks, quantum algorithms are estimated to be able to derive the private key from the public key by the year 2028. In particular, Schor's algorithm can determine prime factors using a quantum computer. And Grover's algorithm can do a key search. With the private key and the address known, it is possible to introduce new blocks (possibly with harmful data or harmful contracts) from that address. The Read-Access and Consensus (and thus Write-Control) have been based on elliptic curve cryptography. However, breaches in cryptocurrency implementations have led to significant monetary losses. With current blockchain technologies proposed for autonomous vehicles, theft of address or theft of message (inclusive of theft of smart contracts) can reverberate through the vehicle's feedback loop negatively up to loss of human life and/or catastrophic damage to infrastructure. Other issues may correspond to scalability. Modern decentralized blockchain technologies currently execute <20 transactions per second (using a decentralized peer-to-peer push model) whereas VisaNet can execute up to 56K transaction messages per second (using a centralized pull model). For Automated Driving and Smart Cities, transactions have to be executed at least on the order of Visa Net.

Accordingly, aspects of the present disclosure may include one or more of the following elements, which may be implemented in an autonomous driving computing system to help to address these issues:

Within the autonomous vehicle, one or more secure private keys (e.g., utilizing Intel SGX (Software Guard Extension)) may be created. The private keys may be used to generate respective corresponding public keys.

Digital signatures may be used for all data based on the private key. The digital signature may be a hash of the sensor data, which is then encrypted using the private key.

A permission-less blockchain may be used inside the autonomous vehicle (e.g., might not need to verify someone adding to the blockchain). All communication buses may be able to read blocks, and the internal network of the autonomous vehicle may determine who can write to the blockchain.

The autonomous vehicle may interface to a permissioned blockchain (e.g., with an access policy that may be based on a vehicle type, such as fleet vehicle (e.g., bus) vs. owned passenger vehicle vs. temporary/rented passenger vehicle (e.g., taxi); read access may be based on key agreements) or dynamic-DAG system when expecting exogenous data. Read access may be subscription based, e.g., software updates can be granted based on paid-for upgrade policies.

When broadcasting data for data sharing, ephemeral public keys (e.g., based on an ephemeral elliptic curve Diffie Hellman exchange or another type of one-time signature scheme) may be used to generate a secret key to unlock the data to be shared.

By using digital signatures, a time stamp and a truth signature may be associated with all data, for further use downstream. Static private keys may be maintained in a secure enclave. In addition, by setting the time constraints on the consensus protocol to be on the order of the actuation time adjustments (e.g., milliseconds), spoofing or hacking attempts directed at one or more sensors may be deterred. Further, network/gateway protocols (at the bus interface or gateway protocol level), within the autonomous vehicle's internal network(s), may only relay the verified blockchain. Additionally, by creating an intra-vehicle database (via the blockchain), a “black box” (auditable data recorder) may be created for the autonomous vehicle.

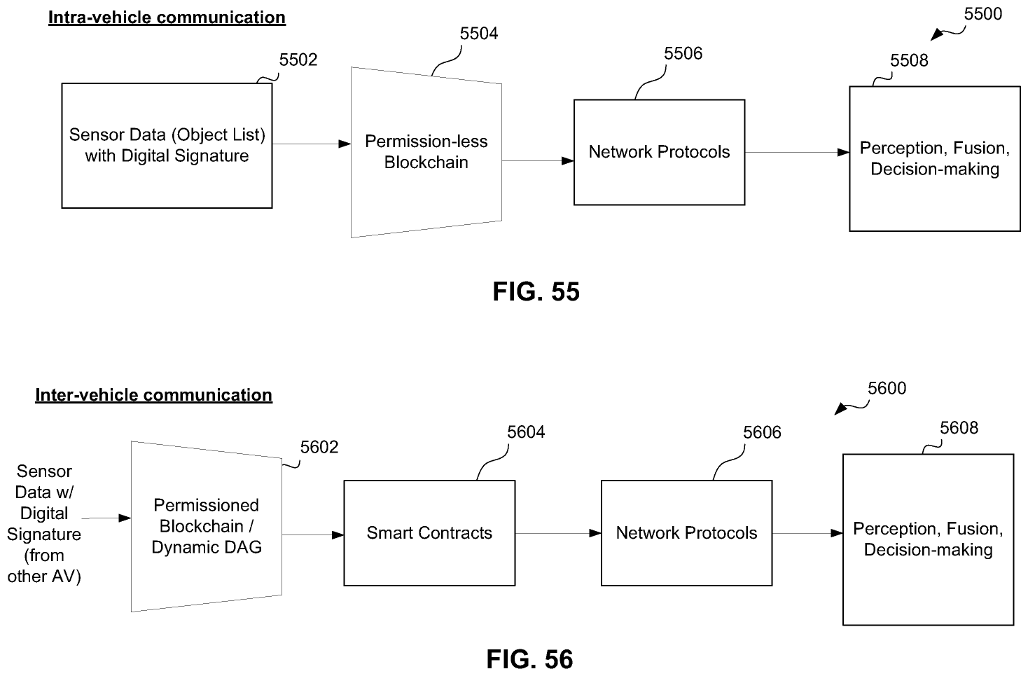

FIG. 55 is a simplified block diagram of an example secure intra-vehicle communication protocol 5500 for an autonomous vehicle in accordance with at least one embodiment. For example, the protocol 5500 may be used by the ego vehicle 5202 of FIG. 52 to secure its data against malicious actors. The example protocol may be used for communicating data from sensors coupled to an autonomous vehicle (e.g., LIDAR, cameras, radar, ultrasound, etc.) to a logic unit (e.g., a logic unit similar to the one described above with respect to FIG. 50) of the autonomous vehicle. In the example shown, a digital signature is appended to sensor data (e.g., object lists). The digital signature may be based on a secure private key for the sensor. The private key may be generated, for example, based on, for an ECC-based protocol such as secp256k1. In some cases, the digital signature may be generated by hashing the sensor data and encrypting the hash using the private key.

The sensor data 5502 (with the digital signature) is added as a block in a block-based topology (e.g., permission-less blockchain as shown) 5504 before being communicated to the perception, fusion, decision-making logic unit 5508 (e.g., an in-vehicle computing system) over certain network protocols 5506. In certain embodiments, only the data on the blockchain may be forwarded by the network/communication protocol inside the autonomous vehicle. The network protocol may verify the data of the block (e.g., comparing a time stamp of the sensor data with a time constraint in the consensus protocol of a blockchain) before communicating the block/sensor data to the logic unit. Further, in certain embodiments, the network protocol may verify the digital signature of the sensor data in the block before forwarding the block to the logic unit. For example, the network protocol may have access to a public key associated with a private key used to generate the digital signature of the sensor data, and may use the public key to verify the digital signature (e.g., by unencrypting the hash using the public key and verifying the hashes match). The blockchain 5504 may be considered permission-less because it does not require any verification before adding to the blockchain. In some cases, one or more aspects of the autonomous vehicle may determine who can write to the blockchain. For instance, during drives through unsavory neighborhoods, triggered by camera detection of ‘unsavory’ neighborhood or navigation map alert, it is possible that the autonomous vehicle's internal networks may revert to verify all until such time as the vehicle has safely exited the neighborhood.

FIG. 56 is a simplified block diagram of an example secure inter-vehicle communication protocol 5600 for an autonomous vehicle in accordance with at least one embodiment. For example, the protocol 5600 may be used by the ego vehicle 5202 of FIG. 52 to verify data from one or more of the other vehicles, backend (e.g., cloud-based) support systems, or infrastructure sensors. The example protocol may be used for communicating sensor data from an autonomous vehicle (which may include an owned vehicle, temporary/rented vehicle, or fleet vehicle) to a logic unit (e.g., a logic unit similar to the one described above with respect to FIG. 50) of another autonomous vehicle. In the example shown, sensor data from a first autonomous vehicle (which may include a digital signature as described above) is added as a block in a block-based topology (e.g., permissioned blockchain or node of a dynamic DAG) 5602 and is sent to a second autonomous vehicle, where one or more smart contracts 5604 are extracted. The Smart Contracts may contain information such as new regulatory compliance processing policies or even executable code that may override how data is processed in the perception, fusion, decision-making logic unit 5608. For instance, a new policy may override the perception flow so that the camera perception engine component that detects pedestrians/people and their faces, can only extract facial landmarks, pose, motion, but not their entire feature maps. Similarly, if the first autonomous vehicle happens to be a government police car, the smart contract may contain a temporary perception processing override and a license plate search to detect if the current autonomous vehicle's cameras have identified a license plate of interest in its vicinity.

In certain embodiments, exogenous data and software updates to the vehicle may arrive as a smart contract. If the smart contracts and/or sensor data are verified by the network protocol 5606, the sensor data is then communicated to the perception, fusion, decision-making logic unit 5608 of the second autonomous vehicle. In some cases, the network protocol may use ephemeral public keys (e.g., based on elliptic curve Diffie-Hellman). Using ephemeral public keys in dynamic environments allows public keys to be created and shared on the fly, while the car is momentarily connected to actor vehicles or the infrastructure it passes along its drive. This type of ephemeral key exchange allows secure data exchange for only the small duration of time in which the ego car is connected.

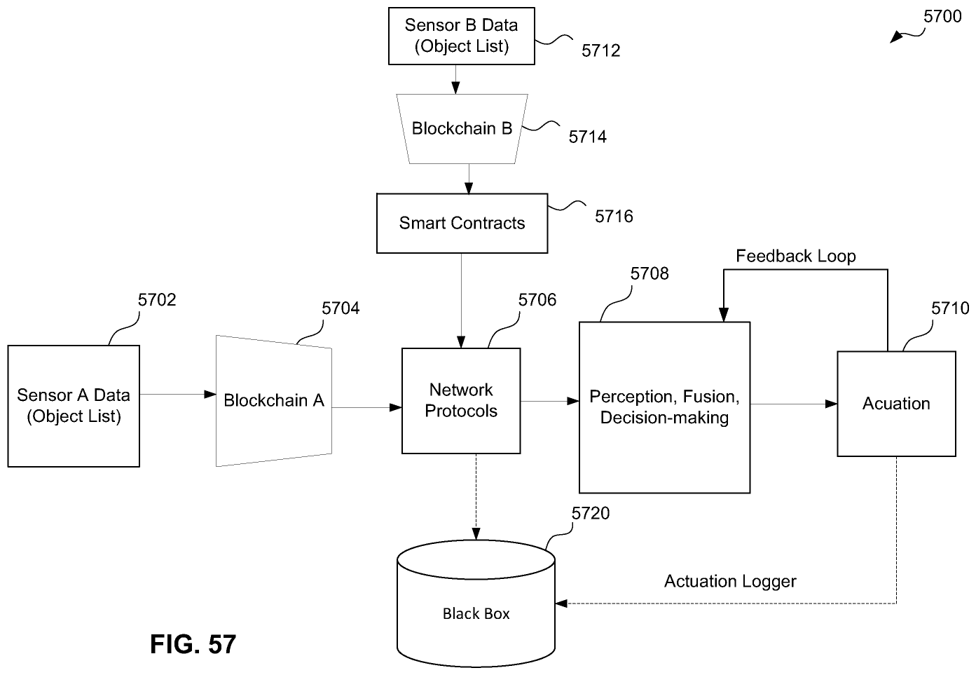

FIG. 57 is a simplified block diagram of an example secure intra-vehicle communication protocol for an autonomous vehicle in accordance with at least one embodiment. In the example shown, the secure intra-vehicle communication protocol utilizes two blockchains (A and B) that interact with each other. In addition, the intra-vehicle communication protocol utilizes an in-vehicle “black box” database 5720. The example sensor data 5702 and 5712, blockchains 5704 and 5714, network protocols 5706, and logic unit 5708 may be implemented similar to the like components shown in FIG. 55 and described above, and the smart contracts 5716 may be implemented similar to the smart contracts 5604 shown in FIG. 56 and described above.

In the example shown, the information generated by the logic unit 5708 may be provided to an actuation unit 5710 of an autonomous vehicle to actuate and control operations of the autonomous vehicle (e.g., as described above with respect to FIG. 50), and the actuation unit may provide feedback to the logic unit. After being used for actuation, the sensor data 5702, information generated by the logic unit 5708, or information generated by the actuation unit 5710 may be stored in an in-vehicle database 5720, which may in turn act as a “black box” for the autonomous vehicle.

The “black box” may act similar to black boxes used for logging of certain aspects and communication and data used for providing air transportation. For instance, because the GDI recorded in the blockchain is immutable, if it is stored in a storage system inside the autonomous vehicle, it can be recovered by government entities in an accident scenario, or by software system vendors during a software update. This GDI can then be used to simulate a large set of potential downstream actuations. Additionally, if the actuation logger also records to the storage system, then the endpoint actuation logger data, together with upstream GDI, can be used to winnow down any errant intermediate stage. This would provide a high probability of fault identification within the autonomous vehicle, with attribution of fault to internals of the ego vehicle, to errant data from actor vehicles, fleets, infrastructure, or other third party.

An autonomous vehicle may have a variety of different types of sensors, such as one or more LIDARs, radars, cameras, global positioning systems (GPS), inertial measurement units (IMU), audio sensors, thermal sensors, or other sensors (such as those described herein or other suitable sensors). The sensors may collectively generate a large amount of data (e.g., terabytes) every second. Such data may be consumed by the perception and sensor fusion systems of the autonomous vehicle stack. In many situations, the sensor data may include various redundancies due to different sensors capturing the same information or a particular sensor capturing information that is not changing or only changing slightly (e.g., while driving on a quiet highway, during low traffic conditions, or while stopped at a stoplight). These redundancies may significantly increase the requirement of resources such as hardware, special data handling big data ecosystems, sensor fusion algorithms, and other algorithm optimizations used to process data in near real time in different stages of the processing pipeline. In some systems, in order to improve a signal-to-noise ratio (SNR) of the sensor system, sensor fusion algorithms (such as algorithms based on, e.g., Kalman filters) may combine data from multiple sensors using equal weights. This may result in an improved SNR relative to data from a single sensor due to an improvement in overall variance.

In particular embodiments of the present disclosure, an improved sensor fusion system may utilize lower quality signals from cost-effective and/or power efficient sensors, while still fulfilling the SNR requirement of the overall system, resulting in a cost reduction for the overall system. Various embodiments may reduce drawbacks associated with sensor data redundancy through one or both of 1) non-uniform data sampling based on context, and 2) adaptive sensor fusion based on context.

In a particular embodiment, a sampling system of an autonomous vehicle may perform non-uniform data sampling by sampling data based on context associated with the autonomous vehicle. The sampling may be based on any suitable context, such as frequency of scene change, weather condition, traffic situation, or other contextual information (such as any of the contexts described herein). Such non-uniform data sampling may significantly reduce the requirement of resources and the cost of the overall processing pipeline. Instead of sampling data from every sensor at a set interval (e.g., every second), the sampling of one or more sensors may be customized based on context.

In one embodiment, a sampling rate of a sensor may be tuned to the sensitivity of the sensor for a given weather condition. For example, the sampling rate for a sensor that is found to produce useful data when a particular weather condition is present may be sampled more frequently than a sensor that produces unusable data during the weather condition. In some embodiments, the respective sampling rates of various sensors are correlated with a density of traffic or rate of scene change. For example, a higher sampling rate may be used for one or more sensors in dense traffic relative to samples captured in light traffic. As another example, more samples may be captured per unit time when a scene changes rapidly relative to the number of samples captured when a scene is static. In various embodiments, a sensor having a high cost, a low throughput per unit of power consumed, and/or high power requirements is used sparingly relative to a sensor with a low cost, a high throughput per unit of power consumed, and/or lower power requirements to save on cost and energy, without jeopardizing safety requirements.

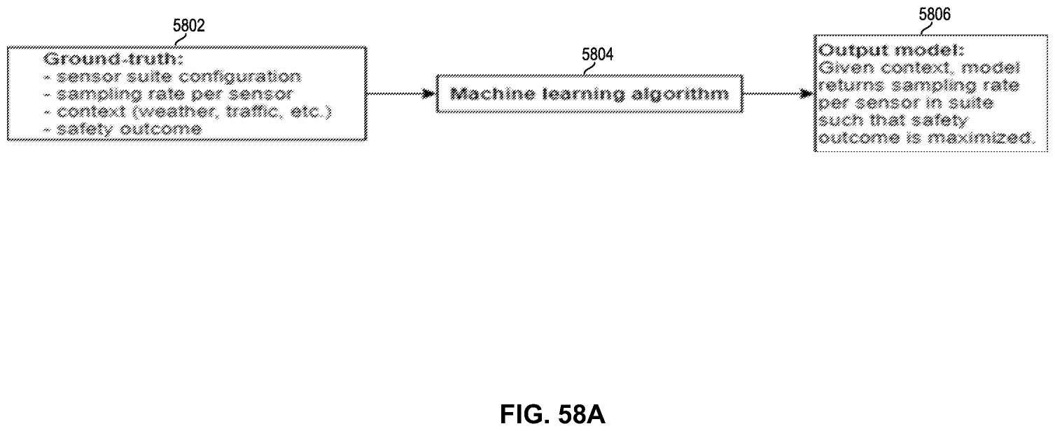

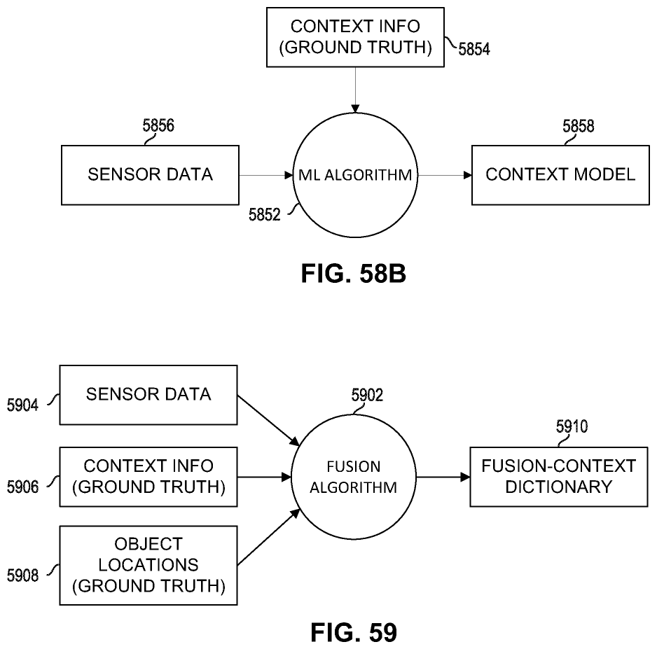

FIG. 58A depicts a system for determining sampling rates for a plurality of sensors in accordance with certain embodiments. The system includes ground-truth data 5802, a machine learning algorithm 5804, and an output model 5806. The ground-truth data 5802 is provided to the machine learning algorithm 5804 which processes such data and provides the output model 5806. In a particular embodiment, machine learning algorithm 5804 and/or output model 5806 may be implemented by machine learning engine 232 or a machine learning engine of a different computing system (e.g., 140, 150).

In the present example, ground-truth data 5802 may include sensor suite configuration data, a sampling rate per sensor, context, and safety outcome data. Ground-truth data 5802 may include multiple data sets that each correspond to a sampling time period and indicate a sensor suite configuration, a sampling rate used per sensor, context for the sampling time period, and safety outcome over the sampling time period. A data set may correspond to sampling performed by an actual autonomous vehicle or to data produced by a simulator. Sensor suite configuration data may include information associated with the configuration of sensors of an autonomous vehicle, such as the types of sensors (e.g., LIDAR, 2-D camera, 3-D camera, etc.), the number of each type of sensor, the resolution of the sensors, the locations on the autonomous vehicle of the sensors, or other suitable sensor information. Sampling rate per sensor may include the sampling rate used for each sensor in a corresponding suite configuration over the sampling time period. Context data may include any suitable contextual data (e.g., weather, traffic, scene changes, etc.) present during the sampling time period. Safety outcome data may include safety data over the sampling time period. For example, safety outcome data may include an indication of whether an accident occurred over the sampling time period, how close an autonomous vehicle came to an accident over the sampling time period, or other expression of safety over the sampling time period.

Machine learning algorithm 5804 may be any suitable machine learning algorithm to analyze the ground truth data and output a model 5806 that is tuned to provide sampling rates for each of a plurality of sensors of a given sensor suite based on a particular context. A sampling rate for each sensor is learned via the machine learning algorithm 5804 during a training phase. Any suitable machine learning algorithm may be used to provide the output model 5806. As non-limiting examples, the machine learning algorithm may include a random forest, support vector machine, any suitable neural network, or a reinforcement algorithm (such as that described below or other reinforcement algorithm). In a particular embodiment, model 5806 may be stored with machine learning models 256.

Output model 5806 may be used during an inference phase to output a vector of sampling rates (e.g., one for each sensor of the sensor suite being used) given a particular context. In various embodiments, the output model 5806 may be tuned to decrease sampling rates or power used during sampling as much as possible while still maintaining an acceptable level of safety (e.g., no accidents, rate of adherence to traffic laws, etc.). In other embodiments, the model 5806 may be tuned to favor any suitable operation characteristics, such as safety, power used, sensor throughput, or other suitable characteristics. In a particular embodiment, the model 5806 is based on a joint optimization between safety and power consumption (e.g., the model may seek to minimize power consumption while maintaining a threshold level of safety).

In addition, or as an alternative to varying the sampling rate of the sensors, in some embodiments, sensor fusion improvement is achieved by adapting weights for each sensor based on the context. The SNR (and consequently the overall variance) may be improved by adaptively weighting data from the sensors differently based on the context.

In a particular embodiment, to assist with object tracking, when the ground truth data are available for different contexts and object position at various instants under these different contexts, the fusion weights may be determined from the training data using a combination of a machine learning algorithm that predicts context and a tracking fusion algorithm that facilitates prediction of object position.

FIG. 58B depicts a machine learning algorithm 5852 to generate a context model 5858 in accordance with certain embodiments. In a particular embodiment, machine learning algorithm 5852 and context model 5858 may be executed by machine learning engine 232 or a machine learning engine of a different computing system (e.g., 140, 150). FIG. 58B depicts a training phase for building a ML model for ascertaining context. Machine learning algorithm 5852 may be any suitable machine learning algorithm to analyze sensor data 5856 and corresponding context information 5854 (as ground truth). The sensor data 5856 may be captured from sensors of one or more autonomous vehicles or may be simulated data. Machine learning algorithm 5852 outputs a model 5858 that is tuned to provide a context based on sensor data input from an operational autonomous vehicle. Any suitable type of machine learning algorithm may be used to train and output the output model 5858. As non-limiting examples, the machine learning algorithm for predicting context may include a classification algorithm such as a support vector machine or a deep neural network.

FIG. 59 depicts a fusion algorithm 5902 to generate a fusion-context dictionary 5910 in accordance with certain embodiments. FIG. 59 depicts a training phase for building a ML model for ascertaining sensor fusion weights. Fusion algorithm 5902 may be any suitable machine learning algorithm to analyze sensor data 5904, corresponding context information 5906 (as ground truth), and corresponding object locations 5908 (as ground truth). The sensor data 5904 may be captured from sensors of one or more autonomous vehicles or may be simulated data (e.g., using any of the simulation techniques described herein or other suitable simulation techniques). In some embodiments, sensor data 5904 may be the same sensor data 5856 used to train a ML model or may be different data, at least in part. Similarly, context information 5906 may be the same as context information 5854, or may be different information, at least in part. Fusion algorithm 5902 outputs a fusion-context dictionary 5910 that is tuned to provide weights based on sensor data input from an operational autonomous vehicle.

Any suitable machine learning algorithm may be used to train and implement the fusion-context dictionary. As a non-limiting example, the machine learning algorithm may include a regression model to predict the sensor fusion weights.

In various embodiments, the fusion algorithm 5902 is neural network-based. During training, the fusion algorithm 5902 may take data (e.g., sensor data 5904) from various sensors and ground truth context info 5906 as input, fuse the data together using different weights, predict an object position using the fused data, and utilize a cost function (such as a root-mean squared error (RMSE) or the like) that minimizes the error between the predicted position and the ground truth position (e.g., corresponding location of object locations 5908). In various embodiments, the fusion algorithm may select fusion weights for a given context to maximize object tracking performance. Thus, the fusion algorithm 5902 may be trained using an optimization algorithm that attempts to maximize or minimize a particular characteristic (e.g., object tracking performance) and the resulting weights of fusion-context dictionary 5910 may then be used to fuse new sets of data from sensors more effectively, taking into account the results of predicted conditions.

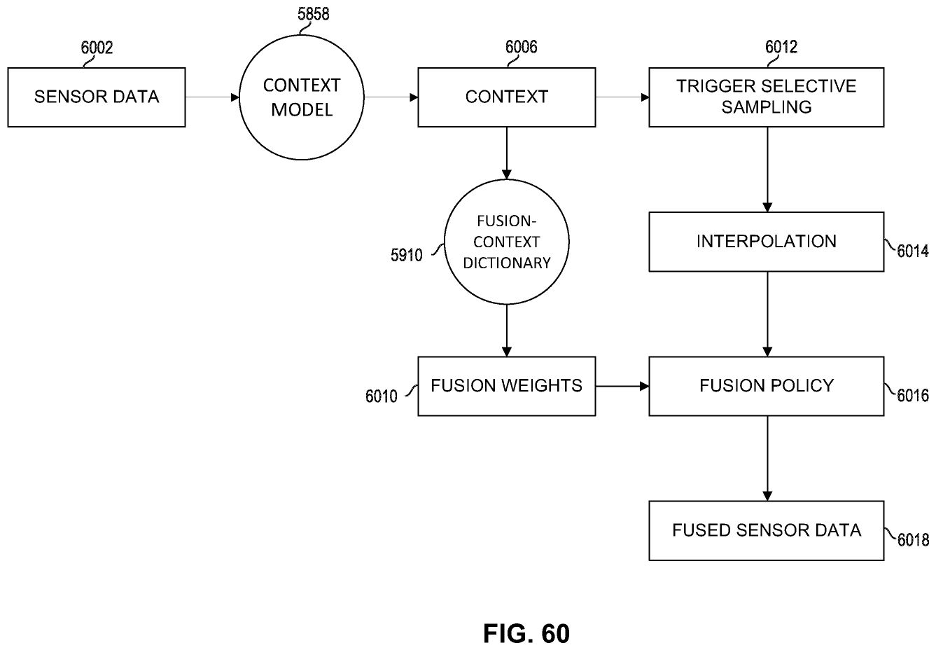

FIG. 60 depicts an inference phase for determining selective sampling and fused sensor weights in accordance with certain embodiments. In a particular embodiment, the inference phase may be performed by the machine learning engine 232 and/or the sensor fusion module 236. During the inference phase, sensor data 6002 captured by an autonomous vehicle is provided to context model 5858. The output of context model 5858 is context 6006. Context 6006 may be used to trigger selective sampling at 6012. For example, the context may be provided to output model 5806, which may provide a rate of sampling for each sensor of a plurality of sensors of the autonomous vehicle. The autonomous vehicle may then sample data with its sensors using the specified sampling rates.

At 6014, interpolation may be performed. For example, if a first sensor is being sampled twice as often as a second sensor and samples from the first and second sensor are to be fused together, the samples of the second sensor may be interpolated such that the time between samples for each sensor is the same. Any suitable interpolation algorithm may be used. For example, an interpolated sample may take the value of the previous (in time) actual sample. As another example, an interpolated sample may be the average of the previous actual sample and the next actual sample. Although the example focuses on fusion at the level of sensor data, fusion may additionally or alternatively be performed at the output also. For example, different approaches may be taken with different sensors in solving an object tracking problem. Finally, in the post analysis stage, complementary aspects of individual outputs are combined to produce fused output. Thus, in some embodiments, the interpolation may alternatively be performed after the sensor data is fused together.

The context 6006 may also be provided to the fusion-context dictionary 5910 and a series of fusion weights 6010 is output from the fusion-context dictionary 5910, where each fusion weight specifies a weight for a corresponding sensor. The fusion weights are used in the fusion policy module 6016 to adaptively weight the sensor data and output fused sensor data 6018. Any suitable fusion policy may be used to combine data from two or more sensors. In one embodiment, the fusion policy specifies a simple weighted average of the data from the two or more sensors. In other embodiments, more sophisticated fusion policies (such as any of the fusion policies described herein) may be used. For example, a Dempster-Shafer based algorithm may be used for multi-sensor fusion. The fused sensor data 6018 may be used for any suitable purposes, such as to detect object locations.

In various embodiments, simulation and techniques such as reinforcement learning can also be used to automatically learn the context-based sampling policies (e.g., rates) and sensor fusion weights. Determining how frequently to sample different sensors and what weights to assign to which sensors is challenging due to the large number of driving scenarios. The complexity of context-based sampling is also increased by the desire to achieve different objectives such as high object tracking accuracy and low power consumption without compromising safety. Simulation frameworks which replay sensor data collected in the real-world or simulate virtual road networks and traffic conditions provide safe environments for training context-based models and exploring the impact of adaptive policies.

In addition to the supervised learning techniques described above, in various embodiments, learning context-based sampling and fusion policies may be determined by training reinforcement learning models that support multiple objectives (e.g., both safety and power consumption). In various embodiments, any one or more of object detection accuracy, object tracking accuracy, power consumption, or safety may be the objectives optimized. In some embodiments, such learning may be performed in a simulated environment if not enough actual data is available. In a particular embodiment, reinforcement learning is used to train an agent which has an objective to find the sensor fusion weights and sampling policies that reduce power consumption while maintaining safety by accurately identifying objects (e.g., cars and pedestrians) in the vehicle's path. During training, safety may be a hard constraint such that a threshold level of safety is achieved, while reducing power consumption is a soft constraint which is desired but non-essential.

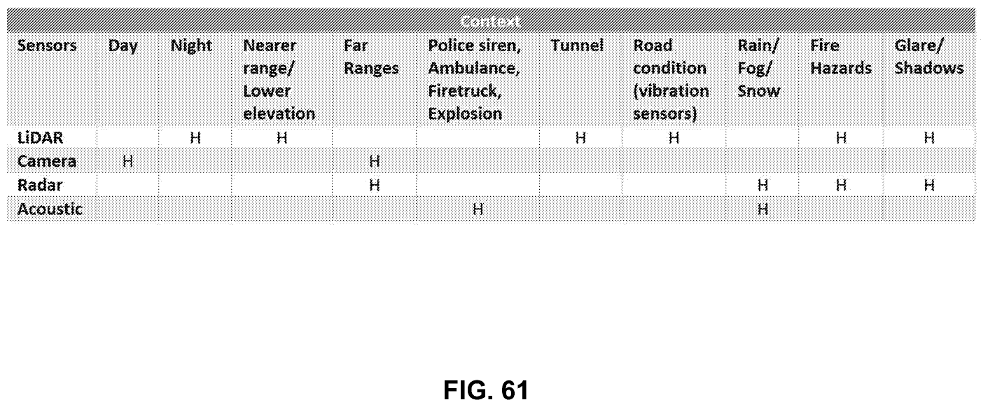

FIG. 61 presents differential weights of the sensors for various contexts. The H in the table represents scenarios where measurements from particular sensors are given a higher rating. As various examples, a LIDAR sensor is given a relatively greater weight at night than a camera sensor, radar sensor, or acoustic sensor, but during the day a camera sensor may be given a relatively greater weight.

FIG. 61 represents an example of outputs that may be provided by the fusion-context dictionary 5910 or by a reinforcement learning model described herein (e.g., this example represents relative weights of various sensors under different contexts). In other embodiments, the sensor weight outputs may be numerical values instead of the categorical high vs. low ratings shown in FIG. 61.

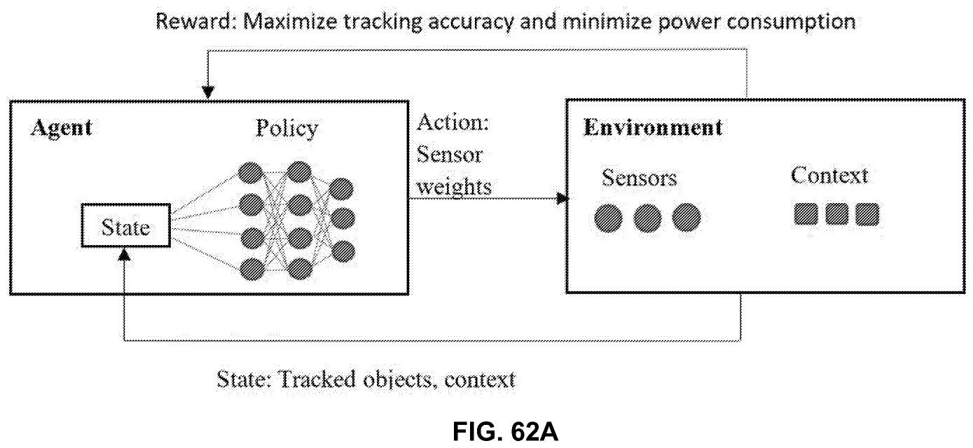

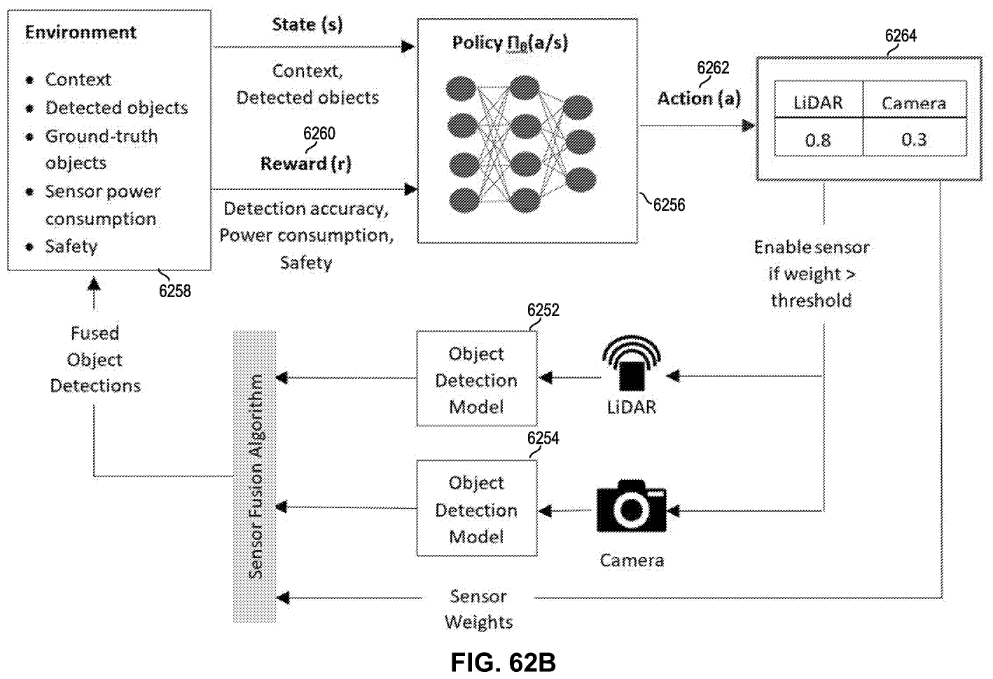

FIG. 62A illustrates an approach for learning weights for sensors under different contexts in accordance with certain embodiments. First, a model that detects objects as accurately as possible may be trained for each individual sensor, e.g., camera, LIDAR, or radar. Although any suitable machine learning models may be used for the object detection models, in some embodiments the objection detection models are supervised machine learning models, such as deep neural networks for camera data, or unsupervised models such as DBSCAN (Density-based spatial clustering of applications with noise) for LIDAR point clouds.

Next, a model may be trained to automatically learn the context-based sensor-fusion policies by using reinforcement learning. The reinforcement learning model uses the current set of objects detected by each sensor and the context to learn a sensor fusion policy. The policy predicts the sensor weights to apply at each time step that will maximize a reward which includes multiple objectives, e.g., maximizing object tracking accuracy and minimizing power consumption.

Thus, as depicted in FIG. 62A, the reinforcement learning algorithm agent (e.g., implemented by a machine learning engine of a computing system) may manage a sensor fusion policy based on an environment comprising sensor data and context and a reward based on outcomes such as tracking accuracy and power consumption and produce an action in the form of sensor weights to use during sensor fusion. Any suitable reinforcement learning algorithms may be used to implement the agent, such as a Q-learning based algorithm.

Under this framework, a weight for a particular sensor may be zero valued for a particular context. A zero-valued weight or a weight below a given threshold indicates that the sensor does not need to be sampled for that particular context as its output is not used during sensor fusion. In each time-step, the model generates a vector with one weight per sensor for the given context.

An alternative implementation of this approach may utilize a multi-agent (one agent per sensor) reinforcement learning model where each agent makes local decisions on weights and sampling rates but the model attempts to achieve a global objective (or combination of objectives) such as increased object tracking accuracy and low power consumption. In such an embodiment, a particular agent may be penalized if it makes a decision that is not achieving the global objective.

FIG. 62B illustrates a more detailed approach for learning weights for sensors under different contexts in accordance with certain embodiments. In this approach, an object detection model 6252 is trained for a LIDAR and an object detection model 6254 is trained for a camera. In a particular embodiment, the object detection model 6254 is a supervised machine learning model, such as deep neural network, and the object detection model, is an unsupervised model, such as DBSCAN for LIDAR point clouds.

As depicted in FIG. 62B, the reinforcement learning algorithm agent may manage a sensor fusion policy 6256 based on an environment 6258 comprising, e.g., context, detected objects, ground-truth objects, sensor power consumption, and safety and a reward 6260 based on outcomes such as detection accuracy, power consumption, and safety. An action 6262 may be produced in the form of sensor weights 6264 to use during sensor fusion. Any uitable reinforcement learning algorithms may be used to implement the agent, such as a Q-learning based algorithm.

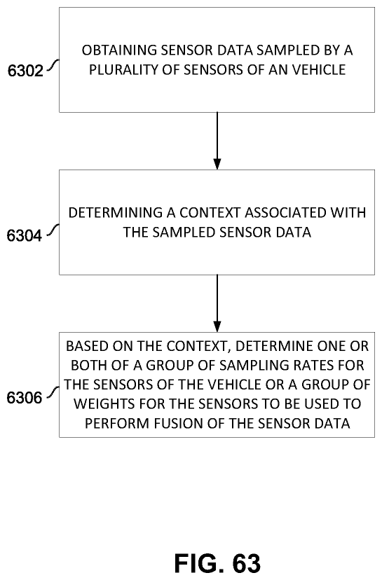

FIG. 63 depicts a flow for determining a sampling policy in accordance with certain embodiments. At 6302, sensor data sampled by a plurality of sensors of a vehicle is obtained. At 6304, a context associated with the sampled sensor data is obtained. At 6306, one or both of a group of sampling rates for the sensors of the vehicle or a group of weights for the sensors to be used to perform fusion of the sensor data are determined based on the context.

In various embodiments, any of the inference modules described above may be implemented by a computing system of an autonomous vehicle or other computing system coupled to the autonomous vehicle, while any of the training modules described above may be implemented by a computing system coupled to one or more autonomous vehicles (e.g., by a centralized computing system coupled to a plurality of autonomous vehicles) or by a computing system of an autonomous vehicle.

Although the above examples have been described with respect to object detection, the concepts may be applied to other autonomous driving operations, such as semantic segmentation and object tracking.

Level 5 (“L5”, fully autonomous) autonomous vehicles may use LIDAR sensors as a primary sending source which does not help economic scalability to wide end consumers. Level 2 (“L2”) or other lower-level autonomous vehicles (with lower levels of automation), on the other hand, may typically use cameras as a primary sensing source and may introduce LIDAR in a progressive mode (usually a low-cost version of a LIDAR sensor) for information redundancy and also correlation with the camera sensors. One piece of information that LIDAR provides over cameras is the distance between the vehicle and vehicles/objects in its surrounding, and also the height information of the surrounding vehicles and objects. However, LIDAR may be one of the most expensive sensor technologies to include in autonomous vehicles.

Accordingly, in some embodiments, a low-cost light-based communication technology may be used as a substitute for LIDAR sensors, to provide depth and height information that the LIDAR provides while providing a savings in the cost of the sensor by substituting information. Such communication modules may be deployed on autonomous vehicles, roadside units, and other systems monitoring traffic and events within a driving environment. In some implementations, Li-Fi (Light Fidelity) technology may be leveraged to convey (in real-time) the exact location of each vehicle, the vehicle's height, and any other information relevant to the vehicle's size/height that may be useful to surrounding vehicles to keep safe distance. The light-based communication technology (e.g., Li-Fi) may be applied to different types of vehicles, including automobiles, motor-cycles, and bicycles, by equipping the vehicles with light sources (e.g., LEDs) and photodetectors. Li-Fi can be applied between vehicles of different types (e.g., a bicycle can use LiFi to convey to a vehicle in its surrounding its location and any other useful information to help maintaining safe distance).

Li-Fi is an emerging technology for wireless communication between devices making use of light to transmit data (e.g., position information) over light waves. Li-Fi may be considered to be similar to Wi-Fi in terms of wireless communication (e.g., may utilize similar protocols, such as IEEE 802.11 protocols), but differs from Wi-Fi in that Li-Fi uses light communication instead of radio frequency waves, which may allow for much larger bandwidth. Li-Fi may be capable of transmitting high speed data over Visible Light Communication (VLC), where Gigabit per second (Gbps) bandwidths can be reached. Li-Fi may use visible light between 400 THz (780 nm) and 800 THz (375 nm) for communication, but may also, in some instances, use Ultra Violet (UV) or Infrared (IR) radiation for communication.

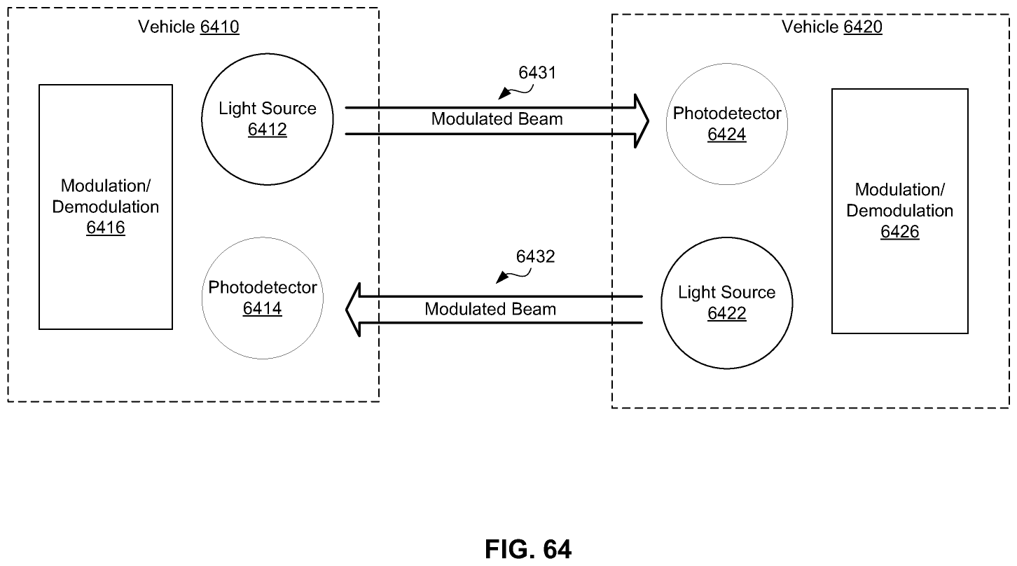

FIG. 64 is a simplified diagram of example VLC or Li-Fi communications between autonomous vehicles 6410, 6420 in accordance with at least one embodiment. In the example shown, a sending light source (e.g., 6412, 6422) of a vehicle (e.g., a lamp of the vehicle fitted with light emitting diodes (LEDs)) transmits a modulated light beam (e.g., 6431, 6432) to a photodetector (e.g., photodiode) of another vehicle. The vehicles may be equipped with signal processing modules (e.g., 6416, 6426) that modulate the light beam emitted so that the beam includes embedded data (e.g., position or height information for the sending vehicle as described above and further below) and demodulate received light signals. The photodetector (e.g., 6414, 6424) of the receiving vehicle receives the light signals from the sending vehicle and converts the changes in amplitude into an electrical signal (which is then converted back into data streams through demodulation). In some embodiments, simultaneous reception for a Li-Fi device from multiple light sources is possible through having photo sensors that include an array of photodetectors (e.g., photodiodes).

This can also allow multiple reception from multiple channels from one light source for increased throughput, in some instances, or from multiple light sources. The multiple channels may be implemented as different channels (wavelengths) on the light (visible, infrared, and/or ultraviolet) spectrum.

Position or other vehicle data (e.g., height of the vehicle, size of the vehicle, or other information that can help other surrounding vehicles create a structure of the transmitting vehicle) may be transmitted through modulation of light waves. The size of the transmitted data may be on the order of a few bytes. For example, position information for the vehicle may utilize approximately 12 digits and 2 characters if it follows the Degree Minute and Second (DMS) format (e.g., 40° 41′ 21.4″ N 74° 02′ 40.2″ W for the closest location to the statue of liberty), which may utilize approximately 7-8 bytes (e.g., 4 bits for each digit and 4 bits for each character of “ASCII code”). As another example, height information for the vehicle (e.g., in meters with one decimal digit) may utilize approximately 4 bits of data. As another example, size information for the vehicle (which may include a length and width of the vehicle in meters) may utilize approximately 1 byte of data for the length and 4 bits of data for the width (e.g., with 1-2 decimal digits for the length “considering buses” and 1 decimal digit for the width).

Any suitable modulation scheme can be used for the communication between the vehicles. Examples of modulation schemes that may be used in embodiments of the present disclosure include:

On-Off Keying (OOK) that is a form of Amplitude Shift Keying (ASK): where LEDs can be switched on or off to model a digital string of binary numbers

Variable pulse position modulation (VPPM): where M bits are encoded by transmitting single pulse in one of 2M possible required time shifts. This is repeated every T seconds (that is variable) to have bit rate (M/T bps)

Color-Shift Keying (CSK): is introduced in IEEE 80215.7 standard that defines and it encodes data in the light using a mixture of red, green and blue LEDs and varying the flickering rate of each LED to transmit data

The sampling rate of the position, height, size or other information transmitted by a vehicle can take at least two forms. As one example, the sampling may be proactive, where each vehicle constantly sends its position (or other) information at a given frequency. For instance, proactive sampling may be chosen in highly crowded areas, high crash risk areas, or during night time. The photodetector in this case may be considered as a physical sensor bringing sensing “depth” information from the received data, with the sensor fusion constantly considering inputs from the photo-detector. As another example, the sampling may be event-based, where each vehicle sends its position information once it detects other vehicle(s) in its surrounding. The photodetector in this case may be considered as a physical sensor bringing sensing “depth” information from the received data on-demand whenever a traffic vehicle is detected in the surrounding, and the sensor fusion may consider inputs from the photodetector in an event-based manner.

In some cases, each vehicle may leverage existing light sources (front-light, back-light, side-light, or roof-placed LEDs) and modulate the light waves from those sources to transmit the required data at a particular frequency or in an event-driven form (e.g., when the vehicle cameras detect surrounding vehicles, or when the vehicle is stopped at a traffic light or stop sign).

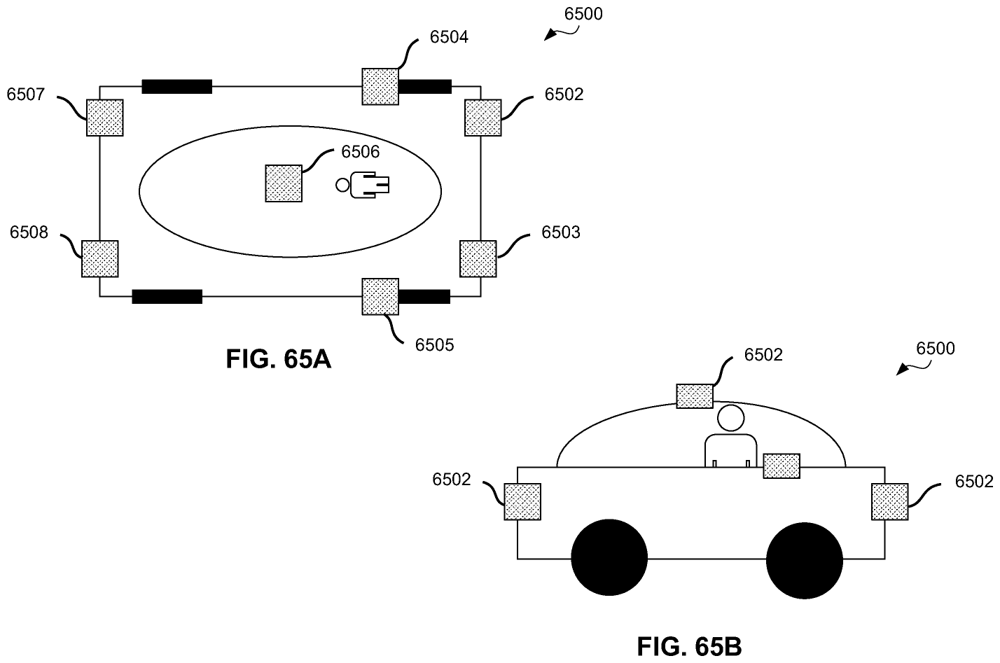

FIGS. 65A-65B are simplified diagrams of example VLC or Li-Fi sensor locations on an autonomous vehicle 6500 in accordance with at least one embodiment. FIG. 65A shows a bird's eye view of the autonomous vehicle 6500, while FIG. 65B shows a side view of the autonomous vehicle 6500. The autonomous vehicle 6500 includes sensors 6502, 6503, 6504, 6505, 6506, 6507, 6508. Each sensor may include both a light source (or multiple light sources, e.g., an array of LEDs) and a photodetector (or multiple photodetectors, e.g., an array of photodetectors). In some embodiments, existing light sources of the vehicles (e.g., front-lights (for sensors 6502, 6503), back-lights (for sensors 6507, 6508), and side-lights (for sensors 6504, 6505)) may be leveraged to communicate in real-time the position information for each vehicle to all field of view surrounding vehicles. This allows each vehicle to calculate the distance from all surrounding vehicles (substituting the depth information that the LIDAR currently provides). The height information can be provided (as well as size or any relevant information that can help maintaining safe distance and discovering the surrounding in real-time). Sensors may also be placed in other locations of the vehicle where there are no current light sources, such as on top of the vehicle as shown for sensor 6506. Sensors may also be placed in other locations on the autonomous vehicle 6500 than those shown in FIG. 65.

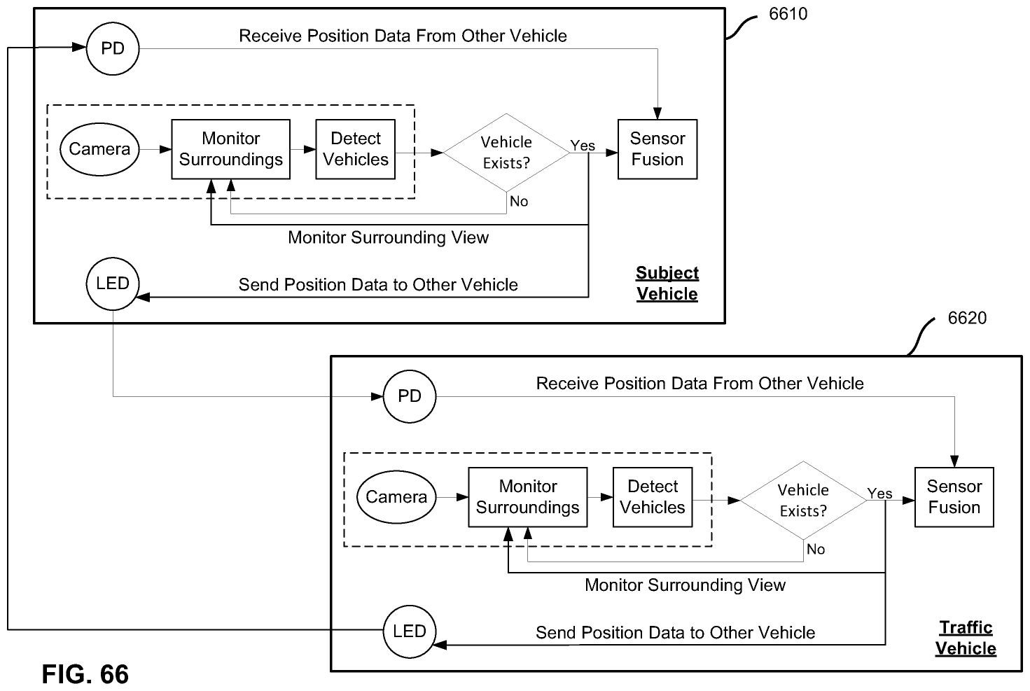

FIG. 66 is a simplified diagram of example VLC or Li-Fi communication between a subject vehicle 6610 and a traffic vehicle 6620 in accordance with at least one embodiment. In particular, FIG. 66 shows how a subject autonomous vehicle considers in its sensor fusion process the surrounding traffic vehicle(s) position information coming from a Li-Fi data transmission by a traffic vehicle (and how a traffic vehicle gets the position information of the subject vehicle in its surrounding in a similar way). The subject autonomous vehicle may utilize the same process to process other Li-Fi data transmissions from other traffic vehicles as well (not shown).

In the example shown, each vehicle is equipped with a vision system (among other sensors) and Li-Fi transmitters (e.g., LEDs and signal processing circuitry/software) and Li-Fi receivers (e.g., photodetectors (PD) and signal processing circuitry/software). As shown, the sensor fusion module/stack in each vehicle takes the usual inputs from the camera-based vision system and additional input from the photo-detector.

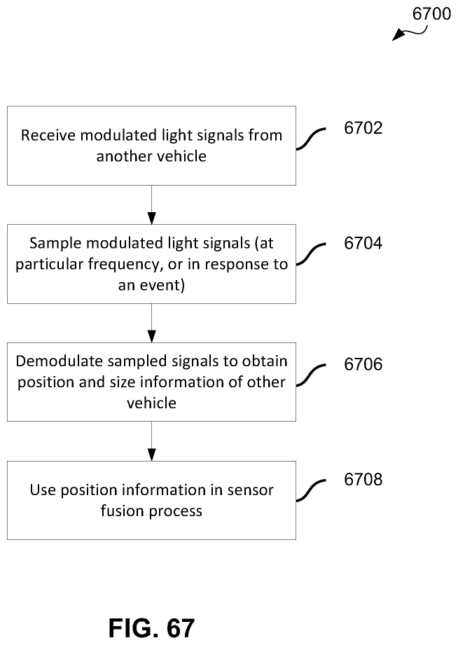

FIG. 67 is a simplified diagram of example process of using VLC or Li-Fi information in a sensor fusion process of an autonomous vehicle in accordance with at least one embodiment. Operations in the example process 6700 may be performed by components of an autonomous vehicle (e.g., one or both of the autonomous vehicles of FIG. 66). The example process 6700 may include additional or different operations, and the operations may be performed in the order shown or in another order. In some cases, one or more of the operations shown in FIG. 6700 are implemented as processes that include multiple operations, sub-processes, or other types of routines. In some cases, operations can be combined, performed in another order, performed in parallel, iterated, or otherwise repeated or performed another manner.

At 6702, an autonomous vehicle receives modulated light signals from another vehicle (a “traffic vehicle”). In some cases, the autonomous vehicle may receive modulated light signals from multiple traffic vehicles.

At 6704, the modulated light signals are sampled. The sampling may be done at a particular frequency (e.g., every few milliseconds), or in response to a detected event (e.g., detecting the presence of the traffic vehicle in the surrounding area of the autonomous vehicle).

At 6706, the sampled signals are demodulated to obtain position and size information for the traffic vehicle. The position information may include information indicating an exact location of the traffic vehicle. For example, the position information may include geocoordinates of the traffic vehicle in a DMS format, or in another format. The size information may include information indicating a size of the traffic vehicle, and may include a length, width, and/or height of the traffic vehicle (e.g., in meters).

At 6708, the position information obtained at 6706 is used in a sensor fusion process of the autonomous vehicle. For example, the autonomous vehicle may use the position information in a perception phase of an autonomous driving pipeline.

Reducing the costs of the underlying technology and components utilized to implement autonomous driving functionality may be considered a key element in making autonomous driving economically feasible for the mass consumer markets and hastening its adoption on the road. Part of the high cost of autonomous vehicles lies in the use of high performance sensors such as LIDAR sensors, radar sensors, cameras, inertial measurement units (IMU), global navigation satellite system (GNSS) receivers, and others. Part of the high cost lies in the need for high performance data processing, high bandwidth data communication, and high volume storage. Both sensors and compute capabilities need to process very large amounts of data in real-time, in a highly robust manner, using automotive-grade components, and satisfying functional safety standards. Part of the high cost lies in the development process for autonomous vehicles.

The development process for autonomous vehicles and associated sensors typically includes development, training and testing of perception, planning and control software algorithms and hardware components, through various methods of simulation and field testing. In particular, modern perception systems for autonomous vehicles may utilize machine learning methods, which require training of perception (e.g., computer vision) algorithms, resulting in trained models specific to the task and sensor at hand. Modern machine learning based methods require collection of very large data sets as well as very large efforts to obtain ground-truth algorithm output (e.g., “data labeling”), which are very costly. These data sets are commonly dependent on the specific sensor used and characteristics of the data. Efforts to ease the re-use of perception algorithms in domains other than those for which the algorithm was originally developed involve the concepts of transfer learning and domain adaptation. Despite significant efforts, re-use of these algorithms remains a difficult and unsolved problem.

One approach to reducing costs may include integration of the various sensing and planning data processing subsystems into fewer compute components, reducing the footprint and power needs of the processing pipeline gradually, and reaching economies of scale. Another approach to reducing cost is to maximize the re-use of fewer data processing components and to utilize common components across the multiple tasks that need to be performed in a single autonomous vehicle and across multiple types of autonomous vehicles. This may involve the use of common perception algorithms, common algorithm training data sets and common machine learning models.

According to some embodiments, a data processing pipeline utilizes common components for both camera (visual) data and LIDAR (depth/distance/range) data, which may enable utilization of common processing components for both camera data and LIDAR data. This may reduce the cost of the development of autonomous vehicles and may reduce the cost of the components themselves.

In some embodiments, sensor data may be abstracted away from the raw physical characteristics that both camera data and LIDAR data possess, into a more normalized format that enables processing of the data in a more uniform manner. These techniques can be considered a kind of pre-processing that may reduce noise or reduce sensor-specific characteristics of the data, while preserving the fidelity of the data and the critical scene information contained in it. The resulting abstracted and normalized data can be provided to standard perception components/algorithms (e.g., those in a perception phase/subsystem of a control process for the autonomous vehicle), for example object detection, road sign detection, traffic sign detection, traffic light detection, vehicle detection, or pedestrian detection, that are necessary for autonomous driving. The resulting abstracted and normalized data enables easier transfer learning and domain adaptation for perception algorithms and other processing components that must recognize the state of the world around the autonomous vehicle from the data. In addition to detection, the perception phase/subsystem may more generally include classification functions, e.g., detecting specific traffic signs and/or classifying the exact type of the traffic sign, or classifying vehicles into specific types such as passenger car, van, truck, emergency vehicles, and others. Furthermore, the perception phase/subsystem may involve estimation of the position and velocity of road agents and other dimensions of their state. Furthermore, the autonomous vehicle perception phase/subsystem may classify or recognize the actions or behavior of road agents. All such functions of the perception phase/system may be dependent on the specifics of the sensor(s) and may benefit from sensor data abstraction.

In some instances, sensor data abstraction and normalization may enable common processing amongst different sensors of the same type used in a single vehicle. For example, multiple types of cameras may be used in a single vehicle (e.g., a combination of one or more of the following: perspective cameras, fisheye cameras, panoramic cameras). The different types of cameras may have strongly different fields of view or different projections into the image plane. Each type of camera may also be used in specific configurations on the vehicle. Modalities such as visible light, infrared light, thermal vision, and imaging at other wavelengths each have their own characteristics. Likewise, multiple types of LIDAR, with different characteristics, may be used on a vehicle. Accordingly, in certain aspects of the present disclosure, the sensor data from the different types of cameras may be abstracted into a common format, and sensor data from different types of LIDAR may similarly be abstracted into a common format.

Aspects of the present disclosure may enable low-level fusion of sensor data within and across modalities and sensor types. Broadly speaking, low-level sensor fusion for autonomous driving and mobile robotics includes combining sensor data from multiple modalities that have an overlapping field of view. In some cases, for example, sensor fusion may include one or more of the following:

Combining data strictly within the overlapping field of view, but may also include stitching together data from different fields of view with some overlap (e.g., image mosaicking, panoramic image creation).

Combining multiple camera images captured at a given resolution to achieve super-resolution (e.g., creation of images at resolutions higher than the camera resolution). This can allow using lower-cost cameras to achieve the resolution of higher-cost cameras.

Combining multiple LIDAR data scans to increase their resolution. To the best of our knowledge, achieving super-resolution with LIDAR data is an entirely new field.

Combining multiple camera images captured at a given limited dynamic range, to achieve higher dynamic range.

Combining multiple camera images or multiple LIDAR scans to achieve noise reduction, e.g., suppressing noise present in each individual camera image or LIDAR scan.

Combining camera and LIDAR images to achieve a higher detection rate of objects present in both modalities, but with independent “noise” sources.

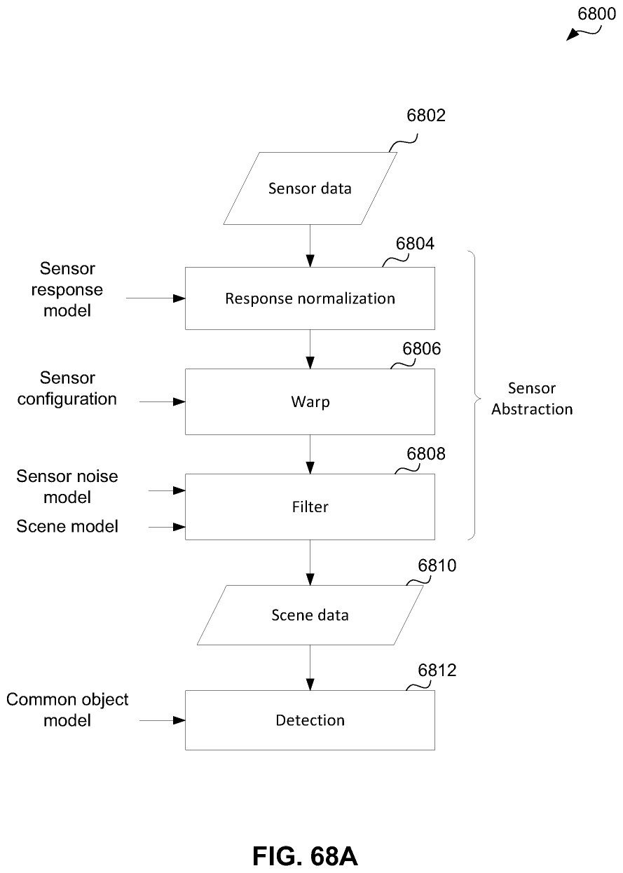

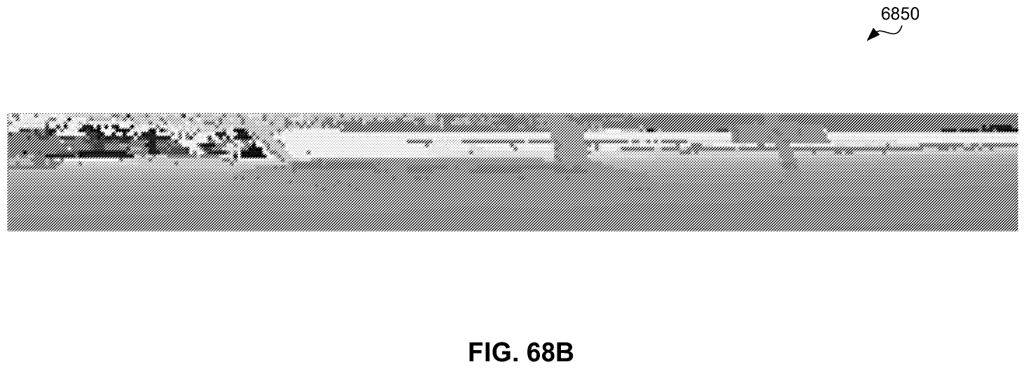

One embodiment is shown in FIG. 68A, which illustrates a processing pipeline 6800 for a single stream of sensor data 6802 coming from a single sensor. By several sensor abstraction actions 6804, 6806, 6808, the original sensor data is transformed and normalized into a “scene data” format 6810. The scene data is subsequently provided to a detection stage/algorithm 6812, which may include vehicle detection, pedestrian detection, or other detection components critical to autonomous driving. The detection stage uses a common object model, which can be used in combination with scene data originating from multiple types of sensors, since the scene data 6810 has been abstracted from the original sensor data 6802. In the case of a machine learning model, such as a deep neural net, convolutional neural net, fully connected neural net, recursive neural net, etc., the abstraction actions (6804, 6806, 6808) are applied both during training and inference. For brevity, FIG. 68A only shows the inference stage.

In one example, an example sensor abstraction process may include an action (e.g., 6804) to normalize the sensor response values. In the case of a camera image, for example, this may include normalizing the pixel values (e.g., grayscale or color values). For example, different cameras of an autonomous vehicle may have different bit depths, such as 8 bit per pixel, 10 bit or 12 bit per pixel, or different color space (often represented as RGB or as YUV (luminance, chrominance), or in different color spaces). The response normalization action may use a model of the sensor response (e.g., a camera response function) to transform the response values into a normalized range and representation. This may also enable combination of camera images captured with different exposures into a high-dynamic range image, in some embodiments. The parameters of the sensor response model may be known (e.g., from exposure and other sensors settings) or may be estimated from the data itself.

In the case of LIDAR, raw sensor data may be in the form of depth or distance values. Based on the horizontal angle (azimuth angle) and vertical angle (elevation angle), the depth values can be converted to X,Y,Z point position values. As an example, the X axis may be close to being perpendicular to the vehicle longitudinal axis, the Y axis may be close to parallel to the vehicle longitudinal axis, and the Z axis may be close to pointing upwards, away from the ground. For the purpose of object recognition, either the raw depth value or one or two of the X,Y,Z values may be most useful. Hence, LIDAR values may be represented as either a single scalar, or as a pair, or triplet of values. The values themselves may be transformed into a normalized range in some embodiments. In some instances, LIDAR sensors may provide a two-dimensional (2-D) array of depth or distance values across a horizontal and vertical field of view, and the array may be in the same form as a 2-D image. An example of such an image obtained directly from LIDAR data is shown in FIG. 68B. In certain aspects of the present disclosure, LIDAR sensor data may be retained in this 2-D array form rather than being represented as a point cloud. An important consequence from retaining the data in the 2-D array is that both camera and LIDAR data are represented as 2-D arrays or images.

Continuing with this example, the sensor abstraction process may continue by warping (e.g., 6806) the sensor data. In some embodiments, the warp stage may include a spatial upscaling or downscaling operation. A simple upscaling or downscaling may be used to change the spatial resolution of a camera image or LIDAR array. As illustrated in the example shown in FIG. 68B, the resolution of LIDAR sensor data 6850 may be high in the horizontal dimension, but low in the vertical dimension. In order to facilitate sensor abstraction, sensor fusion, and object detection using common detection models, it may therefore be desirable to increase the vertical resolution of the LIDAR array. One method of doing this is to apply an upscaling operation, using the same or similar techniques to those developed in image processing.

In some embodiments, warping also incorporates corrections for geometric effects inherent to the sensing process. As an example, warping may correct for the differences between perspective cameras and fisheye cameras. The warping action may transform a fisheye image into a perspective image or panoramic image. Again, this may enable a common detection model at a later stage. The warping action may also consider the configuration and fields of view of the camera or LIDAR sensor, which may enable combination of images or LIDAR scans from multiple sensors into a mosaic or panoramic image (a.k.a. image stitching).

In some embodiments, the warping action may also incorporate corrections for camera motion, including both motion due to the car motion as well as unintended motion due to vibration. This may enable combining multiple images or LIDAR scans captured at slightly different times and accounting for the motion of the sensor between the two capture times. This combination of multiple images of the same scene enables improved resolution (super-resolution), noise reduction, and other forms of sensor fusion. The parameters of the sensor motion and other required parameters may be measured (e.g., using other sensors) or may be estimated from the data itself. To summarize, the warping action may account for many types of geometric differences between sensor data streams, and may result in spatial and temporal alignment (or registration) of the data into a normalized configuration.

In some implementations, sensor abstraction may continue with applying filtering (e.g., 6808) to the data. This filtering may utilize data from a single time instant, or may involve filtering using data from previous and current time instants. For example, a single camera image or multiple camera images (or image frames) may be used.

In some embodiments, a time-recursive method of filtering may be used. A time-recursive image filter may use the previously filtered image at the previous time instant and combine it with image data sensed at the current time. As a specific example, a Kalman filter (or a variant of the Kalman filter) may be used. The filter (e.g., a Kalman filter or variant thereof) may incorporate a prediction action based on data from previous time instants and an update action based on data from current time. Other filters known in the art may be used as well, such as a particle filter, histogram filter, information filter, Bayes filter, Gaussian filter.

In some cases, the filtering action may use a sensor noise model to properly account and suppress noise from the different types of sensors, camera and/or LIDAR. The noise model describes the nature and strength of the noise in the original sensor data, while keeping track of the pipeline operations prior to filtering (e.g., response normalization and warping), and their effects on the noise in the data. As an example, the strength of the noise in the original data is modulated during the response normalization action. Also, the spatial characteristics of the noise may be affected during the warping action. The parameters of the sensor noise model may be based on measurement or may be estimated from the data itself. The filtering action may also use a scene model, which may capture the uncertainty or noise predicting the current data from previous data. For example, the relation between the data at the current time action and data at the previous time action is dependent on the motion of the autonomous vehicle and its sensors. This motion can be measured or estimated, within some remaining uncertainty or noise. The scene model accounts for this uncertainty. The scene model may also describe the magnitude of significant variations in the true signal due to the scene itself (without noise). This information can be used by the filtering action to weigh the significance of variations observed in the data. The filtering action may also use a model of the sensor that includes additional characteristics, such as lens, imaging, and solid-state sensor characteristics in the case of cameras, and may result in spatial blur or other effects. The filtering action may reduce the effects of these characteristics or normalize the data to a common level, for example a common level of blur. Hence, in the case of images (for example), the filtering action may operate to reduce or increase the level of blur, depending on the situation, using well-known convolution or deconvolution techniques. The sensor model keeps track of the effect of the previous data abstraction actions on the level of blur throughout the data as well. Finally, the filtering action keeps track of the level of noise and blur in its output, throughout the output data. This information may be used during the next time instant, if the filtering action is a time-recursive process, e.g., a type of Kalman filtering. This information may also be used by subsequent processes, such as sensor fusion of the abstracted sensor data, or by the detection stage.

The filter actions may also consider the validity of individual samples and may use a validity or occupancy map to indicate valid samples. In LIDAR data, for example, individual samples can be invalid in case a LIDAR return was not received or not received with sufficient signal strength. Also, given multiple sensor images or arrays captured at different angles of view and field of view, some parts of an image or sensor array may be considered not useful, e.g., when combining images with overlapping (but not identical) field of view.

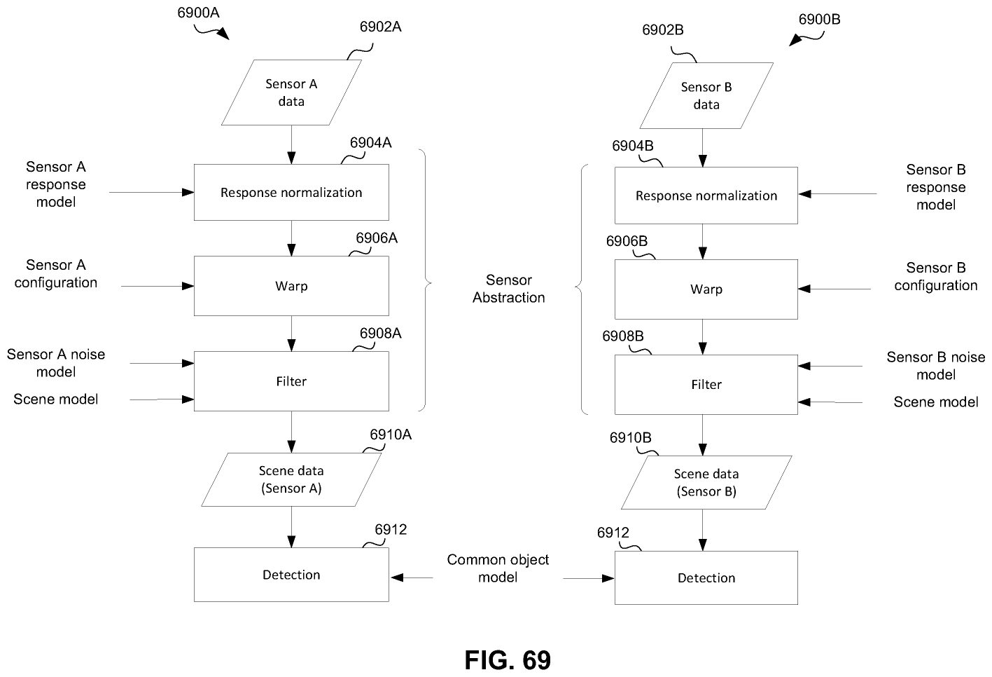

FIGS. 69, 70, and 71 show embodiments of processing pipelines for multiple streams of sensor data coming from multiple sensors.

FIG. 69 shows example parallel processing pipelines 6900 for processing multiple streams of sensor data 6902. Each aspect of the pipelines 6900 is the same as the corresponding aspect in the pipeline 6800 shown in FIG. 68A and described above, with each pipeline handline sensor data from a different sensor (Sensors A and B). In the example shown, a common detection/perception algorithm (or trained machine learning model) (e.g., 6912) is applied to more than one sensor data stream 6902, but without any fusion. For instance, in the example shown, the common object model is fed into both detection blocks 6912 of the two pipelines 6900. One benefit of the data abstraction idea is that the detection/perception algorithm can be trained on and applied to “abstracted” data from various sensors, and hence there may be less cost/effort needed to develop detection algorithms for each sensor.

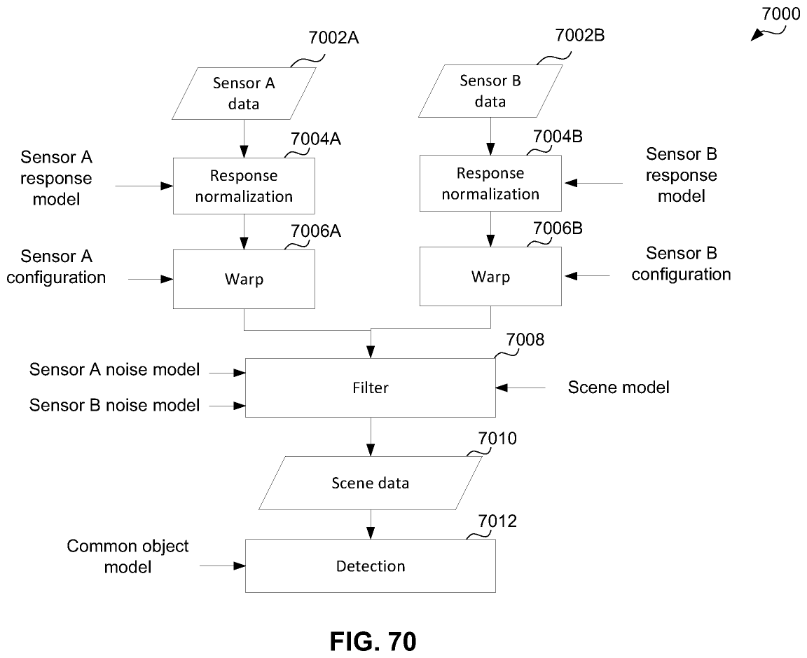

FIG. 70 shows a processing pipeline 7000 where data from multiple sensors is being combined by the filtering action. In the example shown, the sensor abstraction process includes normalizing each respective stream of sensor data 7002 at 7004 and warping each respective stream of sensor data 7002 at 7006 before combining the streams at the filtering action 7008. Each action of the sensor abstraction process may be performed in a similar manner to the corresponding sensor abstraction process actions described with respect to FIG. 68A above. The filtering action 7008 may utilize sensor noise models for each respective sensor data stream, along with a scene model to produce abstracted scene data 7010. The abstracted scene data may then be passed to a detection process/algorithm 7012 for object detection. The detection process/algorithm may be performed similar to the detection stage/algorithm described above with respect to FIG. 68A. As an example, the pipeline 7000 may be used in the case of image mosaicking, super-resolution, or high-dynamic range imaging, whereby multiple images may be combined by the filtering action.

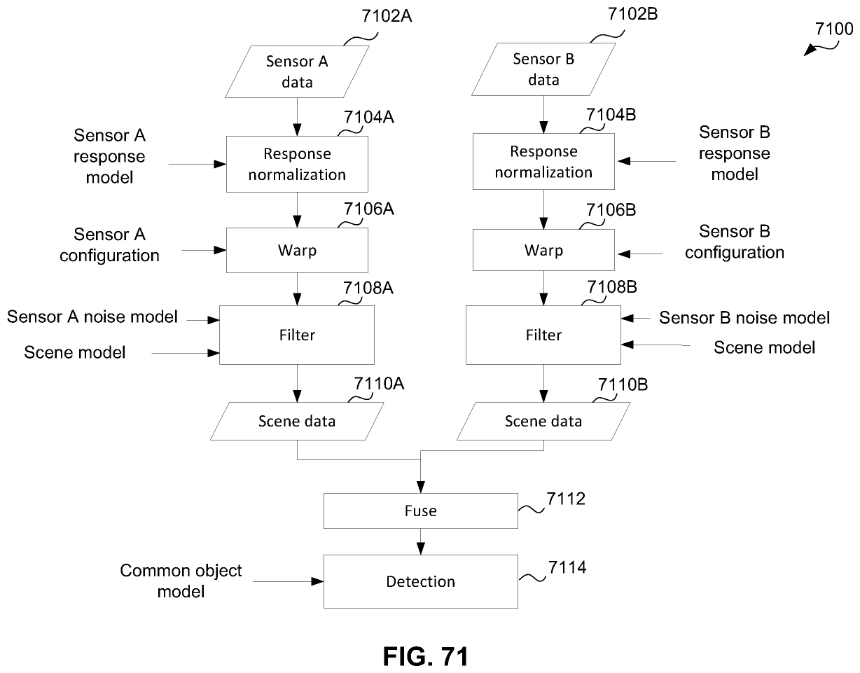

FIG. 71 shows a processing pipeline 7100 where data from multiple sensors is being combined by a fusion action after all actions of sensor abstraction outlined above. In the example shown, the sensor abstraction process includes normalizing each respective stream of sensor data 7102 at 7104, warping each respective stream of sensor data 7102 at 7106, and applying filtering to each respective stream of sensor data 7103 at 7008. Each action of the sensor abstraction process may be performed in a similar manner to the corresponding sensor abstraction process actions described with respect to FIG. 68A above. The respective filtering actions 7008 for each data stream may utilize sensor noise models for the corresponding sensor data stream, along with a scene model to produce abstracted scene data 7010 for the respective sensor data. The abstracted scene data may then be passed to a fuse stage 7112, where the abstracted scene data are fused, before providing the fused data to the detection process/algorithm 7014 for object detection. The detection process/algorithm may be performed similar to the detection stage/algorithm described above with respect to FIG. 68A. As an example, the pipeline 7100 may be used in the case of fusion of LIDAR and camera data, whereby data from a LIDAR sensor and data from a camera are combined prior to the detection stage.

Operations in the example processes shown in FIGS. 68, 70, 71 may be performed by various aspects or components of an autonomous vehicle. The example processes may include additional or different operations, and the operations may be performed in the order shown or in another order. In some cases, one or more of the operations shown in FIGS. 68, 70, 71 are implemented as processes that include multiple operations, sub-processes, or other types of routines. In some cases, operations can be combined, performed in another order, performed in parallel, iterated, or otherwise repeated or performed another manner.

An autonomous vehicle may have a variety of different types of sensors, such as one or more LIDARs, radars, cameras, global positioning systems (GPS), inertial measurement units (IMU), audio sensors, thermal sensors, or other sensors (such as those described herein or other suitable sensors). These sensors may be used to aid perception performed by the vehicle. Since perception is generally the first function performed in the autonomous vehicle stack, errors in perception will impact subsequent functions, such as sensor fusion, localization, path planning, or other phases in a detrimental manner. Such errors may lead to accidents and consequent loss of trust and acceptance of autonomous vehicles. To mitigate errors in perception, many systems utilize high quality, high-resolution cameras and other sensors. However, these high-quality components may increase the costs of autonomous vehicles and increase the power consumed, which may in turn slow down the acceptance of autonomous vehicles.

Various embodiments of the present disclosure may address this problem by providing a scalable sensors approach based on super-resolution upscaling methods. For example, sensors with relatively low-resolution may be deployed. The low-resolution data obtained from such sensors may then be upscaled to high-resolution data through the use of super-resolution processing methods. Any suitable super-resolution upscaling methods may be utilized. For example, the upscaling may be performed by various deep neural networks, such as deep generative models. As another example, the upscaling may be performed using a model trained using knowledge distillation techniques. In various embodiments, such networks may be trained on real-world data to derive high-resolution data from low-resolution data.

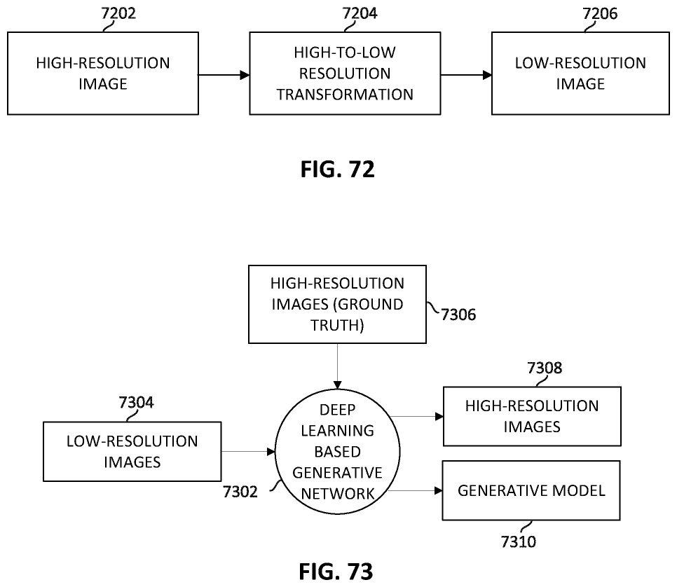

FIG. 72 depicts a flow for generating training data including high-resolution and corresponding low-resolution images in accordance with certain embodiments. The flow may begin with the capture of a high-resolution image 7202 (having high quality) using one or more high-resolution sensors. At 7204, the high-resolution image is then transformed to look like an image generated using one or more low-resolution sensors (e.g., low-resolution image 7206). The high-to-low-resolution transform 7204 may be performed in any suitable manner. In various examples, one or more low-pass filters may be applied to the high-resolution image (e.g., resulting in a smoothing of the image), sub-sampling may be performed on the high-resolution image, noise may be added to the high-resolution image (e.g., salt and pepper noise may be added to mimic weather conditions (e.g., rain or snow)), the high-resolution image may be downsampled, channels (e.g., RGB values) of a color image may be randomized (e.g., to simulate various illumination conditions), other techniques may be performed, or a combination of techniques may be performed by a computing system (e.g., an in-vehicle computing system). The flow of FIG. 72 may be performed any number of times using data from any number of sensors to generate a rich training dataset.

In addition, or as an alternative, the training data may be obtained by simultaneously capturing images using a high-resolution sensor and a low-resolution sensor. The resulting images may be calibrated in terms of position and timing such that the images represent the same field of view at the same time. Thus, each high-resolution image may have a corresponding low-resolution image.

FIG. 73 depicts a training phase for a model 7310 to generate high-resolution images from low-resolutions images in accordance with certain embodiments. During the training phase, a deep learning based generative network 7302 may receive high-resolution images 7306 as the ground truth and corresponding low-resolution images 7304. The network 7302 generates high-resolution images 7308 as an output and compares these with the ground truth high-resolution images 7306. The error between a generated high-resolution image and the corresponding ground truth image is back propagated to train the parameters of the network 7302. In some embodiments, the error is based on a loss function which also factors in robustness to adversarial attacks. Once the model 7310 is trained, it may be deployed in vehicles for inference in cars equipped with low-resolution cameras (e.g., using an inference engine). A particular advantage of this method for training is that it does not require an expensive labeling process for the ground truth, and thus is unsupervised in a sense.

In various embodiments, any suitable machine learning model may be used to generate high-resolution images from low-resolution images (also referred to as image super resolution). For example, a generative neural network may be used (where an adversary may or may not be present). In some embodiments, the model may be based on a convolutional neural network (CNN), a neighbor embedding regression, random forest, or other suitable machine learning architecture. As various examples, a Very-Deep Super-Resolution (VDSR) model, a learning method Single Image Super-Resolution (SISR) model, a reconstruction method SISR model, a Super-Resolution Convolutional Neural Network (SRCNN), or any other suitable model may be used.

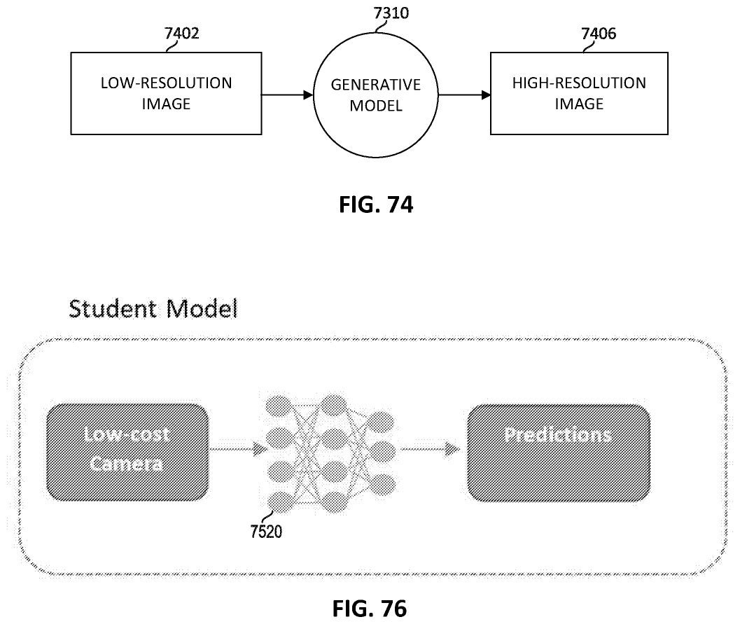

FIG. 74 depicts an inference phase for a model 7310 to generate high-resolution images from low-resolution images in accordance with certain embodiments. During the inference phase, a low-resolution image 7402 captured by one or more low-resolution cameras is supplied to the generative model 7310. The generative model 7310 processes the image 7402 using the parameters determined during training and outputs a high-resolution image 7406. The high-resolution images generated by generative model 7310 may be used for perception or other suitable blocks of the autonomous vehicle stack.

Although the examples above focus on processing of camera image data, similar super-resolution upscaling methods may be applied to other sensor data, such as LIDAR data. Raw LIDAR data may include an array of depth or distance measurements across a field of view. Super-resolution processing may be applied to such a two-dimensional (2-D) array in a very similar manner as with camera image data. As in the above, a deep learning-based generative network can be trained using collected high-resolution LIDAR data as ground truth. Subsequently, the trained network can be deployed in an autonomous vehicle to upscale low-resolution LIDAR data to high-resolution LIDAR data. In particular embodiments, a similar super-resolution processing method may also be used to upscale LIDAR data in a point cloud format.

In various embodiments of the present disclosure, knowledge distillation techniques may be used to support scalable sensing. Knowledge distillation is a technique for improving the accuracy of a student model by transferring knowledge from a larger teacher model or ensemble of teacher models to the student. Despite the differences in sensing technologies between sensors such as LIDAR and cameras, there is overlap in the features they can detect. For example, 3D cameras can provide depth information albeit at a lower resolution than LIDAR sensors which provide a high-resolution 3D mapping of a scene. In general, models trained using the lower resolution sensors tend to be less accurate than models trained using higher resolution sensors, even though a human observer might be able to correctly identify objects in the low-resolution images. In particular embodiments of the present disclosure, knowledge distillation may be used to transfer knowledge from an ensemble of teacher models trained using various types of high-cost sensors (e.g., LIDAR and high-resolution cameras) to student models that use low-cost sensors (e.g., low-resolution cameras or low-resolution LIDARs).

During training, knowledge distillation transfers knowledge from the teacher to the student using a multi-task loss which minimizes the loss for the primary task of the model (e.g., object detection), as well as the distillation loss between how the teacher network encodes its features and how the student network encodes them. Training data is generated by synchronizing data using calibration and timestamps to ensure that both the high-cost and low-cost sensors are viewing the same scene.

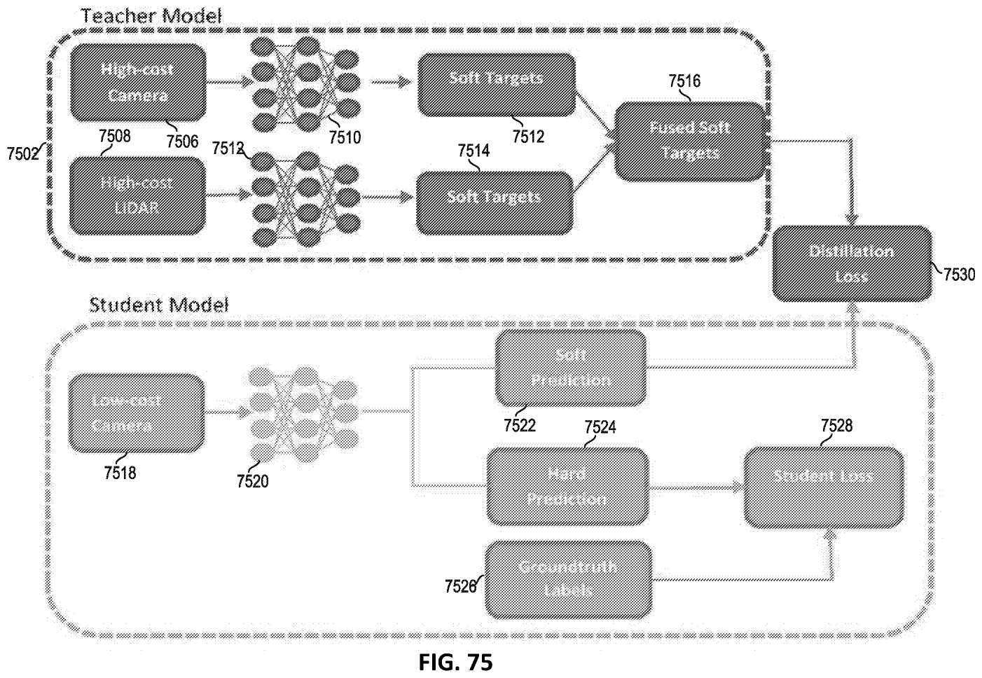

FIG. 75 depicts a training phase for training a student model 7504 using knowledge distillation in accordance with certain embodiments. First, a teacher model comprising an ensemble 7502 of models 7510 and 7512 are trained using the high-cost sensors 7506 and 7508 to detect objects as accurately as possible. Next, knowledge from the ensemble 7502 of teacher models 7510 and 7512 is transferred to the student model 7520 by computing soft targets 7512 and 7514 from the distribution of object probabilities predicted by the ensemble 7502 of teacher models and using them to teach the student model 7520 how to generalize information. The soft targets 7512 and 7514 are used in conjunction with the hard targets (predictions 7524) obtained from the ground-truth labels 7526 to improve the accuracy of the student model.

Any suitable models may be used for either the ensemble 7502 of models or the student model 7520. In particular embodiments, one or more of these models comprises a convolutional neural network (CNN). In some embodiments, one or more of these models comprises a recurrent neural network (RNN) (e.g., in a segmentation model learning how to categorize pixels in a scene by predicting the sequence of polygon coordinates that bound objects). Yet other embodiments may include models that include any suitable neural network or other machine learning models.

In a particular embodiment, soft targets 7512, 7514, and 7522 may be extracted from a layer of a respective classification algorithm (e.g., neural network) that is not the final output. For example, in an object detection model, a soft target may indicate one or more of dimensions of a bounding box of an object, one or more classes determined for the object, or a likelihood associated with each class (e.g., 0.7 cat, 0.3 dog). In a segmentation model, a soft target may indicate, for each pixel, softmax probabilities of that pixel with respect to different semantic categories. In a particular embodiment, a soft target may include information from a feature map of a particular layer of a neural network.

The fused soft targets 7516 may be determined from the soft targets 7512 and 7514 in any suitable manner. As various examples, the soft targets may be combined using weighted averages, Dempster-Shafer theory, decision trees, Bayesian inference, fuzzy logic, any techniques derived from the context-based sensor fusion methods described herein, or other suitable manners. In one embodiment, a union operation may be performed for the bounding boxes wherein the area that is common to a bounding box predicted by model 7510 and a bounding box predicted by model 7512 is determined to be the bounding box of the fused soft target in 7516. In various embodiments, the soft targets may be fused together in any suitable manner.

The hard prediction 7524 may be the final output of the model 7520. As an example, the hard prediction 7524 may include the class predicted for a detected object or pixel.

The distillation loss 7530 is the difference between the fused soft targets 7516 predicted by the high cost sensors and the corresponding soft targets 7522 predicted by the low cost camera 7518.

Instead of merely optimizing the student model 7520 on the student loss 7528, e.g., the differences between the hard predictions 7524 and the ground truth labels 7526, a multi-task loss (including the student loss 7528 and the distillation loss 7530) is used to tune the parameters of the student model 7520.

FIG. 76 depicts an inference phase for a student model trained using knowledge distillation in accordance with certain embodiments. During inference, the student model detects objects using only the data from one or more low-cost sensors, in the case of camera image data. In other embodiments, a similar inference process may involve LIDAR data input (e.g., from a low cost LIDAR with a lower resolution). In that case, the student model would also be trained with LIDAR data as input.

In various embodiments, the model depicted may be adapted for any suitable sensors. The parent ensemble 7502 or the student model may include any number, qualities of, and/or types of sensors. For example, the student model may be trained using data from a low-cost LIDAR sensor (e.g., having lower resolution than a high-resolution LIDAR sensor that is part of the teacher ensemble). In another embodiment, the student model may be trained with data from both a low-resolution camera 7518 as well as a low-resolution LIDAR (or any other suitable quality or types of sensors) with fused soft and hard targets used to determine the student loss 7528 and compared against the fused soft targets 7516 to determine the distillation loss 7530. In such embodiments, a similar inference process may be utilized for a combination of LIDAR and camera data input when deployed in a vehicle.

In a particular embodiment, high-resolution sensor data is captured from an autonomous vehicle. The high-resolution sensor data is transformed to low-resolution sensor data using techniques such as low-pass filtering, subsampling, or other suitable techniques. A generative machine learning model is trained to transform low-resolution sensor data into high-resolution sensor data. During inference, object detection operations are performed at a vehicle by using the trained generative machine learning model to transform low-resolution sensor data into high-resolution sensor data.

In another particular embodiment, an ensemble of machine learning models are trained to perform a task of an autonomous vehicle stack by using high-resolution data from different types of sensors (e.g., camera, LIDAR, etc.). Knowledge from the ensemble of machine learning models trained using high-resolution sensor data is transferred to a student machine learning model trained using low-resolution sensor data by incorporating a distillation loss between the fused soft prediction targets of the ensemble of machine learning models and soft prediction targets of the student machine learning model. During inference, object detection operations are performed at a vehicle by using the trained student machine learning model using low resolution sensor data.

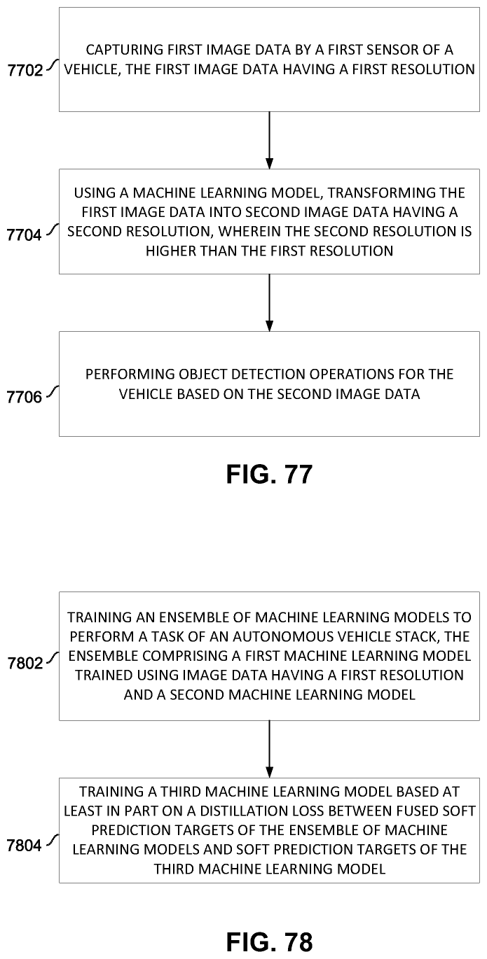

FIG. 77 depicts a flow for increasing resolution of captured images for use in object detection in accordance with certain embodiments. At 7702, first image data is captured by a first sensor of a vehicle, the first image data having a first resolution. At 7704, the first image data is transformed, using a machine learning model, into second image data having a second resolution, wherein the second resolution is higher than the first resolution. At 7706, object detection operations are performed for the vehicle based on the second image data.

FIG. 78 depicts a flow for training a machine learning model based on an ensemble of methods in accordance with certain embodiments. At 7802, an ensemble of machine learning models is trained to perform a task of an autonomous vehicle stack, the ensemble comprising a first machine learning model trained using image data having a first resolution and a second machine learning model. At 7804, a third machine learning model is trained based at least in part on a distillation loss between fused soft prediction targets of the ensemble of machine learning models and soft prediction targets of the third machine learning model.

It is widely known that humans have limited sensing capabilities. One of the possible benefits of autonomous vehicles is the capability of receiving a greater amount of information about the road, given the number of sensors on an autonomous vehicle, thereby increasing safety. However, even autonomous vehicles, with their array of sensors, are prone to errors and blind spots. It is important to acknowledge and account for these limitations in the perception and motion planners of the autonomous vehicles.

LIDARs and radars installed on road side units can exist along roadways, which can give additional information to vehicles on the road. Similarly, the use of cooperative sensing fits well with cooperative driving of autonomous vehicles. As one example, the platooning of trucks and service fleets can make use of cooperative sensing as cooperative driving is being used. As another example, consumer vehicles on roads (who may not know each other) may also contribute to cooperative driving and conduct cooperative sensing.

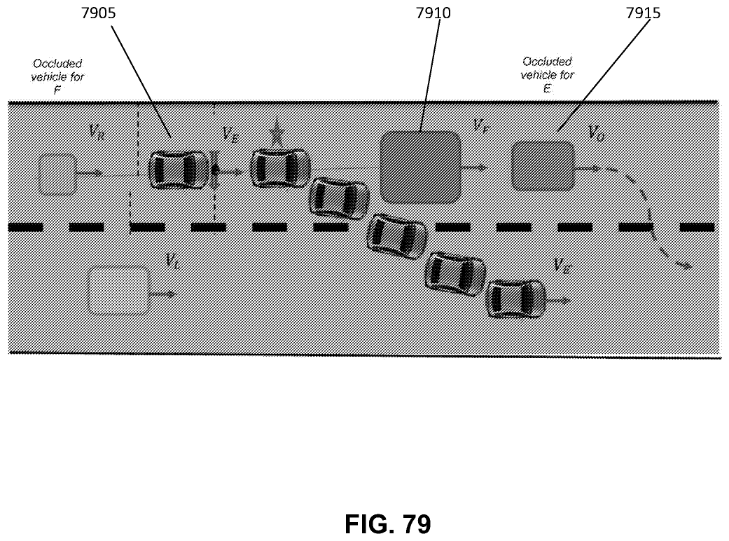

FIG. 79 illustrates an example of a situation in which an autonomous vehicle has occluded sensors, thereby making a driving situation potentially dangerous. As can be seen, vehicle 7905 is trailing vehicle 7910. Given the size of vehicle 7910, vehicle 7915 is occluded for vehicle 7905. In the situation depicted in FIG. 79, vehicle 7905 moves to pass vehicle 7910. However, vehicle 7915 is changing lanes at the same time and vehicle 7905 is not aware of the potential dangers of this situation. However, when an autonomous vehicle is capable of receiving additional information from surrounding vehicles and/or other external sensors, some of the dangers can be mitigated. In addition, the use of other communication between vehicles can create an even safer driving environment.

The concept of virtual reality perception contemplates a car seeing its environment through the eyes of the surrounding traffic agents, such as, for example, dynamic cars on the road, surveillance cameras, cameras installed at intersections or turns, traffic signs, and traffic lights. This information can be used for occlusion detection when the perception and/or dynamic map of a vehicle is not up-to-date. In addition, the enhanced perception can improve decision making by enhancing the field of perception in a manner that is not achievable by only relying on the on-vehicle set of sensors. For example, having information from sensors not on the vehicle can improve safety as a vehicle approaches an occluded pedestrian crosswalk. The speed of the approaching vehicle can properly be determined if the car can now see the occluded crosswalk using sensors from other traffic agents.

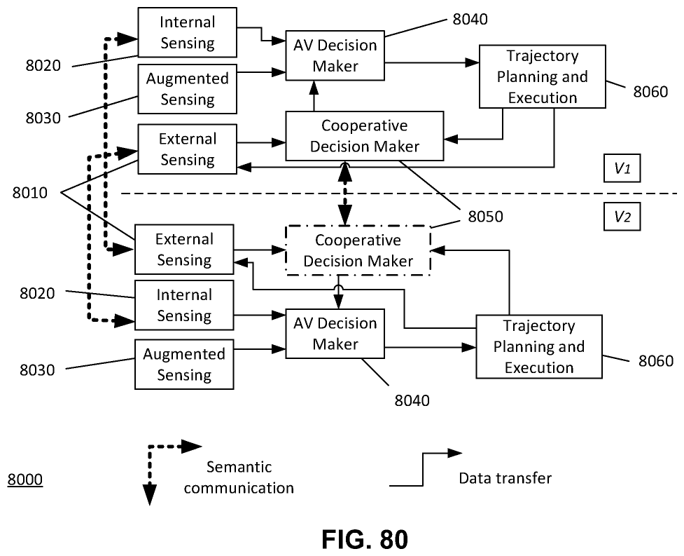

Systems and methods that combine cooperative sensing, cooperative decision making, and semantic communication language can greatly improve the safety of autonomous vehicles. An example of a system that uses vehicle cooperation is illustrated in the high-level architecture diagram shown in FIG. 80. The system 8000 of FIG. 80 may provide cooperative sensing, decision making, and common semantic communication language for autonomous vehicles. Cooperative sensing occurs when vehicles communicate with one or more surrounding vehicles to communicate data based on data sensed by the sensors of the respective vehicles.

The example of FIG. 80 shows a system that includes two vehicles (V₁ and V₂) communicating cooperatively. According to the example depicted in FIG. 80, each vehicle comprises an internal sensing module 8020, an augmented sensing module 8030, an external sensing module 8010, a cooperative decision maker 8050, an autonomous vehicle decision maker module 8040 and a trajectory planning and execution module 8060.

The internal sensing modules 8020 comprise sensing information of an autonomous vehicle, such as data traditionally used by autonomous vehicles in route planning and execution. As an example, sensing modules 8020 may comprise information sensed by on-vehicle sensors. The external sensing modules 8010 comprise information obtained from another vehicle (for example, sensing module 8010 of V₁ may include sensed information received from V₂.) This data may take any form. In some embodiments, the data is exchanged via semantic communication. In various embodiments of the present disclosure, a novel semantic language utilized by traffic elements (e.g. vehicles or roadside computing units) allows the vehicles to manage their communication in a fast and secure mode. This generalized language for communication in transport can include both sensing and planning data and may be shared and exploited by other traffic components. The semantic communication can be carried out as either a broadcast or based on request/response manner. Furthermore, the semantic language can be transmitted using any available transmission protocol, such as, for example, Bluetooth or ZigBee. If two vehicles try to share all the data they receive from their sensors, the size of the data transfer may be too big and take too long to transmit and to analyze. In a situation in which decisions need to be made immediately, the semantic communication will allow a quick communication concerning important safety issues on the road. As an example, the semantic language will allow the vehicles to share specifics from one another, such as the location of a vehicle or other object and a movement pattern or plan for the vehicle or object, such as a plan for the vehicle to change lanes.

The transmission of sensed data from one vehicle to another, as mentioned above, can be considered cooperative sensing. Autonomous vehicles are usually equipped with a wide range and number of sensors. The data provided by these sensors can be analyzed in real-time using computer vision algorithms or LIDAR/RADAR-based data processing methods. Data from the sensors can be processed and analyzed and the results may be shared among vehicles in accordance with embodiments presented herein. Each of the physical sensors has its own limitations in range, field of view, weather conditions, etc. As discussed with reference to the example of FIG. 79, there are many instances on the road in which a vehicle has one or more of its sensors occluded. Cooperative sensing allows a vehicle to use the data from another vehicle, or other traffic objects (e.g., traffic sensors and cameras along the road such as any of those illustrated in FIG. 1 or other suitable sensors) to augment the field of vision of the autonomous vehicle.

With reference to the example of FIG. 80, system 8000 can also include a cooperative decision maker module 8050 on each vehicle. The cooperative decision maker modules 8050 can receive data related to another vehicle's decision making, such as a planned route for the vehicle. Thus, the autonomous vehicle can adjust its own path planning and, in particular, motion planning given the new data set. The data related to another vehicle's decision making can comprise data that relates to a decision the other vehicle makes. For example, if two vehicles are planning to switch lanes, they can alert each other, and the two vehicles can coordinate and plan their actions accordingly. Cooperative decision making can be more general and reliable than using pure negotiation between autonomous vehicles, and in some embodiments may take into account additional objects sensed by the vehicles or other sensors. Cooperative decision making may allow a more complex optimization problem to be solved and the result may be shared with surrounding traffic components (e.g., other vehicles or roadside assistance computing units). According to some examples, cooperative decision maker modules 8050 communicate to one another using semantic language.

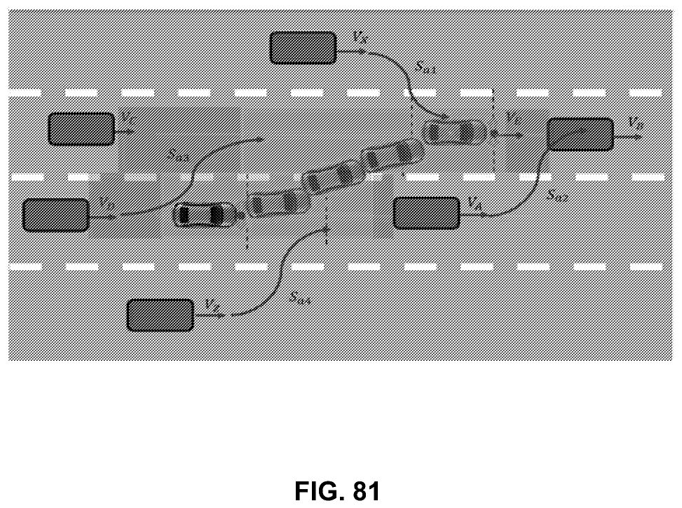

Any one or more of cooperative decision making, cooperative sensing, and semantic language may allow autonomous vehicles to travel more efficiently and safely. As an example, two main potential collision situations involve a high-speed difference between two vehicles and/or a small distance between forward and rear vehicles. Time-based collision indicators can be defined mathematically. Such indicators can be used to distinguish between safe and unsafe trajectories. In some embodiments, a vehicle may analyze a thorough picture of a potentially dangerous situation without repeating the calculation and analysis on the raw data perceived by another vehicle. When the data set is compacted, a smaller bandwidth is utilized to send the information. FIG. 81 illustrates an example of a situation in which multiple actions are contemplated by multiple vehicles. The combination of cooperative decision making, cooperative sensing, and semantic language will enable the vehicles to safely maneuver in this situation and other situations.

System 8000 also includes augmented sensing modules 8030. These modules receive sensor information from outside sources (e.g., any source outside of the vehicle, such as any of the sources shown in FIG. 1). This data may supplement sensor data received from other vehicles via an external sensing module 8010 and the semantic communication. In one example, module 8030 can receive a full data stream comprising data collected by (or based on data collected by) one or more sensors from another vehicle or traffic agent nearby.

The autonomous vehicle decision maker module 8040 may make autonomous vehicle driving decisions based on the information received from sensors, whether internally or externally. According to one example embodiment, the cooperative decision maker module 8050 is separate from the autonomous vehicle decision maker module 8040, allowing additional information to be considered by the autonomous vehicle in its decision making and planning.

System 8000 also includes a trajectory planning and execution module 8060 for each vehicle. Module 8060 may execute the driving decisions that have been made by a vehicle's decision maker modules 8040 or 8050; or can plan the vehicle's trajectory based on the decisions determined by these modules.

The system described in FIG. 80 is merely representative of modules that may occur in particular embodiments. Other embodiments may comprise additional modules not specifically mentioned herein. In addition, one or more modules may be omitted, or modules may be combined in other embodiments.

In order to achieve 360-degree awareness around an autonomous vehicle, various systems may include numerous sensors with different modalities. In some situations, such sensors may result in redundancies among the sensors. However, the increased number of sensors may add to the hardware cost (e.g., both in terms of the price of the sensors the associated processing unit) and may result in dependence by the autonomous vehicle stack on a specific sensor configuration. This inhibits the scalability of the autonomous vehicle solution across various types of vehicles (e.g., a compact vehicle may utilize a configuration that is very different from the configuration of a sport utility vehicle). When fixed sensors are used, the sensor configuration (e.g., the types of sensors and the positions of sensors on vehicle) is customized for each autonomous vehicle type to achieve full redundancy in the range of perception around vehicle.

Various embodiments of the present disclosure provide adaptive image sensors to enable variable field of view (FOV) and range of focus. Similar to the human visual system, particular embodiments may add physical movement to the sensors by enabling vertical and horizontal rotation of the sensors (similar to eye globe and neck movement to expand the vision field). A particular embodiment may utilize one or more Pan-Tilt-Zoom (PTZ) cameras that may rotate to cover larger FOVs. After rotation of a camera, a calibration phase may be performed using one or more markers that are attached to the vehicle. In some embodiments, a machine learning algorithm may be trained to automate the calibration process, invoking the use of the markers when a particular sensor is to be recalibrated. Various embodiments remove the dependency on the fixed position of a sensor on a vehicle and the number of redundant sensors utilized to achieve a full coverage for the field of view. In various embodiments, external mechanical enforcements and intelligence (e.g., pre-processing of the raw sensor data) may add functionality to already existing sensors. Various advantages, such as a reduction in the number of sensors, a reduction in the amount of data that needs to be sensed, or a reduction in the power used during sensing may be achieved by one or more of the embodiments described herein.

A standard field of view of a standard monocular camera is 40° by 30° which, in the context of autonomous vehicles, is a relatively narrow and limited field of view. Due to this restricted field of view of the sensor, many autonomous vehicles include multiple sensors on a vehicle at different positions. Depending on the trajectory of an AV, the data sensed by various sensors around the vehicle are not equally important nor do they have equally useful information. For instance, for an AV driving on an empty highway, the most useful information for the AV may be obtained from one or more front facing sensors (while the data from a rear sensor is not as important, but may be checked occasionally).

In various embodiments of the present disclosure, a vehicle may include automated mechanical mounts for sensors to enable the sensors to rotate in left, right, up and down directions. Although a camera's fixed gaze may be limited (e.g., to 40° by 30°), motion of the mechanical mount will effectively increase the field of view. Thus, the useful information from a vehicle's environment may be captured by moving the gaze/attention of one or more sensors. In particular embodiments, the movement of the sensor is intelligently automated based on motion detected around the vehicle.

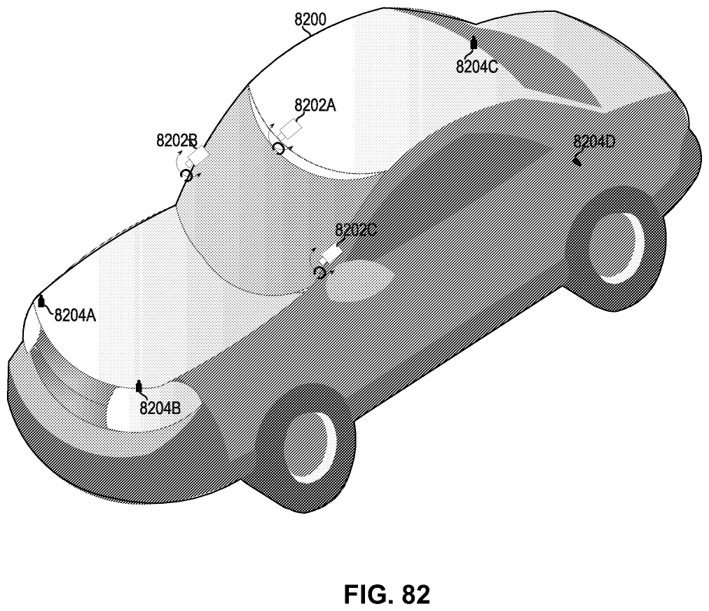

FIG. 82 depicts a vehicle 8200 having dynamically adjustable image sensors 8202A-C and calibration markers 8204A-D. Vehicle 82 may have any one or more of the characteristics of any of the vehicles (e.g., 105) described herein. Image sensors 8202 may include any suitable logic to implement the functionality of the sensors. Although the example depicts particular numbers and positions of image sensors 8202 and calibration markers 8204, various embodiments may include any suitable number of image sensors and calibration markers mounted at any suitable locations of the vehicle.

In various embodiments, the calibration markers 8204 are attached to the vehicle 8200. The markers 8204 may be placed on the exterior of the vehicle at any suitable locations. The markers 8204 may have any suitable shape (e.g., a small sphere, dot, cylinder, etc.). The markers may be of a color that is different from the exterior portion of the vehicle 8200 to which the markers are attached so as to aid detection during image capture performed during calibration. The specific locations of the markers and cameras (and the distances between them) may be used during calibration to dynamically adjust the field of view or other parameters of the image sensors 8202.

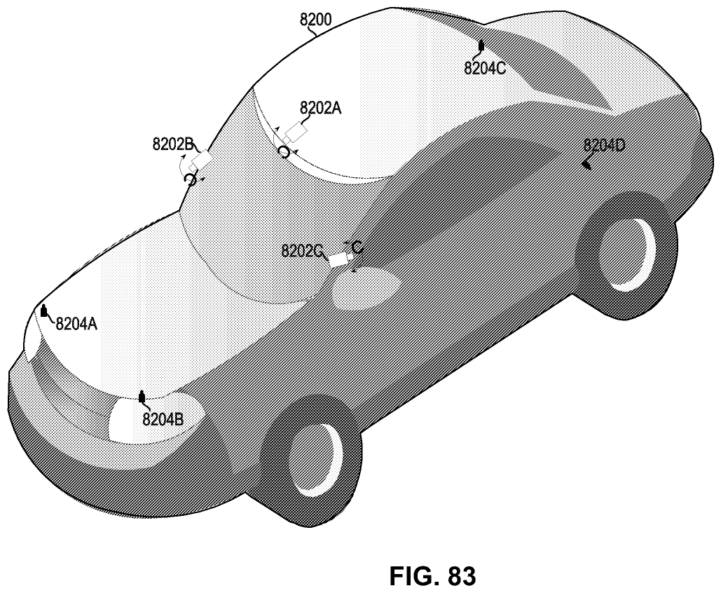

In response to a control signal from a control unit (e.g., system manager 250) of the vehicle 8200, an image sensor 8202 may rotate in a horizontal and/or vertical direction. In some embodiments, an image sensor 8202 may also be mounted on a rail or other mechanical apparatus such that the image sensor may be vertically or horizontally displaced in response to a control signal. The image sensors 8202 may be moved (e.g., rotated and/or displaced in a horizontal and/or vertical direction) into any suitable position in response to any suitable condition. For example, in the embodiment depicted, the vehicle, during normal operation, may have three forward facing cameras 8202A, 8202B, and 820C. In response to an upcoming lane change, image sensor 8202C may be rotated horizontally as depicted in FIG. 83 (e.g., to capture a field of view that is to the side and rear of the vehicle 8200). Once the lane change has been completed (or, e.g., in response to a determination that no potentially dangerous objects are in the field of view), the image sensor may return to its original position. Sensor 8202B may be rotated in a similar manner to capture the other side of the vehicle in response to a control signal. In another example, a sensor that normally faces forward (e.g., 8202A), may rotate in a horizontal direction (e.g., 180 degrees) to periodically capture images to the rear of the vehicle 8200.

One or more markers 8204 may be used to calibrate the movement of one or more of the image sensors 8202. As an example, when an image sensor 8202 is to be moved, the control unit may provide adjustment instructions (wherein the instructions may include, e.g., units of adjustment directly or an identification of a sensor configuration that the image sensor 8202 can translate into units of adjustment). In various examples, the units of adjustment may include a degree of horizontal rotation, a degree of vertical rotation, a horizontal distance, a vertical distance, a zoom level, and/or other suitable adjustment. The sensor 8202 may affect the instructed adjustment and may initiate capture of image data (e.g., pictures or video).

Image data from the sensor 8202 is fed back to the control unit of the vehicle. The control unit may process the image and detect the location and/or size of one or more markers 8204D in the image data. If the one or more markers are not in the correct location in the image and/or are not the correct size, the control unit may determine additional adjustment instructions and provide them to the sensor. Additional image captures and adjustments may be performed until the marker(s) are the desired size and/or have the desired location within the image data (in some embodiments, after the second adjustment the image sensor may be assumed to be in a suitable configuration without an additional analysis of the marker(s)). In various embodiments, the adjustment instructions and the results (e.g., as reflected by the locations and sizes of the markers in the images) are stored by the control unit and used to refine future adjustment instructions.

In particular embodiments, instead of explicit markers embedded in the vehicle 8200, contours of the car may be used as the markers for calibration, though such embodiments may invoke more intensive processing for calibration.

In some embodiments, calibration is not performed each time a sensor 8202 is moved. In other embodiments, calibration may not be performed each time a sensor 8202 is moved, but e.g., periodically, once every n times a sensor is moved, or in response to a determination that calibration would be useful.

In various embodiments, the control unit may direct movement of one or more sensors in response to a detected condition associated with the car. In particular embodiments, such conditions may be detected based on a time-based analysis of sensor data (e.g., from one or more image sensors 8202 or other sensors of the vehicle or associated sensors). In some embodiments, movement of a sensor may be directed in response to motion in a field of view of one or more sensors (e.g., a particular image sensor 8202 may have its motion adjusted to track an object, e.g., to track another vehicle passing or being passed by the vehicle 100). In various embodiments, the movement may be directed in response to a detection of a change in driving environment (e.g., while driving on a highway, the sensors may predominately face in a forward direction, but may face towards the side more often during city driving). In some embodiments, a condition used to direct sensor movement may be a predicted condition (e.g., a predicted merge from a highway into a city based on slowing of speed, detection of objects indicating city driving, and/or GPS data). In various embodiments, machine learning may be utilized to detect conditions to trigger movement of one or more sensors.

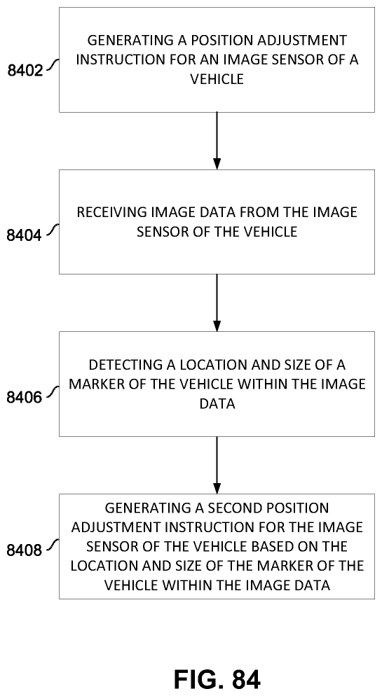

FIG. 84 depicts a flow for adjusting an image sensor of a vehicle in accordance with certain embodiments. At 8402, a position adjustment instruction for an image sensor of a vehicle is generated. At 8404 image data from the image sensor of the vehicle is received. At 8406, a location and size of a marker of the vehicle within the image data is detected. At 8408, a second position adjustment instruction for the image sensor of the vehicle is generated based on the location and size of the marker of the vehicle within the image data.

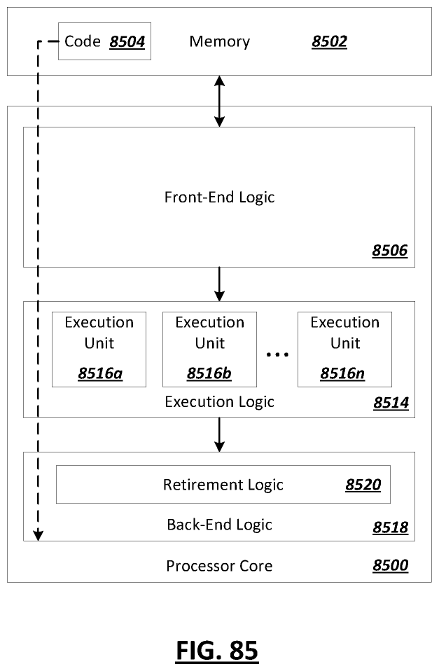

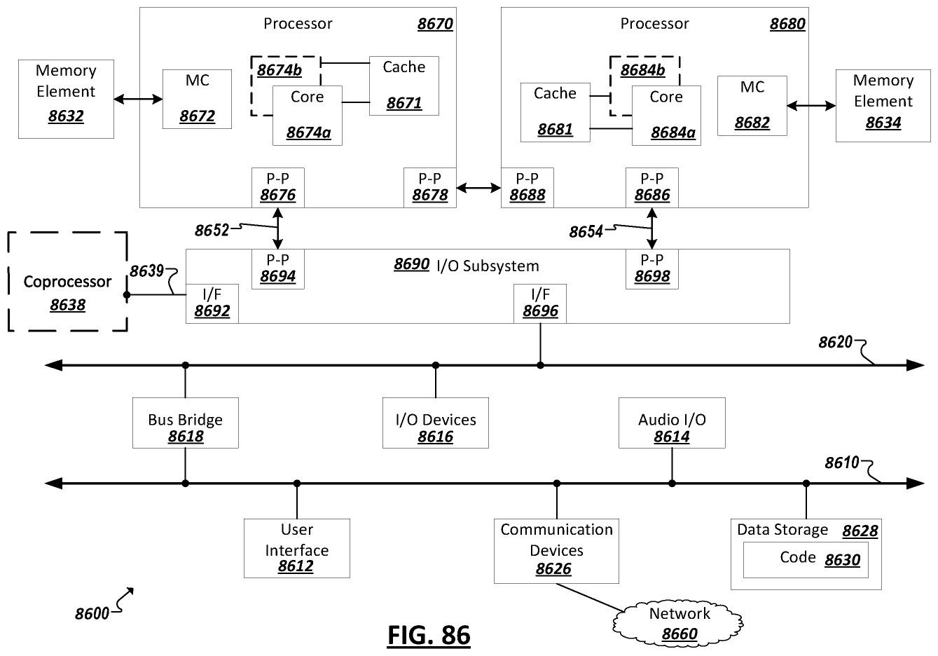

FIGS. 85-86 are block diagrams of exemplary computer architectures that may be used in accordance with embodiments disclosed herein. Other computer architecture designs known in the art for processors and computing systems may also be used. Generally, suitable computer architectures for embodiments disclosed herein can include, but are not limited to, configurations illustrated in FIGS. 85-86.

FIG. 85 is an example illustration of a processor according to an embodiment. Processor 8500 is an example of a type of hardware device that can be used in connection with the implementations above. Processor 8500 may be any type of processor, such as a microprocessor, an embedded processor, a digital signal processor (DSP), a network processor, a multi-core processor, a single core processor, or other device to execute code. Although only one processor 8500 is illustrated in FIG. 85, a processing element may alternatively include more than one of processor 8500 illustrated in FIG. 85. Processor 8500 may be a single-threaded core or, for at least one embodiment, the processor 8500 may be multi-threaded in that it may include more than one hardware thread context (or “logical processor”) per core.

FIG. 85 also illustrates a memory 8502 coupled to processor 8500 in accordance with an embodiment. Memory 8502 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 8500 can execute any type of instructions associated with algorithms, processes, or operations detailed herein. Generally, processor 8500 can transform an element or an article (e.g., data) from one state or thing to another state or thing.

Code 8504, which may be one or more instructions to be executed by processor 8500, may be stored in memory 8502, or may be stored in software, hardware, firmware, or any suitable combination thereof, or in any other internal or external component, device, element, or object where appropriate and based on particular needs. In one example, processor 8500 can follow a program sequence of instructions indicated by code 8504. Each instruction enters a front-end logic 8506 and is processed by one or more decoders 8508. The decoder may generate, as its output, a micro operation such as a fixed width micro operation in a predefined format, or may generate other instructions, microinstructions, or control signals that reflect the original code instruction. Front-end logic 8506 also includes register renaming logic 8510 and scheduling logic 8512, which generally allocate resources and queue the operation corresponding to the instruction for execution.

Processor 8500 can also include execution logic 8514 having a set of execution units 8516a, 8516b, 8516n, etc. Some embodiments may include a number of execution units dedicated to specific functions or sets of functions. Other embodiments may include only one execution unit or one execution unit that can perform a particular function. Execution logic 8514 performs the operations specified by code instructions.

After completion of execution of the operations specified by the code instructions, back-end logic 8518 can retire the instructions of code 8504. In one embodiment, processor 8500 allows out of order execution but requires in order retirement of instructions. Retirement logic 8520 may take a variety of known forms (e.g., re-order buffers or the like). In this manner, processor 8500 is transformed during execution of code 8504, at least in terms of the output generated by the decoder, hardware registers and tables utilized by register renaming logic 8510, and any registers (not shown) modified by execution logic 8514.

Although not shown in FIG. 85, a processing element may include other elements on a chip with processor 8500. For example, a processing element may include memory control logic along with processor 8500. The processing element may include I/O control logic and/or may include I/O control logic integrated with memory control logic. The processing element may also include one or more caches. In some embodiments, non-volatile memory (such as flash memory or fuses) may also be included on the chip with processor 8500.

FIG. 86 illustrates a computing system 8600 that is arranged in a point-to-point (PtP) configuration according to an embodiment. In particular, FIG. 86 shows a system where processors, memory, and input/output devices are interconnected by a number of point-to-point interfaces. Generally, one or more of the computing systems described herein may be configured in the same or similar manner as computing system 8500.

Processors 8670 and 8680 may also each include integrated memory controller logic (MC) 8672 and 8682 to communicate with memory elements 8632 and 8634. In alternative embodiments, memory controller logic 8672 and 8682 may be discrete logic separate from processors 8670 and 8680. Memory elements 8632 and/or 8634 may store various data to be used by processors 8670 and 8680 in achieving operations and functionality outlined herein.

Processors 8670 and 8680 may be any type of processor, such as those discussed in connection with other figures herein. Processors 8670 and 8680 may exchange data via a point-to-point (PtP) interface 8650 using point-to-point interface circuits 8678 and 8688, respectively. Processors 8670 and 8680 may each exchange data with a chipset 8690 via individual point-to-point interfaces 8652 and 8654 using point-to-point interface circuits 8676, 8686, 8694, and 8698. Chipset 8690 may also exchange data with a co-processor 8638, such as a high-performance graphics circuit, machine learning accelerator, or other co-processor 8638, via an interface 8639, which could be a PtP interface circuit. In alternative embodiments, any or all of the PtP links illustrated in FIG. 86 could be implemented as a multi-drop bus rather than a PtP link.

Chipset 8690 may be in communication with a bus 8620 via an interface circuit 8696. Bus 8620 may have one or more devices that communicate over it, such as a bus bridge 8618 and I/O devices 8616. Via a bus 8610, bus bridge 8618 may be in communication with other devices such as a user interface 8612 (such as a keyboard, mouse, touchscreen, or other input devices), communication devices 8626 (such as modems, network interface devices, or other types of communication devices that may communicate through a computer network 8660), audio I/O devices 8614, and/or a data storage device 8628. Data storage device 8628 may store code 8630, which may be executed by processors 8670 and/or 8680. In alternative embodiments, any portions of the bus architectures could be implemented with one or more PtP links.

The computer system depicted in FIG. 86 is a schematic illustration of an embodiment of a computing system that may be utilized to implement various embodiments discussed herein. It will be appreciated that various components of the system depicted in FIG. 86 may be combined in a system-on-a-chip (SoC) architecture or in any other suitable configuration capable of achieving the functionality and features of examples and implementations provided herein.

While some of the systems and solutions described and illustrated herein have been described as containing or being associated with a plurality of elements, not all elements explicitly illustrated or described may be utilized in each alternative implementation of the present disclosure. Additionally, one or more of the elements described herein may be located external to a system, while in other instances, certain elements may be included within or as a portion of one or more of the other described elements, as well as other elements not described in the illustrated implementation. Further, certain elements may be combined with other components, as well as used for alternative or additional purposes in addition to those purposes described herein.

Further, it should be appreciated that the examples presented above are non-limiting examples provided merely for purposes of illustrating certain principles and features and not necessarily limiting or constraining the potential embodiments of the concepts described herein. For instance, a variety of different embodiments can be realized utilizing various combinations of the features and components described herein, including combinations realized through the various implementations of components described herein. Other implementations, features, and details should be appreciated from the contents of this Specification.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Computing systems may be provided, including in-vehicle computing systems (e.g., used to implement at least a portion of an automated driving stack and enable automated driving functional of the vehicle), roadside computing systems (e.g., separate from vehicles; implemented in dedicated roadside cabinets, on traffic signs, on traffic signal or light posts, etc.), on one or more computing systems implementing a cloud- or fog-based system supporting autonomous driving environments, or computing system remote from an autonomous driving environments may include logic implemented using one or a combination of one or more data processing apparatus (e.g., central processing units, graphics processing units, tensor processing units, ASICs, FPGAs, etc.), accelerator hardware, other hardware circuitry, firmware, and/or software to perform or implement one or a combination of the following examples.

Example A1 is a method that includes receiving HD map data from a server; receiving sensor data from a sensor device coupled to an autonomous vehicle; computing a confidence score for the sensor data based on information associated with the collection of the sensor data; computing a delta value based on a comparison of the sensor data and information in the HD map corresponding to a location of the autonomous vehicle when the sensor data was obtained; and determining, based on the confidence score and the delta value, whether to publish the sensor data to the server for updating of the HD map.

Example A2 includes the subject matter of Example A1, where the method further includes publishing the sensor data to the server in response to a determination that the confidence score is above a first threshold value and the delta value is above a second threshold value.

Example A3 includes the subject matter of Example A1, where the information associated with the collection of the sensor data includes one or more of weather data at the time of data collection sensor device configuration information, sensor device operation information, local sensor corroboration data, or sensor device authentication status information.

Example A4 includes the subject matter of any one of Examples A1-A3, where the method further includes signing the sensor data with a pseudo-anonymous digital certificate.

Example A5 includes the subject matter of Example A4, where the pseudo-anonymous digital certificate is based on a V2X protocol.

Example A6 is an apparatus that includes memory and processing circuitry coupled to the memory, where the processing circuitry is configured to perform a method of any one of Examples A1-A5.

Example A7 is a system comprising means for performing a method of any one of Examples A1-A5.

Example A8 is a product comprising one or more tangible computer-readable non-transitory storage media comprising computer-executable instructions operable to, when executed by at least one computer processor, enable the at least one computer processor to implement operations of any one of the methods of Examples A1-A5.

Example A9 is a method that includes receiving sensor data from an autonomous vehicle (AV), the sensor data comprising a confidence score indicating a confidence level in the sensor data; determining whether the AV is trusted based at least in part on a trust score associated with the AV, wherein the trust score is based at least in part on the confidence score and one or more other confidence scores for sensor data previously received from the AV; and updating an HD map using the sensor data in response to a determination that the AV is trusted.

Example A10 includes the subject matter of Example A9, where the method further includes determining whether the confidence score is above a threshold value, wherein updating the HD map is further in response to the confidence score being above the threshold value.

Example A11 includes the subject matter of Example A9, where the trust score is further based on whether the sensor data is signed by the AV using a pseudo-anonymous digital certificate.

Example A12 includes the subject matter of Example A9, where determining whether the AV is trusted is further based on whether the AV is blacklisted.

Example A13 includes the subject matter of Example A9, where determining whether the AV is trusted is further based on a correlation of the sensor data with sensor data from other AVs nearby the AV.

Example A14 includes the subject matter of Example A9, where the method further includes updating the trust score for the AV based on the confidence score.

Example A15 includes the subject matter of Example A14, where updating the trust score comprises one or more of incrementing the trust score in response to the confidence score being above a first threshold value, and decrementing the trust score in response to the confidence score being below a second threshold value.

Example A16 is an apparatus that includes memory and processing circuitry coupled to the memory, where the processing circuitry is configured to perform a method of any one of Examples A11-A15.

Example A17 is a system comprising means for performing a method of any one of Examples A11-A15.

Example A18 is a product comprising one or more tangible computer-readable non-transitory storage media comprising computer-executable instructions operable to, when executed by at least one computer processor, enable the at least one computer processor to implement operations of any one of the methods of Examples A11-A15.

Example B1 is a method that includes receiving sensor data from an autonomous vehicle; obtaining geolocation information from the sensor data, the geolocation information indicating a location of the autonomous vehicle; computing a goodness score for the sensor data based at least on the geolocation information; comparing the goodness score to a threshold value; and storing the sensor data in a database in response to the goodness score being above a threshold.

Example B2 includes the subject matter of Example B1, where the method further comprises computing a location score based on the geolocation information; and computing the goodness score is based on the location score and one or more other scores associated with the sensor data.

Example B3 includes the subject matter of Example B2, where computing the location score comprises: accessing a heatmap associated with the geolocation information, the heatmap indicating an amount of sensor data collected at a plurality of locations; obtaining a value from the heat map associated with the location indicated by the geolocation information; and using the value from the heat map to compute the location score.

Example B4 includes the subject matter of any one of Examples B2-B3, where the goodness score is a weighted sum of the location score and the one or more other scores associated with the sensor data.

Example B5 includes the subject matter of any one of Examples 2-4, wherein the location score is a weighted sum of the geolocation information and one or more additional categories of environment information, each category of environment information indicating a condition of a location of the autonomous vehicle.

Example B6 includes the subject matter of Example B5, where the one or more additional categories of environment information includes one or more of elevation information indicating an elevation of the autonomous vehicle, temperature information indicating a temperature outside the autonomous vehicle, weather information indicating weather conditions near the autonomous vehicle, and terrain information indicating features of the area traversed by the autonomous vehicle.

Example B7 includes the subject matter of Example B5, where computing the location score comprises, for each of the one or more additional categories of environment information: accessing a heatmap associated with the additional category, the heatmap indicating an amount of sensor data collected at a plurality of locations; obtaining a value from the heat map associated with the location indicated by geolocation information; and using the obtained value to compute the location score.

Example B8 includes the subject matter of any one of Examples B2-B7, where the one or more other scores include one or more of a noise score for the sensor data, and an object diversity score for the sensor data.

Example B9 includes the subject matter of any one of Examples 1-8, where obtaining the geolocation information from the sensor data comprises one or more of obtaining geographic coordinate information in the sensor data and analyzing metadata of the sensor data to obtain the geolocation information.

Example B10 includes the subject matter of any one of Examples 1-9, where the method further includes computing a vehicle dependability score associated with the autonomous vehicle based on the goodness score.

Example B11 is an apparatus that includes memory and processing circuitry coupled to the memory, where the processing circuitry is to perform one or more of the methods of Examples B1-B10.

Example B12 is a system that includes means for performing one or more of the methods of Examples B1-B10.

Example B13 is a product comprising one or more tangible computer-readable non-transitory storage media comprising computer-executable instructions operable to, when executed by at least one computer processor, enable the at least one computer processor to implement operations of the methods of Examples B1-B10.

Example C1 is a method that includes identifying an instance of one or more objects from data captured by one or more sensors of a vehicle; performing a categorization of the instance by checking the instance against a plurality of categories and assigning at least one category of the plurality of categories to the instance; determining a score based on the categorization of the instance; selecting a data handling policy for the instance based at least in part on the score; and processing the instance based on the determined data handling policy.

Example C2 includes the subject matter of Example C1, where a category of the plurality of categories is a category indicating a frequency of detection of the one or more objects.

Example C3 includes the subject matter of Example C2, where the frequency of detection indicates a frequency of detection of the one or more objects within a particular context associated with the capture of one or more underlying sensor data streams of the instance.

Example C4 includes the subject matter of any of Examples C1-C3, where a category of the plurality of categories is a category indicating a level of diversity among multiple detected objects of the instance.

Example C5 includes the subject matter of any of Examples C1-C4, where a category of the plurality of categories is a category indicating a noise level of one or more underlying data streams for the instance.

Example C6 includes the subject matter of any of Examples C1-C5, where the method further includes determining the score based on the categorization of the instance and a context of the data captured by the one or more sensors.

Example C7 includes the subject matter of any of Examples C1-C6, where the selected data handling policy is to delete the instance and one or more underlying sensor data streams for the instance.

Example C8 includes the subject matter of any of Examples C1-C6, where the selected data handling policy is to save the instance and one or more underlying sensor data streams for the instance for use in training an object detection model.

Examples C9 includes the subject matter of any of Examples C1-C6, where the selected data handling policy is to generate synthetic data comprising at least one image that is the same type of object as a detected image of the instance, the synthetic data for use in training an object detection model.

Example C10 includes the subject matter of any of Examples C1-C9, further comprising providing categorization results to a machine learning training model and providing parameters of the machine learning training model to a computing system of a vehicle for use in categorization of objects detected by the vehicle.

Example C11 is vehicle that includes a computing system for performing one or more of the methods of Examples C1-C10.

Example C12 is an apparatus that includes memory and processing circuitry coupled to the memory, where the processing circuitry is to perform one or more of the methods of claims C1-C10.

Example C13 is a system comprising means for performing one or more of the methods of Examples C1-C10.

Example C14 includes at least one machine readable medium comprising instructions, wherein the instructions when executed realize an apparatus or implement a method as claimed in any one of claims C1-C10.

Example D1 is a method that includes identifying a context associated with sensor data captured from one or more sensors of a vehicle, wherein the context includes a plurality of text keywords; determining that additional image data for the context is desired; and providing the plurality of text keywords of the context to a synthetic image generator, the synthetic image generator to generate a plurality of images based on the plurality of text keywords of the context.

Example D2 includes the subject matter of Example 1, where the synthetic image generator is a generative adversarial network.

Example D3 includes the subject matter of any of Examples D1-D2, where determining that additional image data for the context is desired comprises determining a level of commonness of the context indicating an amount of available sensor data associated with the context.

Example D4 includes the subject matter of any of Examples D1-D3, where determining that additional image data for the context is desired comprises analyzing results from a database to determine whether the identified context is realistic.

Example D5 includes the subject matter of Example D4, where the database comprises a compilation of data obtained from a variety of internet data sources.

Example D6 includes the subject matter of any of Examples D4-D5, wherein the database comprises a plurality of text keywords extracted from image data obtained from a variety of internet data sources.

Example D7 includes the subject matter of any of Examples D1-D6, where the method further includes: in response to determining a level of commonness of the context, determining, whether the context is realistic, wherein the determination of whether the context is realistic is determined independently of the determination of the level of commonness of the context.

Example D8 includes the subject matter of any of Examples 1-7, where providing the plurality of text keywords of the context to the synthetic image generator is performed in response to determining that the context has a low level of commonness but is still realistic.

Example D9 includes the subject matter of any of Examples 1-8, where the plurality of text keywords describes an operating environment of the vehicle.

Example D10 includes the subject matter of any of Examples 1-9, where the sensor data associated with the identified context and the plurality of images generated by the synthetic image generator are added to a dataset for use in training one or more models for the vehicle.

Example D11 is an apparatus that includes memory and processing circuitry coupled to the memory to perform one or more of the methods of Examples D1-D10.

Example D12 is a system that includes means for performing one or more of the methods of Examples D1-D10.

Example D13 includes at least one machine readable medium comprising instructions, wherein the instructions when executed realize an apparatus or implement a method as claimed in any one of Examples D1-D10.

Example E1 is a method that includes accessing a benign data set comprising a plurality of image samples or a plurality of audio samples, the samples of the benign data set having known labels; generating a simulated attack data set comprising a plurality of adversarial samples, wherein the adversarial samples are generated by performing a plurality of different attack methods to samples of the benign data set; and training a machine learning classification model using the adversarial samples, the known labels, and a plurality of benign samples.

Example E2 includes the subject matter of Example E1, where the method further includes providing the trained machine learning classification model to a vehicle for use in classifying samples detected by one or more sensors of the vehicle.

Example E3 includes the subject matter of any of Examples E1-E2, where the plurality of different attack methods comprise one or more of a fast gradient sign method, an iterative fast gradient sign method, a deep fool method, or universal adversarial perturbation.

Example E4 includes the subject matter of any of Examples E1-E3, where the method further includes generating the simulated attack data set by performing the plurality of different attack methods according to a ratio based on an expected attack ratio.

Example E5 includes the subject matter of any of Examples E1-E4, where generating the simulated attack data set comprises utilizing a plurality of different attack strengths for at least one attack method of the plurality of different attack methods.

Example E6 includes the subject matter of any of Examples 1-5, where the method further includes measuring classification accuracy for a plurality of ratios of benign samples to adversarial samples to determine an optimal ratio of benign samples to adversarial samples to use during the training.

Example E7 includes the subject matter of any of Examples 1-6, where the method further includes imposing a penalty during the training for misclassification of an adversarial sample.

Example E8 includes the subject matter of any of Examples 1-7, where the benign data set comprises a collection of image samples.

Example E9 includes the subject matter of any of Examples 1-7, where the benign data set comprises a collection of audio samples.

Example E10 is an apparatus that includes memory and processing circuitry coupled to the memory to perform one or more of the methods of Examples E1E9.

Example E11 is a system comprising means for performing one or more of the methods of Examples E1-E9.

Example E12 includes at least one machine readable medium comprising instructions, wherein the instructions when executed realize an apparatus or implement a method as claimed in any one of Examples E1-E9.

Example F1 is a method that includes classifying, by a linear classifier, input samples from a vehicle; classifying, by a non-linear classifier, the input samples from the vehicle; detecting a change in an accuracy of the linear classifier; and triggering at least one action in response to the change in accuracy of the linear classifier.

Example F2 includes the subject matter of Example F1, where the triggered at least one action comprises a retraining of the linear classifier and the non-linear classifier.

Example F3 includes the subject matter of any of Examples F1-F2, where the triggered at least one action comprises a generation of synthetic data based on recently classified input samples.

Example F4 includes the subject matter of any of Examples F1-F3, where the triggered at least one action comprises a determination of whether an attack has been made on the input samples.

Example F5 includes the subject matter of any of Examples F1-F4, where the triggered at least one action comprises a random sampling of recently classified input samples, the random sampling to be used in retraining the linear classifier and non-linear classifier, the other samples of the recently classified input samples to not be used in the retraining.

Example F6 includes the subject matter of any of Examples F1-F5, where detecting the change in the accuracy of the linear classifier comprises detecting that the accuracy of the linear classifier has fallen below a threshold value.

Example F7 includes the subject matter of any of Examples F1-F6, where the method further includes performing object detection based at least in part on classifying the input samples using the non-linear classifier.

Example F8 includes the subject matter of any of Examples F1-F7, where the input samples are collected from one or more sensors of the vehicle.

Example F9 is an apparatus that includes memory and processing circuitry coupled to the memory to perform one or more of the methods of Examples F1-F8.

Example F10 is a system comprising means for performing one or more of the methods of Examples F1-F8.

Example F11 includes at least one machine readable medium comprising instructions, wherein the instructions when executed realize an apparatus or implement a method as claimed in any one of Examples F1-F8.

Example G1 is a method that includes providing an extracted feature from image data to a first class prediction model and to a second class prediction model; determining a difference between an output of the first class prediction model and an output of the second class prediction model; and assigning an anomaly class to the extracted feature based on the difference between the output of the first class prediction model and the output of the second class prediction model.

Example G2 includes the subject matter of Example G1, where the first class prediction model is a baseline prediction model comprising a Gated Recurrent Unit (GRU) or a Long Short Term Memory networks (LSTM) neural network.

Example G3 includes the subject matter of any of Examples G1-G2, where the second class prediction model is based on a LSTM neural network.

Example G4 includes the subject matter of any of Examples G1-G3, where the method further includes assigning a second anomaly class to a second extracted feature based on a second difference between a second output of the first class prediction model and a second output of the second class prediction model.

Example G5 includes the subject matter of any of Examples G1-G4, where the method further includes determining an anomaly threshold during training of the first class prediction model and the second class prediction model based on differences between outputs of the first class prediction model and the second class prediction model.

Example G6 includes the subject matter of any of Examples G1-G5, further comprising outputting a prediction confidence associated with the anomaly class assigned to the extracted feature.

Example G7 is an apparatus that includes memory and processing circuitry coupled to the memory to perform one or more of the methods of Examples G1-G6.

Example G8 is a system comprising means for performing one or more of the methods of Examples G1-G6.

Example G9 includes at least one machine readable medium comprising instructions, wherein the instructions when executed realize an apparatus or implement a method as claimed in any one of Examples G1-G6.

Example H1 is a method that includes determining a safety score for a vehicle; determining a road score for at least a portion of a road; comparing the road score to the safety score; and determining the acceptable autonomy level of the vehicle on the at least a portion of the road.

Example H2 includes the subject matter of Example H1, where determining the acceptable autonomy level of the vehicle comprises determining to allow the vehicle to be driven autonomously if the safety score is greater than or equal to the road score.

Example H3 includes the subject matter of any one or more of Examples H1-H2, where the safety score is determined using multiple weighted elements.

Example H4 includes the subject matter of any one or more of Examples H1-H3, wherein the road score is determined using multiple weighted elements.

Example H5 includes the subject matter of any one or more of Examples H1-H4, where the road score is dynamically calculated to consider the current conditions of the at least a portion of the road.

Example H6 includes the subject matter of any one or more of Examples H1-H5, wherein the safety score is calculated dynamically to consider the current condition of the vehicle.

Example H7 includes the subject matter of any one or more of Examples H1-H6, where the method further includes displaying the road score for at least a portion of a road on a map user interface.

Example H8 includes the subject matter of any one or more of Examples H1-H7, where the road score is determined using a weighted value for weather conditions.

Example H9 includes the subject matter of any one or more of Examples H1-H8, where the road score is determined using a weighted value for the condition of the at least a portion of the road.

Example H10 includes the subject matter of any one or more of Examples H1-H9, where the safety score is determined using a weighted value for the sensors of the vehicle.

Example H11 includes the subject matter of any one or more of Examples H1-H10, wherein the safety score is determined using a weighted value for one or more autonomous driving algorithms implemented by the vehicle.

Example H12 includes the subject matter of any one or more of Examples H1-H11, where calculating the safety score comprises conducting testing on the vehicle.

Example H13 is a system that includes means to perform any one or more of Examples H1-H12.

Example H14 includes the subject matter of Example 13, wherein the means comprises at least one machine readable medium comprising instructions, wherein the instructions when executed implement a method of any one or more of Examples 1-12.

Example I1 is a method that includes receiving an image captured by an image capturing device associated with a vehicle; detecting a face in the captured image; generating an input image for a first neural network of a Generative Adversarial Network (GAN), the input image depicting the face detected in the captured image; generating a disguised image based, at least in part, on applying the first neural network to the input image, wherein a gaze attribute of the face depicted in the input image is included in the disguised image, and wherein one or more other attributes of the face depicted in the input image are modified in the disguised image.

Example I2 includes the subject matter of Example I1, where the first neural network is a generative model, and wherein the GAN includes a second neural network that is a discriminative model.

Example I3 includes the subject matter of any one of Examples I1-I2, where the second neural network is a convolutional neural network to classify disguised images produced by the first neural network as real or fake.

Example I4 includes the subject matter of any one of Examples I1-I3, where the first neural network is an inverse convolutional neural network that generates the disguised image.

Example I5 includes the subject matter of any one of Examples I1-I4, where the method further includes: estimating locations of one or more facial components of the face detected in the captured image, wherein the input image is generated based, at least in part, on the detected image and the locations of the one or more facial components.

Example I6 includes the subject matter of any one of Examples I1-I5, where the one or more other attributes that are modified in the disguised image include age and gender.

Example I7 includes the subject matter of any one of Examples I1-I5, where the one or more other attributes that are modified in the disguised image are selected from a group of attributes comprising age, gender, hair color, baldness, bangs, eye glasses, makeup, skin color, and mouth expression.

Example I8 includes the subject matter of any one of claims I1-I7, where the first neural network generates the disguised image based, at least in part, on a target domain that indicates the one or more other attributes to modify in the face detected in the captured image.

Example I9 includes the subject matter of any one of Examples I1-I8, where the GAN model is preconfigured with the target domain based on the GAN model generating disguised images from test images and a facial recognition model being unable to identify at least a threshold number of the disguised images.

Example I10 includes the subject matter of any one of Examples I1-I9, where an emotion attribute in the face detected in the captured image is included in the disguised image.

Example I11 includes the subject matter of Example I10, where the method further includes: sending the disguised image to a data collection system associated with the vehicle, wherein the data collection system is to detect an emotion based on the emotion attribute in the disguised image.

Example I12 includes the subject matter of any one of Examples I1-I11, where the method further includes: providing the disguised image to a computer vision application of the vehicle, wherein the computer vision application is to detect a gaze based on a gaze attribute in the disguised image and identify a trajectory of a human represented in the disguised image based on the detected gaze.

Example I13 is an apparatus that includes memory and processing circuitry coupled to the memory to perform one or more of the methods of Examples I1-I12.

Example I14 is a system comprising means for performing one or more of the methods of Examples I1-I12.

Example I15 includes at least one machine readable medium comprising instructions, wherein the instructions when executed realize an apparatus or implement a method as claimed in any one of Examples I1-I13.

Example J1 is a method that includes receiving a dataset comprising data collected by a vehicle, wherein one or more tags are associated with the dataset; determining a first policy to be applied to the dataset based on the one or more tags; determining whether the first policy is designated as a lazy policy; based on determining that the first policy is designated as a lazy policy, marking the dataset for on-demand processing without applying the first policy to the dataset; subsequent to marking the dataset for on-demand processing, receiving a first request for the dataset; and applying the first policy to the dataset in response to receiving the first request for the dataset.

Example J2 includes the subject matter of Example 1, where applying the first policy to the dataset includes at least one of obscuring one or more faces in an image in the dataset, obscuring one or more license plates in an image in the dataset, anonymizing personal identifying information in the dataset, or modifying location information in the dataset.

Example J3 includes the subject matter of any one of Examples J1-J2, where the method further includes: determining a geographic location of the vehicle; and associating a tag to the dataset, the tag containing information indicating the geographic location of the vehicle.

Example J4 includes the subject matter of any one of Examples J1-J3, where the method further includes: using a machine learning model to identify at least one of the one or more tags to associate with the dataset.

Example J5 includes the subject matter of any one of Examples J1-J4, where the dataset is received at a policy enforcement engine in one of the vehicle or a cloud processing system remote from the vehicle.

Example J6 includes the subject matter of any one of Examples J1-J5, where the method further includes: determining a second policy to be applied to the dataset based on the one or more tags; determining whether the second policy is designated as a lazy policy; and based on determining that the second policy is not designated as a lazy policy, applying the second policy to the dataset.

Example J7 includes the subject matter of Example 6, where applying the second policy to the dataset includes obscuring, anonymizing, or modifying at least some data in the dataset.

Example J8 includes the subject matter of any one of Examples J1-J7, where the method further includes: receiving a second dataset comprising second data collected by the vehicle, wherein one or more second tags are associated with the second dataset; determining a second policy to be applied to the second dataset based on the one or more second tags, wherein the second policy is designated as a lazy policy; and based on determining that a contextual policy is applicable to the second dataset, overriding the lazy policy designation and applying the contextual policy to the second dataset.

Example J9 includes the subject matter of Example 8, where the contextual policy includes at least one action required by the second policy.

Example J10 includes the subject matter of any one of Examples J1-J9, where the method further includes: based upon receiving the first request for the dataset, determining a current location of the vehicle; determining whether the current location of the vehicle is associated with different regulations than a prior location associated with the dataset; based on determining the current location of the vehicle is associated with different regulations, attach an updated tag to the dataset, the updated tag including information indicating the current location of the vehicle; determining that a new policy is to be applied to the dataset based, at least in part, on the updated tag; and applying the new policy to the dataset.

Example J11 includes the subject matter of any one of Examples J1-J10, where the method further includes: receiving a third dataset comprising third data collected by the vehicle, wherein one or more third tags are associated with the third dataset; determining a third policy to be applied to the third dataset based on the one or more third tags; and based on determining that the third policy is not designated as a lazy policy, applying the third policy to the third dataset; and marking the third dataset as policy-compliant based on determining that no policy to be applied to the third dataset is designated as a lazy policy and on applying, to the third dataset, each policy determined to be applicable to the third dataset.

Example J12 includes the subject matter of any one of Claims J1-J11, where the method further includes: receiving a second request for the dataset subsequent to receiving the first request for the dataset; and applying a fourth policy to the dataset in response to receiving the second request for the dataset, wherein the one or more tags are associated with the fourth policy in response to a regulation change applicable to the data in the dataset.

Example J13 is an apparatus that includes memory and processing circuitry coupled to the memory to perform one or more of the methods of Examples J1-J12.

Example J14 is a system comprising means for performing one or more of the methods of Examples J1-J12.

Example J15 includes at least one machine readable medium comprising instructions for generating a disguised image, wherein the instructions when executed realize an apparatus or implement a method as claimed in any one of Examples J1-J13.

Example K1 is a method that includes receiving sensor data from a sensor coupled to an autonomous vehicle (AV); applying a digital signature to the sensor data; adding a new block to a block-based topology, the new block comprising the sensor data and the digital signature; verifying the digital signature; and communicating the block to a logic unit of the AV based on the digital signature being verified.

Example K2 includes the subject matter of Example K1, where the block-based topology is a permission-less blockchain.

Example K3 includes the subject matter of Example K1, where the digital signature is based on an elliptic curve cryptographic (ECC) protocol.

Example K4 includes the subject matter of any one of Examples K1-K3, where verifying the block comprises verifying a time stamp of the sensor data using a time constraint of a consensus protocol.

Example K5 is an apparatus that includes memory and processing circuitry coupled to the memory to perform one or more of the methods of claims K1-K4.

Example K6 is a system comprising means for performing one or more of the methods of Examples K1-K4.

Example K7 is a product comprising one or more tangible computer-readable non-transitory storage media comprising computer-executable instructions operable to, when executed by at least one computer processor, enable the at least one computer processor to implement operations of the methods of Examples 1-4.

Example K8 is a method that includes receiving, at a first autonomous vehicle (AV), a block of a block-based topology, the block comprising sensor data from a sensor coupled to a second autonomous vehicle (AV) and a digital signature associated with the sensor data; verifying the digital signature; and communicating the block to a logic unit of the first AV in response to verifying the digital signature.

Example K9 includes the subject matter of Example K8, where the block-based topology includes one or more of a blockchain or a dynamic acyclic graph (DAG).

Example K10 includes the subject matter of Example K8, where the block-based topology is a permissioned blockchain.

Example K11 includes the subject matter of any one of Examples K8-K10, where the digital signature is verified using a secret key generated based on an ephemeral public key.

Example K12 includes the subject matter of Example K11, where the ephemeral public key is based on an elliptic curve Diffie Hellman exchange.

Example K13 includes the subject matter of any one of Examples K8-K12, where the method further includes extracting one or more smart contracts from the block.

Example K14 is an apparatus that includes memory and processing circuitry coupled to the memory to perform one or more of the methods of Examples K8-K13.

Example K15 is a system comprising means for performing one or more of the methods of Examples K8-K13.

Example K16 is a product comprising one or more tangible computer-readable non-transitory storage media comprising computer-executable instructions operable to, when executed by at least one computer processor, enable the at least one computer processor to implement operations of the methods of Examples K8-K13.

Example L1 is a method that includes obtaining sensor data sampled by a plurality of sensors of a vehicle; determining a context associated with the sampled sensor data; and based on the context, determine one or both of a group of sampling rates for the sensors of the vehicle or a group of weights for the sensors to be used to perform fusion of the sensor data.

Example L2 includes the subject matter of Example L1, where the method further includes providing the context as an output of a machine learning algorithm that receives the sampled sensor data as input.

Example L3 includes the subject matter of Example L2, where the machine learning algorithm is trained using data sets as ground truth, wherein each data set includes a context, sampling rates for the plurality of sensors, and a safety outcome.

Example L4 includes the subject matter of any of Examples L1-L3, where the method further includes: providing the group of weights for the sensors using a fusion-context dictionary that receives the context from the plurality of sensors as an input and outputs the group of weights.

Example L5 includes the subject matter of Example L4, where the fusion-context dictionary is provided by training a machine learning algorithm using context information and object locations as ground truth.

Example L6 includes the subject matter of any of Examples L1-L5, where the context is used to determine the group of sampling rates for the sensors of the vehicle and the group of weights for the sensors to be used to perform fusion of the sensor data.

Example L7 includes the subject matter of any of Examples L1-L6, where the method further includes combining samples from the plurality of the sensors based on the group of weights.

Example L8 includes the subject matter of any of Examples L1-L7, where the method further includes determining the group of weights based on the context using a reinforcement learning model.

Example L9 includes the subject matter of Example 8, where the reinforcement learning model is trained using an environment of sensor samples and contexts.

Example L10 includes the subject matter of any of Examples L8-L9, wherein the reinforcement learning model is trained using a reward based on object tracking accuracy and minimization of power consumption.

Example L11 is an apparatus that includes memory and processing circuitry coupled to the memory to perform one or more of the methods of Examples L1-L10.

Example L12 is a system comprising means for performing one or more of the methods of Examples L1-L10.

Example L13 includes at least one machine readable medium comprising instructions, wherein the instructions when executed realize an apparatus or implement a method as claimed in any one of Examples L1-L10.

Example M1 is a method that includes receiving, at a subject autonomous vehicle (AV) from a traffic vehicle, modulated light signals; sampling the modulated light signals; demodulating the sampled light signals to obtain position information for the traffic vehicle; and using the position information of the traffic vehicle in a sensor fusion process of the subject AV.

Example M2 includes the subject matter of Example M1, where the modulated light signals are sampled at a particular frequency.

Example M3 includes the subject matter of Example M2, where the particular frequency is selected proactively.

Example M4 includes the subject matter of Example M2, where the particular frequency is selected based on events.

Example M5 includes the subject matter of Example M1, where the modulated light signals are sampled in response to detection of the traffic vehicle's presence.

Example M6 includes the subject matter of Example M1, where the position information includes geocoordinates of the traffic vehicle in a Degree Minute and Second format.

Example M7 includes the subject matter of Example 1, where the modulated light is demodulated to further obtain size information for the traffic vehicle, the size information including one or more of a length, width, or height of the traffic vehicle.

Example M8 includes the subject matter of any one of Examples M1-M7, where the modulated light is transmitted according to a Li-Fi protocol.

Example M9 includes the subject matter of any one of Examples M1-M7, where the modulated light signals are modulated according to On-Off Keying (OOK), Amplitude Shift Keying (ASK), Variable pulse position modulation (VPPM), or Color-Shift Keying (CSK).

Example M10 includes the subject matter of any one of Examples M1-M7, where the modulated light includes one or more of visible light having a wavelength between 375 nm and 780 nm, infrared light, and ultraviolet light.

Example M11 is an apparatus that includes memory and processing circuitry coupled to the memory to perform one or more of the methods of Examples M1-M10.

Example M12 is a system comprising means for performing one or more of the methods of Examples M1-M10.

Example M13 is a product comprising one or more tangible computer-readable non-transitory storage media comprising computer-executable instructions operable to, when executed by at least one computer processor, enable the at least one computer processor to implement operations of the methods of Examples M1-M10.

Example N1 is a method that includes obtaining sensor data from a sensor coupled to an autonomous vehicle; applying a sensor abstraction process to the sensor data to produce abstracted scene data, wherein the sensor abstraction process includes one or more of: applying a response normalization process to the sensor data; applying a warp process to the sensor data; and applying a filtering process to the sensor data; and using the abstracted scene data in a perception phase of a control process for the autonomous vehicle.

Example N2 includes the subject matter of Example N1, where sensor data includes first sensor data from a first sensor and second sensor data from a second sensor, wherein the first sensor and second sensor are of the same sensor type, and applying the sensor abstraction process comprises one or more of: applying a respective response normalization process to each of the first sensor data and the second sensor data; applying a respective warping process to each of the first sensor data and the second sensor data; and applying a filtering process to a combination of the first sensor data and the second sensor data.

Example N3 includes the subject matter of Example N1, wherein the sensor data includes first sensor data from a first sensor and second sensor data from a second sensor, wherein the first sensor and second sensor are different sensor types, and applying the sensor abstraction process comprises one or more of: applying a respective response normalization process to each of the first sensor data and the second sensor data; applying a respective warping process to each of the first sensor data and the second sensor data; and applying a respective filtering process to each of the first sensor data and the second sensor data to produce first abstracted scene data corresponding to the first sensor data and second abstracted scene data corresponding to the second sensor data; and the method further comprises applying a fuse process to the first and second abstracted scene data; wherein the fused first and second abstracted scene data are used in the perception phase.

Example N4 includes the subject matter of any one of Examples N1-N3, where applying a response normalization process comprises one or more of normalizing pixel values of an image, normalizing a bit depth of an image, normalizing a color space of an image, and normalizing a range of depth or distance values in lidar data.

Example N5 includes the subject matter of any one of Examples N1-N3, where applying a response normalization process is based on a model of the sensor response.

Example N6 includes the subject matter of any one of Examples N1-N3, where applying a warping process comprises performing one or more of a spatial upscaling operation, a downscaling operation, a correction process for geometric effects associated with the sensor, and a correction process for motion of the sensor.

Example N7 includes the subject matter of any one of Examples N1-N3, where applying a warping process is based on sensor configuration information.

Example N8 includes the subject matter of any one of Examples N1-N3, where applying a filtering process comprises applying one or more of a Kalman filter, a variant of the Kalman filter, a particle filter, a histogram filter, an information filter, a Bayes filter, and a Gaussian filter.

Example N9 includes the subject matter of any one of Examples N1-N3, where applying a filtering process is based on one or more of a model for the sensor and a scene model.

Example N10 includes the subject matter of any one of Examples N1-N3, where applying a filtering process comprises determining a validity of the sensor data and discarding the sensor data in response to determining that the sensor data is invalid.

Example N11 is an apparatus that includes memory and processing circuitry coupled to the memory to perform one or more of the methods of Examples N1-N10.

Example N12 is a system comprising means for performing one or more of the methods of Examples N1-N10.

Example N13 is a product comprising one or more tangible computer-readable non-transitory storage media comprising computer-executable instructions operable to, when executed by at least one computer processor, enable the at least one computer processor to implement operations of the methods of Examples N1-N10.

Example O1 is a method that includes capturing first image data by a first sensor of a vehicle, the first image data having a first resolution; using a machine learning model, transforming the first image data into second image data having a second resolution, wherein the second resolution is higher than the first resolution; and performing object detection operations for the vehicle based on the second image data.

Example O2 includes the subject matter of Example O1, where the first sensor of the vehicle comprises a camera.

Example O3 includes the subject matter of Example O1, where the first sensor of the vehicle comprises a LiDAR.

Example O4 includes the subject matter of Examples O1-O3, where the machine learning model is trained using a training set comprising third images captured by a second sensor and fourth images generated by distorting the third images to appear to have a lower resolution than the third images.

Example O5 includes the subject matter of Example O4, where the fourth images are generated by distorting the third images using any one or more of: applying a low-pass filter to the third images; sub-sampling the third images; downsampling the third images; injecting noise into the third images; or randomizing channels of the third images.

Example O6 includes the subject matter of any of Examples O1-O4, where the machine learning model is trained using a training set comprising third images captured by a second sensor having the first resolution and fourth images captured by a third sensor having the second resolution.

Example O7 includes the subject matter of any of Examples O1-O5, where the machine learning model comprises a convolutional neural network architecture.

Example O8 includes the subject matter of any of Examples 1-6, where the machine learning model comprises a generative neural network.

Example O9 is an apparatus that includes memory and processing circuitry coupled to the memory to perform one or more of the methods of Examples O1-O8.

Example O10 is a system comprising means for performing one or more of the methods of Examples O1-O8.

Example O11 includes at least one machine readable medium comprising instructions, wherein the instructions when executed realize an apparatus or implement a method as claimed in any one of Examples O1-O8.

Example O12 is a method that includes training an ensemble of machine learning models to perform a task of an autonomous vehicle stack, the ensemble comprising a first machine learning model trained using image data having a first resolution and a second machine learning model; and training a third machine learning model based at least in part on a distillation loss between fused soft prediction targets of the ensemble of machine learning models and soft prediction targets of the third machine learning model.

Example O13 includes the subject matter of Example O12, where the method further includes training the third machine learning model further based on a loss representing a difference between ground truth labels and hard prediction targets of the third machine learning model.

Example O14 includes the subject matter of any of Examples O12-O13, where the image data having the first resolution is data captured by one or more LiDARs.

Example O15 includes the subject matter of any of Examples O12-O13, where the image data having the first resolution is data captured by one or more cameras.

Example O16 includes the subject matter of any one of Examples O12-O15, where the third machine learning model is trained using image data having a second resolution, the second resolution lower than the first resolution.

Example O17 includes the subject matter of any of Examples O12-O16, where the third machine learning model is trained using image data captured by one or more cameras.

Example O18 includes the subject matter of any of Examples O12-O16, where the third machine learning model is trained using image data captured by one or more LIDARs.

Example O19 includes the subject matter of any of Examples O12-O18, where the third machine learning model is a combination of a fourth machine learning model trained using image data captured by one or more LIDARs and a fifth machine learning model trained using image data captured by one or more cameras.

Example O20 is an apparatus that includes memory and processing circuitry coupled to the memory to perform one or more of the methods of Examples O12-O19.

Example O21 is a system comprising means for performing one or more of the methods of Examples O12-O19.

Example O22 includes at least one machine readable medium comprising instructions, wherein the instructions when executed realize an apparatus or implement a method as claimed in any one of Examples O12-O19.

Example P1 is a system that includes a memory to store sensed data; an internal sensing module of a first autonomous vehicle, the internal sensing module comprising circuitry to initiate communication of data sensed by the first autonomous vehicle to an external sensing module of a second autonomous vehicle; an external sensing module of the first autonomous vehicle, the external sensing module of the first autonomous vehicle to receive data from an internal sensing module of the second autonomous vehicle; and a cooperative decision maker of the first autonomous vehicle, the cooperative decision maker comprising circuitry to determine driving actions based on communication with a cooperative decision maker of the second autonomous vehicle.

Example P2 includes the subject matter of Example P1, where the internal sensing module of the first autonomous vehicle is to communicate with the external sensing module of the second autonomous vehicle using semantic language.

Example P3 includes the subject matter of any one or more of Examples P1-P2, where the external sensing module of the first autonomous vehicle is to communicate with the internal sensing module of the second autonomous vehicle using semantic language.

Example P4 includes the subject matter of any one or more of Examples P1-P3, where the cooperative decision maker of the first autonomous vehicle is to communicate with the cooperative decision maker module of the second autonomous vehicle using semantic language.

Example P5 includes the subject matter of any one or more of Examples P1-P4, where the system includes an augmented sensing module of the first autonomous vehicle.

Example P6 includes the subject matter of any one or more of Examples P1-P5, where the data that is communicated between the cooperative decision maker of the first autonomous vehicle and the cooperative decision maker of the second autonomous vehicle comprises data that relates to a plan of action of the first autonomous vehicle or the second autonomous vehicle.

Example P7 includes the subject matter of any one or more of Examples P1-P6, where the internal sensing module of the first autonomous vehicle is to analyze the data sensed by the first autonomous vehicle.

Example P8 includes the subject matter of any one or more of Examples P1-P7, where the system further includes a virtual reality perception module comprising circuitry to receive data sensed from one or more external agents to view the surroundings of the first autonomous vehicle using the data sensed from the one or more external agents.

Example P9 is a method that includes sharing data from a first autonomous vehicle to a second autonomous vehicle using a semantic language.

Example P10 includes the subject matter of Example P9, where the data comprises critical data related to one or more traffic situations.

Example P11 is a system comprising means to perform any one or more of Examples P9-P10.

Example P12 includes the subject matter of Example P11, where the means comprises at least one machine readable medium comprising instructions, wherein the instructions when executed implement am method of any one or more of Examples P9-P10.

Example Q1 is a method that includes generating, by a control unit comprising circuitry, a position adjustment instruction for an image sensor of a vehicle; receiving, at the control unit, image data from the image sensor of the vehicle; detecting a location and size of a marker of the vehicle within the image data; and generating, by the control unit, a second position adjustment instruction for the image sensor of the vehicle based on the location and size of the marker of the vehicle within the image data.

Example Q2 includes the subject matter of Example Q1, where the position adjustment instruction specifies an angle of horizontal rotation of the image sensor of the vehicle.

Example Q3 includes the subject matter of any of Examples Q1-Q2, where the position adjustment instruction specifies an angle of vertical rotation of the image sensor of the vehicle.

Example Q4 includes the subject matter of any of Examples Q1-Q3, where the position adjustment instruction specifies a distance of horizontal movement of the image sensor of the vehicle.

Example Q5 includes the subject matter of any of Examples Q1-Q4, where the position adjustment instruction specifies a distance of vertical movement of the image sensor of the vehicle.

Example Q6 includes the subject matter of any of Claims Q1-Q5, where the method further includes generating the position adjustment instruction for the image sensor in response to a detected condition associated with the vehicle.

Example Q7 includes the subject matter of any of Examples Q1-Q6, where the position adjustment instruction is part of a series of periodic position adjustment instructions of the image sensor of the vehicle.

Example Q8 includes the subject matter of any of Examples Q1-Q7, where the marker of the vehicle is disposed on the exterior of the vehicle and is a different color than the exterior of the vehicle.

Example Q9 is an apparatus that includes memory and processing circuitry coupled to the memory to perform one or more of the methods of Examples Q1-Q8.

Example Q10 is a system comprising means for performing one or more of the methods of Examples Q1-Q8.

Example Q11 includes at least one machine readable medium comprising instructions, wherein the instructions when executed realize an apparatus or implement a method as claimed in any one of Examples Q1-Q8.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

1.-31. (canceled)

32. An apparatus comprising:
an interface to receive sensor data from a plurality of sensors of an autonomous vehicle; and
processing circuitry coupled to the interface, the processing circuitry to:
abstract the sensor data to produce abstracted sensor data, wherein the processing circuitry is to abstract the sensor data by one or more of:
normalizing sensor response values of the sensor data;
warping the sensor data; and
filtering the sensor data; and
use the abstracted sensor data in a perception phase of a control process for the autonomous vehicle.

33. The apparatus of claim 32, wherein the sensor data includes first sensor data from a first sensor and second sensor data from a second sensor, the first sensor and second sensor are of the same sensor type, and the processing circuitry is to abstract the sensor data by one or more of:
respectively normalizing sensor response values for the first sensor data and the second sensor data;
respectively warping the first sensor data and the second sensor data; and
filtering a combination of the first sensor data and the second sensor data.

34. The apparatus of claim 32, wherein the sensor data includes first sensor data from a first sensor and second sensor data from a second sensor, the first sensor and second sensor are different sensor types, the processing circuitry is to:
abstract the sensor data to produce first abstracted sensor data corresponding to the first sensor data and second abstracted sensor data corresponding to the second sensor data, wherein the processing circuitry is to abstract the sensor data by one or more of:
normalizing sensor response values for each of the first sensor data and the second sensor data;
warping each of the first sensor data and the second sensor data; and
filtering each of the first sensor data and the second sensor data; and
fuse the first and second abstracted sensor data, wherein the fused first and second abstracted sensor data are used in the perception phase.

35. The apparatus of claim 32, wherein the processing circuitry is to normalize sensor response values by one or more of normalizing pixel values of an image, normalizing a bit depth of an image, normalizing a color space of an image, and normalizing a range of depth or distance values in lidar data.

36. The apparatus of claim 32, wherein the processing circuitry is to normalize sensor response values based on one or more sensor response models for the plurality of sensors.

37. The apparatus of claim 32, wherein the processing circuitry is to warp the sensor data by performing one or more of a spatial upscaling operation, a downscaling operation, a correction process for geometric effects associated with the sensor, and a correction process for motion of the sensor.

38. The apparatus of claim 32, wherein the processing circuitry is to warp the sensor data based on sensor configuration information for the plurality of sensors.

39. The apparatus of claim 32, wherein the processing circuitry is to filter the sensor data by applying one or more of a Kalman filter, a variant of the Kalman filter, a particle filter, a histogram filter, an information filter, a Bayes filter, and a Gaussian filter.

40. The apparatus of claim 32, wherein the processing circuitry is to filter the sensor data based on one or more of sensor noise models for the plurality of sensors and a scene model.

41. The apparatus of claim 32, wherein the processing circuitry is to filter the sensor data determining a validity of the sensor data and discarding the sensor data in response to determining that the sensor data is invalid.

42. The apparatus of claim 32, wherein the processing circuitry is to filter the sensor data by determining a confidence level of the sensor data and discarding sensor data in response to determining that the sensor data is below a confidence threshold.

43. The apparatus of claim 32, wherein the processing circuitry us to filter the sensor data by determining a confidence level of the sensor data and discarding sensor data in response to determining that the sensor data is outside a range of values.

44. The apparatus of claim 32, wherein the apparatus is incorporated in the autonomous vehicle.

45. A computer-readable medium to store instructions, wherein the instructions, when executed by a machine, causes the machine to:
obtain sensor data from at least one sensor coupled to an autonomous vehicle;
abstract the sensor data to produce abstracted sensor data, wherein abstracting the sensor data comprises one or more of:
normalizing sensor response values of the sensor data;
warping the sensor data; and
filtering the sensor data; and
use the abstracted sensor data in a perception phase of a control process for the autonomous vehicle.

46. The computer-readable medium of claim 45, wherein the sensor data includes first sensor data from a first sensor and second sensor data from a second sensor, wherein the first sensor and second sensor are of the same sensor type, and abstracting the sensor data comprises one or more of:
respectively normalizing sensor response values for the first sensor data and the second sensor data;
respectively warping the first sensor data and the second sensor data; and
filtering a combination of the first sensor data and the second sensor data.

47. The computer-readable medium of claim 45, wherein the sensor data includes first sensor data from a first sensor and second sensor data from a second sensor, wherein the first sensor and second sensor are different sensor types, and the instructions further cause the machine to:
produce first abstracted sensor data corresponding to the first sensor data and second abstracted sensor data corresponding to the second sensor data, wherein producing the first abstracted sensor data and the second abstracted sensor data comprises:
respectively normalizing sensor response values for the first sensor data and the second sensor data;
respectively warping the first sensor data and the second sensor data; and
respectively filtering the first sensor data and the second sensor data; and
fuse the first and second abstracted sensor data, wherein the fused first and second abstracted sensor data are used in the perception phase.

48. The computer-readable medium of claim 45, wherein normalizing sensor response values comprises one or more of normalizing pixel values of an image, normalizing a bit depth of an image, normalizing a color space of an image, and normalizing a range of depth or distance values in lidar data.

49. The computer-readable medium of claim 45, wherein normalizing sensor response values is based on one or more sensor response models for the plurality of sensors.

50. The computer-readable medium of claim 45, wherein warping the sensor data comprises one or more of performing one or more of a spatial upscaling operation, a downscaling operation, a correction process for geometric effects associated with the sensor, and a correction process for motion of the sensor.

51. The computer-readable medium of claim 45, wherein warping the sensor data is based on sensor configuration information for the plurality of sensors.

52. The computer-readable medium of claim 45, wherein filtering the sensor data comprises applying one or more of a Kalman filter, a variant of the Kalman filter, a particle filter, a histogram filter, an information filter, a Bayes filter, and a Gaussian filter.

53. The computer-readable medium of claim 45, wherein filtering the sensor data is based on one or more of sensor noise models for the plurality of sensors and a scene model.

54. The computer-readable medium of claim 45, wherein filtering the sensor data comprises determining a validity of the sensor data and discarding the sensor data in response to determining that the sensor data is invalid.

55. An autonomous vehicle comprising:
a plurality of sensors;
an interface to receive sensor data from a plurality of sensors of an autonomous vehicle; and
a control unit comprising circuitry to:
abstract the sensor data to produce abstracted sensor data, wherein the processing circuitry is to abstract the sensor data by one or more of:
normalizing sensor response values of the sensor data;
warping the sensor data; and
filtering the sensor data; and
use the abstracted sensor data in a perception phase of a control process for the autonomous vehicle.

56. A system comprising:
means to abstract sensor data to produce abstracted sensor data, wherein the means comprise one or more of:
means to apply a response normalization process to the sensor data;
means to warp the sensor data; and
means to filter the sensor data; and
means to use the abstracted scene data in a perception phase of a control process for the autonomous vehicle.
